(19) United States
(12) Patent Application Publication
(10) Pub. No.: US 2019/0153308 A1
(43) Pub. Date: May 23, 2019

(54) Dinuclear Organometallic Complex and Application Using Same

(71) Applicants: AAC Microtech (Changzhou) Co., Ltd.,, Changzhou (CN); Zhejiang University of Technology, Hangzhou (CN)

(72) Inventors: Guijie Li, Shenzhen (CN); Yuanbin She, Shenzhen (CN); Xiangdong Zhao, Shenzhen (CN); Shaohai Chen, Saratoga, CA (US)

(21) Appl. No.: 15/975,541

(22) Filed: May 9, 2018

(30) Foreign Application Priority Data
Nov. 17, 2017 (CN) 201711143496.8

(51) Int. Cl. C09K 11/06

(52) U.S. Cl. CPC C09K 11/06; C09K 2211/185; C09K 2211/1074; C09K 2211/1059; C09K 2211/1044

(57) ABSTRACT

The invention relates to the technical field of organic luminescent materials, in particular to a binuclear organometallic complex, its luminescent devices and its application. The binuclear organometallic complexes of the invention are at least one of the compounds shown in the selected from the general formula I. The luminescent interval of the binuclear organometallic complexes of the invention is in the range of 400 nm to about 700 nm, compared with the traditional complexes, the binuclear organometallic complexes of the invention have improved stability and efficiency.

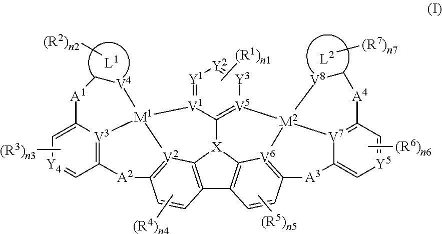

### FIELD OF THE PRESENT DISCLOSURE

The invention relates to the technical field of organic luminescent material, in particular to a binuclear organometallic complex, its luminescent devices and applications.

### DESCRIPTION OF RELATED ART

Compounds capable of absorbing and/or emitting light are ideally suited for use in a variety of optical and electroluminescent devices, including, for example, optical absorption devices e.g.: solar sensitive devices and photo sensitive devices, organic light-emitting diodes (OLED), light emitting devices, or marker devices that can both absorb and emit light and also be used as for biological applications. Many studies have been devoted to the discovery and optimization of organic and organometallic materials used in optical and electroluminescent devices. In general, the research in this area is aimed at achieving many objectives, including improving absorption and emission efficiency, and improving processing capacity.

Despite significant advances in research of chemical and electro-optic materials, for example, red-green phosphorescent organometallic materials have been commercialized and used in OLEDs, lighting devices, and phosphor materials in advanced displays. However, the available materials still have many shortcomings, including poor mechanical properties, inefficient emission or absorption, and less desirable stability.

However, up to now, the blue electroluminescent devices are still the most challenging field in this technology, and the stability of blue devices is a major problem. It has been proved that the selection of host materials is very important for the stability of blue devices. However, the lowest energy of the triple excited state (T1) of the blue luminescent material is very high, which means that the lowest energy of the triple excited state (T1) of the host material from the blue device should be higher. This leads to greater difficulties in the development of the host materials from the blue equipment. Therefore, the limitation of the host materials in blue light devices is an important issue for its development.

In general, the changes in the chemical structure will affect the electronic structure of the compound, which in turn affects the optical properties of the compound (e.g., emission and absorption spectra), thus, it is capable of regulating or adjusting the compounds described in this application to specific emission or absorption energy. In some respects, the optical properties of the compounds disclosed in this application can be regulated by changing the structure of the ligand surrounding the metal center. For example, the compounds having ligands with electron-donating or electron-absorbing substituents usually exhibit different optical properties, including different emission and absorption spectra

Due to the fact that the phosphorescent polydentate palladium metal complexes can simultaneously use the electrically excited singlet and triplet excitons, 100% internal quantum efficiency can be obtained. Thus, these complexes can be used as OLEDs alternative luminescent materials. In general, the ligand of polydentate metal complexes includes luminescent and auxiliary groups. If the conjugated groups, e.g.: aromatic ring substituents or heteratomic substituents, are introduced into the luminescent part, the energy levels of the highest molecular of the luminescent material occupying the orbitals (HOMO) and the lowest molecular orbital (LOMOL) have been changed, at the same time. By further regulating the energy level gap between the HOMO orbital and the LOMO orbital, the emission spectral properties of the phosphorescent polydentate palladium metal complex can be regulated, e.g.: making it wider or narrower, or making red shift or blue shift.

Therefore, there is a need for new materials that exhibit improved performance in optical emission and absorption applications. Thus, such compounds and their luminescent devices are disclosed herein.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 shows ¹H NMR spectra of Compound Pd 1.

FIG. 2 shows the emission spectra of Compound Pd 1 in dichloromethane solution at room temperature.

FIG. 3 shows the emission spectra of Compound Pt 1 in dichloromethane solution at room temperature.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

The present invention is further elaborated in combination with exemplary embodiments. It should be understood that these embodiments are used only to illustrate the invention and not to limit the scope in the invention.

The embodiment of the invention provides a binuclear organometallic complex, which is selected from at least one of the compounds shown in the general formula I:

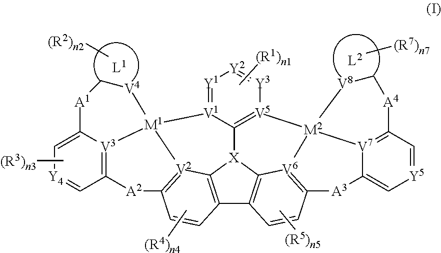

In the formula I, L¹ and L² denote C₆˜C₁₈ aromatic ring, C₃˜C₁₈ heterocyclic ring and C₄˜C₈ heterocyclic independently, respectively. In which, C₆˜C₁₈ aromatic ring can be selected from benzene ring and fused ring structure naphthalene ring etc, and C₃˜C₁₈ heterocyclic ring is an aromatic ring containing at least one hetero atom, and the hetero atom can be selected from nitrogen atom, oxygen atom, phosphorus atom etc, and further selected from nitrogen atom.

In which, from the point of view of preparation, the preparation process is more convenient when L¹ and L² are the same, but it can also be different.

In formula I, M¹ and M² are selected from platinum or palladium independently, respectively. M¹ and M² can be the same or different, from the point of view of preparation, when M¹ and M² are the same, the preparation process is more convenient.

In the formula I, V¹, V², V³, V⁴, V⁵, V⁶, V⁷ and V⁸ are atoms coordinated with palladium, which are selected from nitrogen atoms or carbon atoms independently, respectively. At least two of V¹, V², V³ and V⁴ are nitrogen atoms, and at least two of V⁵, V⁶, V⁷ and V⁸ are nitrogen atoms.

The specific options of V¹, V², V³, V⁴, V⁵, V⁶, V⁷ and V⁸ are listed below:

V¹ and V⁴ are N, V² and V³ are C, V⁵ and V⁸ are N, V⁶ and V⁷ are C; or

V¹, V² and V³ are C, V⁴ are N, V⁵ and V⁸ are N, V⁶ and V⁷ are C; or

V¹ and V³ are C, V² and V⁴ are N, V⁵ and V⁷ are C, V⁶ and V⁸ are N.

Optionally, V¹, V⁵ are nitrogen atoms, at least one of V², V³ and V⁴4 is a nitrogen atom, and at least one of V⁶, V⁷ and V⁸ is a nitrogen atom.

Further optionally, V¹, V⁴, V⁵ and V⁸ are nitrogen atoms, while V², V³, V⁶ and V⁷ are carbon atoms.

In Formula I, X is a trivalent connection unit capable of connecting three groups, each of which is independently selected from

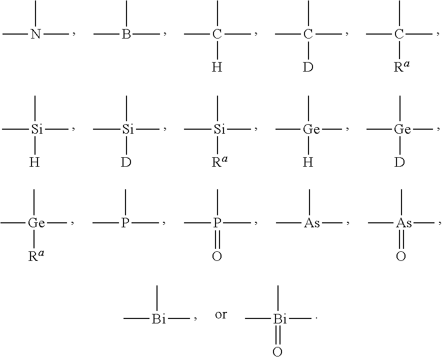

In formula I, Y¹, Y², Y³, Y⁴ and Y⁵ are independently selected from nitrogen or carbon atoms respectively.

Optionally, in the ring structure containing Y¹, Y² and Y³, V¹ and V⁵ are nitrogen atoms. The specific structure of

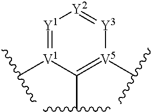

can be selected from

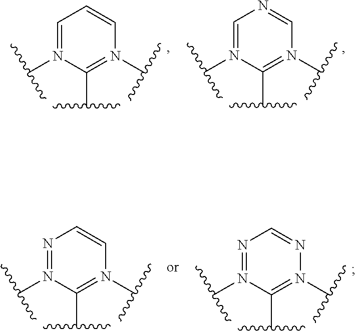

In which, a chemical bond marked with the symbol “ [symbol] ”, indicates that the chemical bond is connected to other atoms.

In Formula I, A¹, A², A³ and A⁴ are bivalent connecting units capable of connecting two groups, each of which is independently selected from —O—, —S—, —CH₂—, —CD₂-, —CR^{a}R^{b}—, —C(═O)—, —SiR^{a}R^{b}—, —GeH₂—, —GeR^{a}R^{b}—, —NH—, —NR^{c}—, —PH—, —PR^{c}—, —R^{c}P(═O)—, —AsR^{c}—, —R^{c}As(═O)—, —S(═O)—, —SO₂—, —Se—, —Se(═O)—, —SeO₂—, —BH—, —BR^{c}—, —R^{c}Bi(═O)—, —BiH—, or —BiR^{c}—, respectively.

In formula I, R¹, R², R³, R⁴, R⁵, R⁶, R⁷, R^{a}, R^{b}, R^{c} and R^{d} are independently selected from hydrogen, deuterium, halogen, hydroxyl, mercapto, nitro, cyanide, amino, carboxyl, sulfonyl, sulfoxyl, sulfoxyl, sulfoxyl, hydrazine, ureyl, substituted or unsubstituted C₁˜C₂₄ alkyl, substituted or unsubstituted C₂˜C₂₄ alkyl, substituted or unsubstituted C₂˜C₂₄ alkynyl, substituted or unsubstituted C₆˜C₃₆ aryl, substituted or unsubstituted C₃˜C₁₈ heterocyclic, substituted or unsubstituted C₃˜C₃₆ hetero aryl, substituted or unsubstituted C₁˜C₂₄ alkoxy, substituted or unsubstituted C₁˜C₂₄ alkyl thioyl, substituted or unsubstituted C₂˜C₂₄, substituted or unsubstituted C₂˜C₂₄ alkyloxy, substituted or unsubstituted C₆˜C₃₆ aryl oxygen group, substituted or unsubstituted C₁˜C₂₄ alkoxy carbonyl, Substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl group, substituted or unsubstituted C₁˜C₃₆ sulfonylamino, substituted or unsubstituted C₁˜C₃₆ phosphoryl amine, substituted or unsubstituted C₂˜C₂₄ alkoxy carbonyl amine, substituted or unsubstituted C₇˜C₃₇ aryoxy carbonyl amino groups, substituted or unsubstituted methylsilyl alkyl, substituted or unsubstituted C₁˜C₁₈ monoalkylamines, Substituted or unsubstituted C₂˜C₃₆ dialkylamino, substituted or unsubstituted C₆˜C₃₆ monoaryl amine, substituted or unsubstituted C₁₂˜C₇₂ bis aryl amine, substituted or unsubstituted C₁˜C₃₆ ureylene and substituted or unsubstituted C₂˜C₃₆ imino, respectively; The substituents are selected from deuterium, halogen, hydroxyl, mercapto, nitro, cyanide, amino, carboxyl, sulfonyl, hydrazine, ureyl, C₁˜C₆ alkyl, C₆˜C₁₂ aryl group respectively.

In formula I, two or more adjacent R¹, R², R³, R⁴, R⁵, R⁶ and R⁷ can be joined to form rings to form heterolipids and heterocyclic rings. For example, two R¹ can form the structure of benzene ring, benzocyclohexane etc on the ring substituted by R¹.

In formula I, n₁, n₂, n₃, n₄, n₅, n₆ and n₇ are selected from integers 1˜4 independently, respectively. In which, the maximum number of substituents is determined by the number of substitutable hydrogen atoms on the ring where the substituents are located.

Taking R¹ as an example, the specific options are as follows:

R¹ does not exist, or R¹ exists, n₁ can be 1, 2, 3, 4, i.e., the formation of single substitution, double substitutions, three substitutions and four substitutions.

In the above-mentioned substituents:

If the alkyl has 1˜24 carbon atoms, the alkyl can be chain alkyl or cycloalkyl, and the hydrogen located on ring of naphthyl can be substituted by alkyl, e.g.: methyl, ethyl, n-propyl, isopropyl, N-butyl, isobutyl, S-butyl, Tert butyl, n-amyl, isoamyl, secondary pentyl, neopentyl, hexyl, heptyl, semi-radical, nonyl, decyl, 12 alkyl, 14 alkyl, cetyl, 20 alkyl, 24 alkyl, etc.

If the alkyl group has 2˜24 carbon atoms, itcan be either cycloalkene group or chain alkenyl group. The number of double-bond in the alkenyl group may be one or more. Specific examples: vinyl, allyl, isopropenyl, pentenyl, cyclopentenyl, cyclobutenyl, cyclopentenyl, cyclopentadienyl, cyclohexenyl, cyclohexadienyl.

If the alkynyl group has 2˜24 carbon atoms, it can be either cyclic or chained. The number of three-bond in the alkynyl group may be one or more. Specific examples: acetylene, propyl, isopropargyl, pentylethynyl, cycloheptynyl, cyclooctynyl, cyclononyl, etc.

If the aryl group has 6˜36 carbon atoms, including a plurality of phenyl-linked biphenyls, also includes two or more phenyl fused to form a dense ring compound, specific examples: phenyl, naphthyl, biphenyl etc.

Heterocyclic groups include heterocyclic groups and hetero-aryl groups, including heterocyclic groups formed by heterocyclic compounds without aromatic characteristics. Specific examples: heterocyclobutylamine and dioxane. Hetero-aryl refers to a monocyclic and polycyclic aromatic ring system: at least one of its central members is not carbon. Specific examples: furyl, imidazolyl, isothiazolyl, isoxazinyl, morpholinyl, oxazolyl (e.g., 1,2,3-oxadiazol, 1,2,5-oxadiazol, 1,3,4-oxadiazol), piperazinyl, piperidinyl, pyrazinyl, pyrazolyl, pyridyl, pyrimidinyl, pyrrolyl, pyrrolidinyl, tetrahydrofuryl, tetrahydropyranyl, tetrazine (e.g., 1,2,4,5-tetrazine), tetrazole (e.g., 1,2,3,4-tetrazole, 1,2,4,5-tetrazole), thiadiazole (e.g., 1,2,3-thiadiazole, 1,2,5-thiadiazole, and 1,3,4-thiadiazole), thiazole, thienyl, triazine (e.g., 1,3,5-triazine, 1,2,4-triazine), triazolyl (e.g., 1,2,3-triazolyl, 1,3,4-triazolyl) etc.

When the above alkyl group contains oxygen atoms, it may be alkoxy group, when the above alkyl group contains oxygen atom, it can be alkenyloxy group, when the above alkynyl group contains oxygen atom, it may be alkyloxy group. When the above aryl group contains oxygen atoms, it may be an aromatic oxygen group. When the above alkyl contains sulfur atoms, it may be alkyl thio.

Alkoxy carbonyl groups are denoted by —O—C(═O)—R′, in which R′ is an alkyl of the present invention.

Methylsilyl is denoted by —SiR′R″R′″, in which R′, R″ and R′″ may be hydrogen or alkyl, alkoxy, alkyl, alkyl, alkynyl, aryl or hetero-aryl as described in this application independently.

The sulfonyl group is denoted by —S(═O)₂R′, and the sulfonyl group is denoted by —S(═O)—R′, in which R′ is alkyl, alkoxy, alkenyl, acetyl, aryl or hetero-aryl etc. described in the present invention.

The sulfonyl amino groups are denoted by —S(═O)₂—NH—R′, —S(═O)₂—NR′R″, in which, R′, R″ are alkyl, alkoxy, alkenyl, alkynyl, aryl or hetero-aryl etc described in this invention.

The amido group is denoted by —C(═O)—NH—R′, —S(═O)₂—NR′R″, in which, R′, R″ are alkyl, alkoxy, alkenyl, alkynyl, aryl or hetero-aryl etc described in this invention.

The phosphoryl group is denoted by —P(═O)2-NH—R′, —P(═O)₂—NR′R″, in which, R′, R″are alkyl, alkoxy, alkenyl, alkynyl, aryl or hetero-aryl etc described in this invention.

The alkoxy carbonyl amino group is denoted by —O—C(═O)—NH—R′, —O—C(═O)—NR′R″, in which, R′, R″ are alkyl groups described in the present invention.

The aryl oxy carbonyl amino group is denoted by —O—C(═O)—NH—R′, —O—C(═O)—NR′R″, in which, R′, R″ are the aryl groups of the present invention.

The dialkylamino group is denoted by —NR′R″, in which R′, R′ are the alkyl groups of the present invention.

Monoalkylamine groups are denoted by —NH—R′, in which R′ is the alkyl of the invention.

The bisaryl amino group is denoted by —NRR″, in which R′, R′ are the aryl groups of the present invention.

The monoaryl amino group is denoted by —NH—R′, in which R′ is the aryl group of the present invention.

The suburetic groups are denoted by —NH—C(═O)—NH—R′, —R″—NH—C(═O)—NH—R′, in which R′ is alkyl, alkenyl, alkynyl, aryl or hetero-aryl etc, and R″ is alkyl, alkenyl, alkylidene, aryl or hetero-aryl, which are alkyl, alkenyl, alkylidene, aryl or hetero-aryl etc described in this invention.

The iminodium group is denoted by —C(═N—R′)—R″, in which R′, R′″ are alkyl, alkenyl, acetylene, aryl or hetero-aryl etc described in the present invention.

The ester groups are denoted by —C(═O)—O—R″, in which R′ is the alkyl, alkenyl, alkynyl, aryl or hetero-aryl etc described in the present invention.

Halogens include fluorine, chlorine, bromine, and iodine.

The embodiment of the invention proposes a new polydentate binuclear ring metal complex, which can not only regulate the photophysical properties of the complex by regulating the ligand. The properties can be regulated by bimetallic and the form and strength of ligand and two metals can be regulated by the design of ligands, and then the whole molecular photophysical properties can be controlled. For example, the color of the metal complexes can be adjusted by modifying the fluorescent luminaires and conjugated groups on the ligands so that the luminescence ranges from 400 nm to about 700 nm. The metal complexes of the present invention are thus customized or tuned to expect specific emission or absorption characteristics. Moreover, the ligand host structure of the polydentate binuclear ring metal complex is hexagonal and quaternary, which has extremely high electrochemical stability and thermal stability. In addition, the complexes formed by ligand and metal coordination have strong rigidity, which can further improve their stability, but also help to reduce the energy consumption of molecules due to vibration, and improve their quantum efficiency. Therefore, the complex of the embodiment of the invention has improved stability and efficiency compared with the traditional emission complex.

Further, the binuclear organometallic complex of the embodiment of the invention is electrically neutral, which is more conducive to the improvement of the evaporation plating performance of the metal complex in the application process.

As an improvement of binuclear organometallic complexes in the embodiment of the invention, when V¹, V⁴, V⁵ and V⁸ are nitrogen atoms, the selection is different according to Y⁴ and Y⁵. The binuclear organometallic complexes of the embodiment of the invention are further selected from groups composed of the compounds shown in the general formula IA and the general IB:

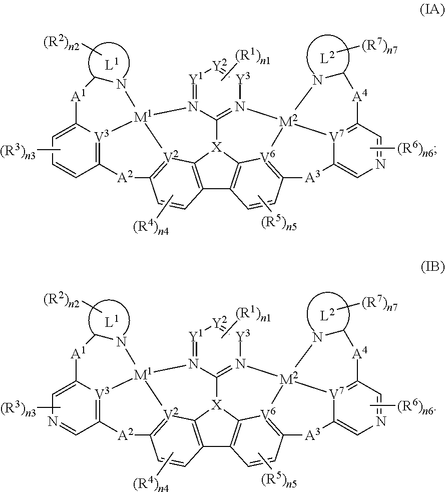

In the general formula IA and IB, V², V³, V⁶ and V⁷ are all carbon atoms;

In the general formula IA, according to different structures of rings containing Y¹, Y² and Y³, the binuclear organometallic complexes shown in the general formula IA can be further selected from the following groups composed of compounds shown in the general formula IAa, the general formula IAb, the general formula IAc and the general formula IAd:

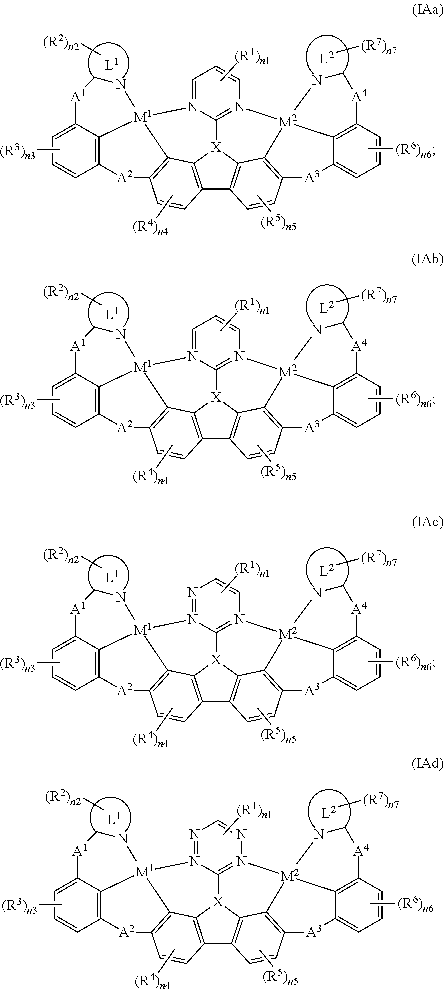

In the general formula IAa, according to differences between A¹ and A⁴, the binuclear organometallic complexes of the general formula IAa can be further selected from the following groups composed of compounds shown in the general formula IAa1, the general formula IAa2, the general formula IAa3, the general formula IAa4 and the general formula IAa5:

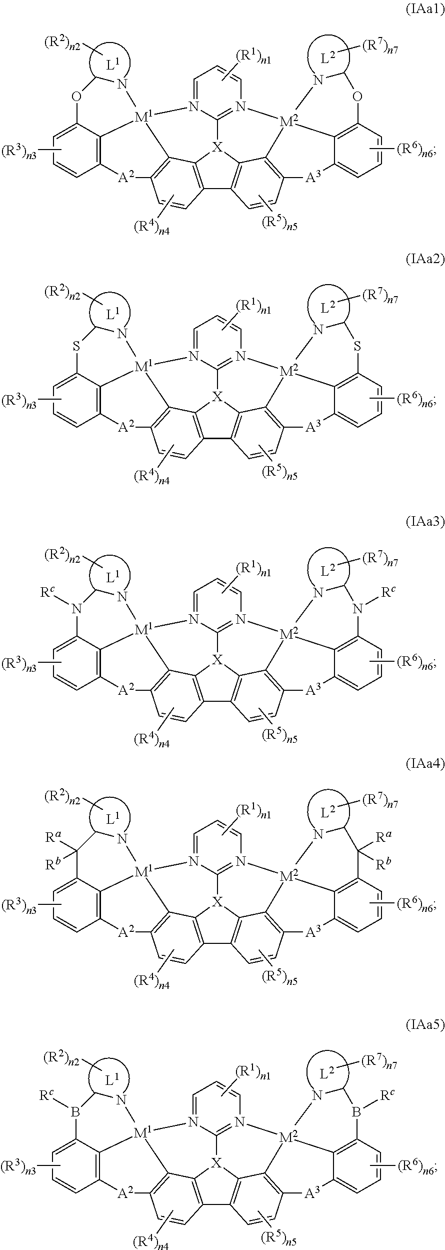

R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group independently, respectively. The substituents are selected from C₁˜C₆ alkyl and C₆˜C₁₂ aryl groups.

In the general formula IAa1, according to differences between A¹ and A⁴, the binuclear organometallic complexes of the general formula IAa1 can be further selected from the groups composed of compounds shown in the general formula IAa11, the general formula IAa12, the general formula IAa13, the general formula IAa14, the general formula IAa15, the general formula IAa16, the general formula IAa17 and the general formula IAa18:

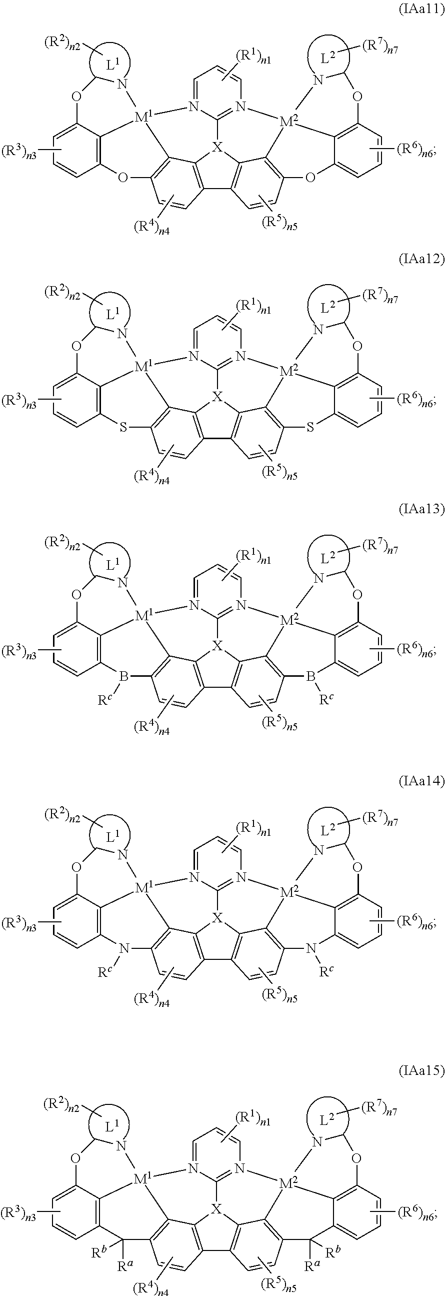

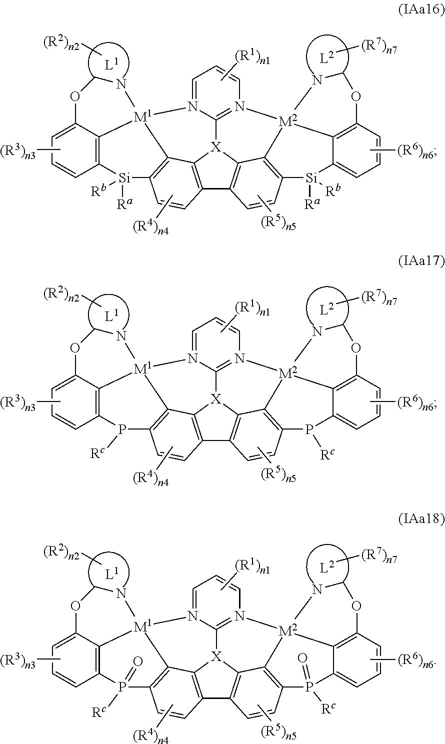

In general formula Aa11, according to difference of X, the compounds shown in general Aa11 can be selected from the groups composed of compounds shown in the general formula IAa111, the general formula IAa112, the general formula IAa113, the general formula IAa114, the general formula IAa115, the general formula IAa116, the general formula IAa117 and the general formula IAa118:

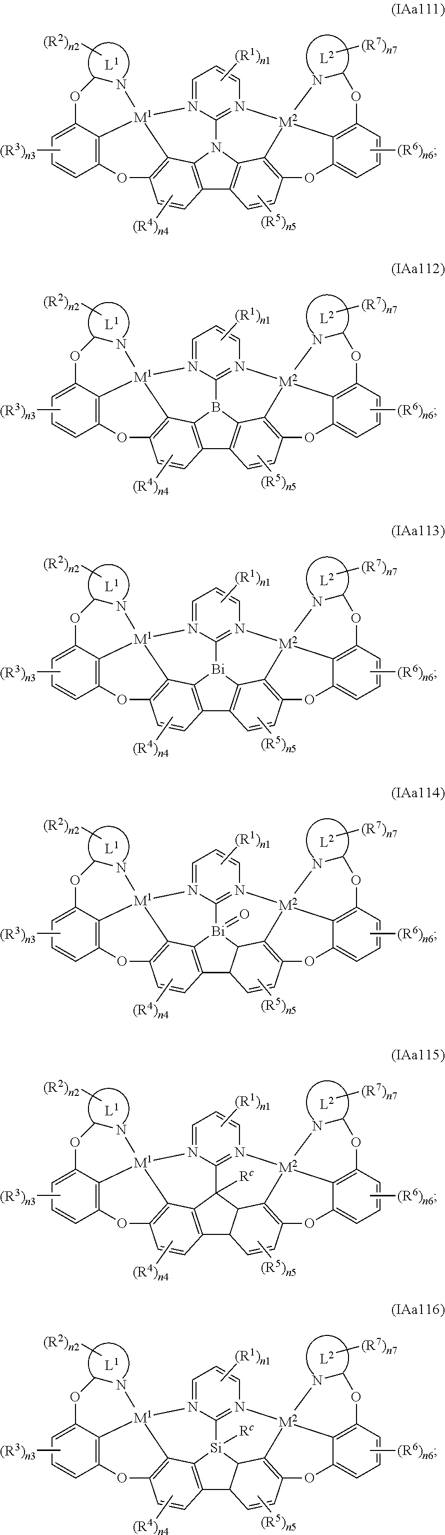

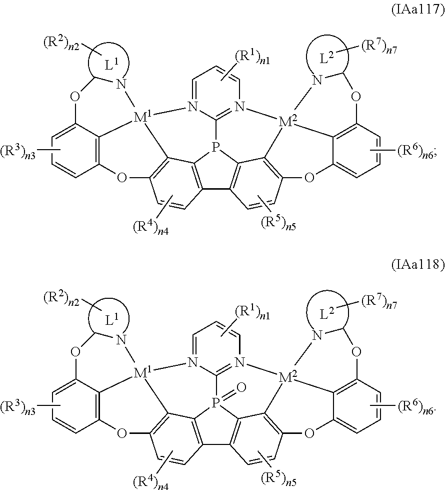

In the above the general formulas, when R¹ is not hydrogen, the position of R¹ is

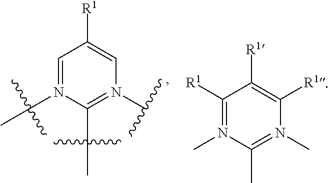

In the general formula IAb, according to difference between A¹ and A⁴, the compounds shown in the general formula IAb are further selected from the groups composed of compounds shown in the general formula IAb1, the general formula IAb2, the general formula IAb3, the general formula IAb4, the general formula IAb5:

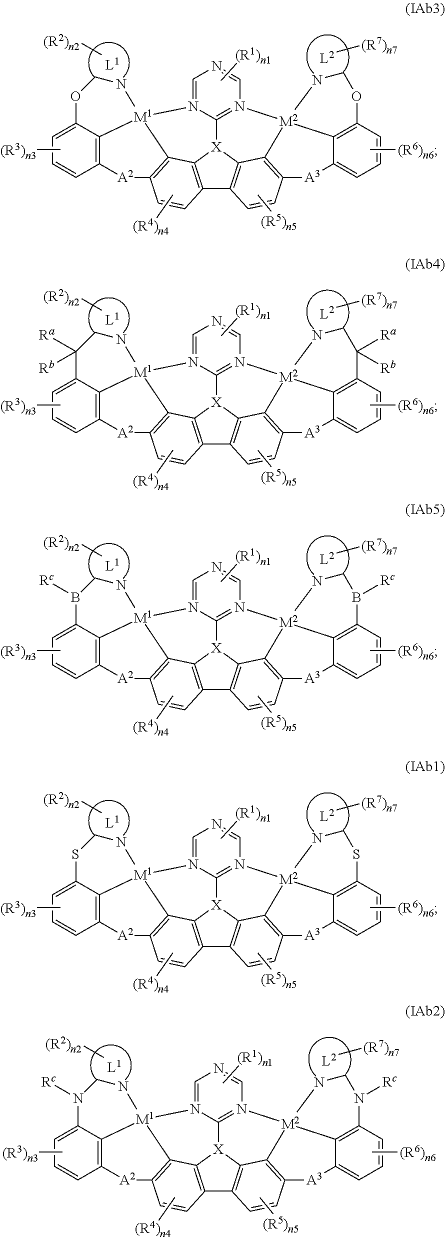

In which, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In the general formula IAb1, according difference between A² and A³, the compounds shown in the general formula IAb1 are further selected from the groups composed of compounds shown in the general formula IAb11, the general formula IAb12, the general formula IAb13, the general formula IAb14, the general formula IAb15, the general formula IAb16, the general formula IAb16, the general formula IAb17 and the general formula IAb18:

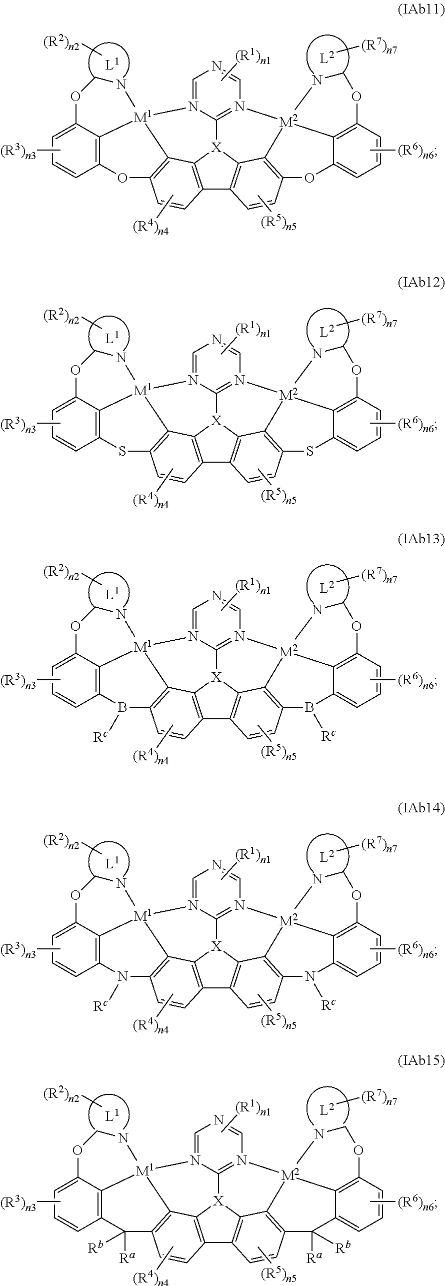

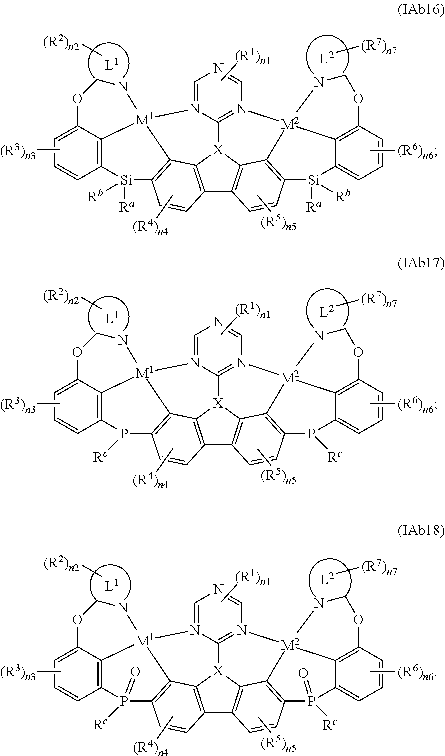

In the general formula IAb11, the compounds shown in the general formula IAb11 are further selected from the groups composed of compounds shown in the general formula IAb111, IAb112, the general formula IAb113, the general formula IAb114, the general formula IAb115, the general formula IAb115, the general formula IAb116, the general formula IAb117, the general formula IAb118:

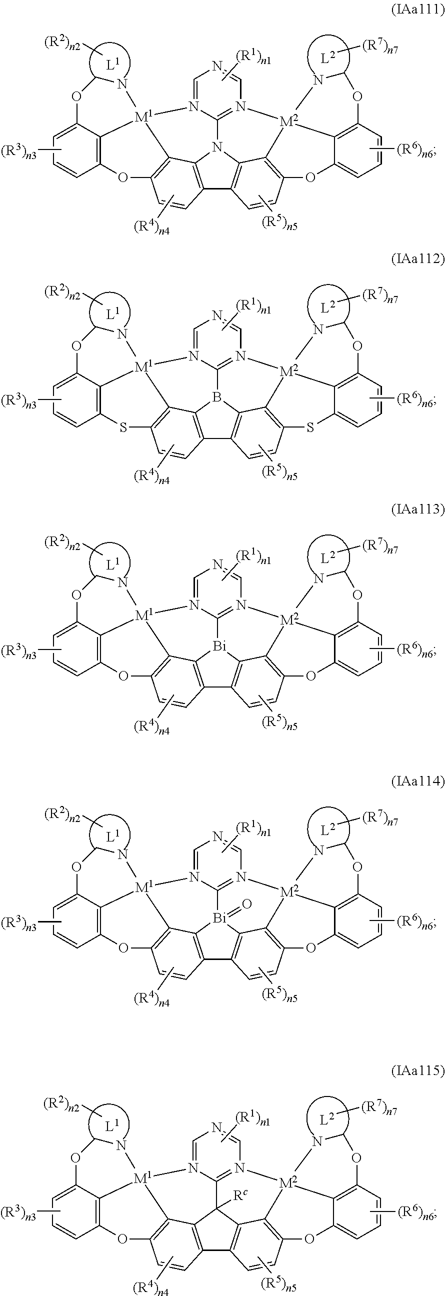

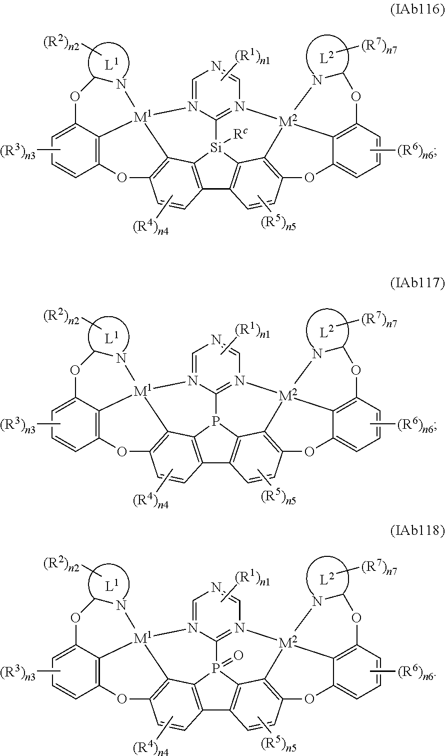

In the general formula IAc, according to difference between A¹ and A⁴, the compounds shown in the general formula IAc are further selected from the groups composed of compounds shown in the general formula IAc1, the general formula IAc2, the general formula IAc3, the general formula IAc4, the general formula IAc5:

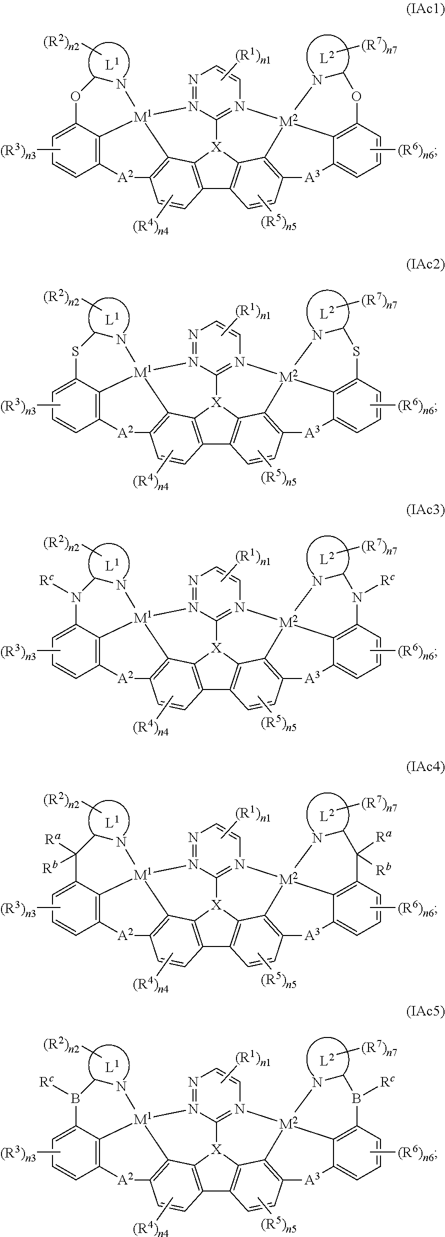

In which, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In the general formula IAc1, according to difference between A² and A³, the compounds shown in the general formula IAc1 are further selected from the groups composed of compounds shown in the general formula IAc11, the general formula IAc12, the general formula IAc13, the general formula IAc14, the general formula IAc15, the general formula IAc16, the general formula IAc16, the general formula IAc17 and the general formula IAc18:

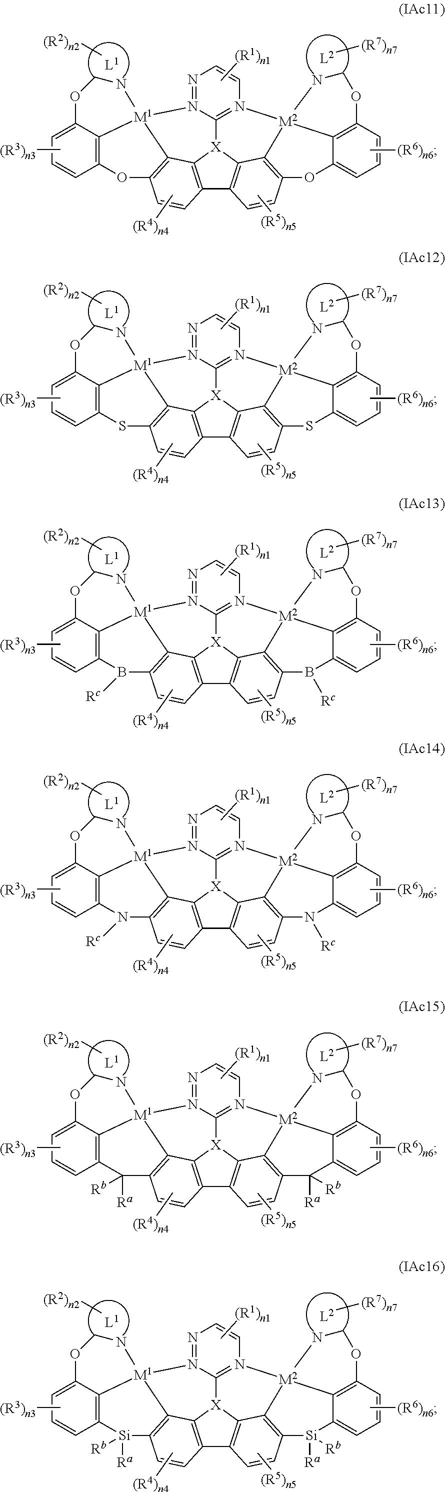

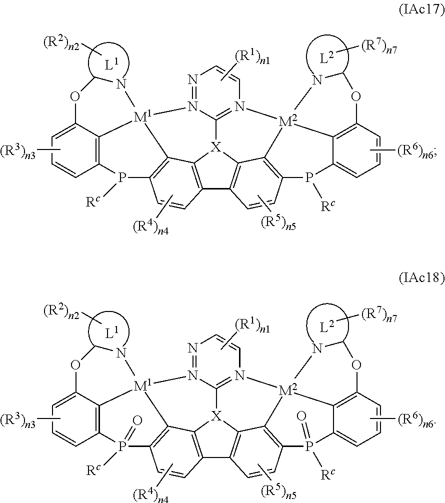

In the general formula IAc11, according to difference of X, the compounds shown in the general formula IAc11 are further selected from the groups composed of compounds shown in the general formula IAc111, IAc112, the general formula IAc113, the general formula IAc114, the general formula IAc115, the general formula IAc115, the general formula IAc116, the general formula IAc117, the general formula IAc118:

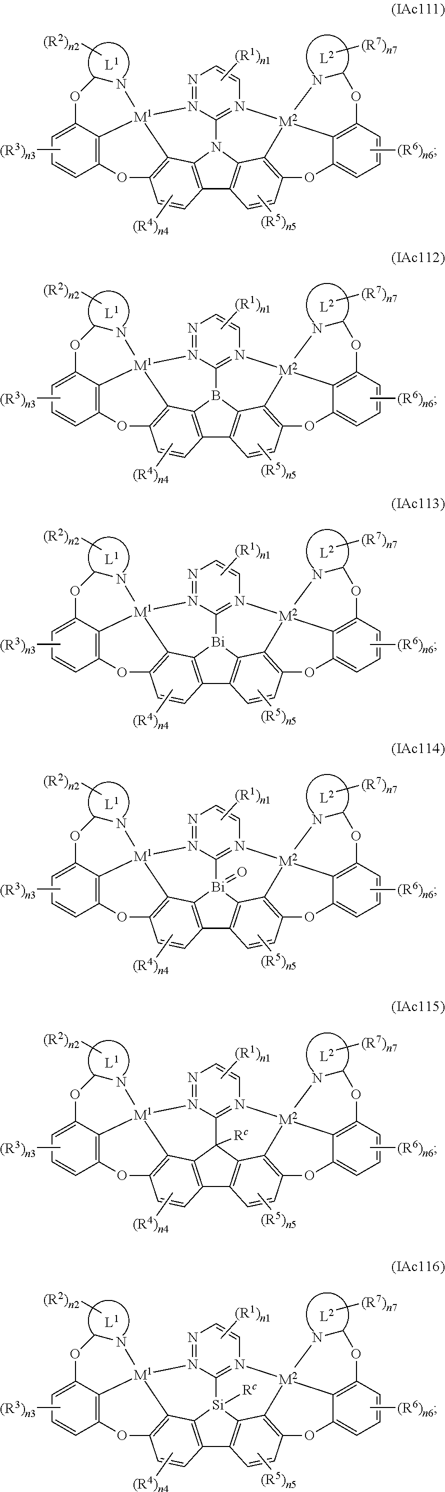

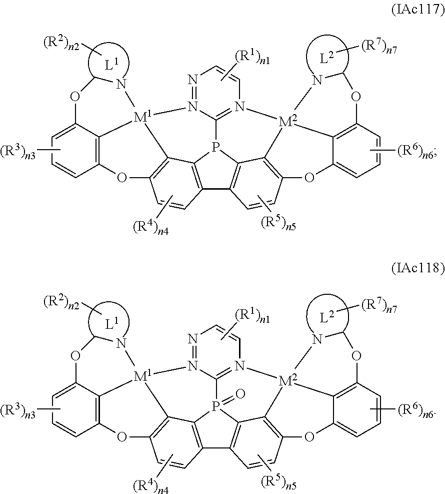

In the general formula IAd, according to difference between A¹ and A⁴, the compounds shown in the general formula IAd are further selected from the groups composed of compounds shown in the general formula IAd1, the general formula IAd2, the general formula IAd3, the general formula IAd4, the general formula IAd5:

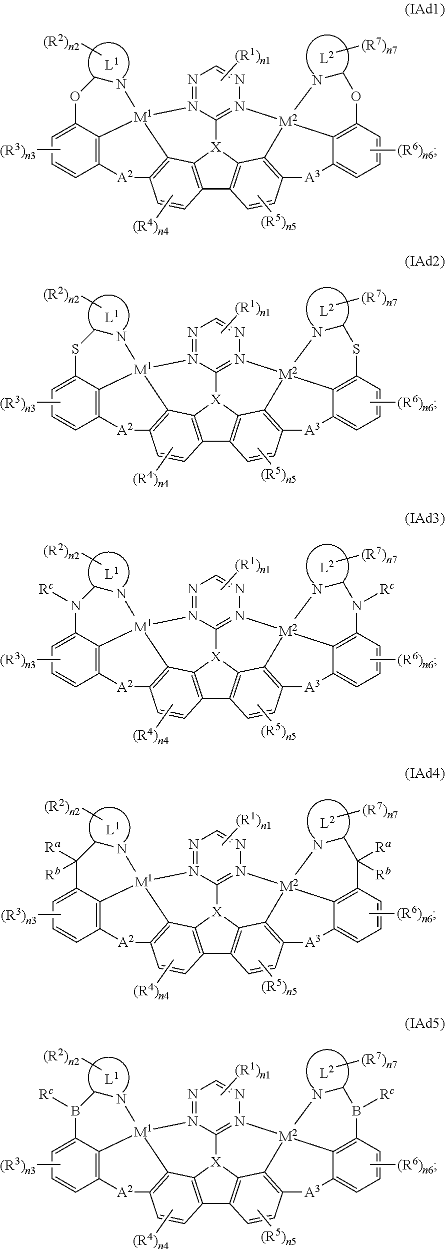

In which, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

In the general formula IAc1, according to difference between A² and A³, the compounds shown in the general formula IAd1 are further selected from the groups composed of compounds shown in the general formula IAd11, the general formula IAd12, the general formula IAd13, the general formula IAd14, the general formula IAd15, the general formula IAd16, the general formula IAd16, the general formula IAd17 and the general formula IAd18:

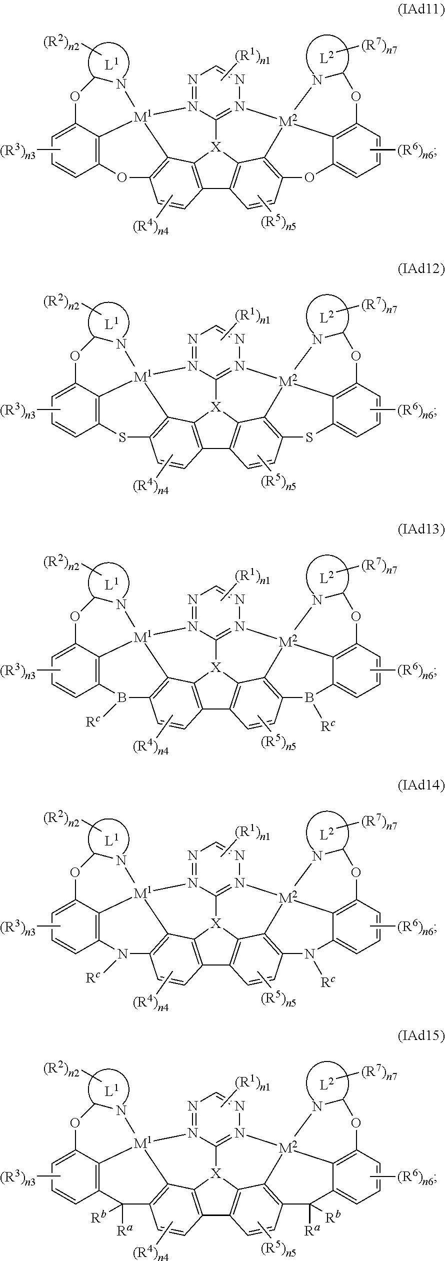

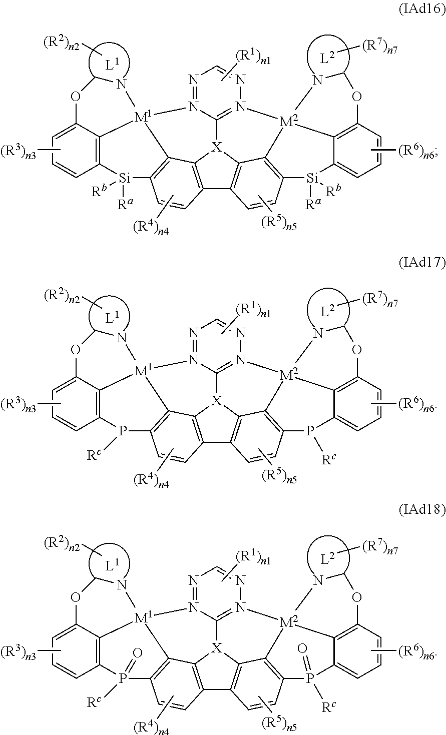

In the general formula IAd11, according to difference of X, the compounds shown in the general formula IAd11 are further selected from the groups composed of compounds shown in the general formula IAd111, IAd112, the general formula IAd113, the general formula IAd114, the general formula IAd115, the general formula IAd115, the general formula IAd116, the general formula IAd117, the general formula IAd118:

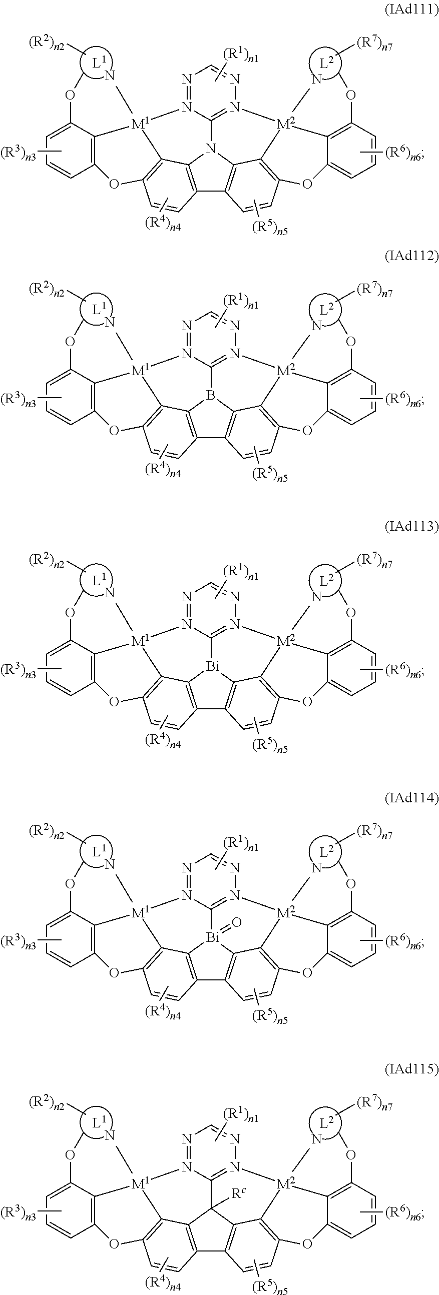

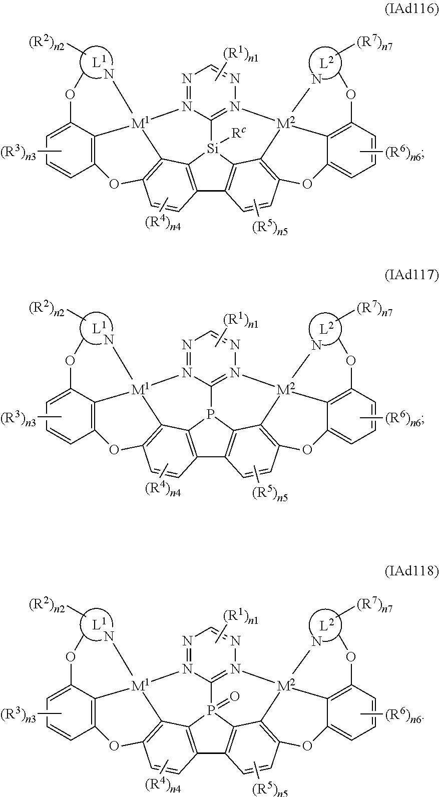

In the general formula IB, the compounds shown in the general IB are further select from the compounds shown in the general formula IBa:

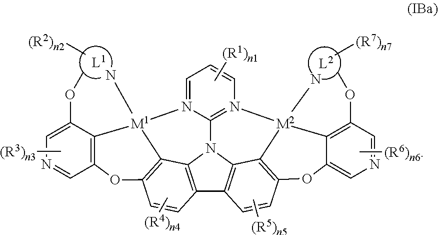

As an improvement of an embodiment in the present invention, each of L¹ and L² represent a ring representing the following structural expressions independently:

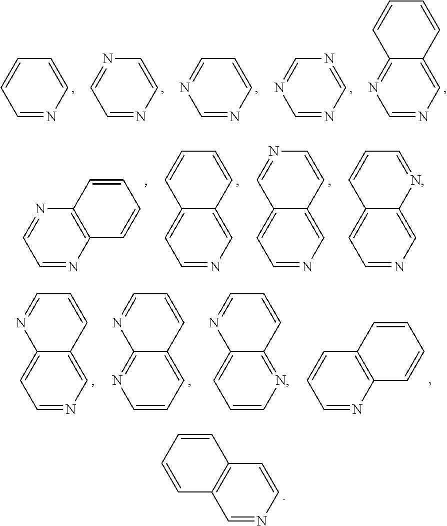

As an improvement of an embodiment in the present invention, R¹ is selected from at least one of the following substituents:

Halogen, deuterium, methyl sulfonyl group, C₁˜C₆ alkyl, C₁˜C₆ deuteroalkyl, C₁˜C₆ fluoroalkyl, C₁˜C₆ alkoxy, phenyl,

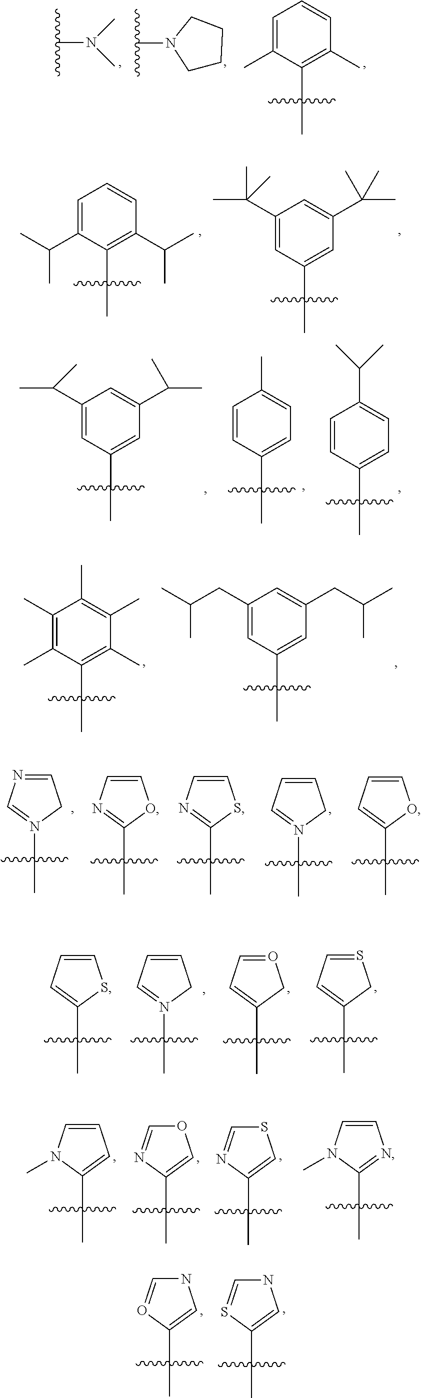

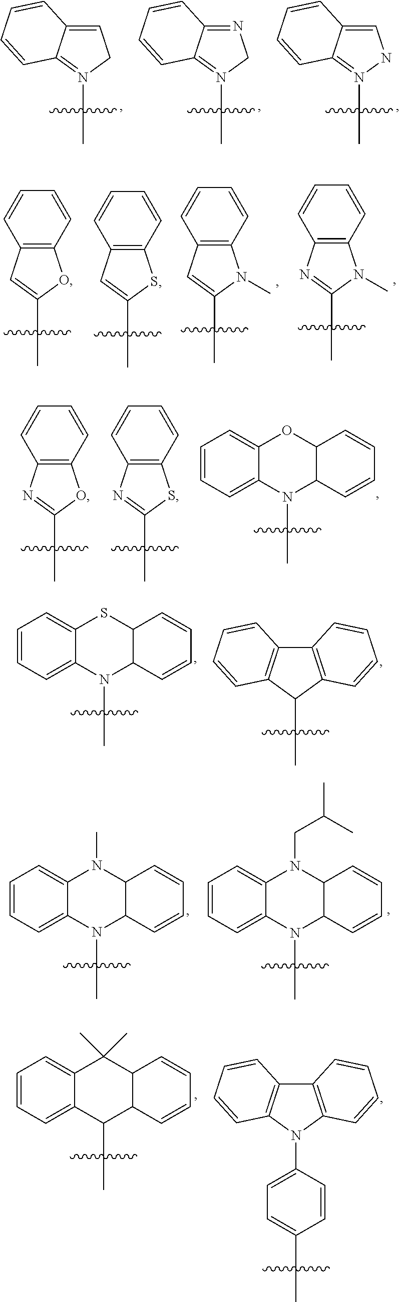

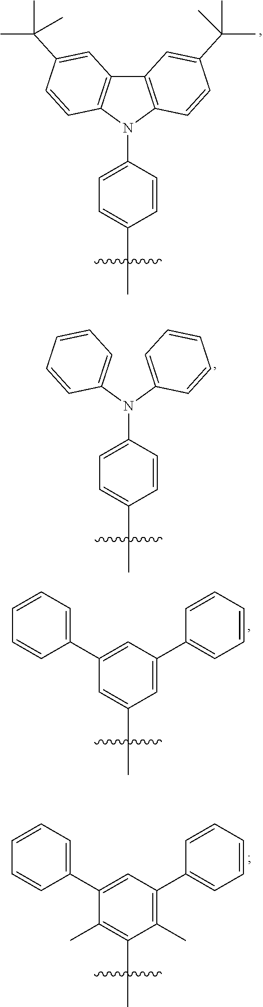 [SMILES: *c1ccc(-n2c3ccc(C(C)(C)C)cc3c3cc(C(C)(C)C)ccc32)cc1 ; *c1ccc(N(c2ccccc2)c2ccccc2)cc1 ; *c1cc(-c2ccccc2)cc(-c2ccccc2)c1 ; *c1c(C)c(-c2ccccc2)cc(-c2ccccc2)c1C]

When two or more adjacent R¹ are connected to form a ring, the ring formed by R¹ is selected from: benzene ring, cyclopentane, cyclohexane, cyclohexane,

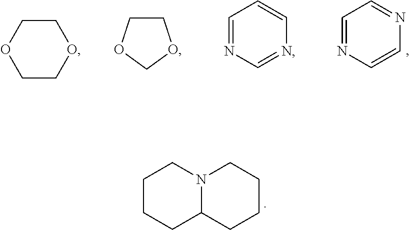 [SMILES: C1COCCO1 ; C1COCO1 ; c1cncnc1 ; c1cnccn1 ; C1CCN2CCCCC2C1]

Optionally, the binuclear organometallic complexes of the embodiment of the present invention are selected from a group of compounds shown in the following chemical formula and are not limited to this:

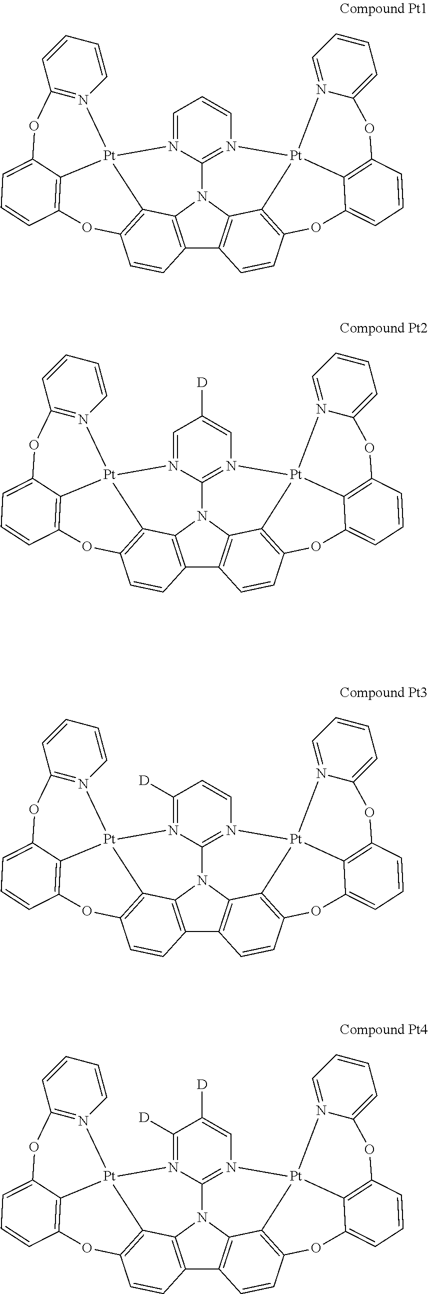

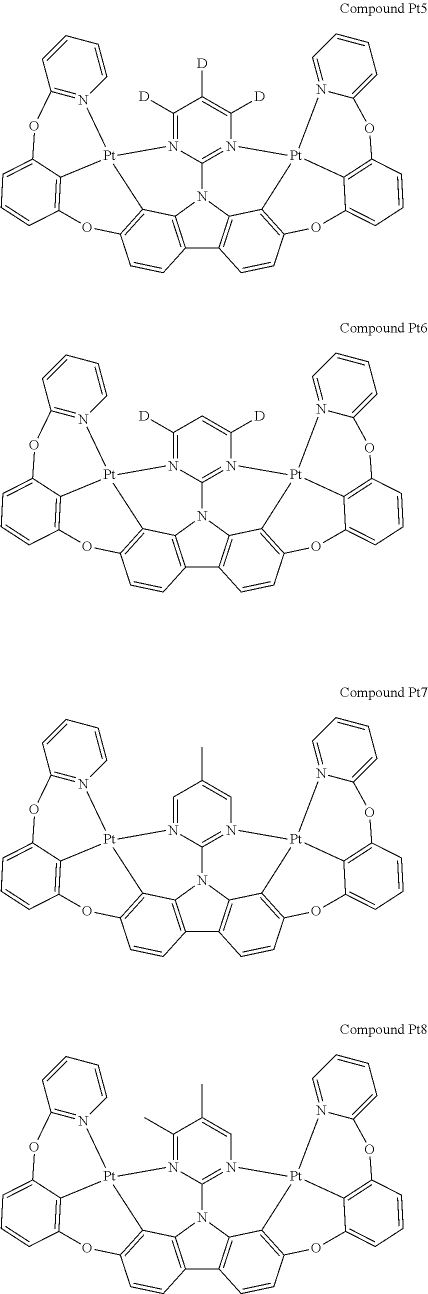

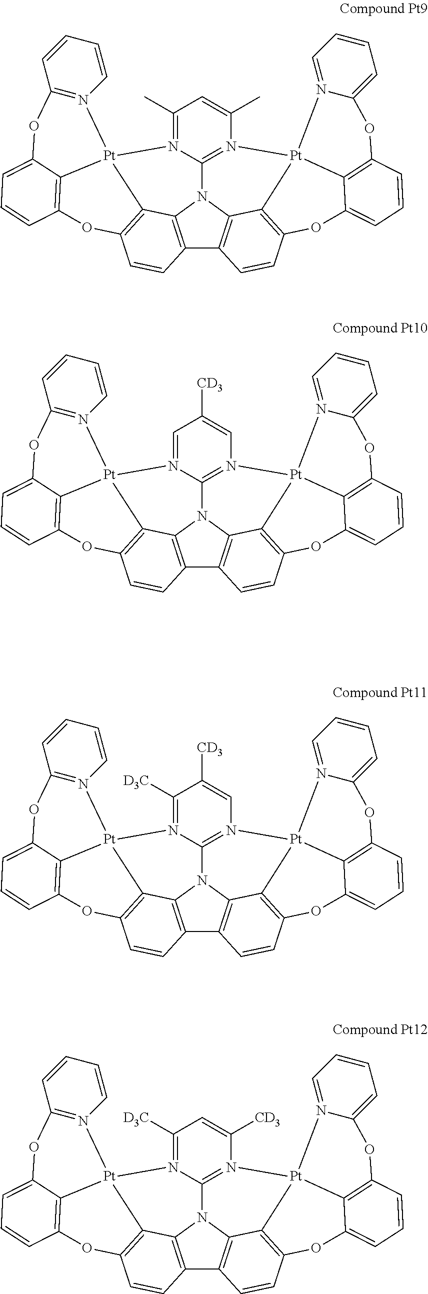

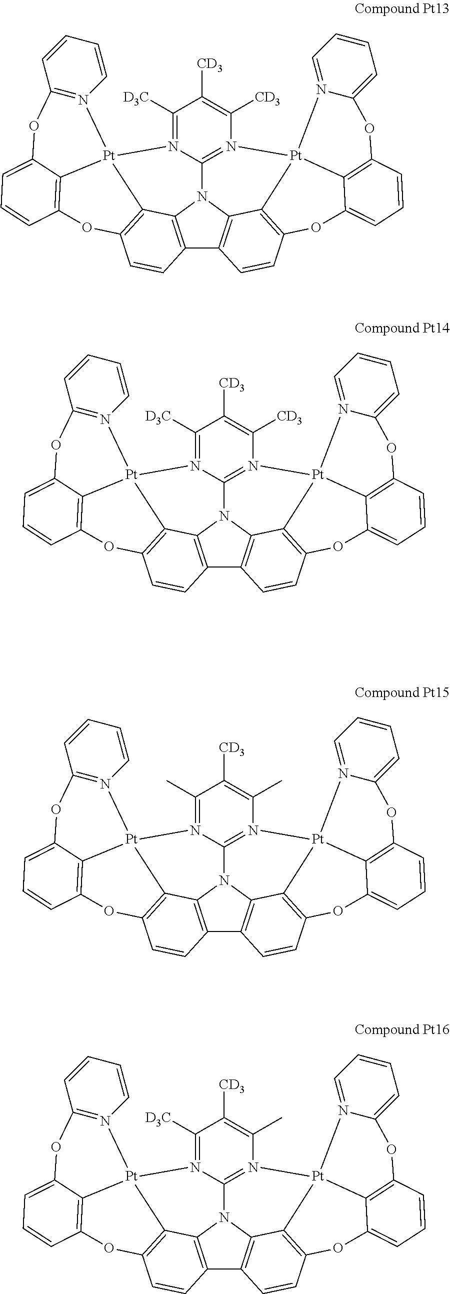

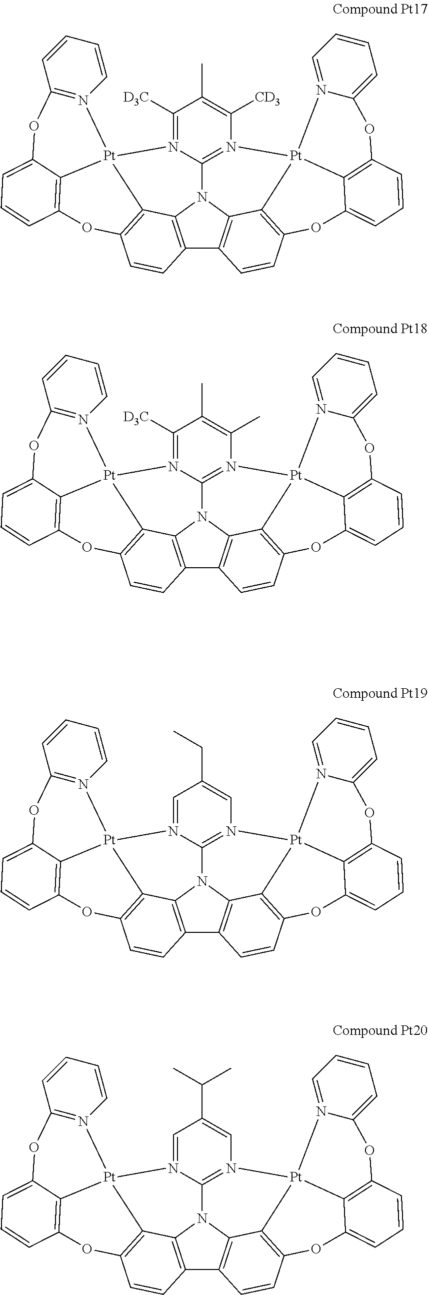

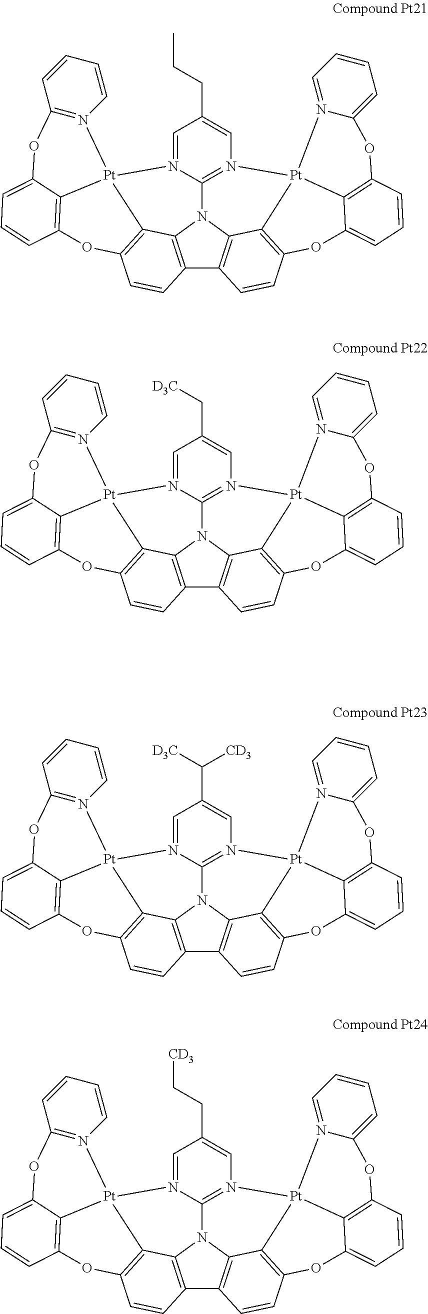

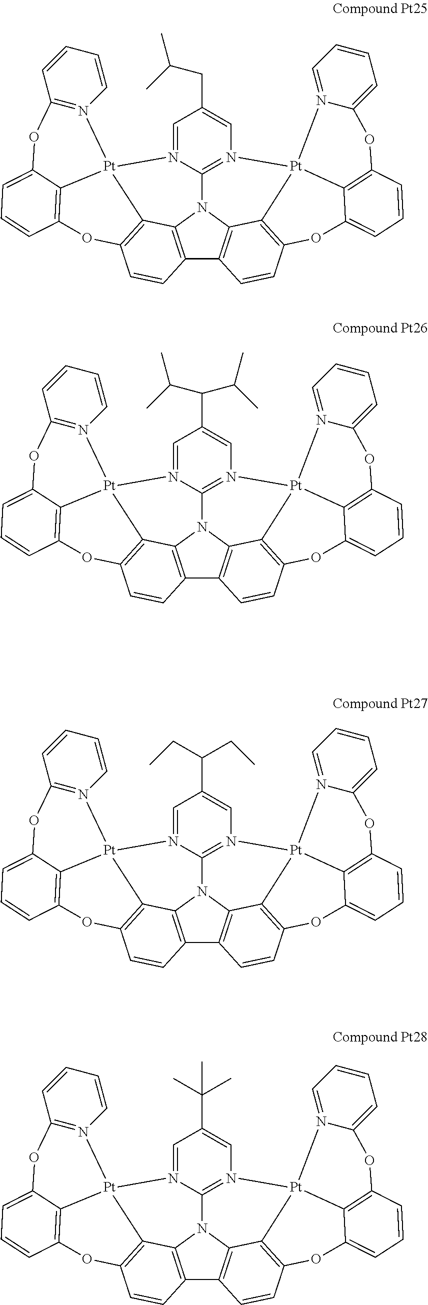

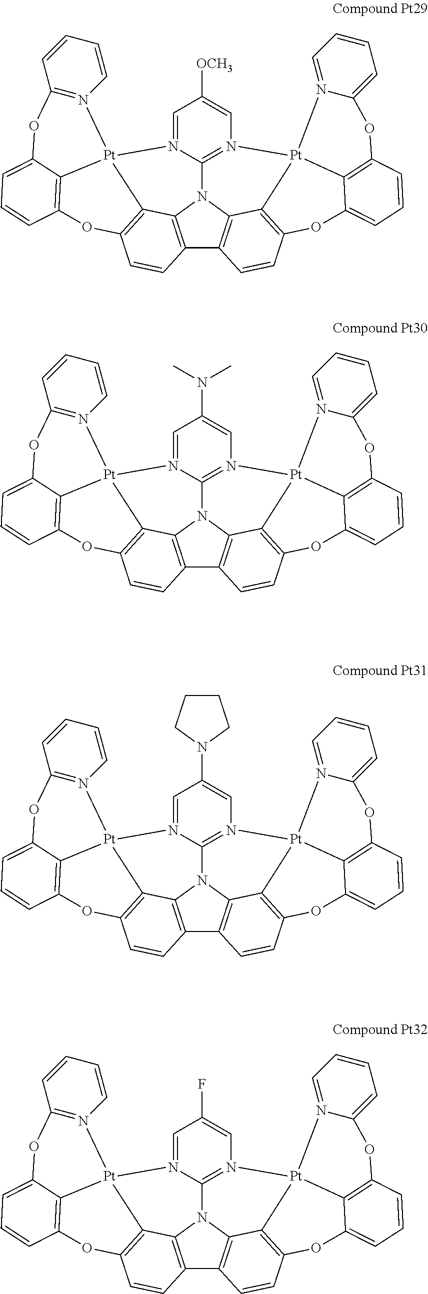

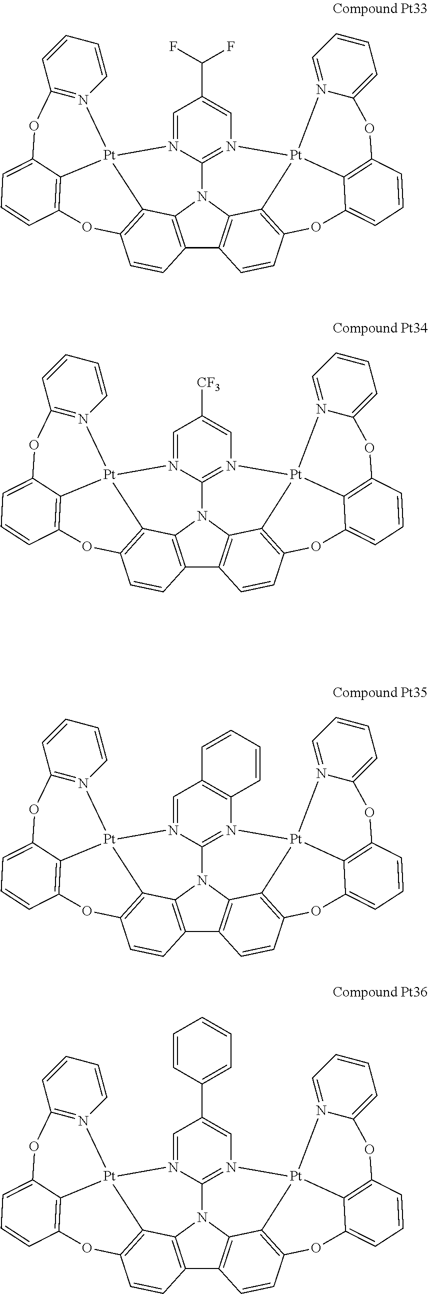

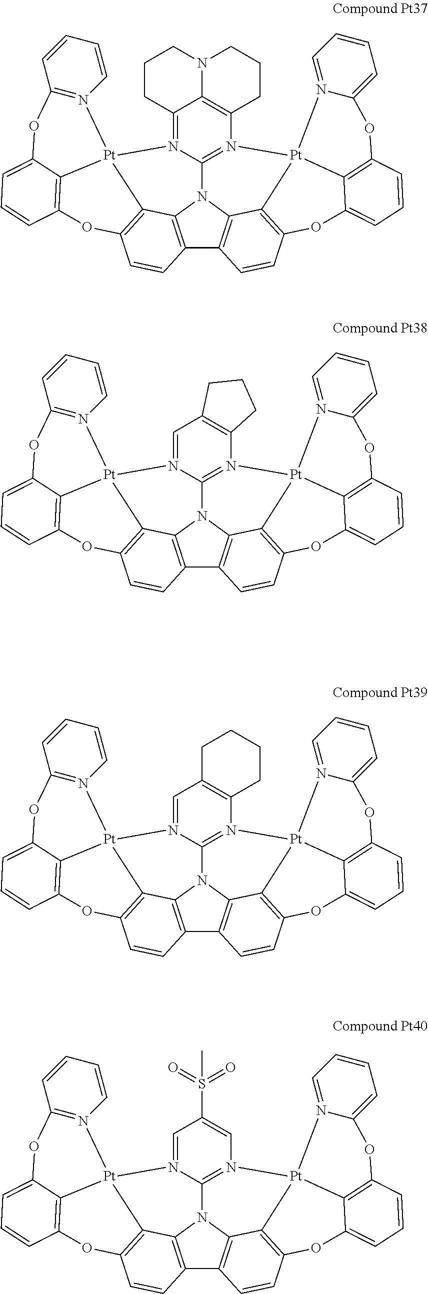

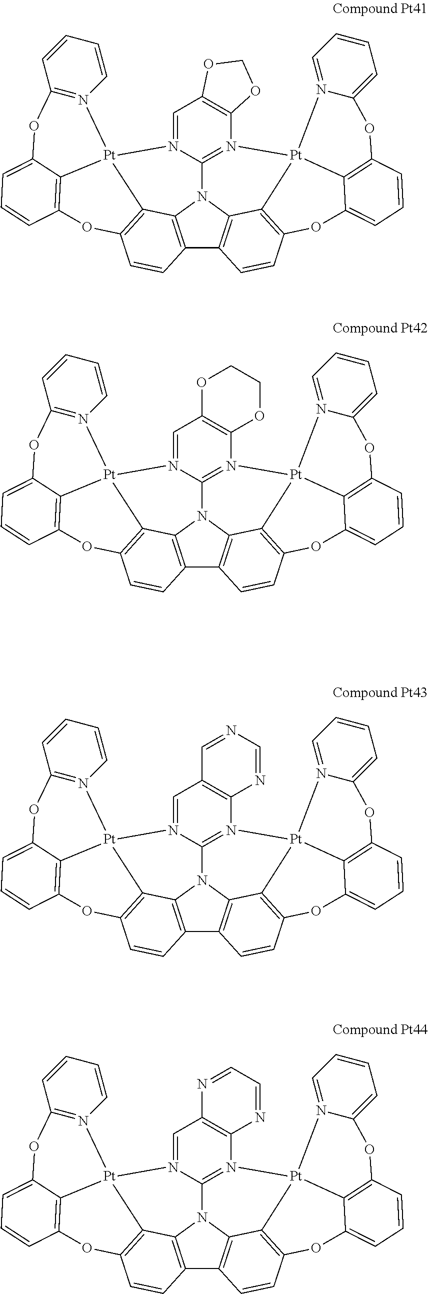

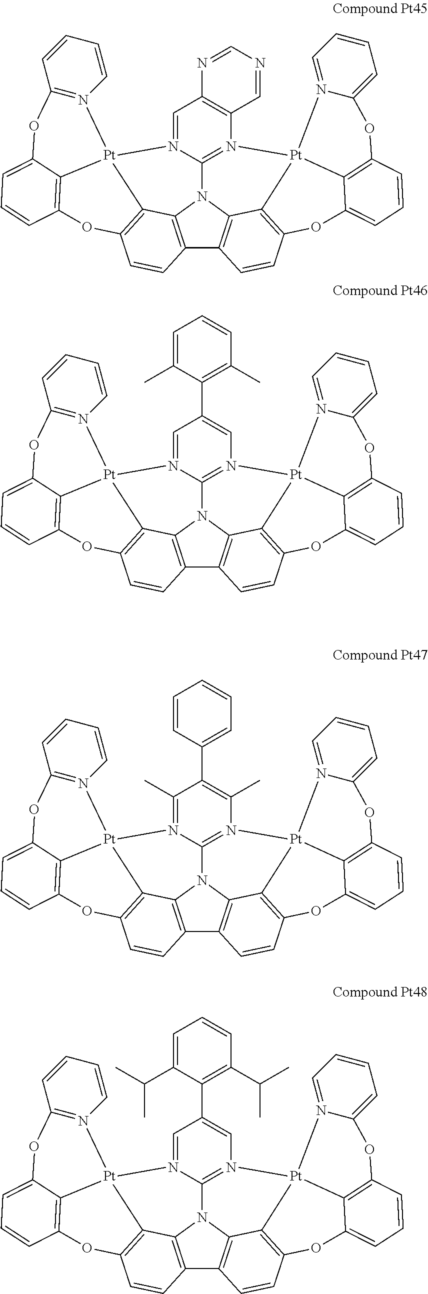

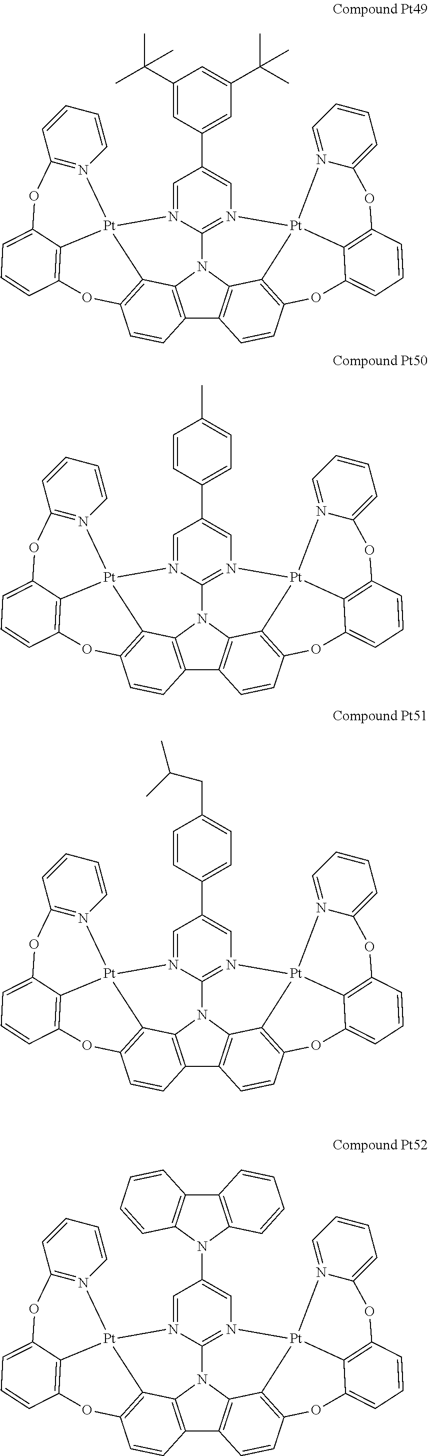

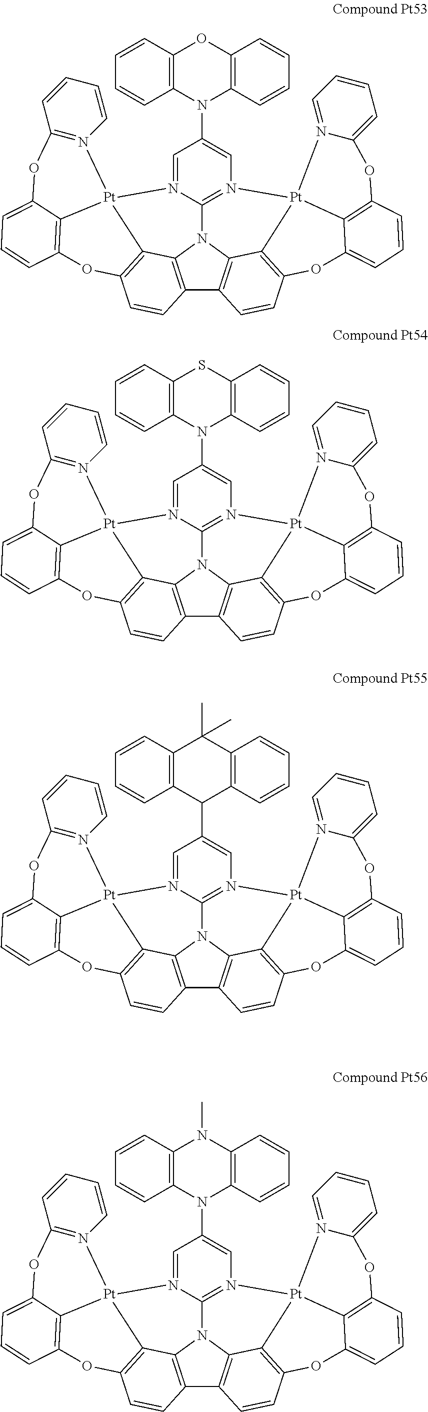

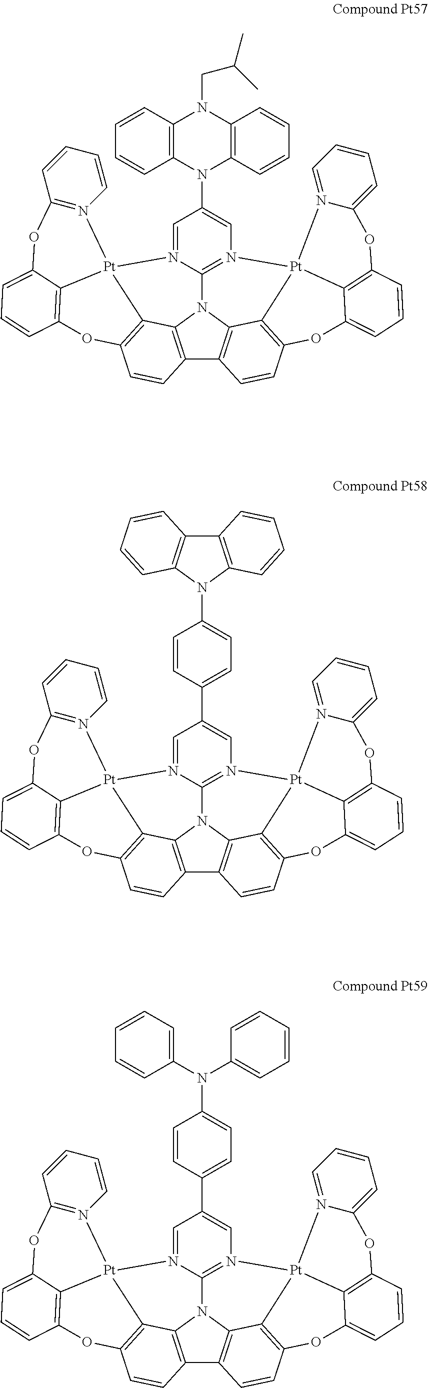

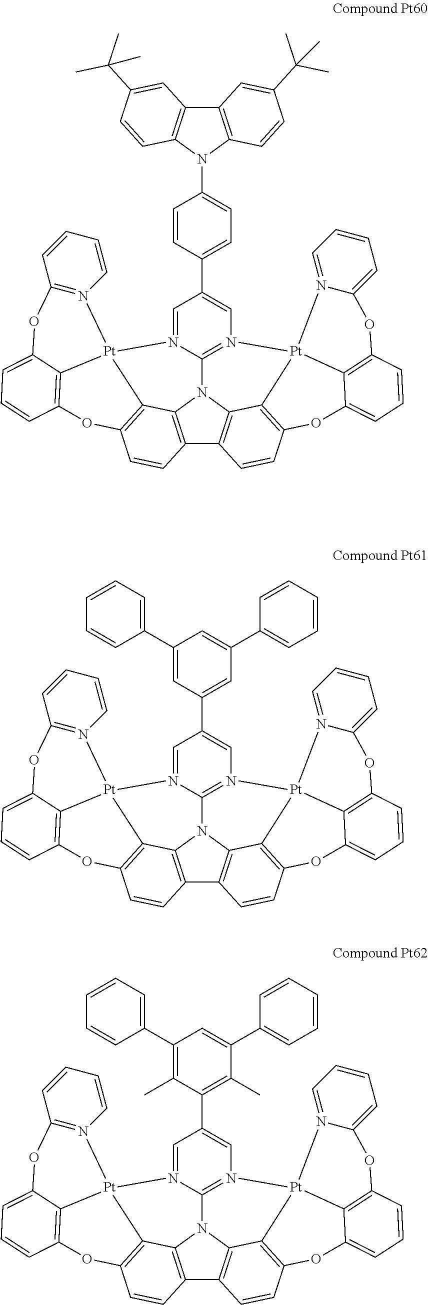

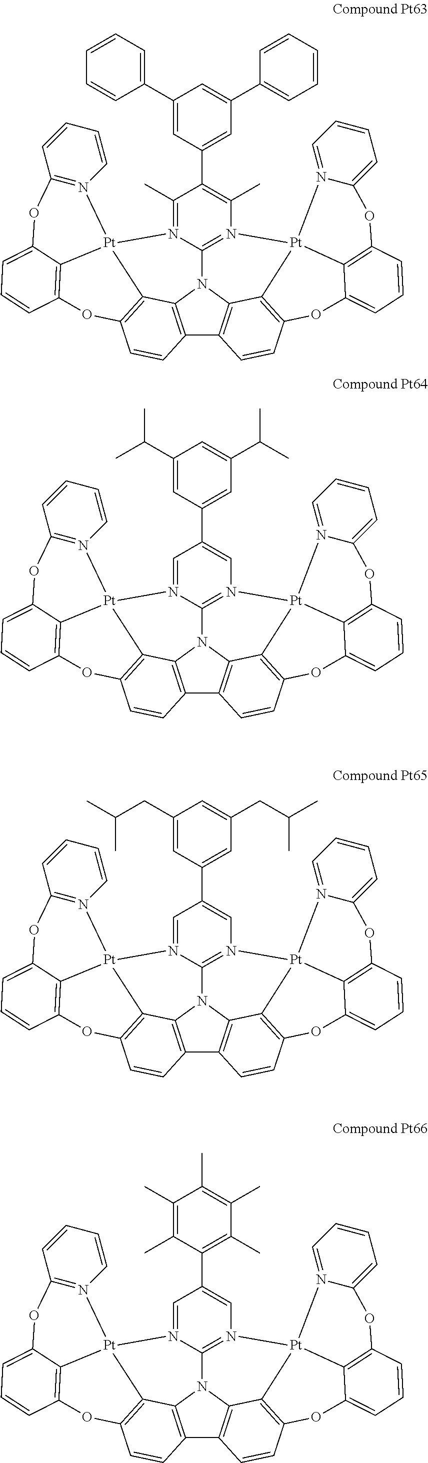

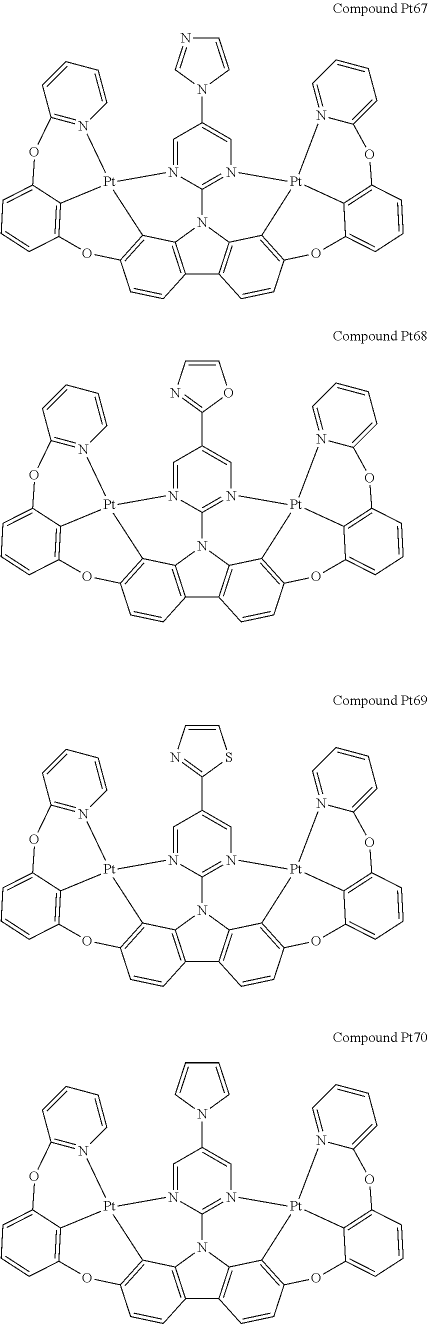

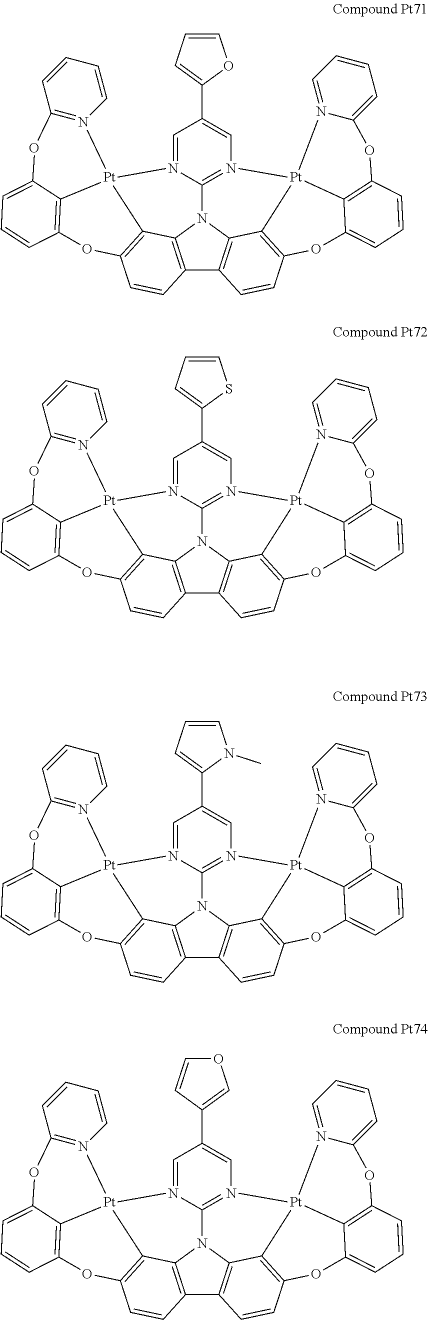

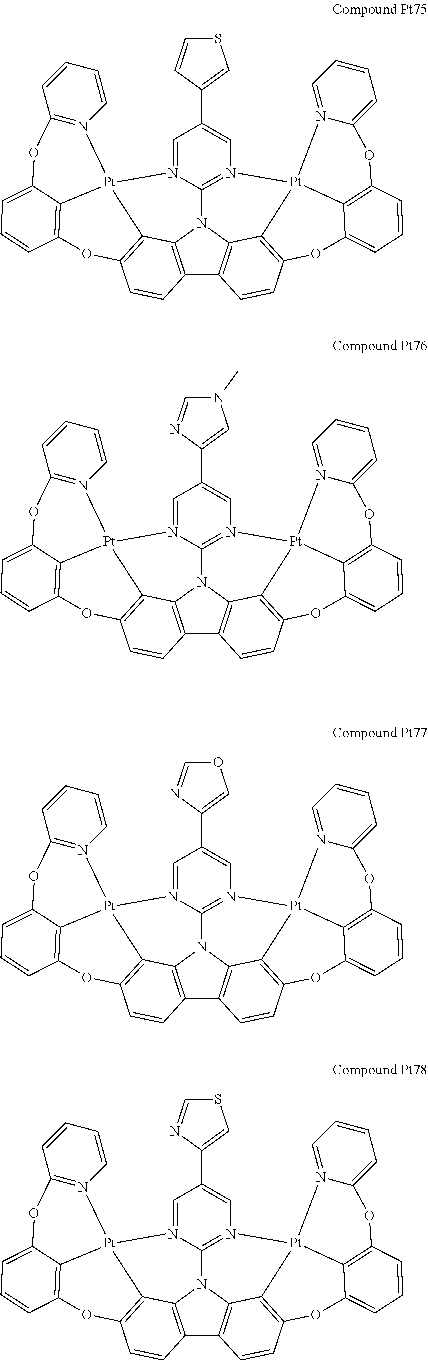

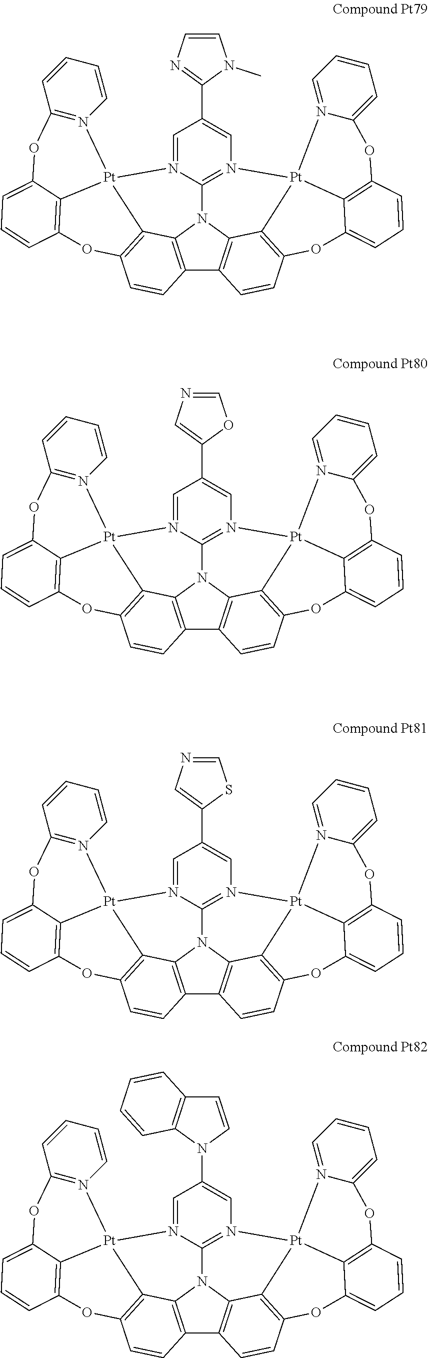

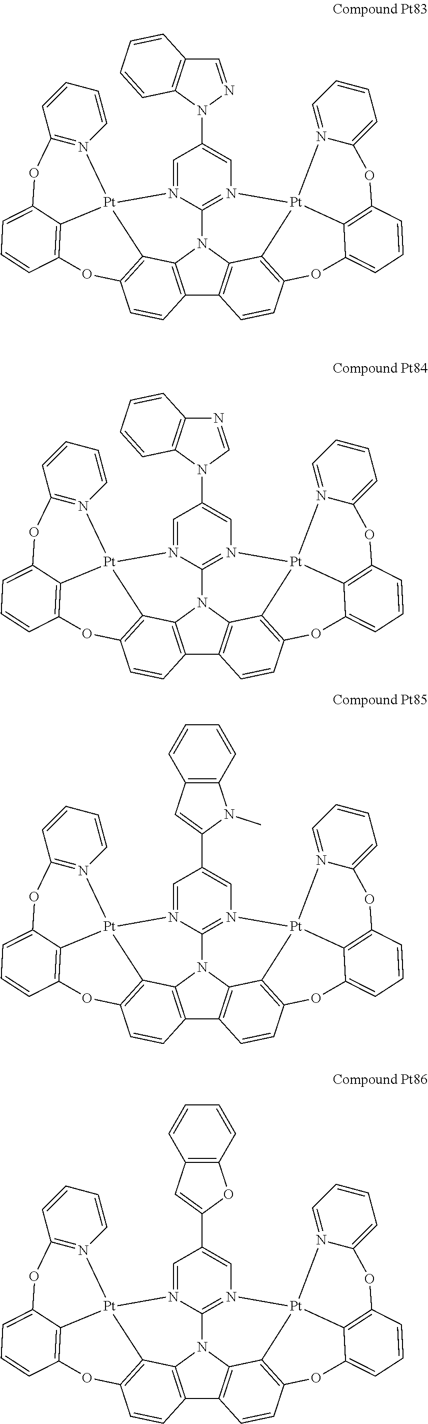

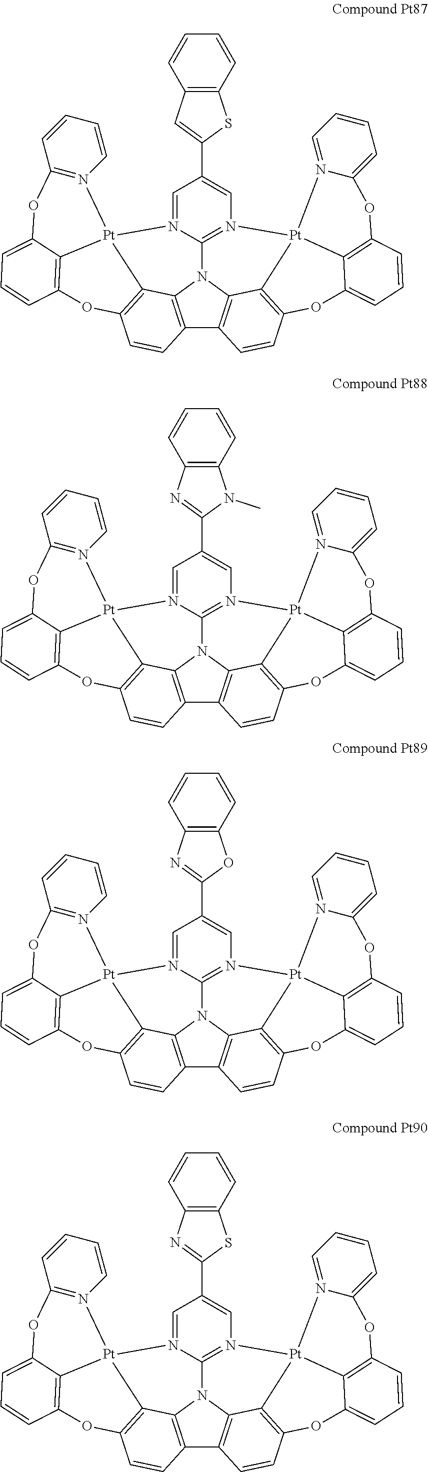

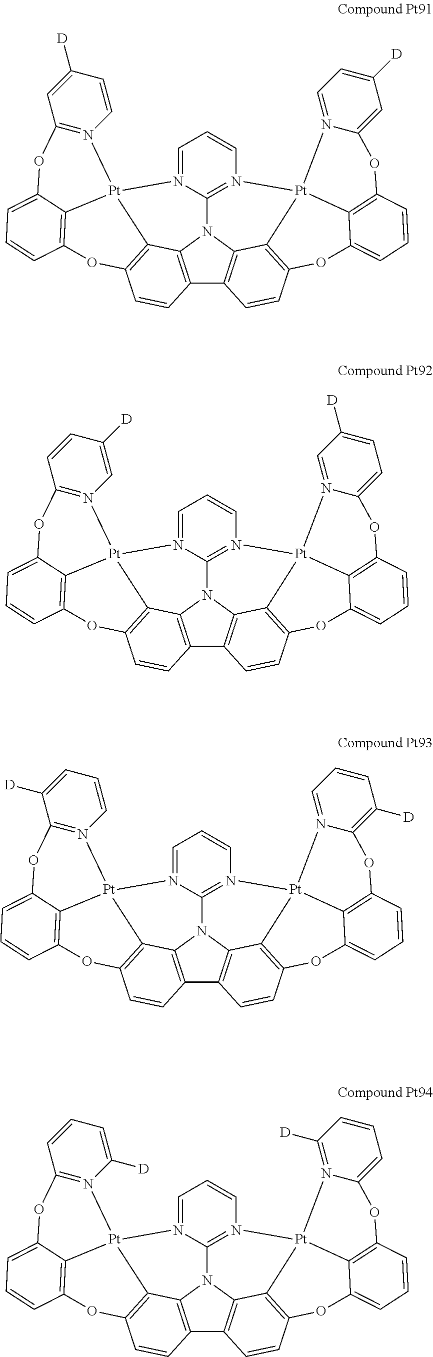

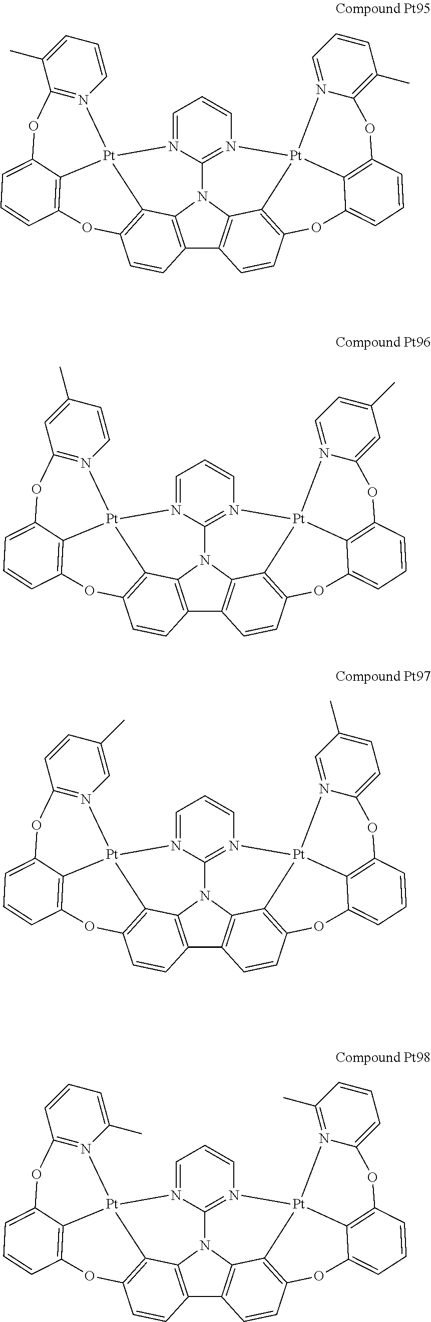

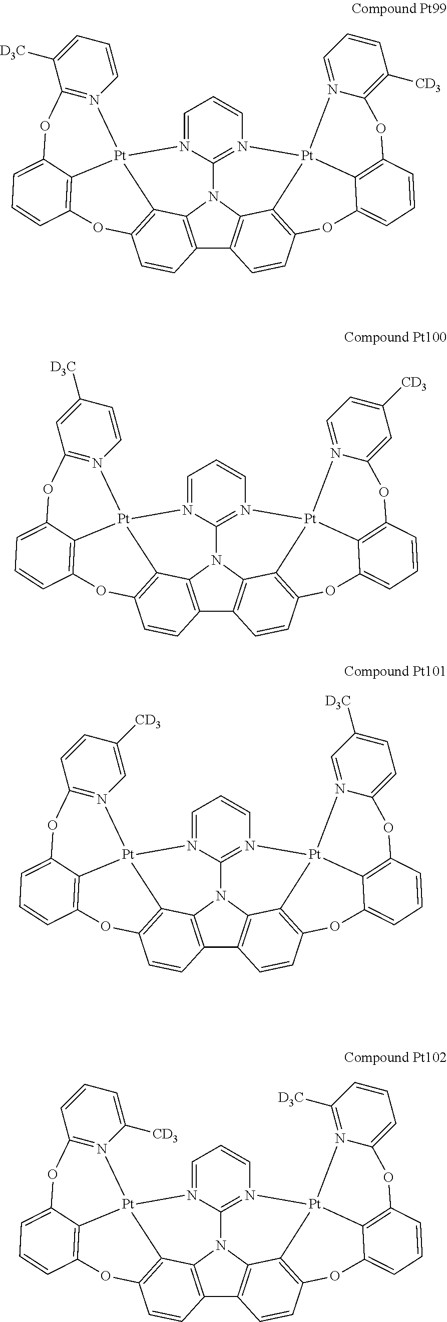

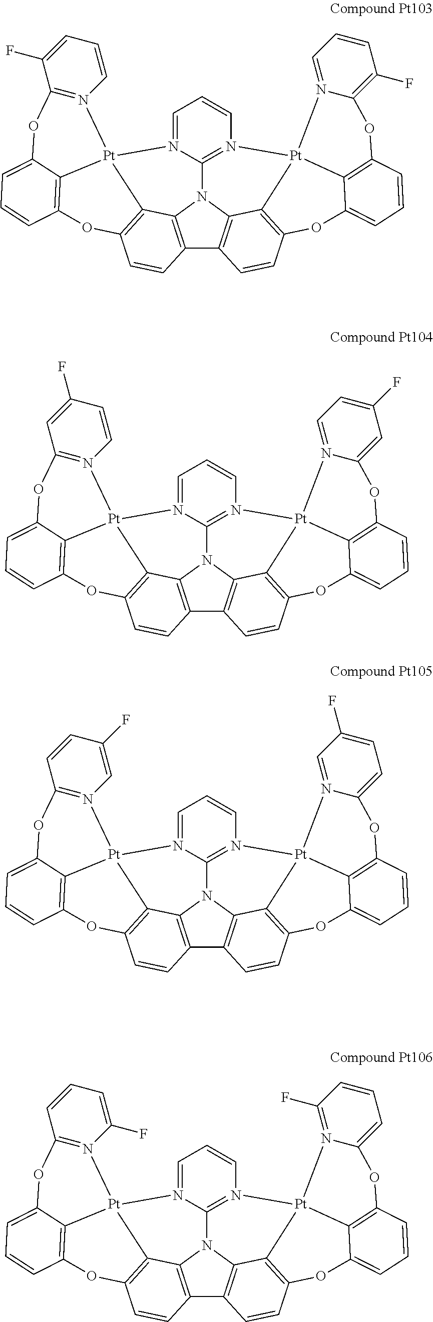

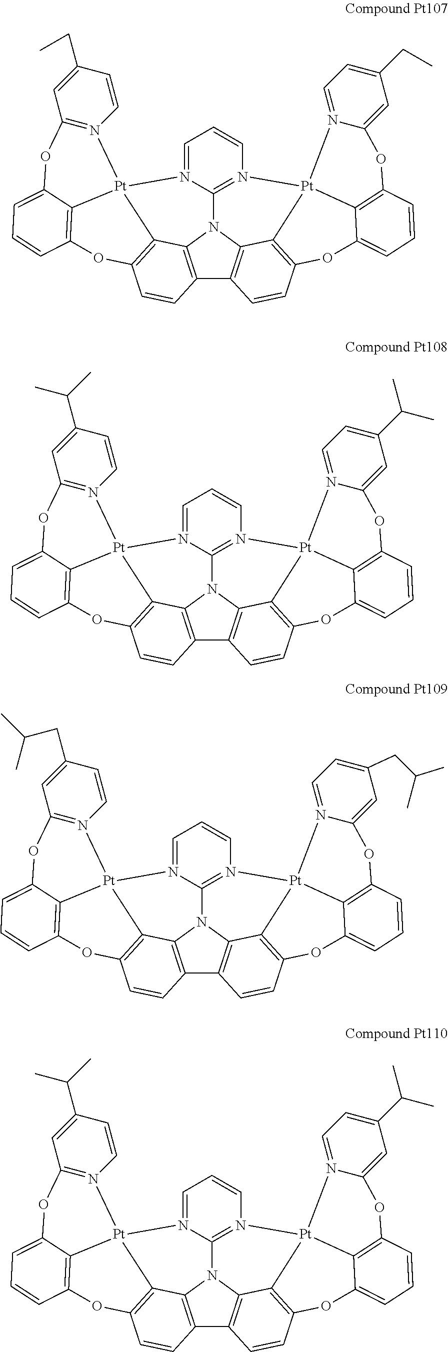

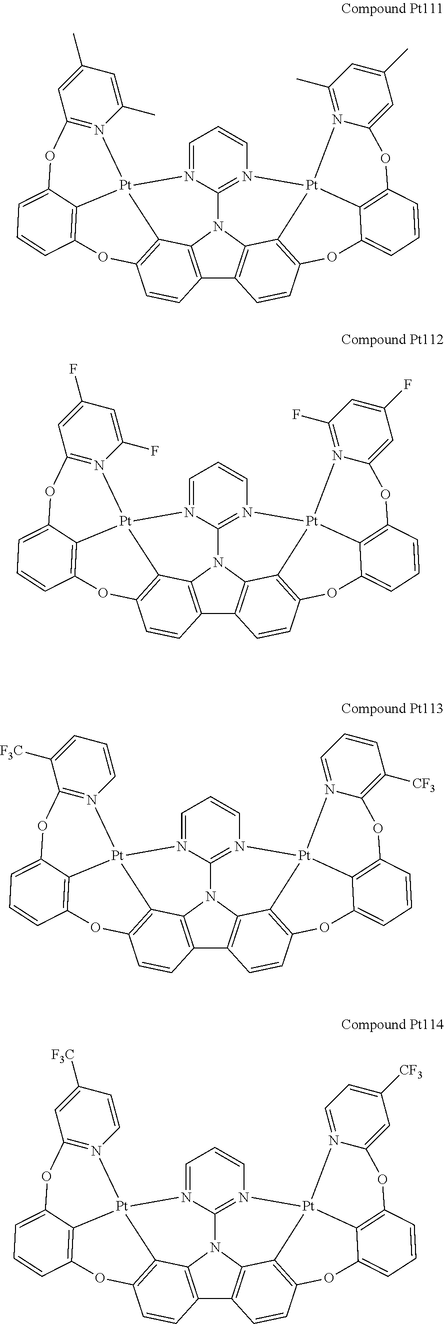

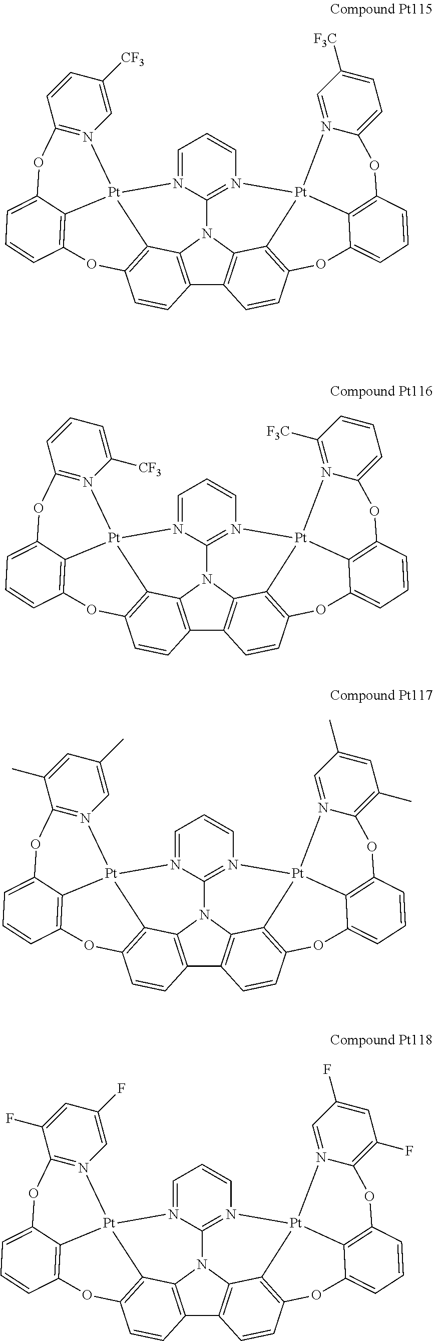

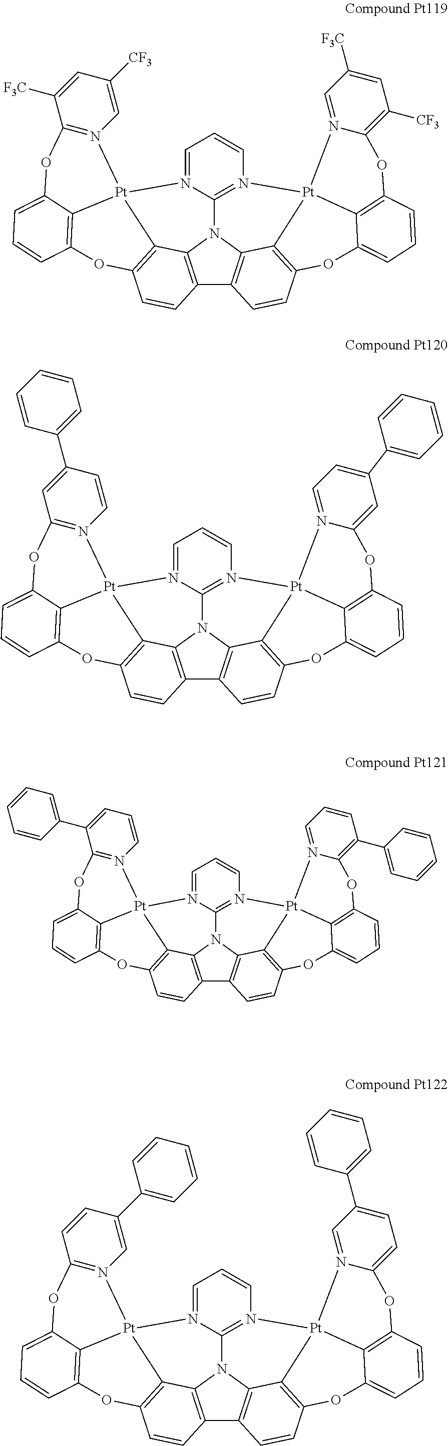

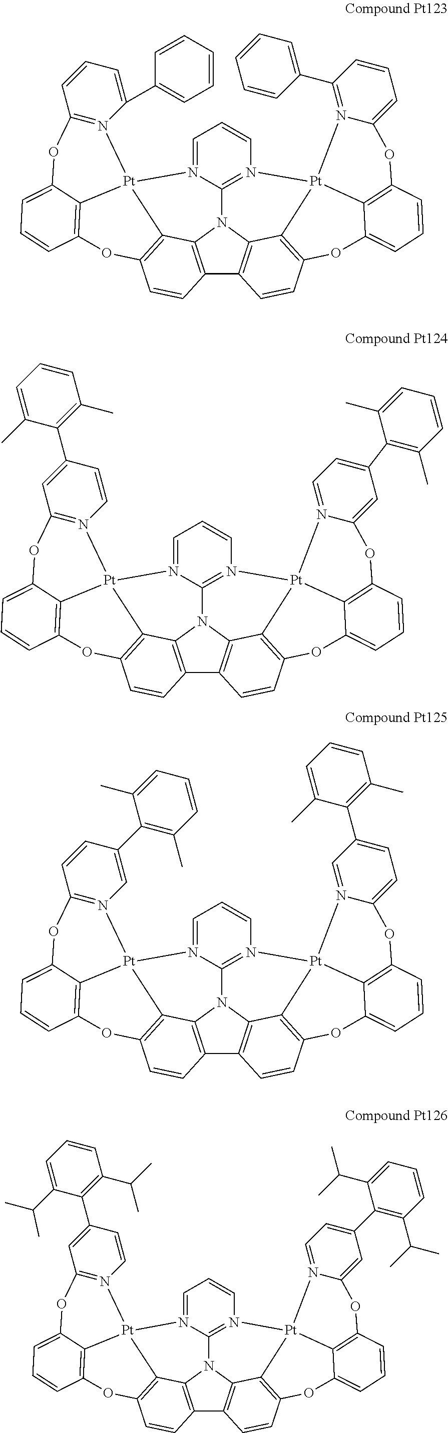

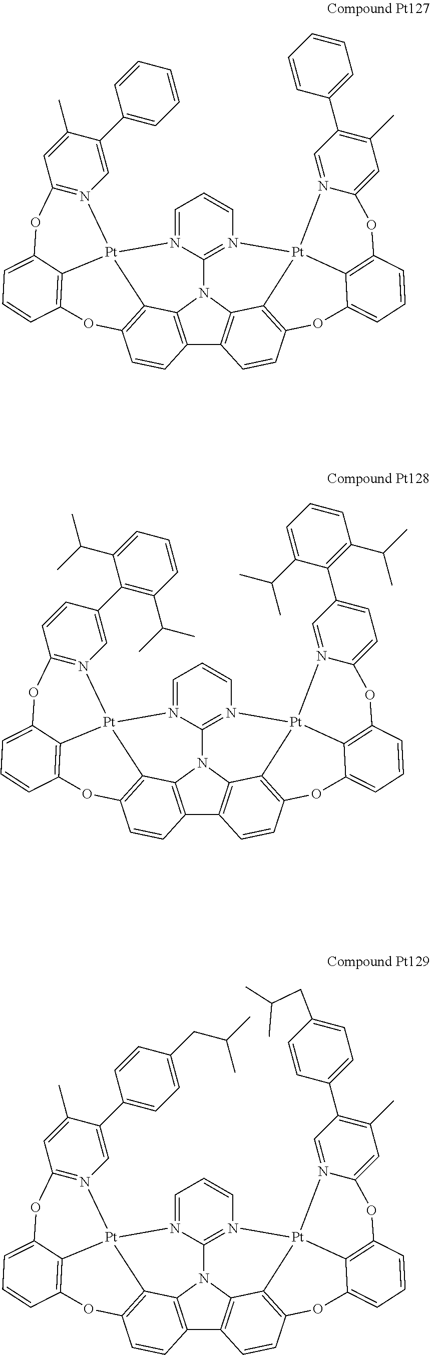

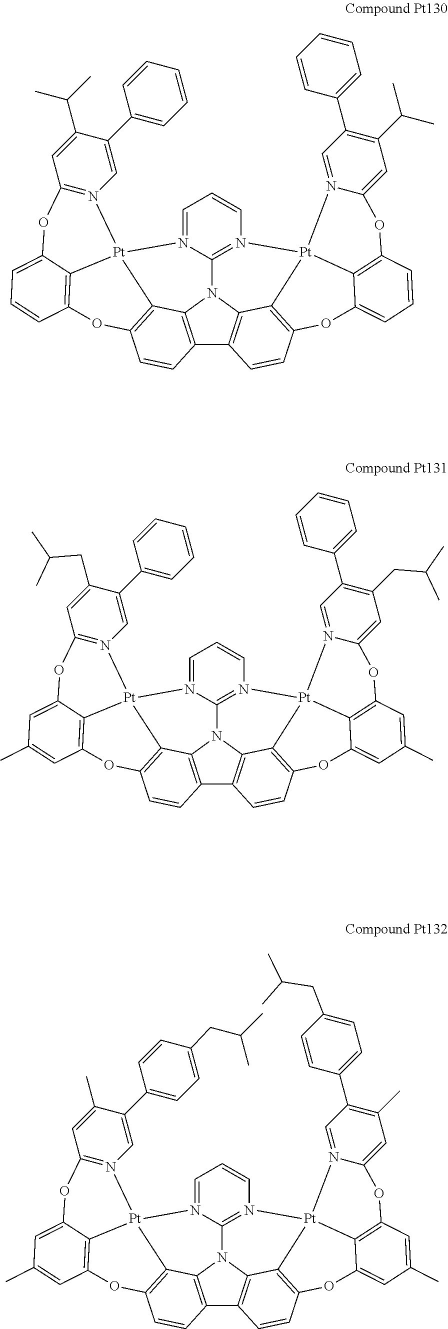

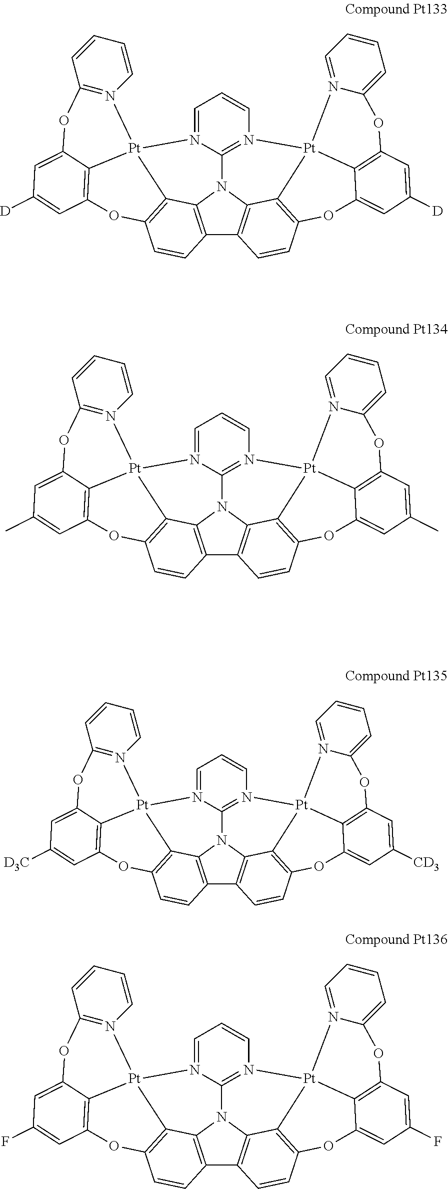

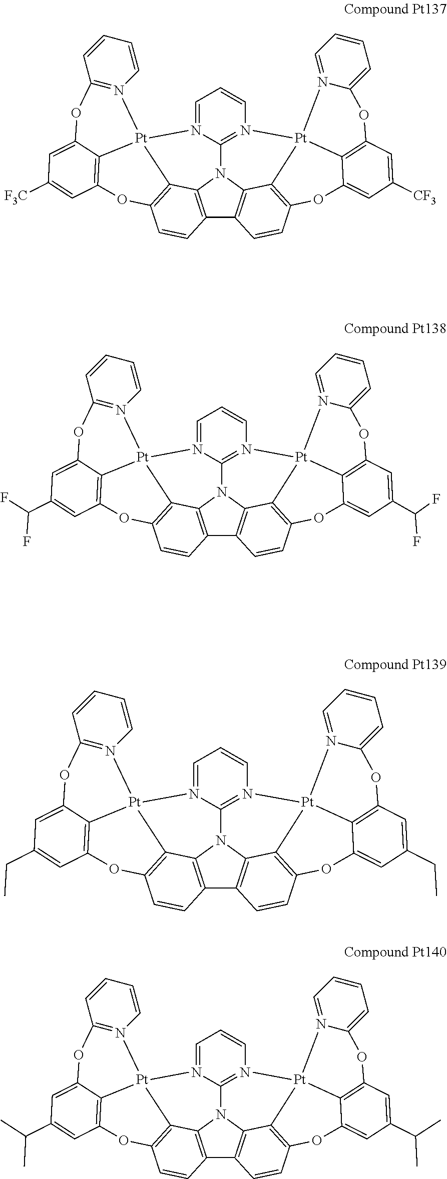

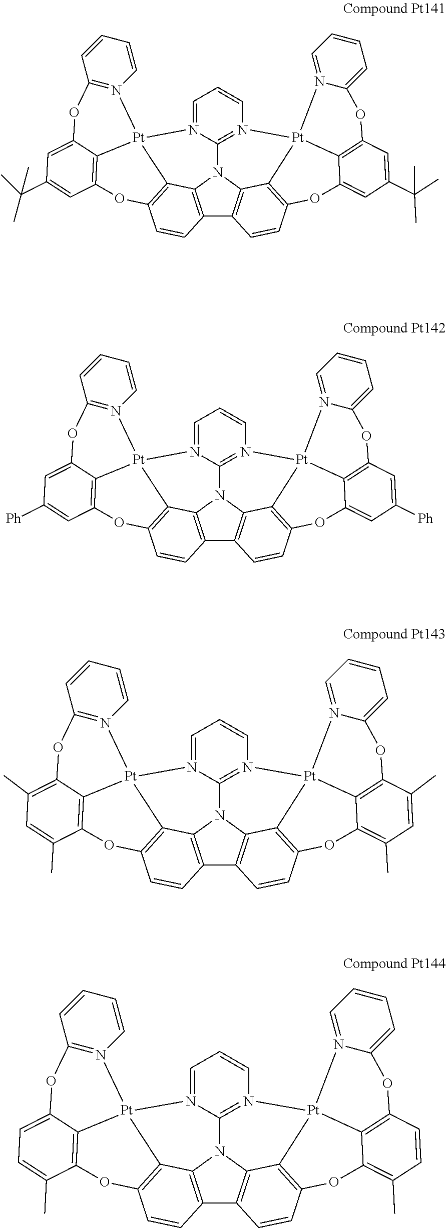

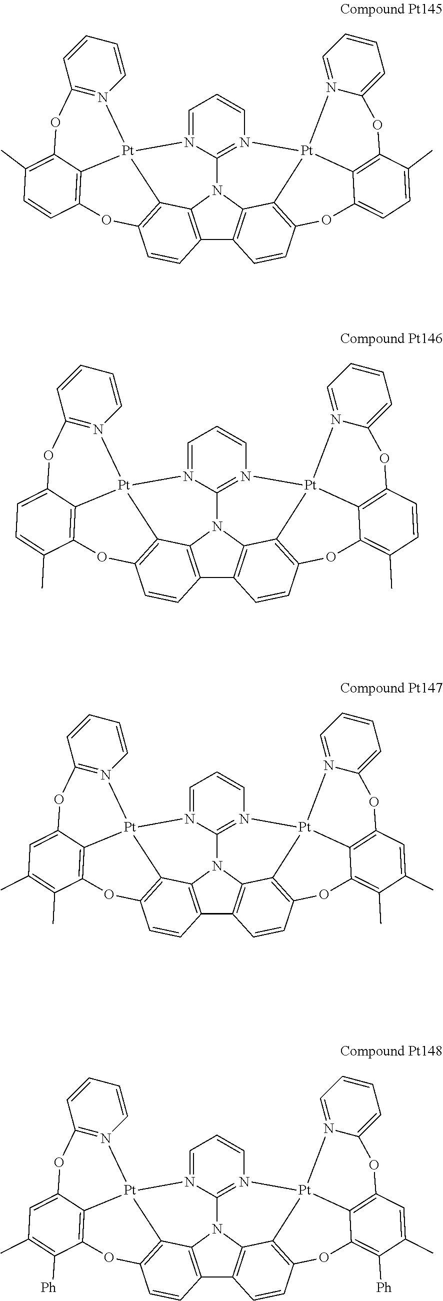

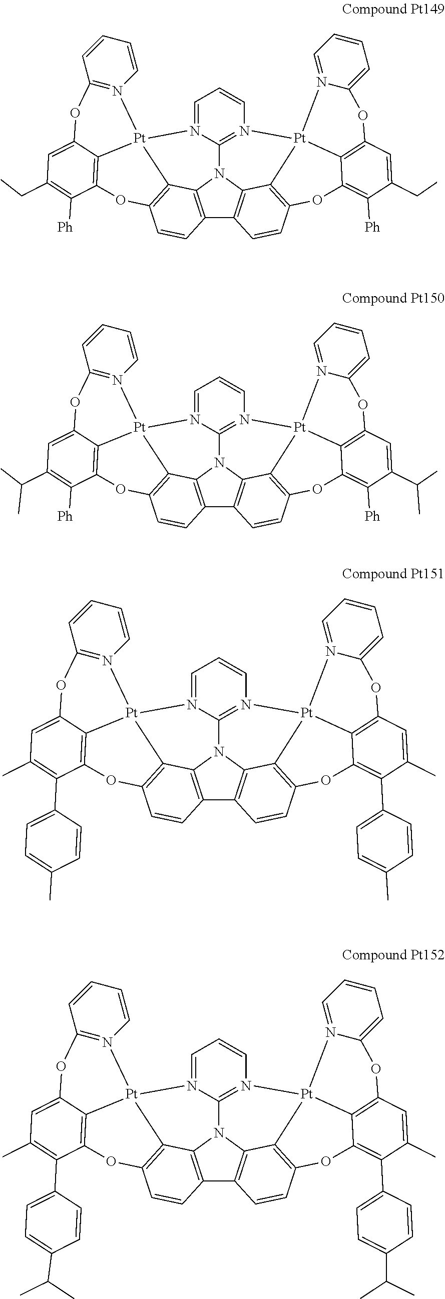

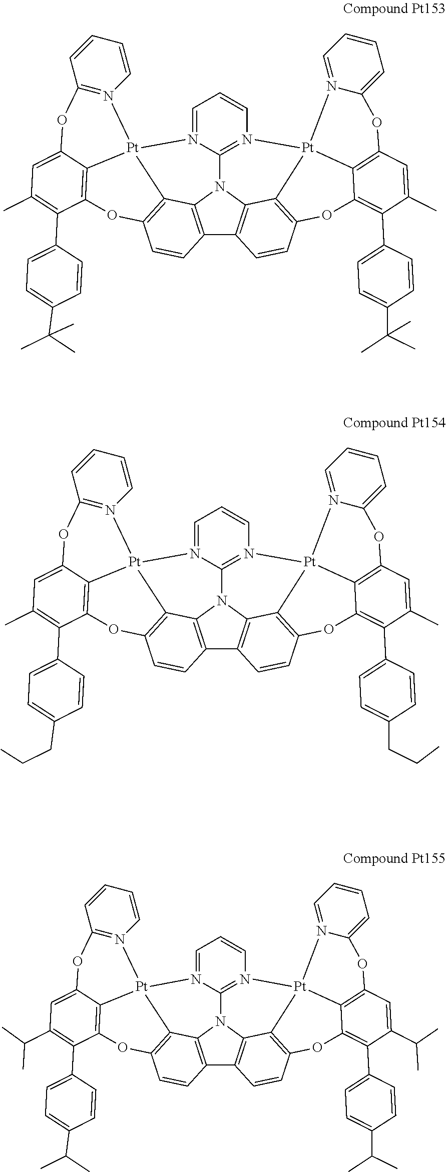

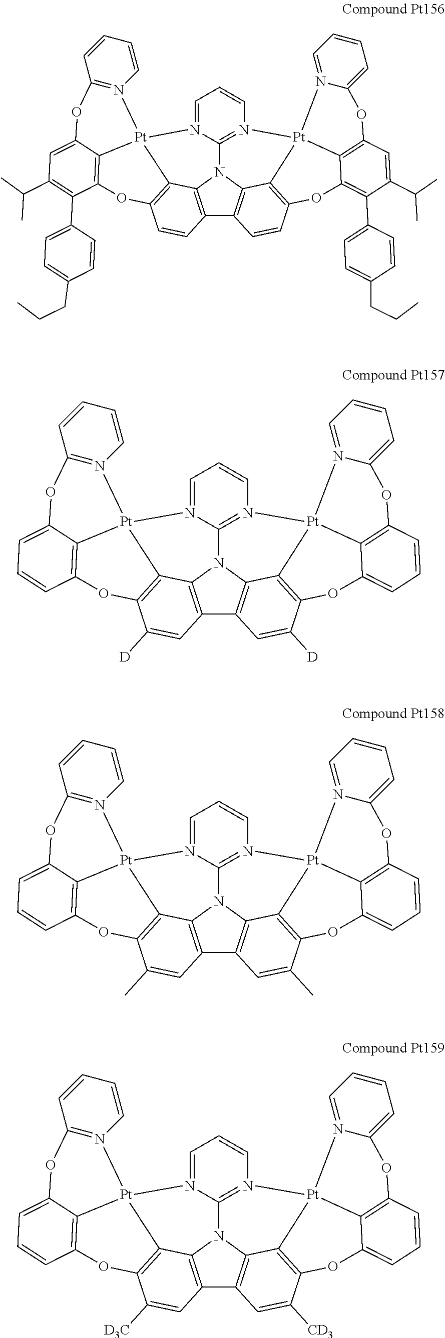

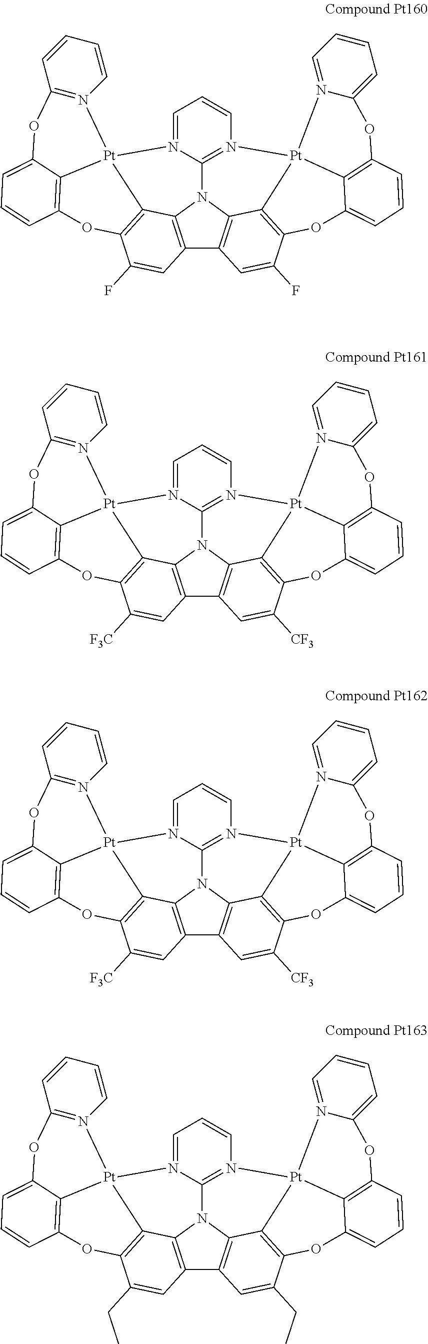

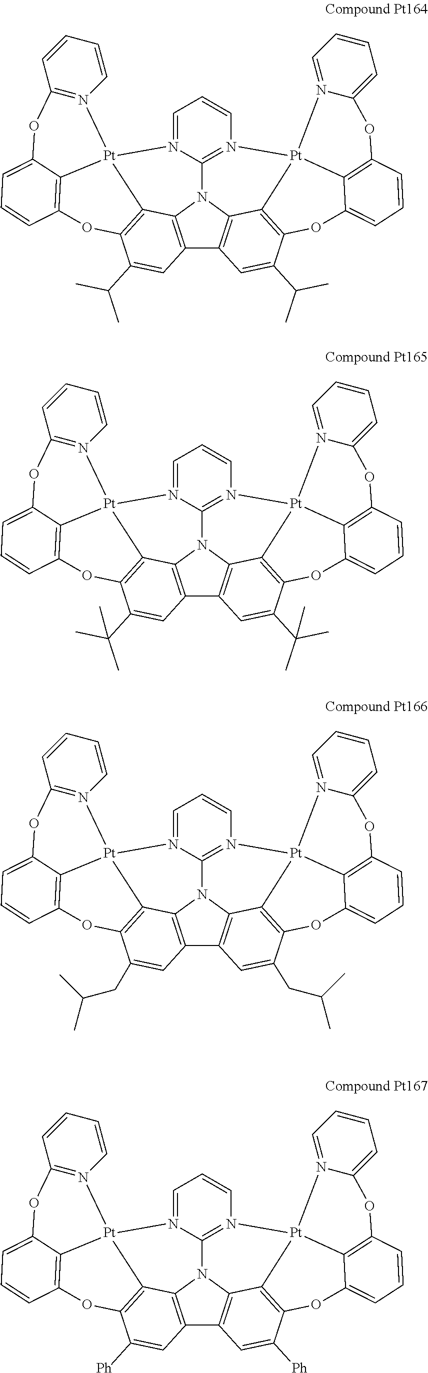

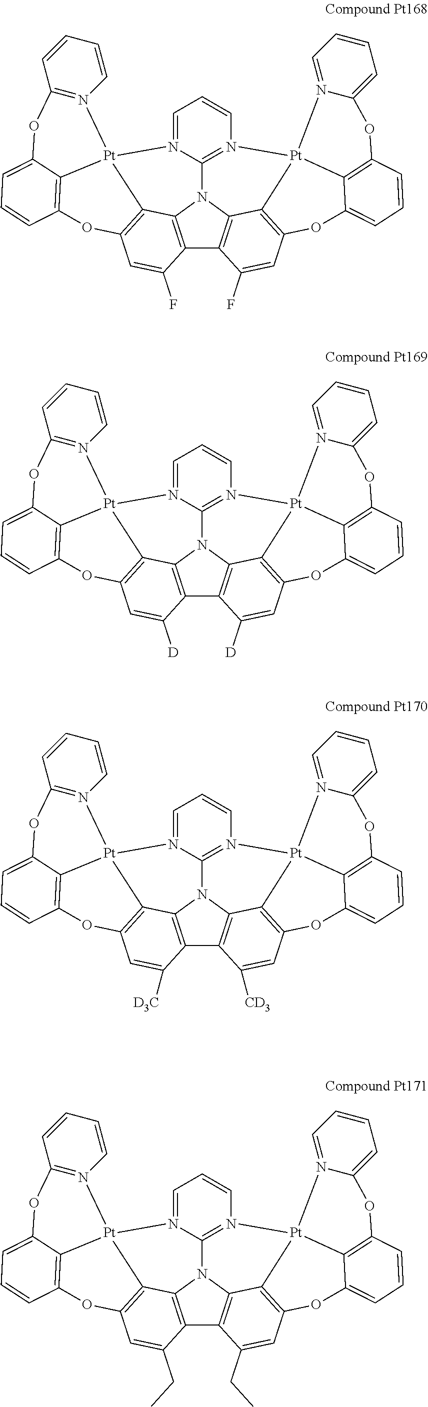

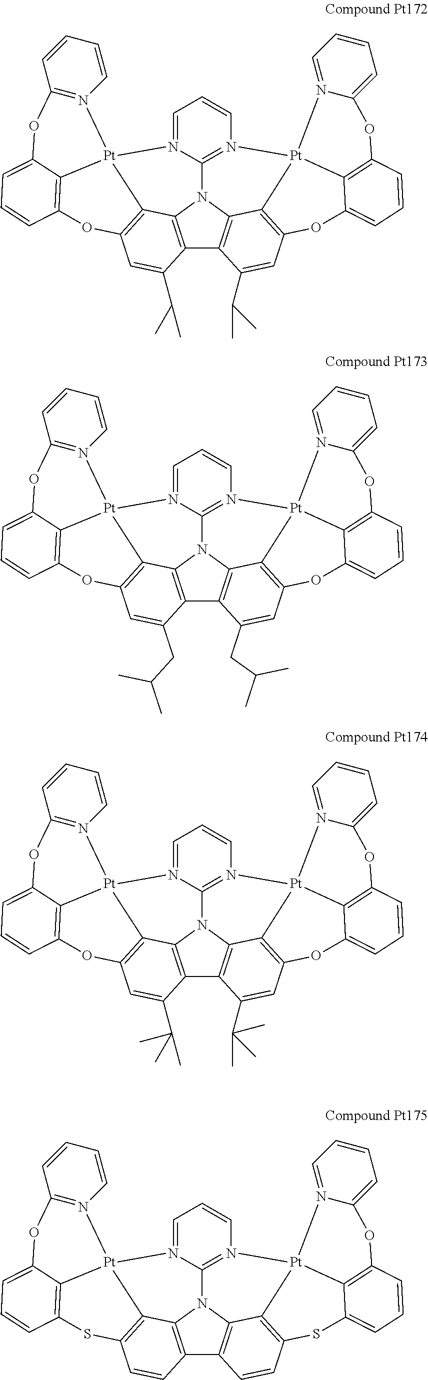

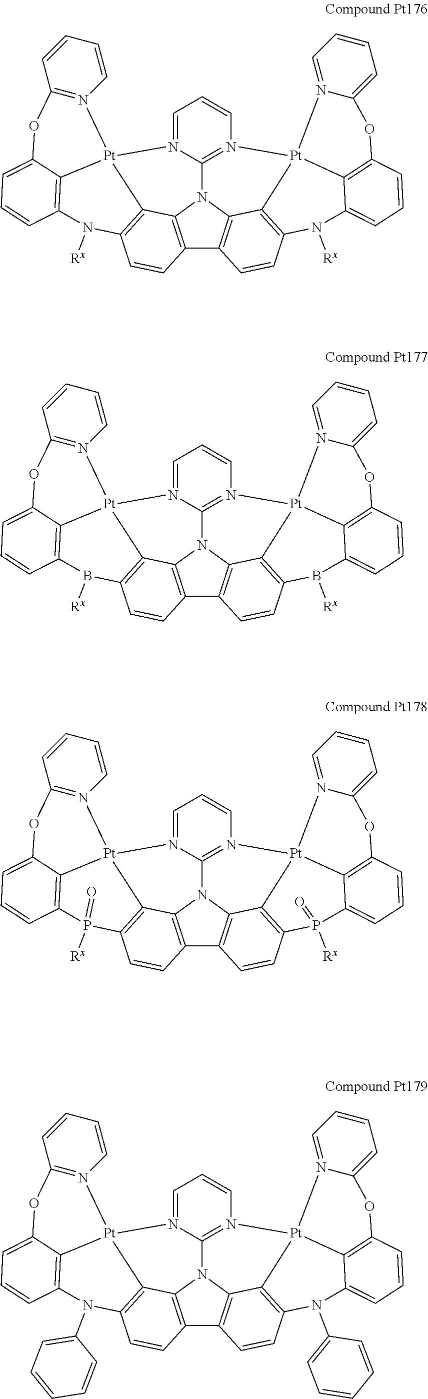

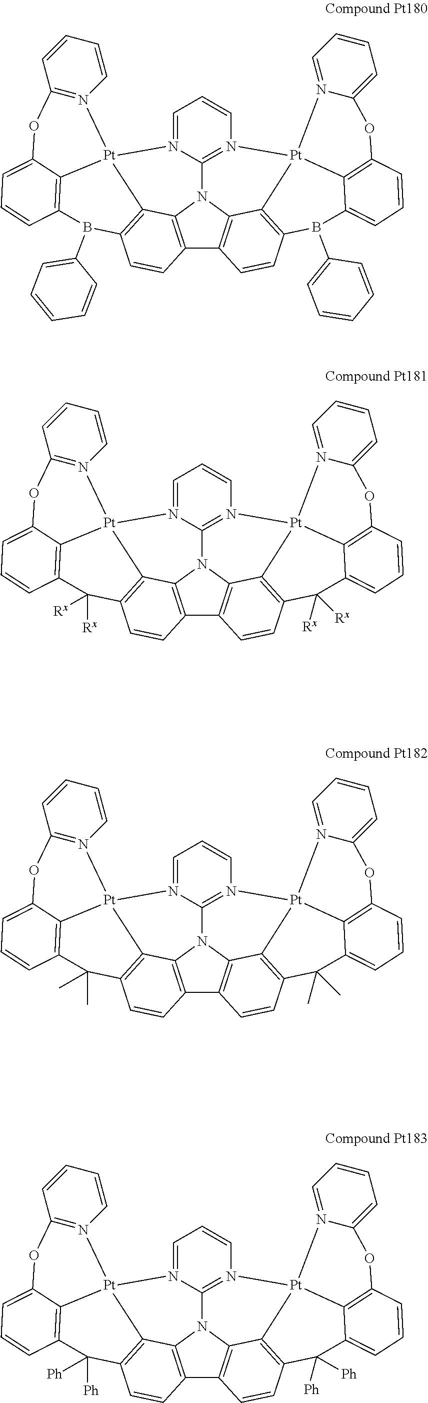

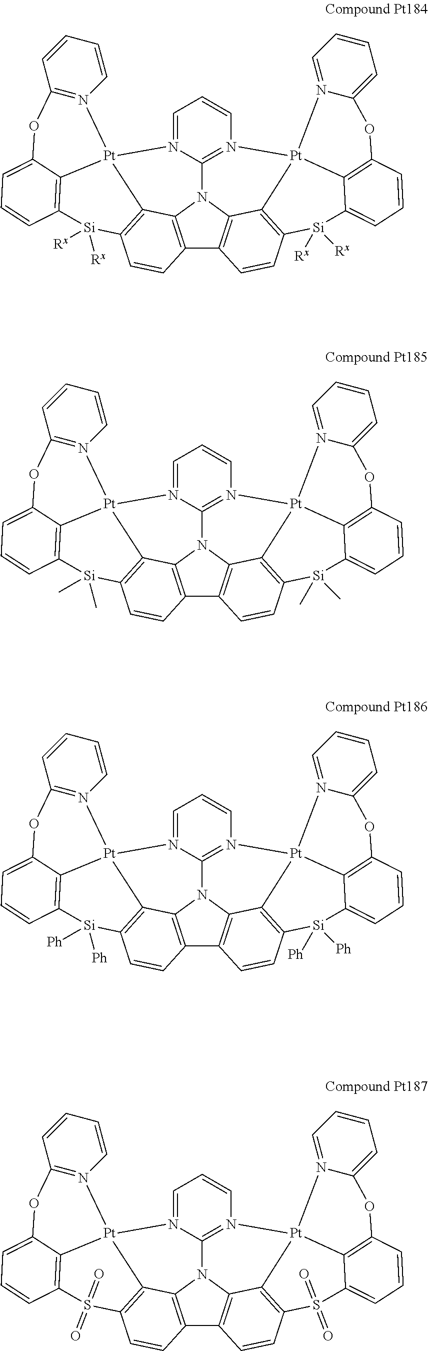

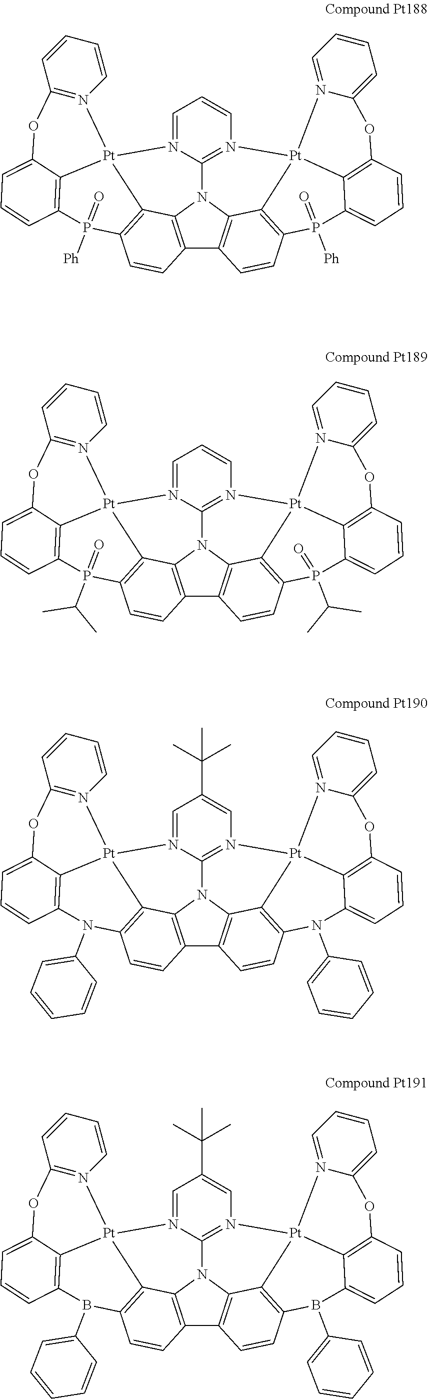

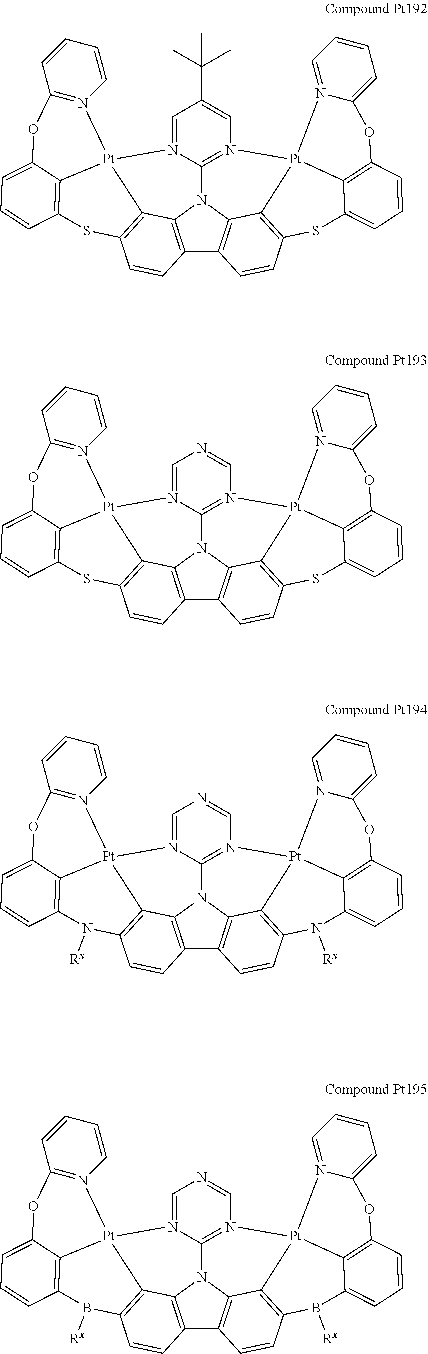

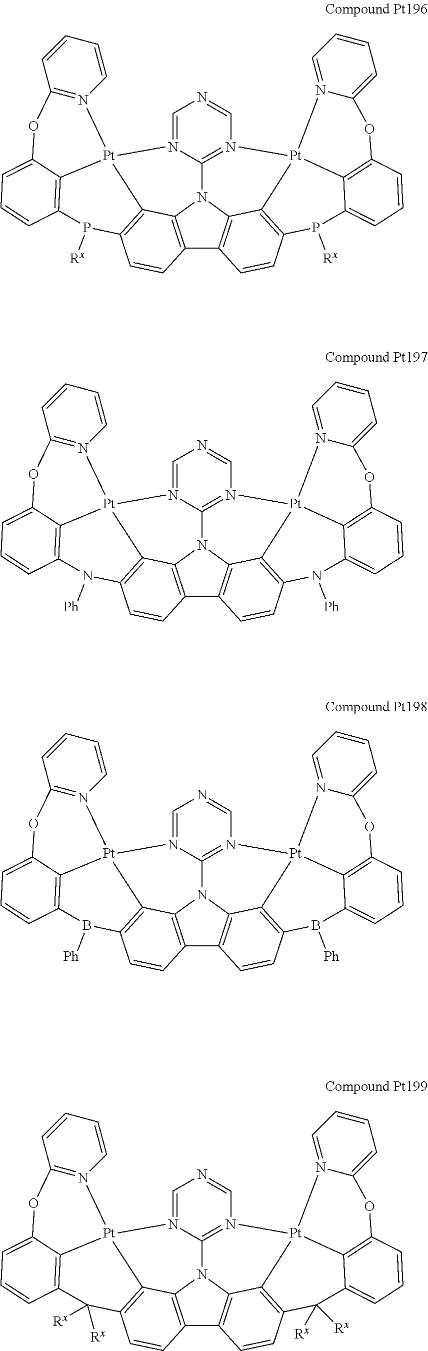

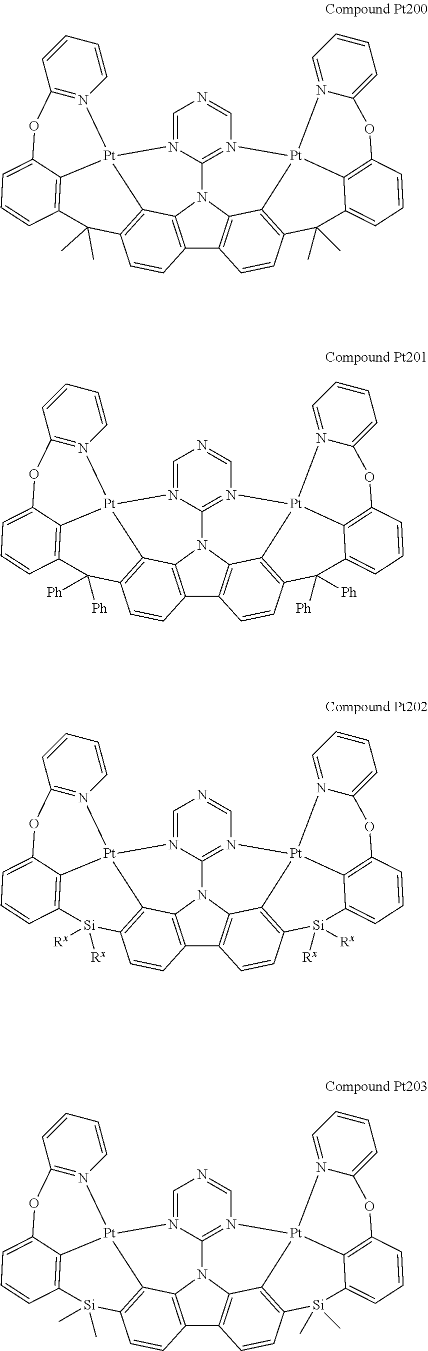

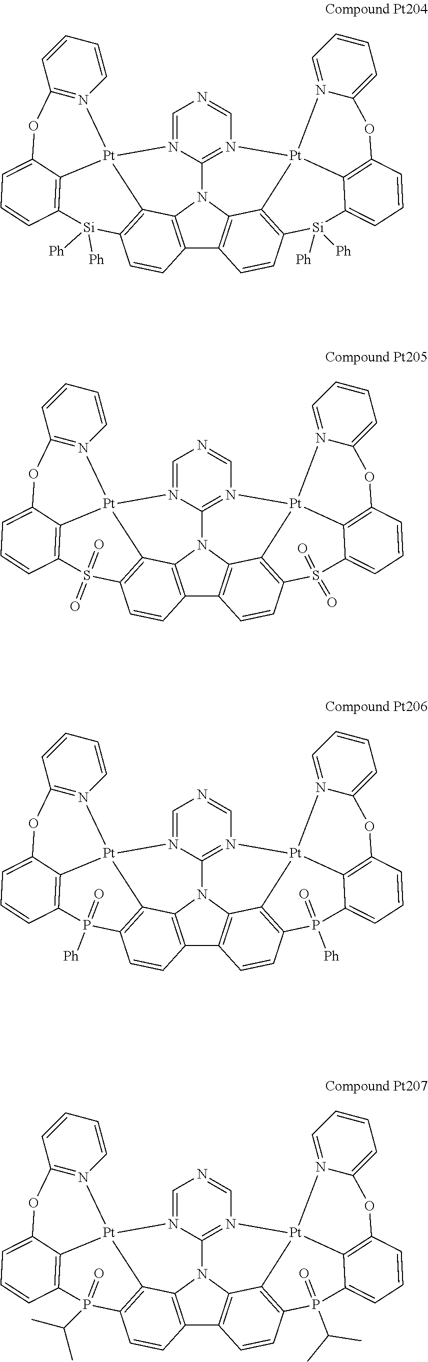

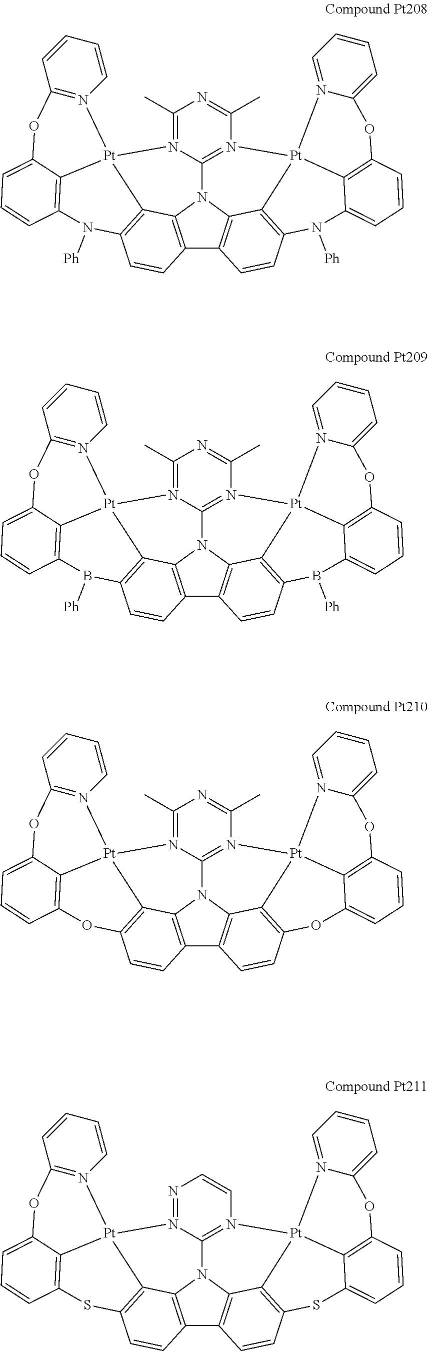

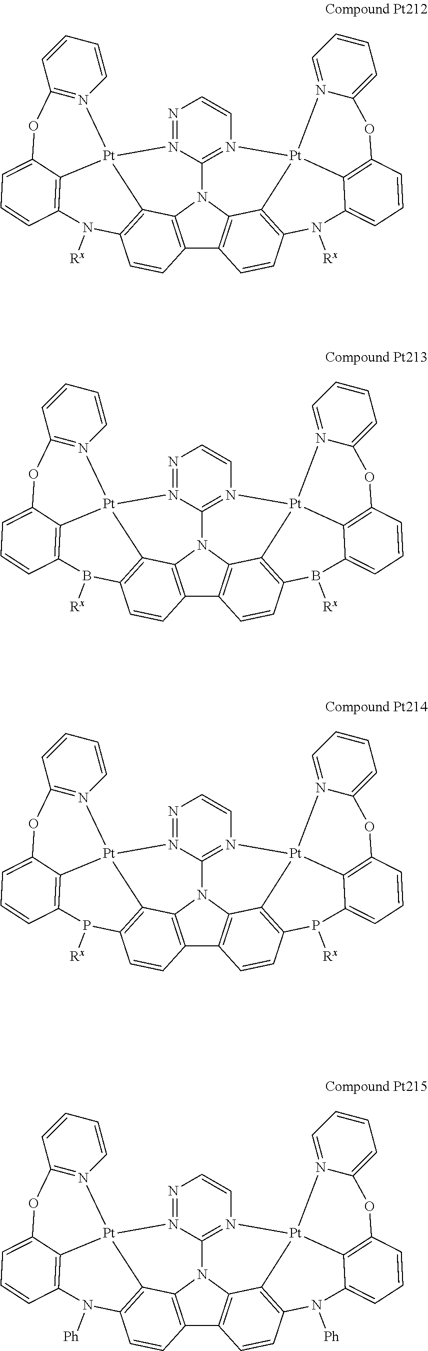

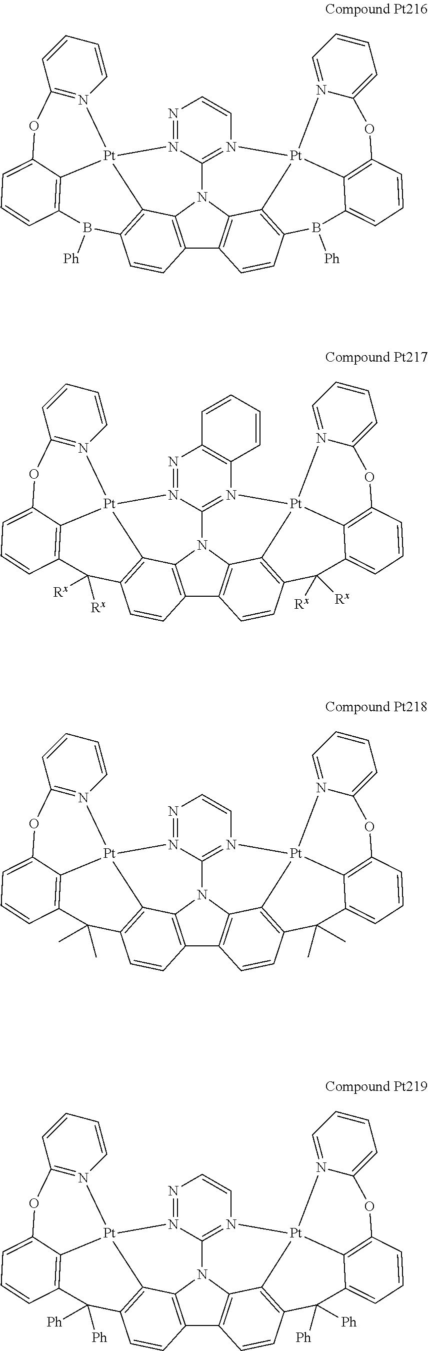

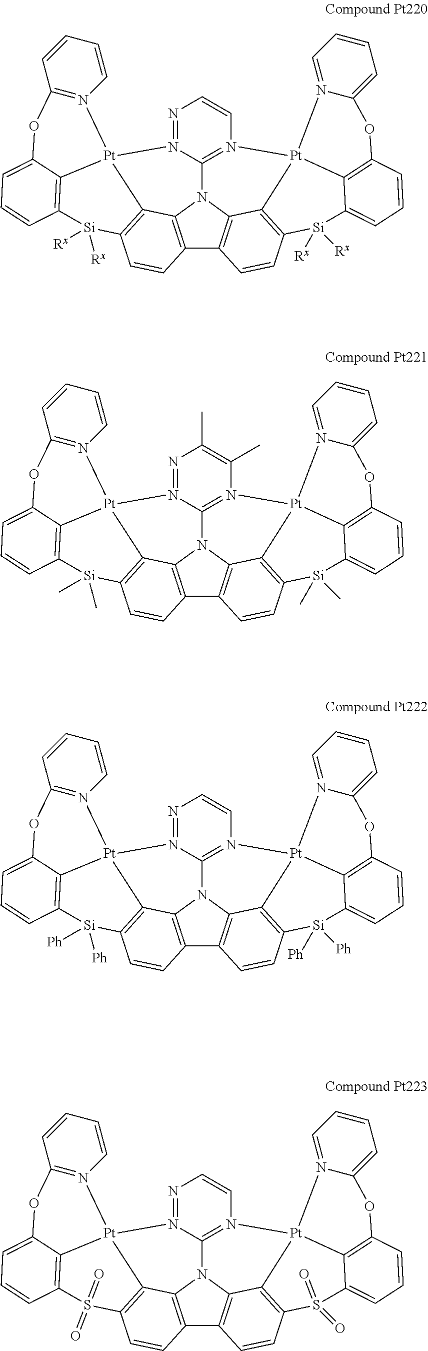

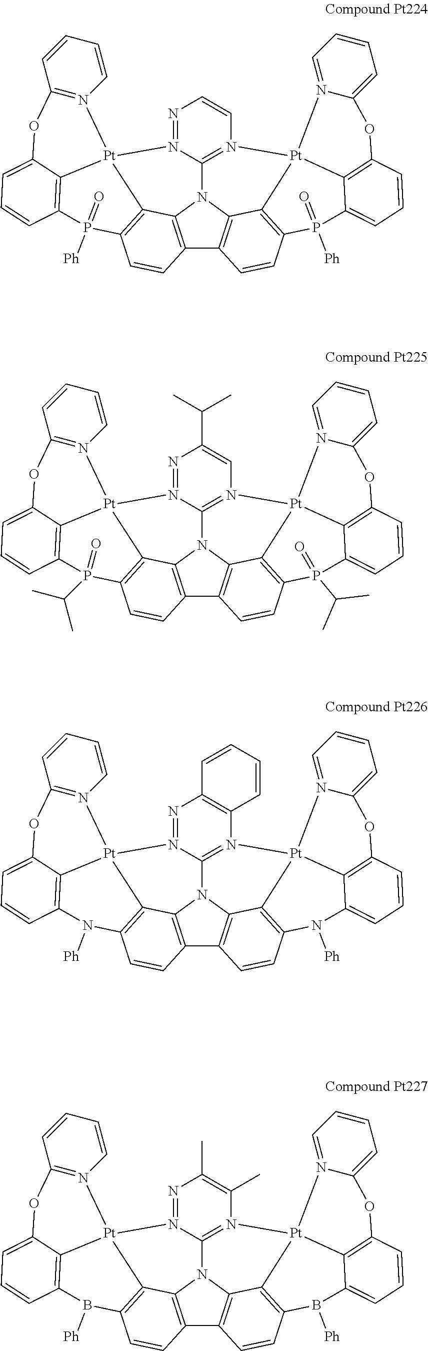

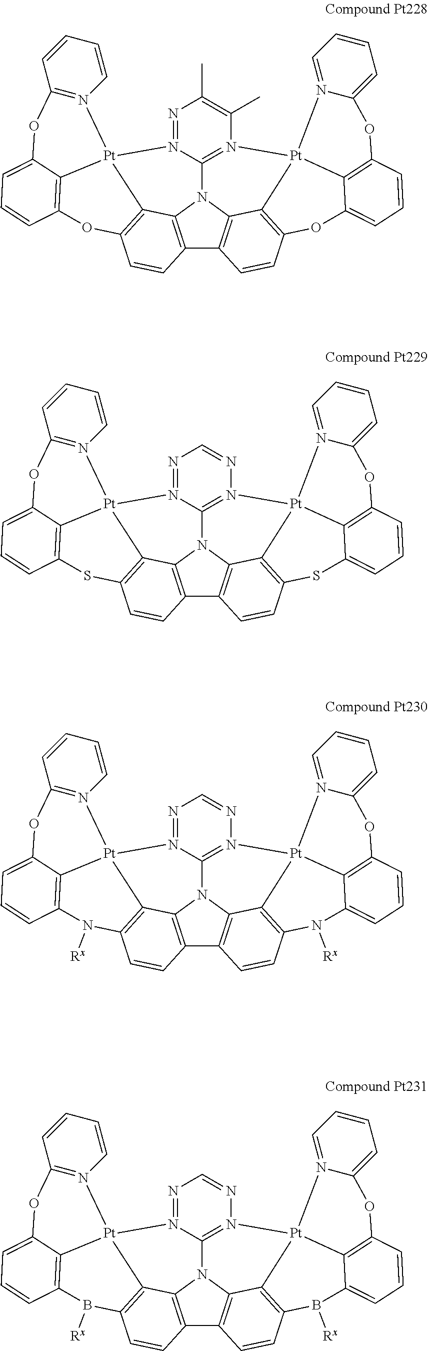

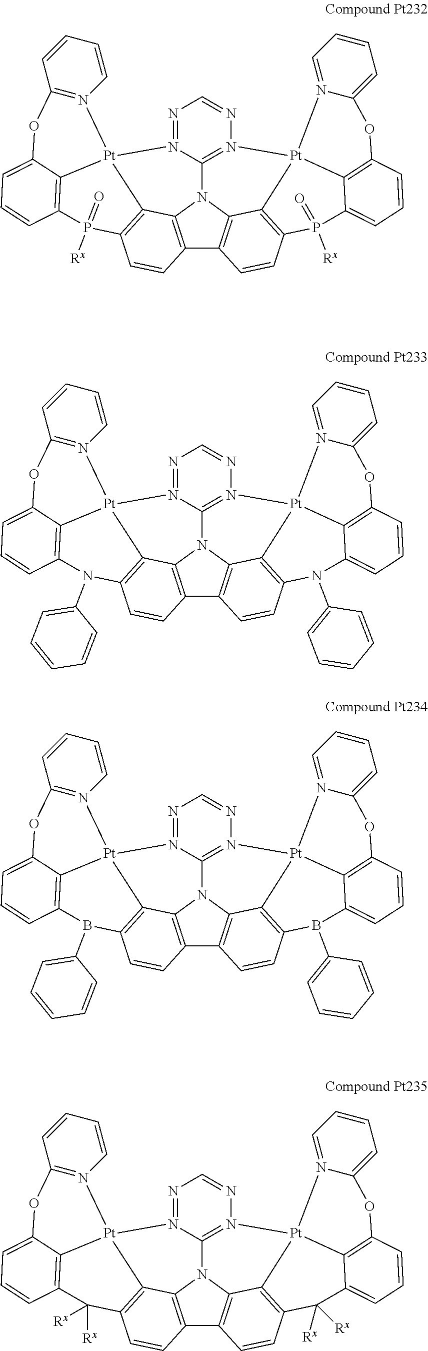

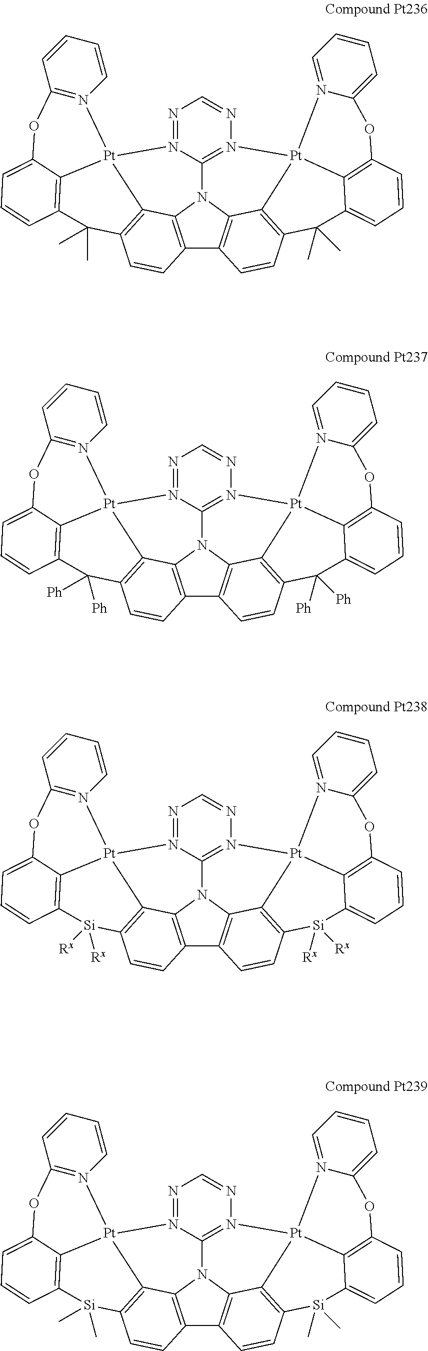

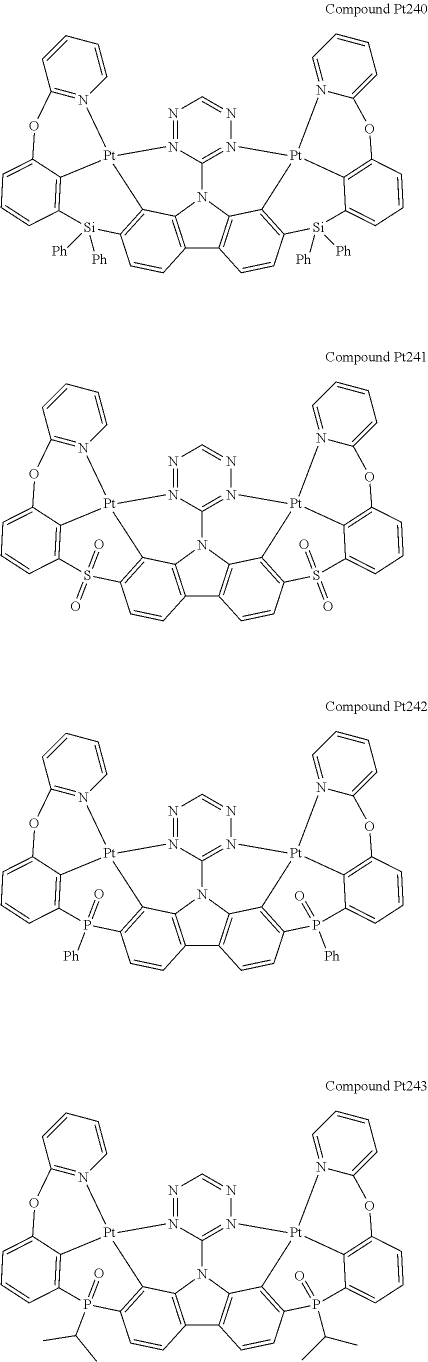

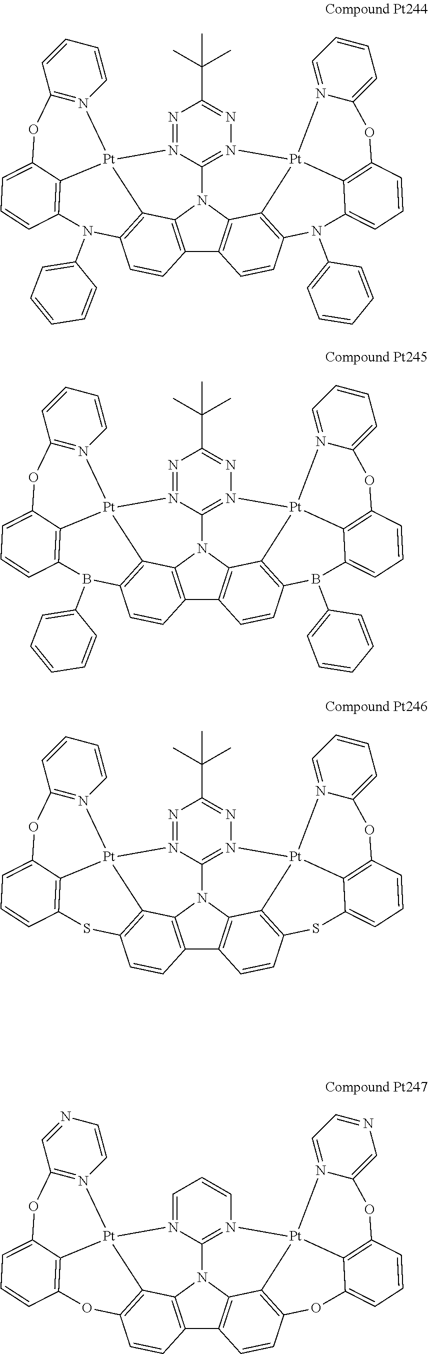

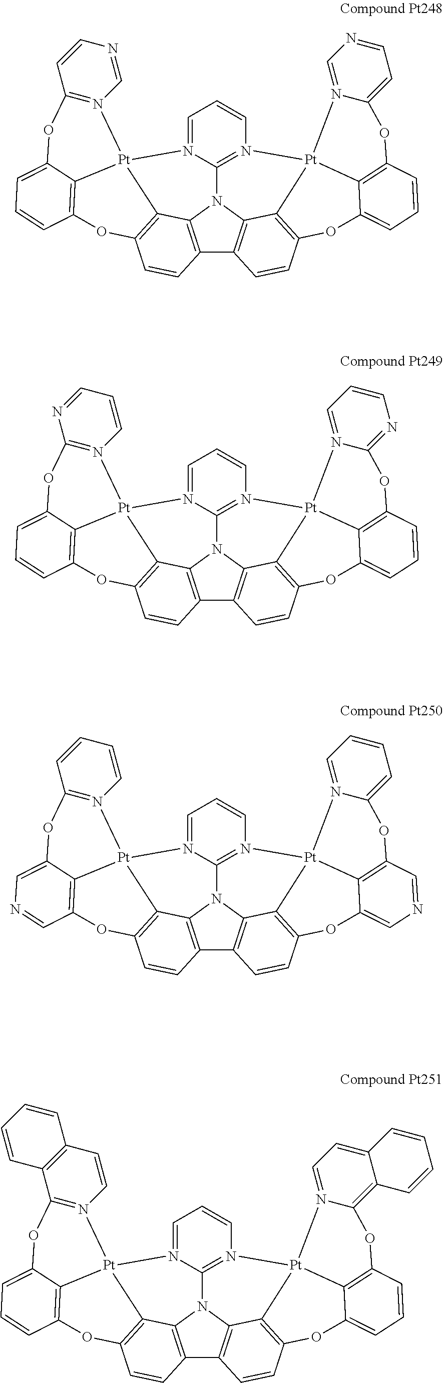

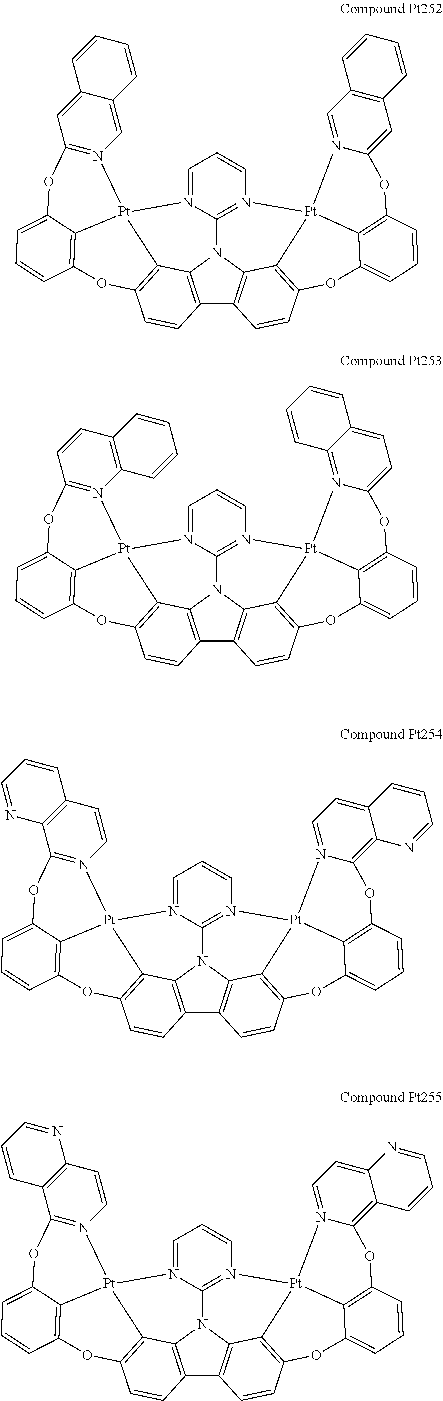

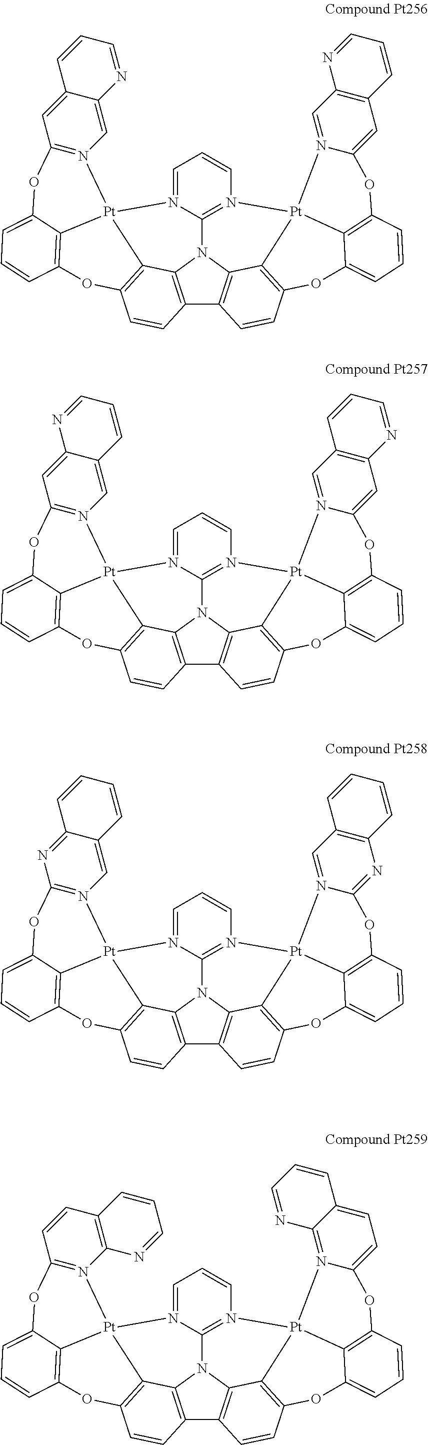

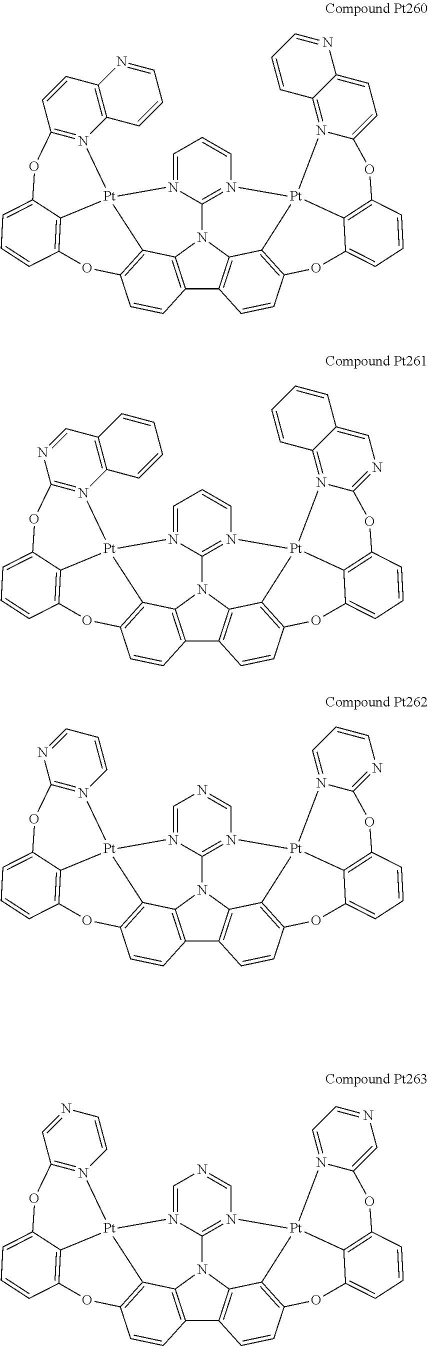

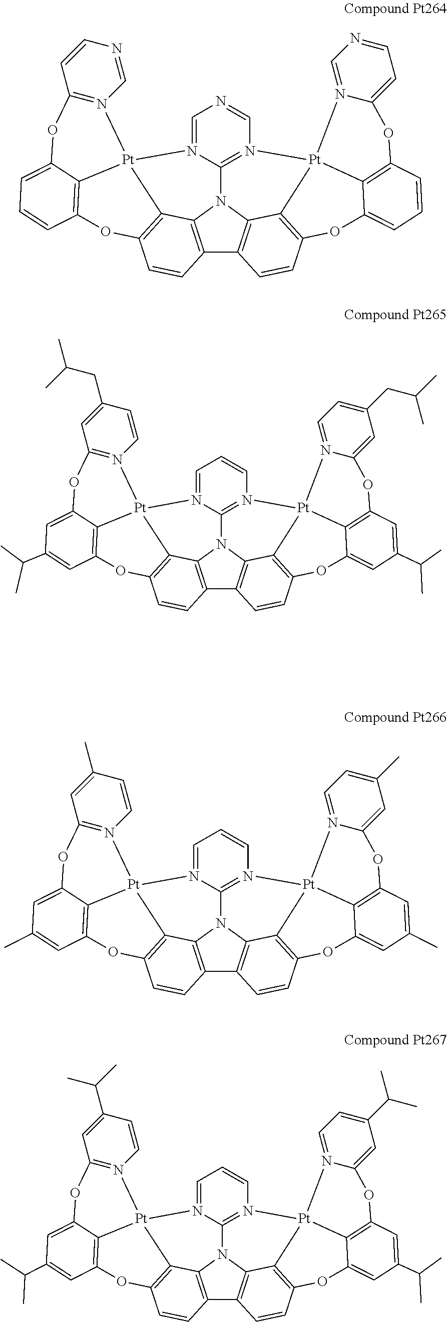

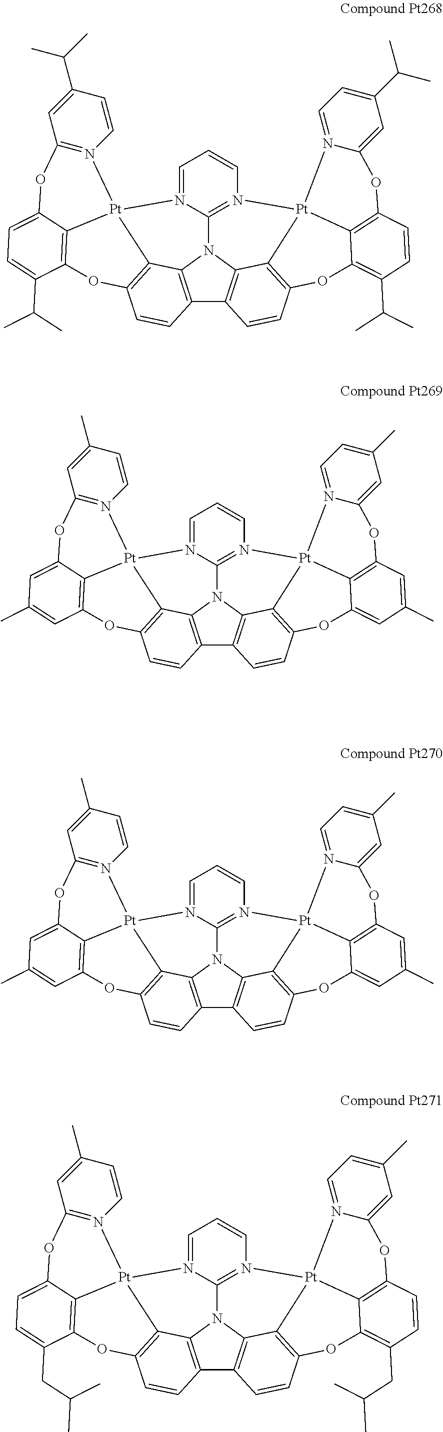

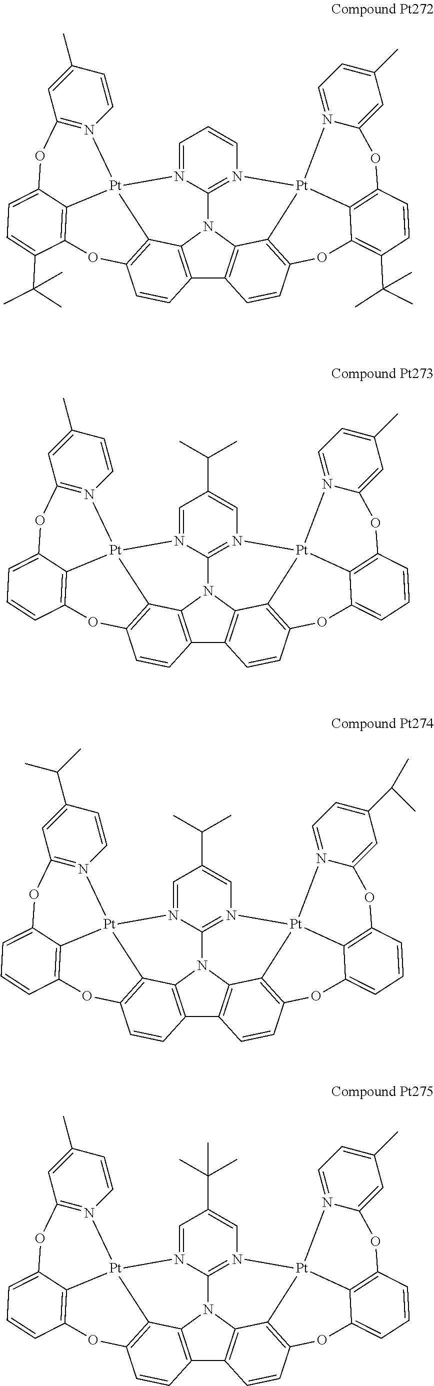

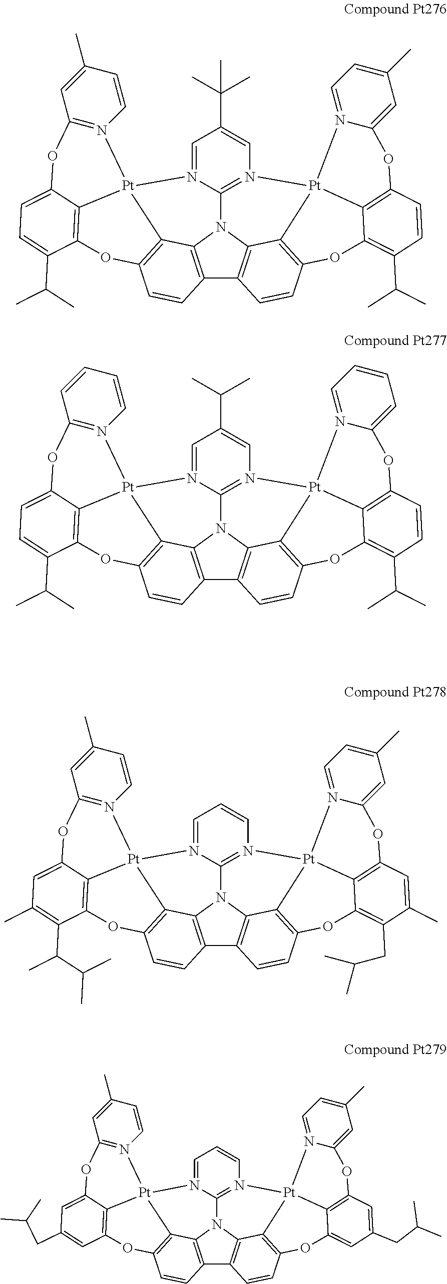

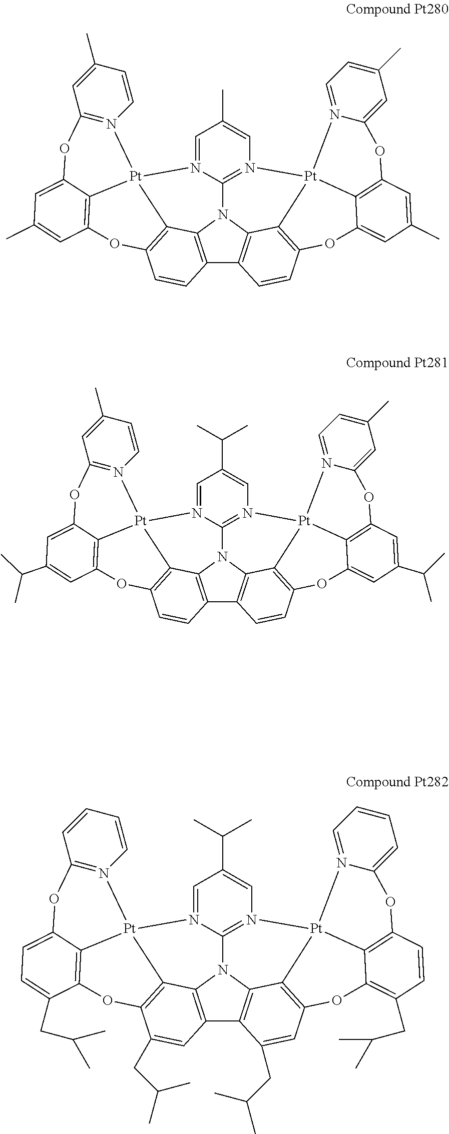

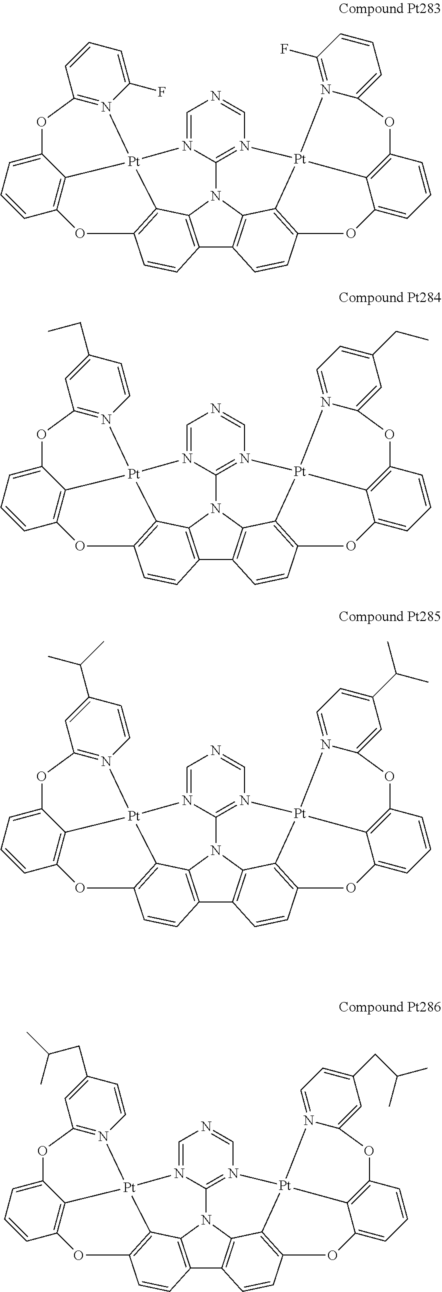

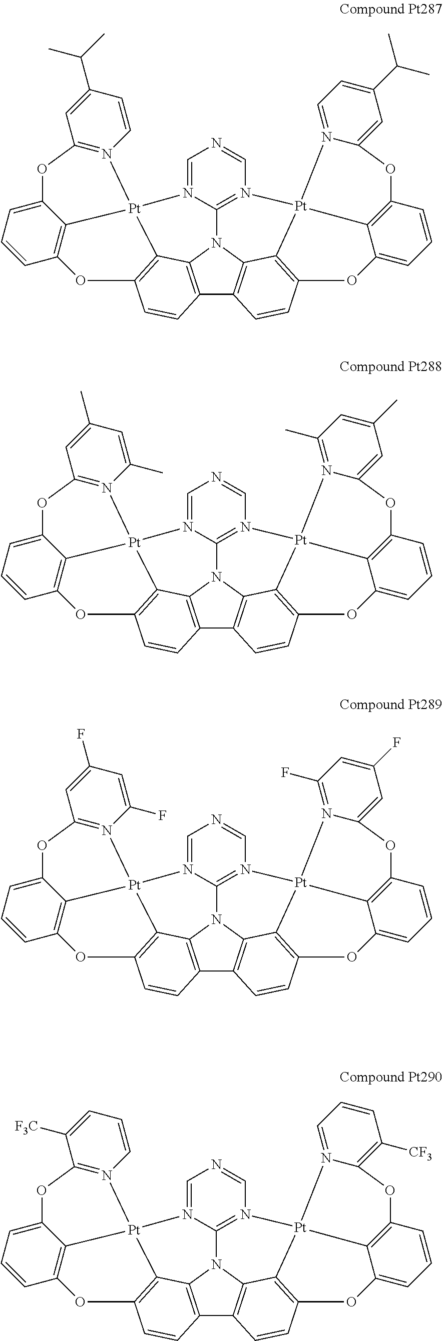

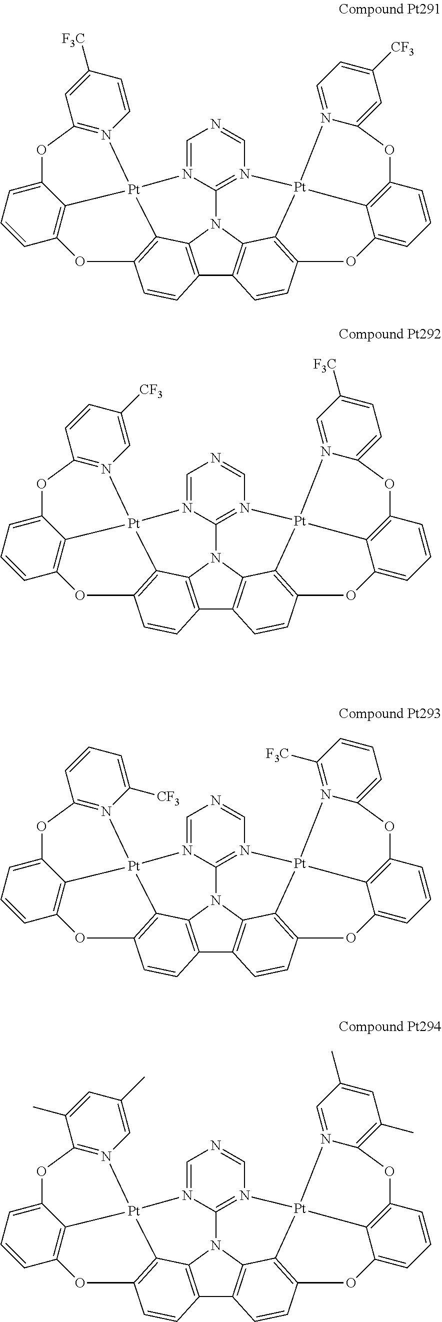

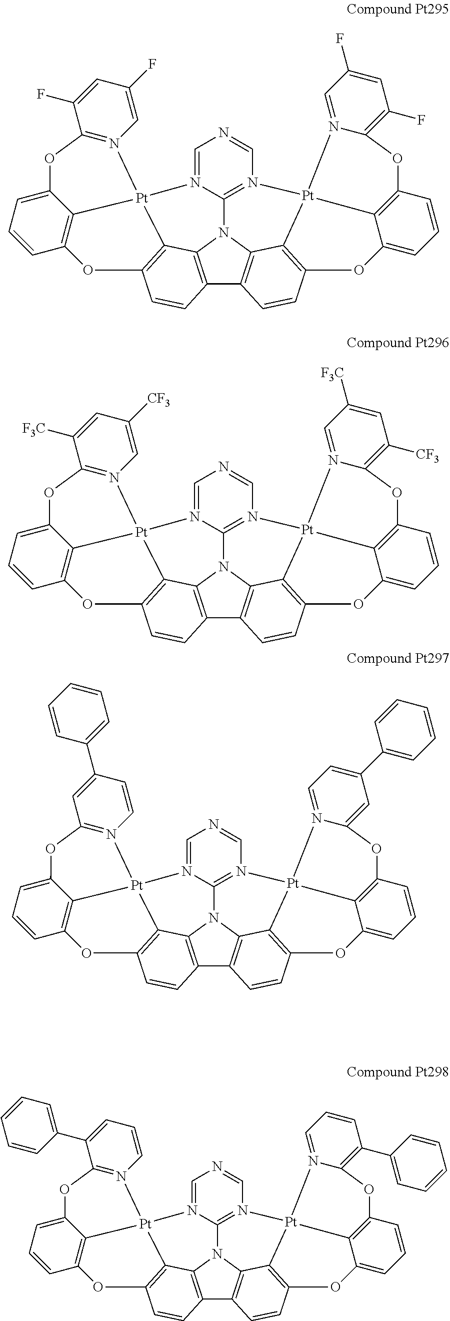

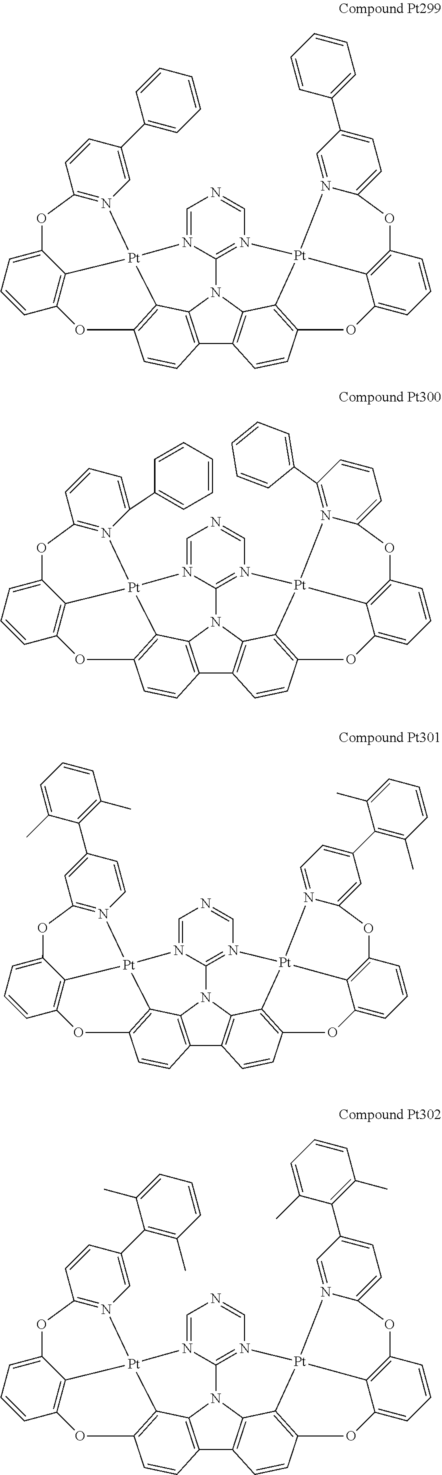

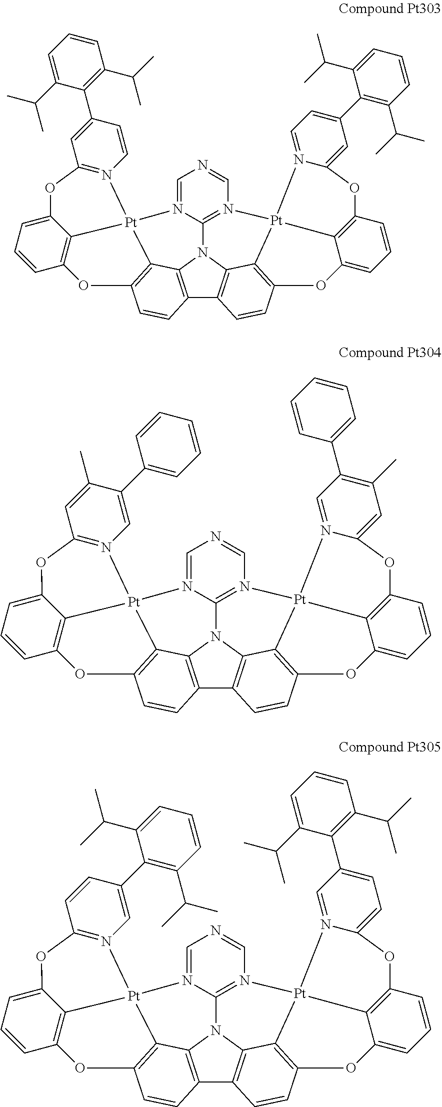

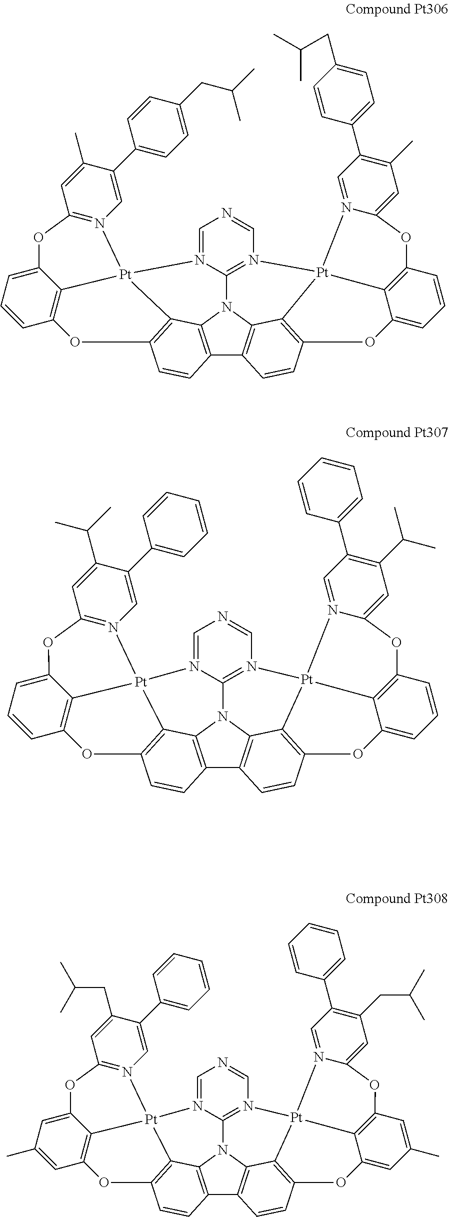

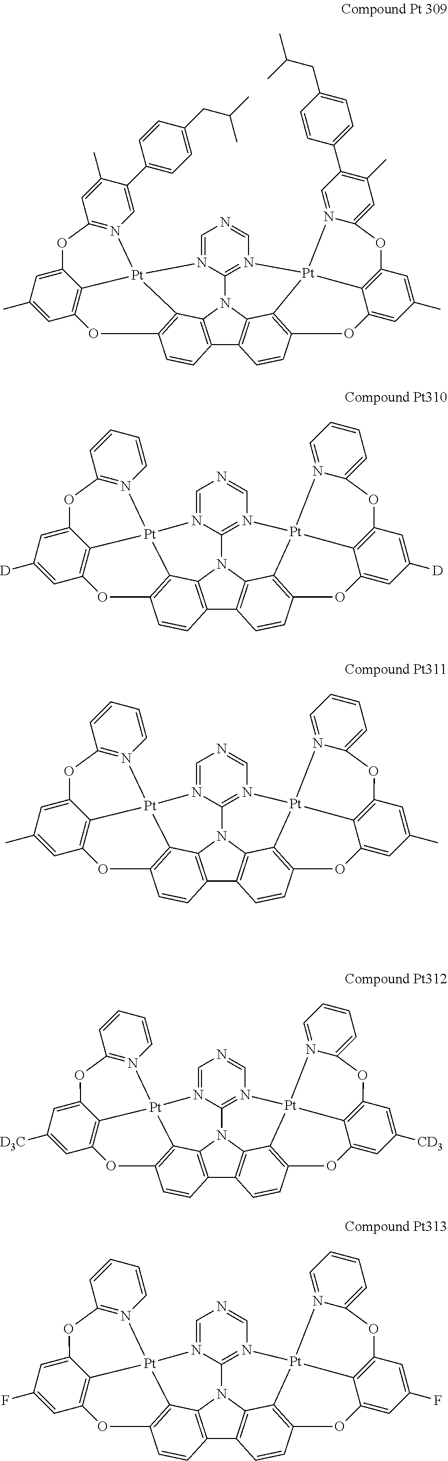

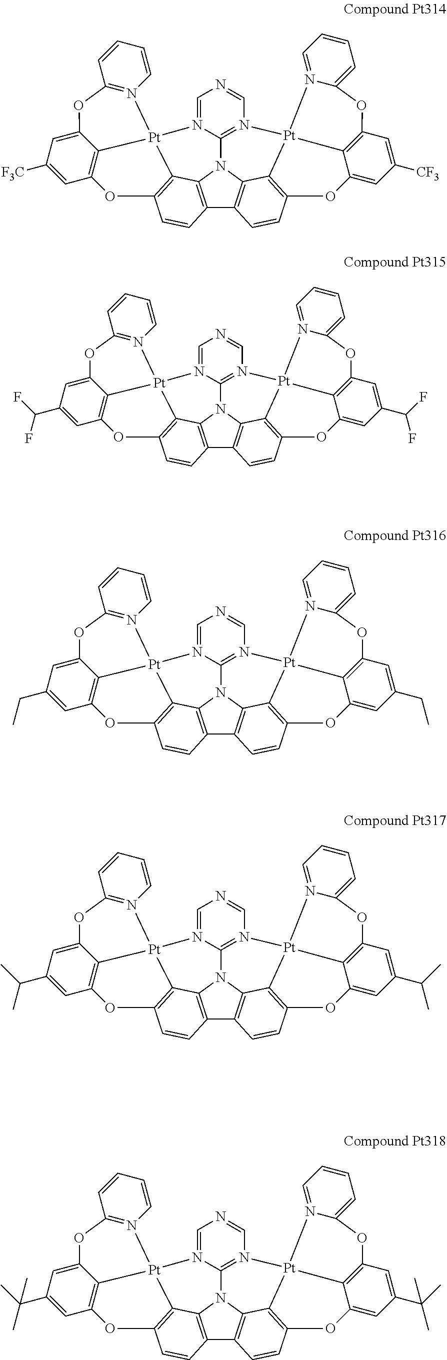

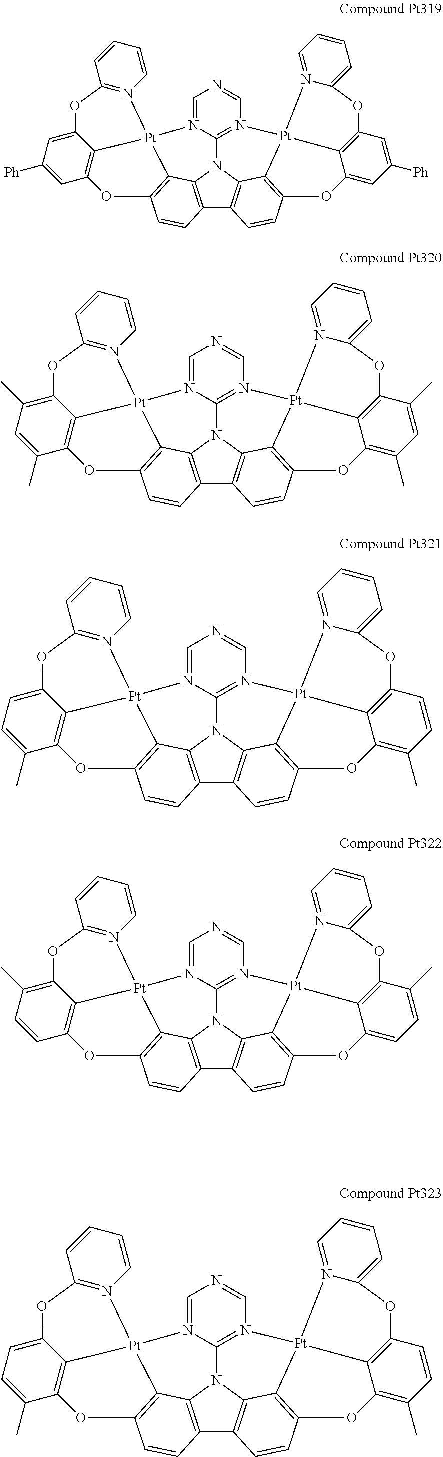

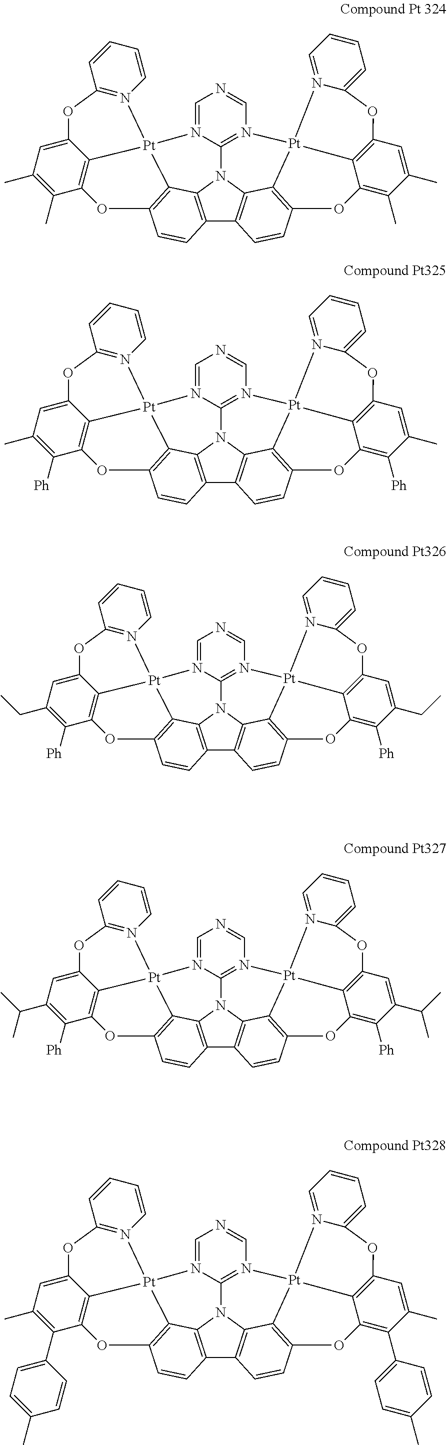

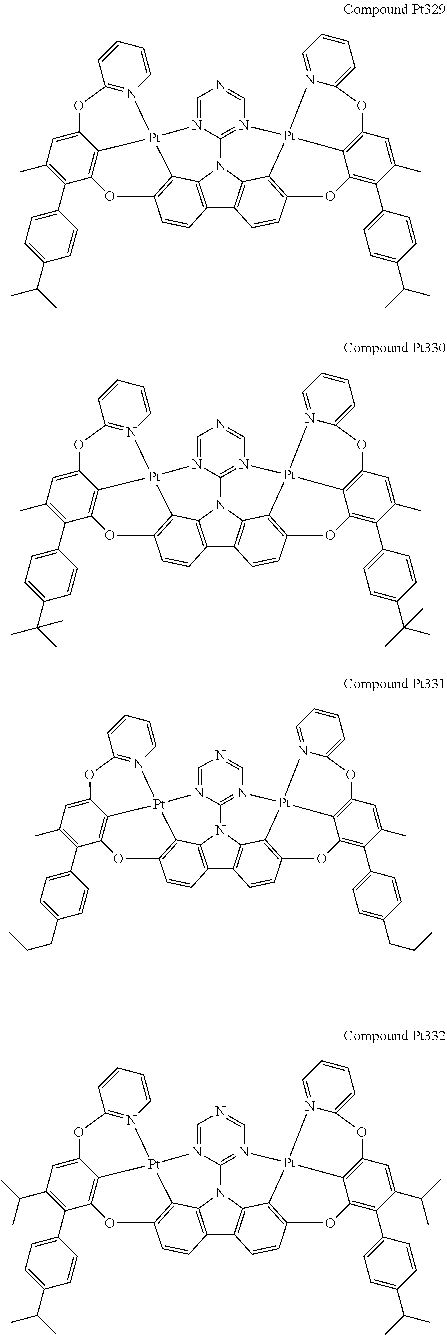

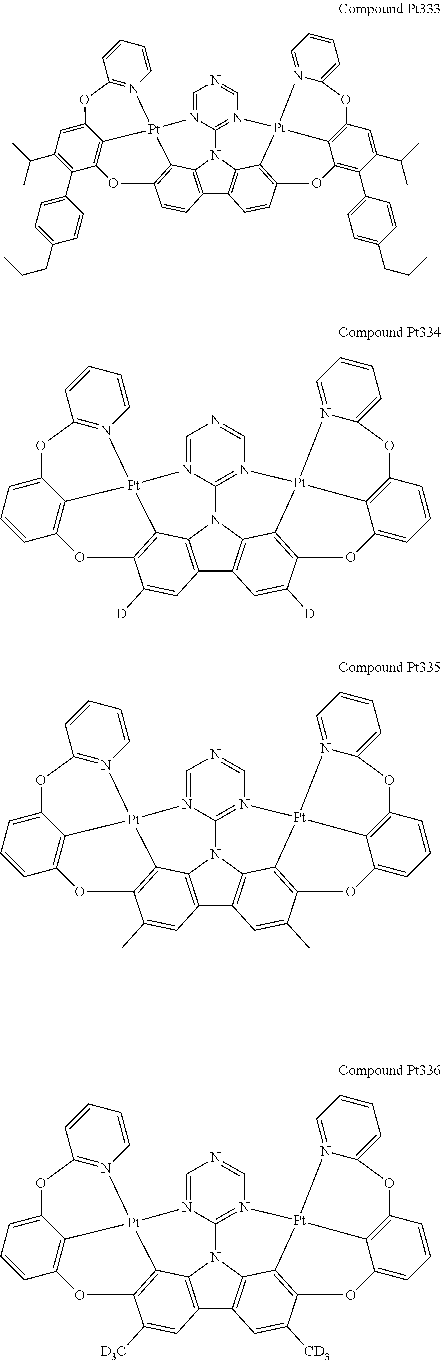

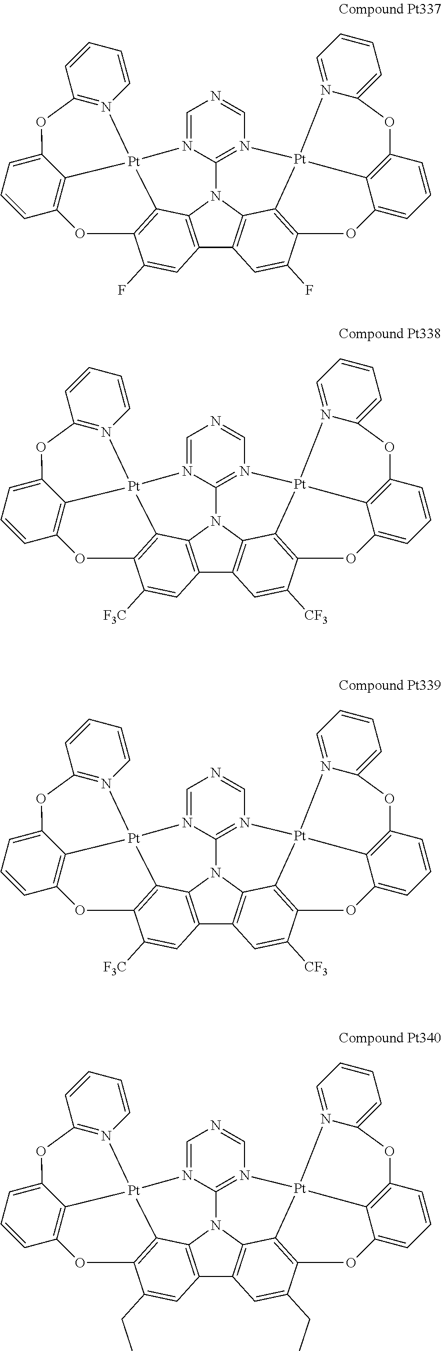

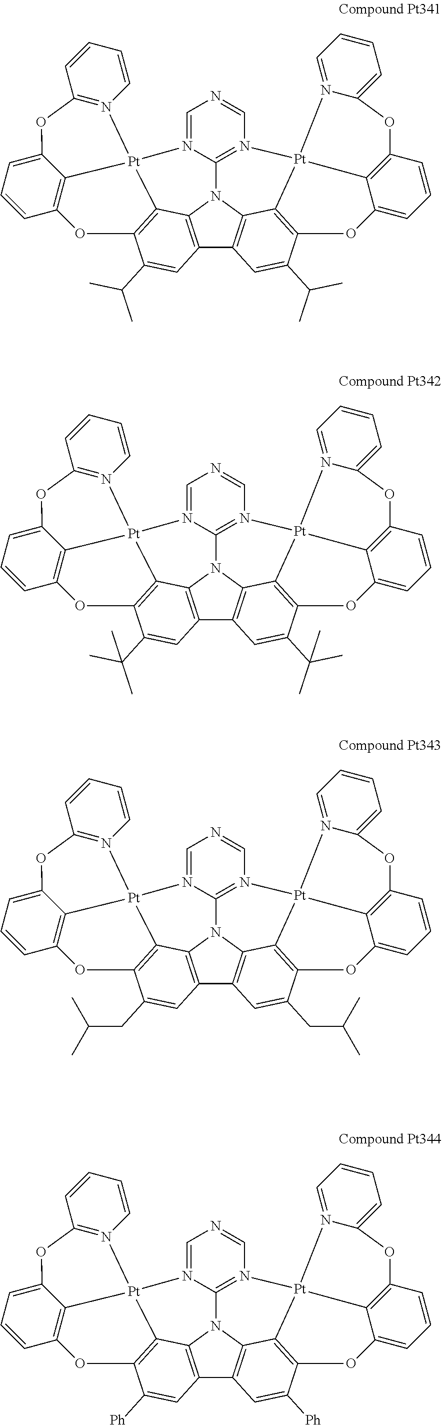

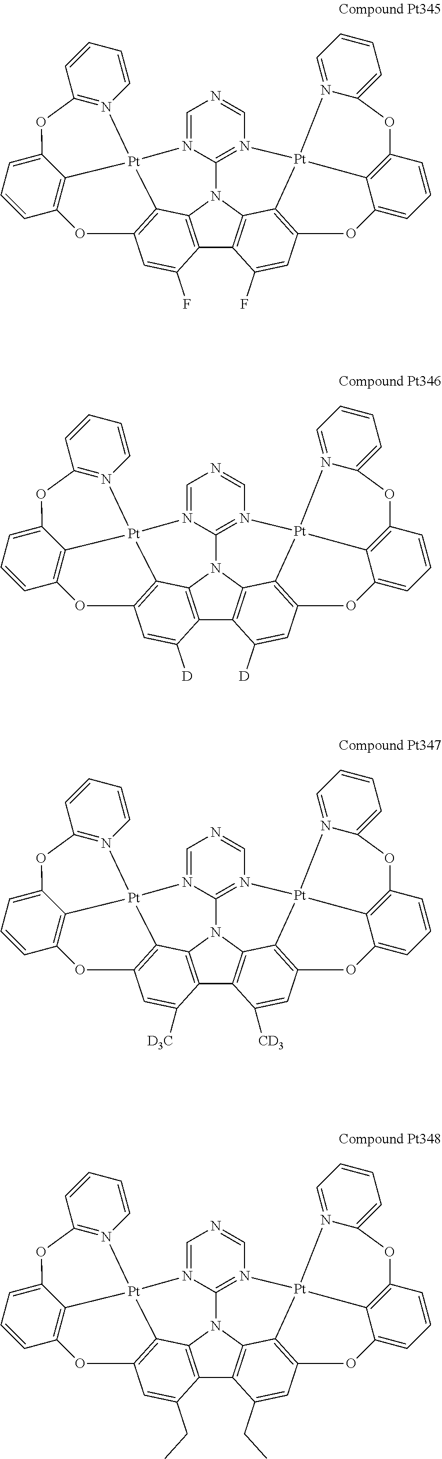

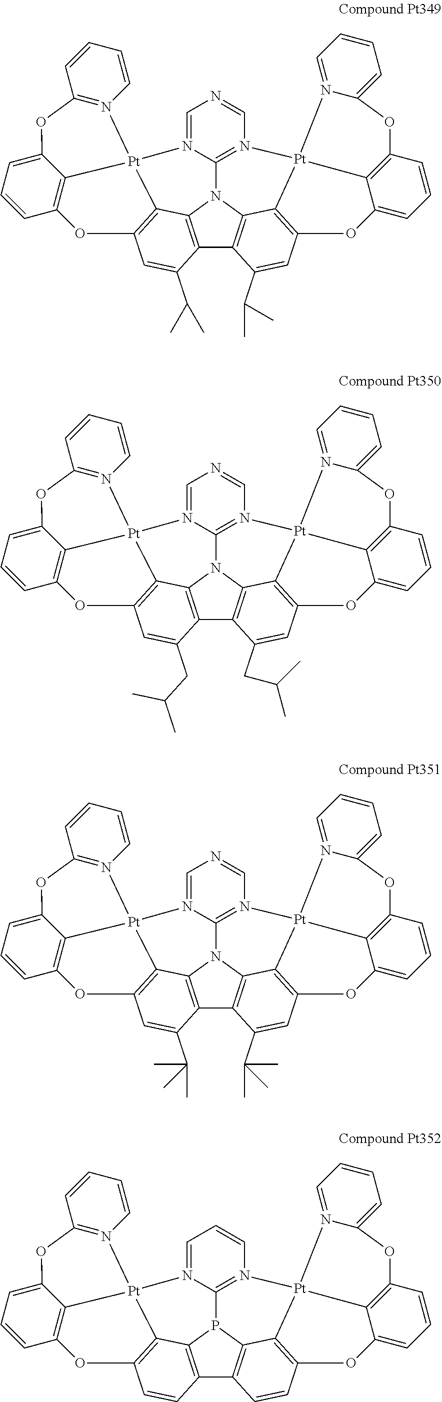

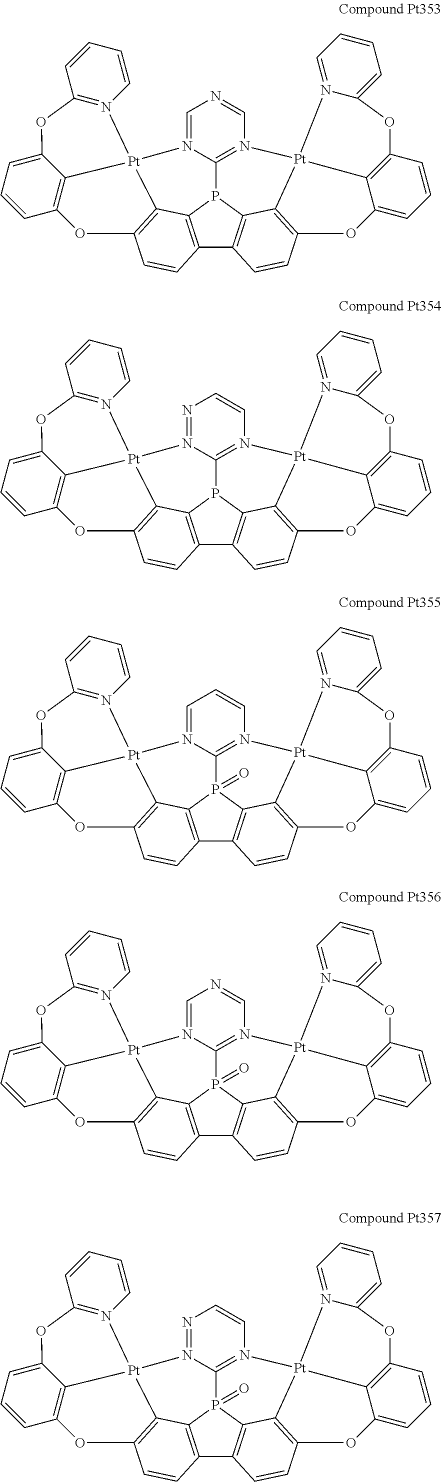

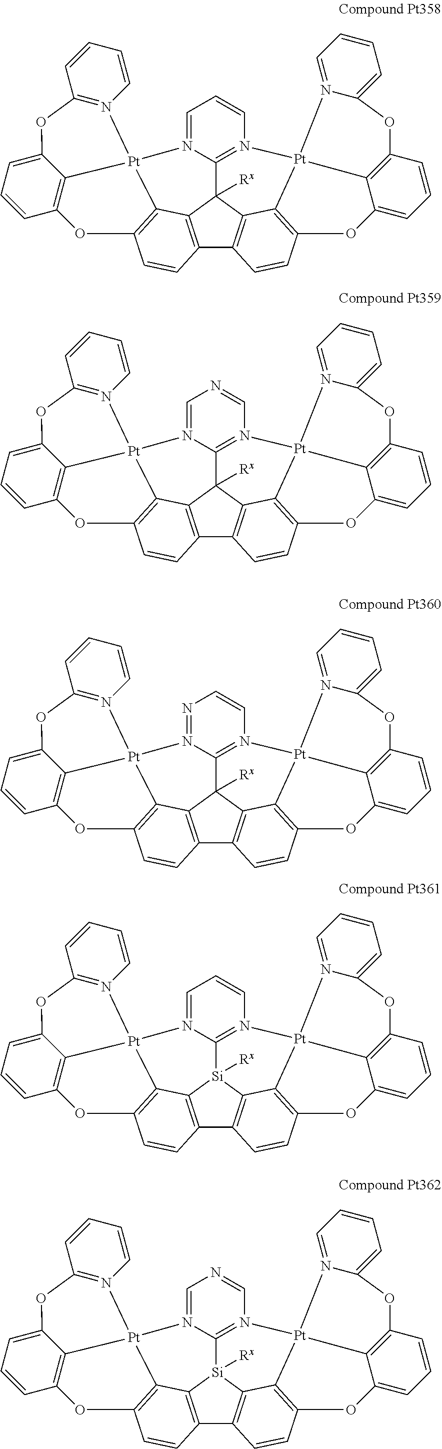

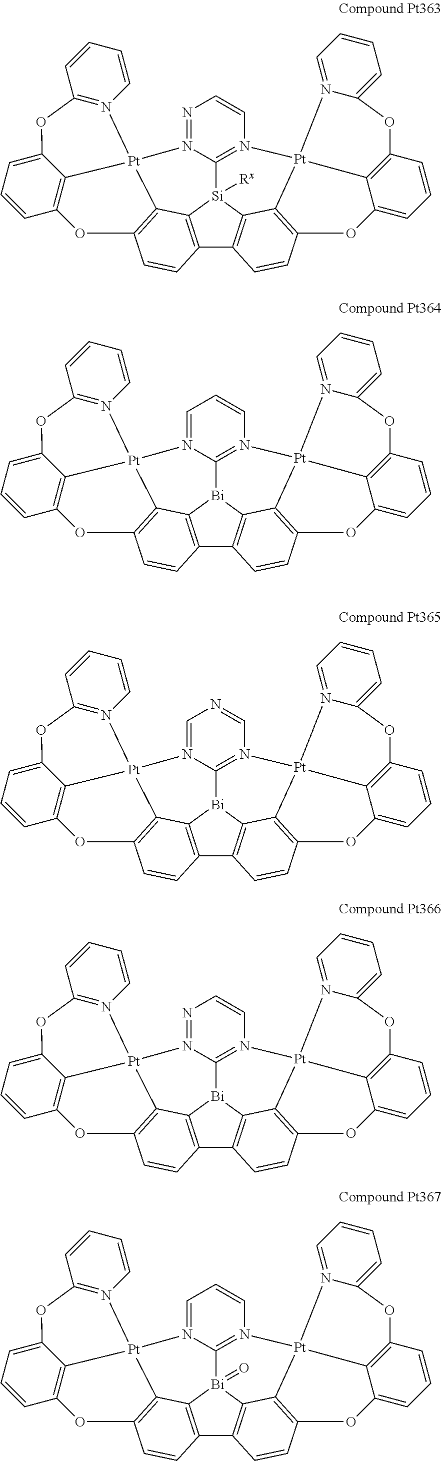

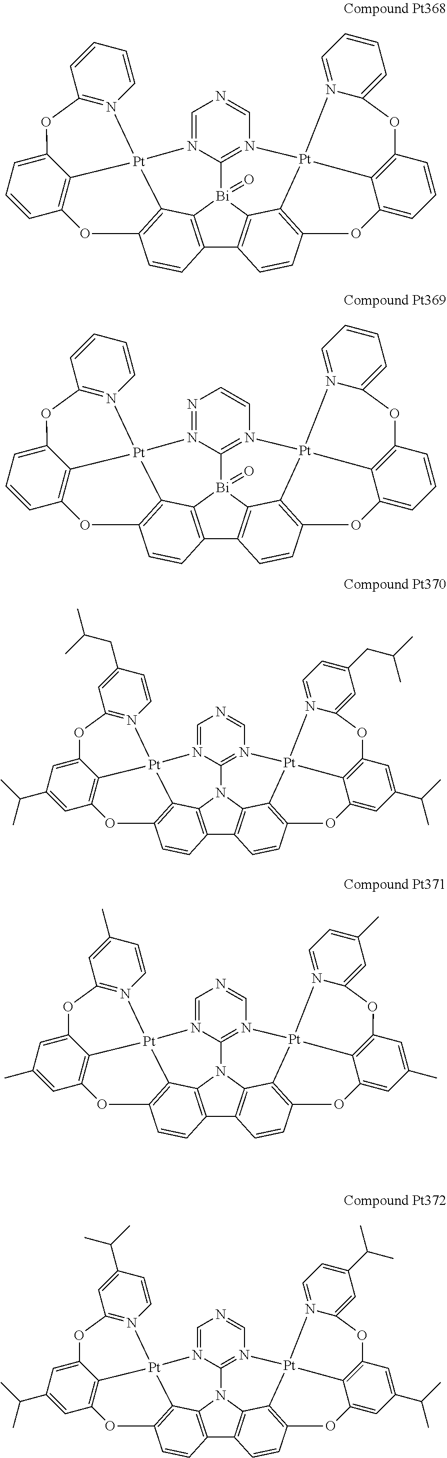

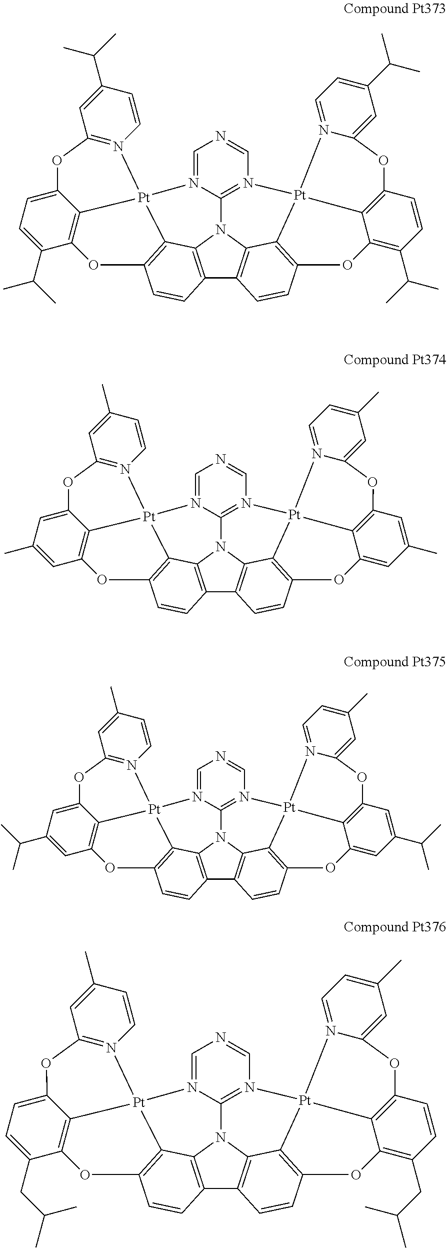

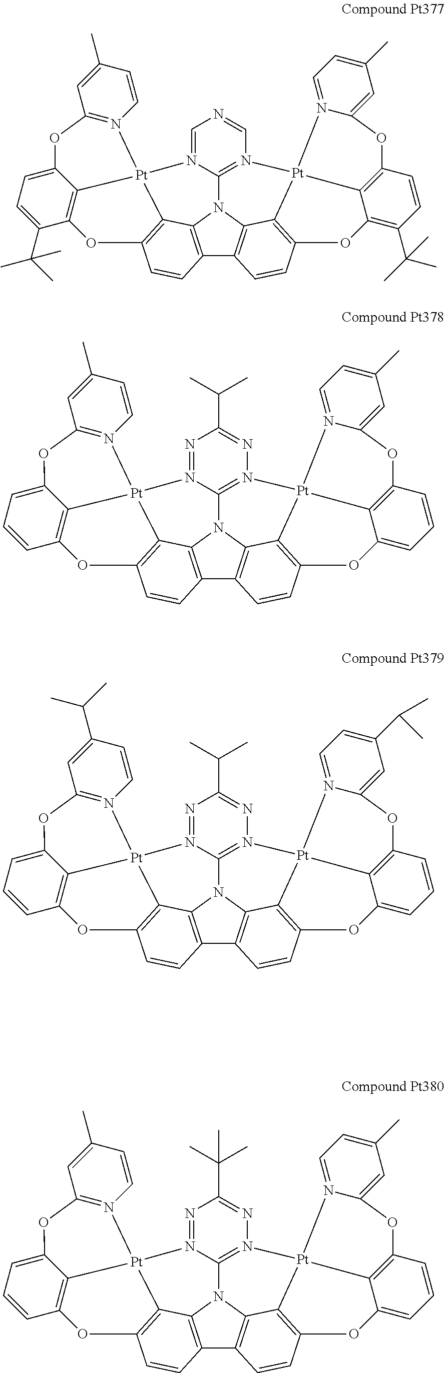

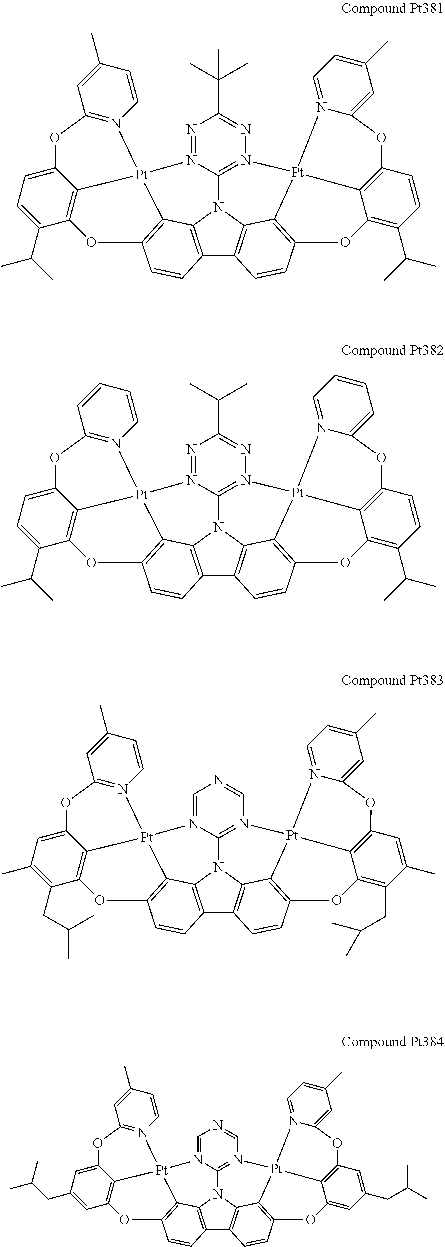

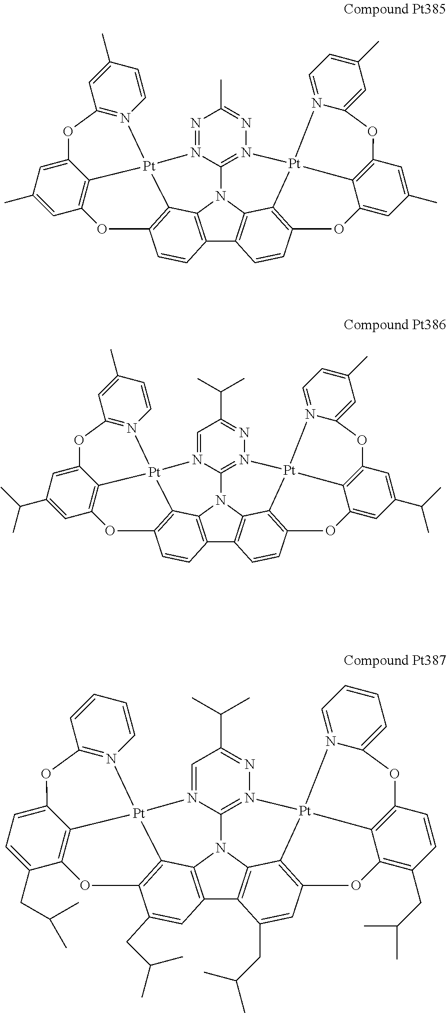

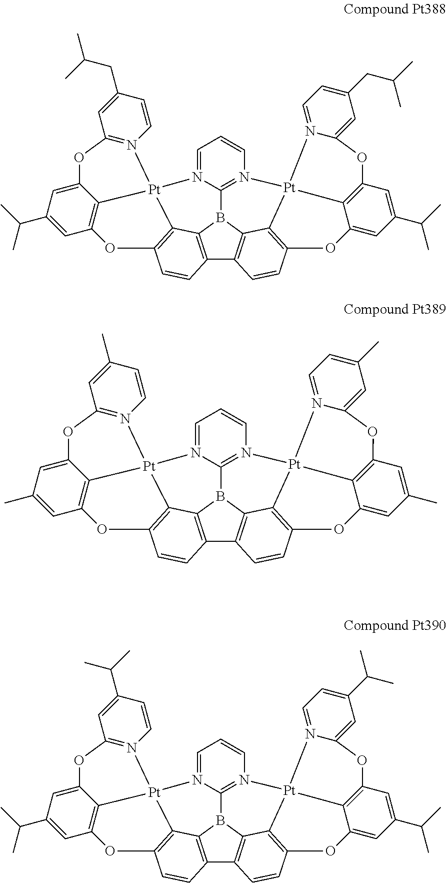

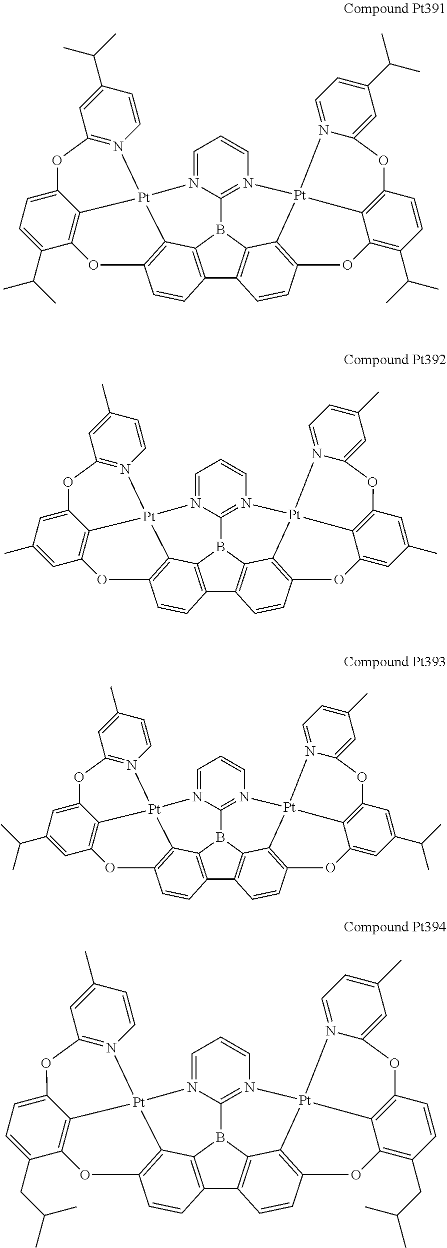

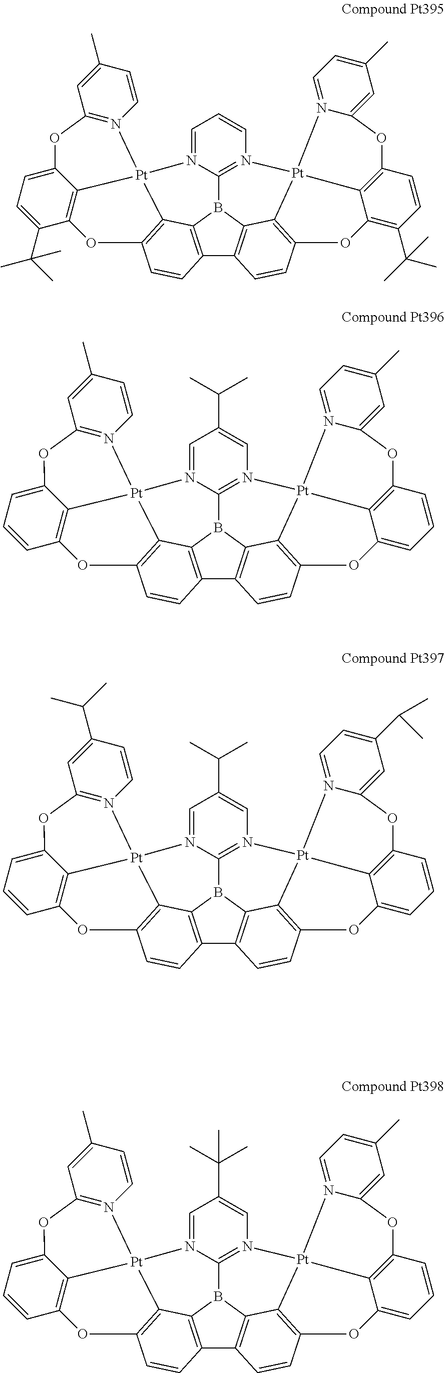

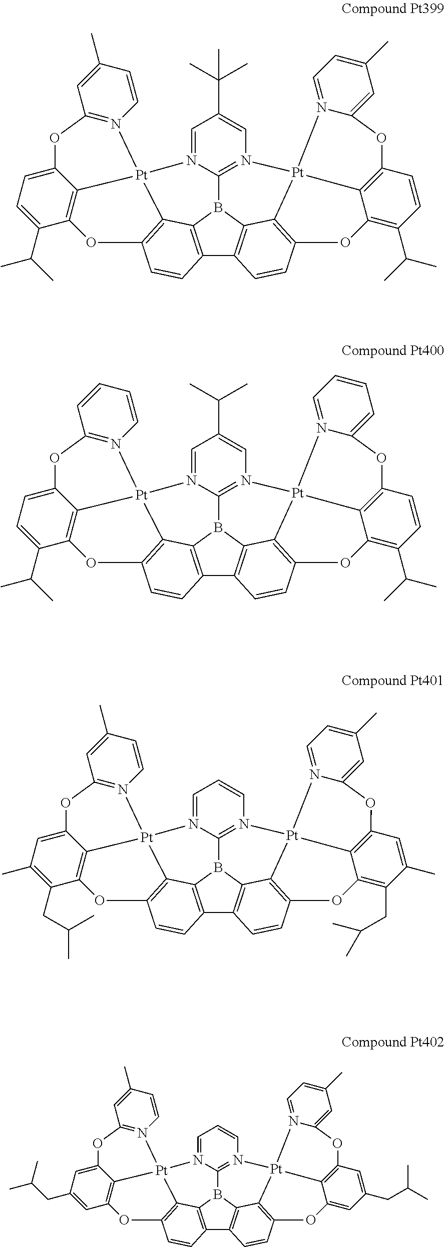

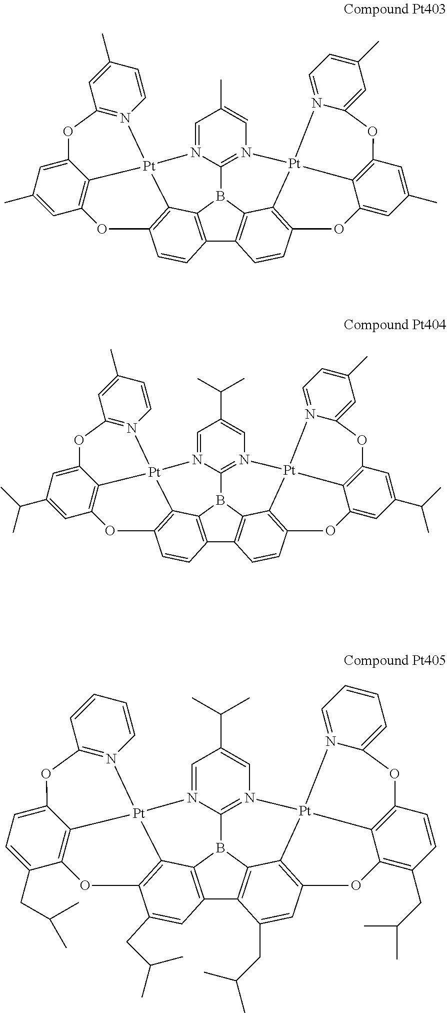

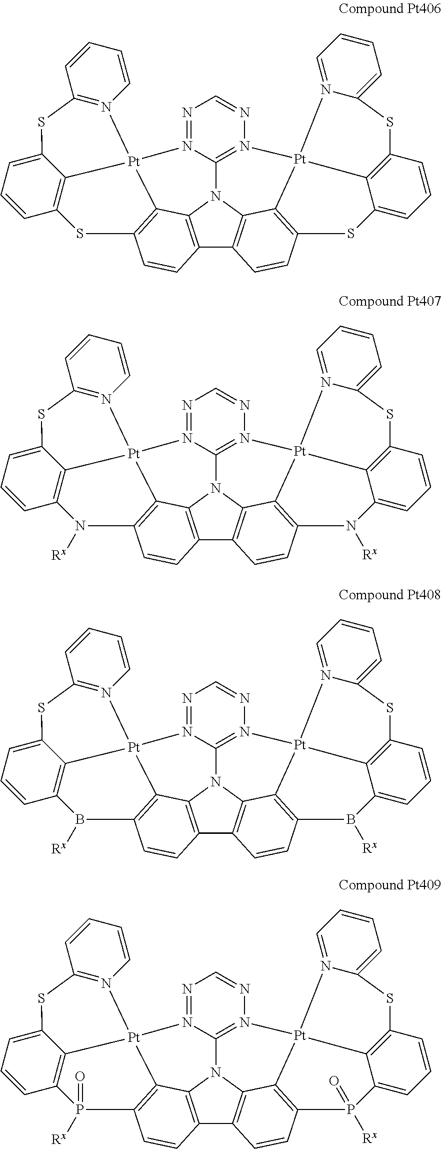

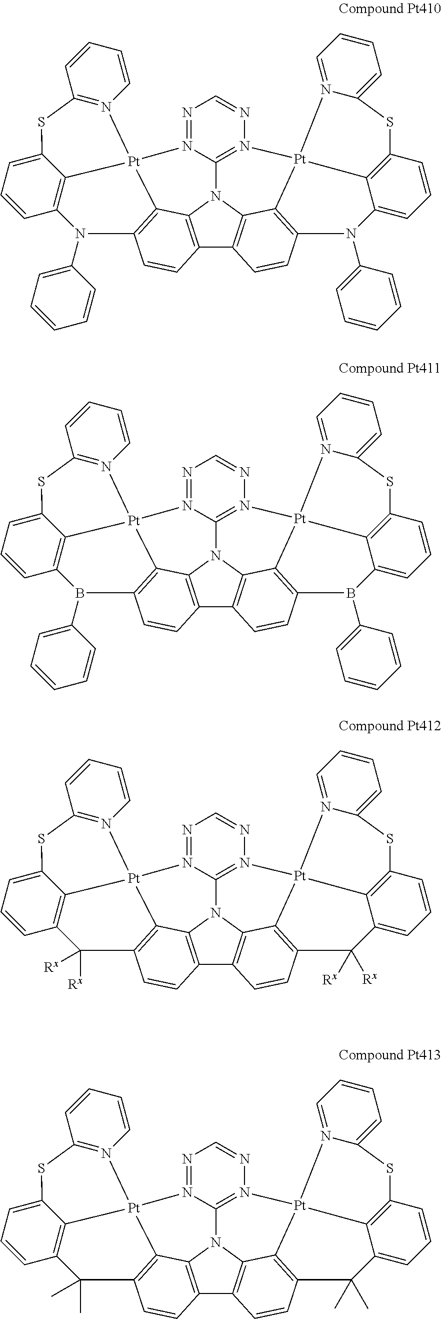

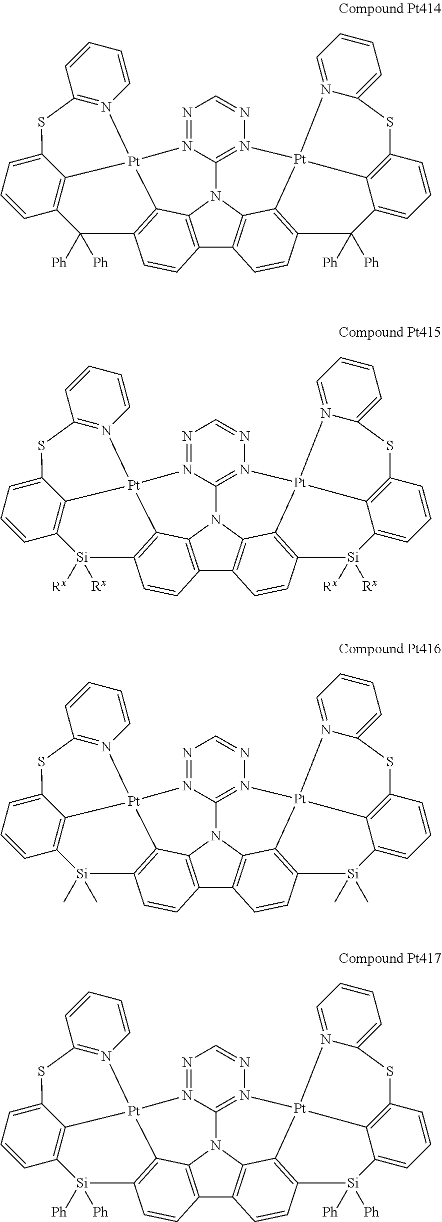

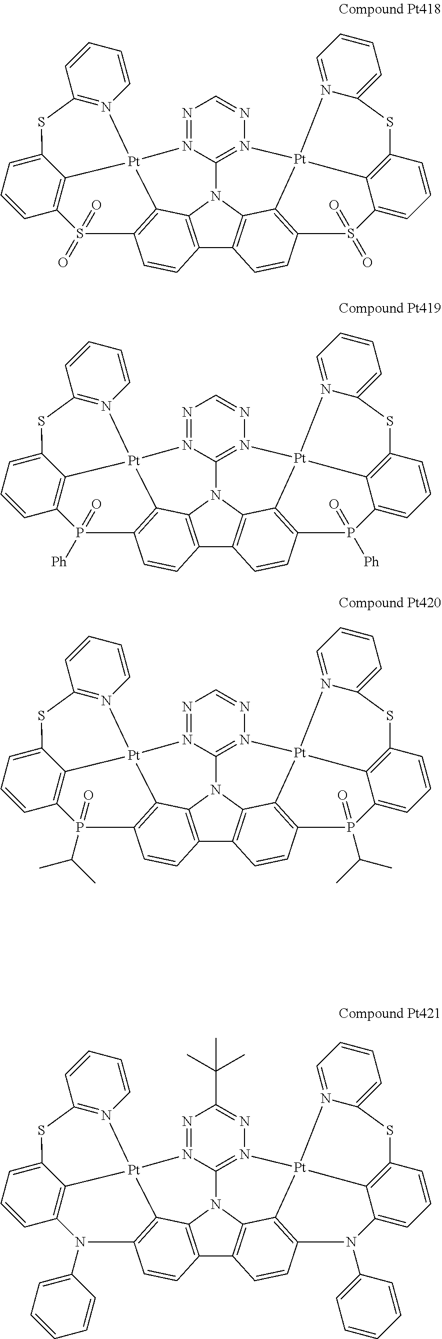

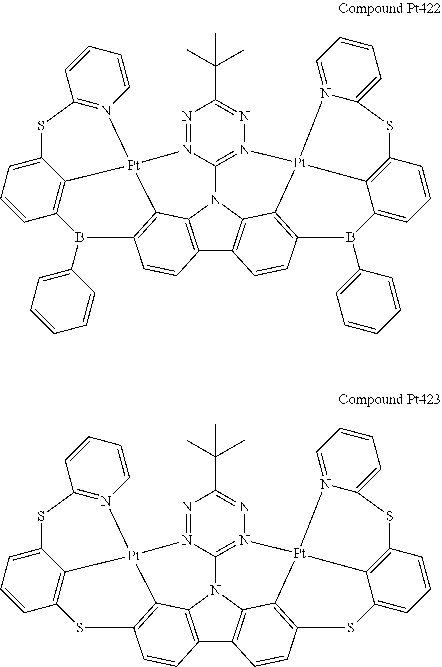

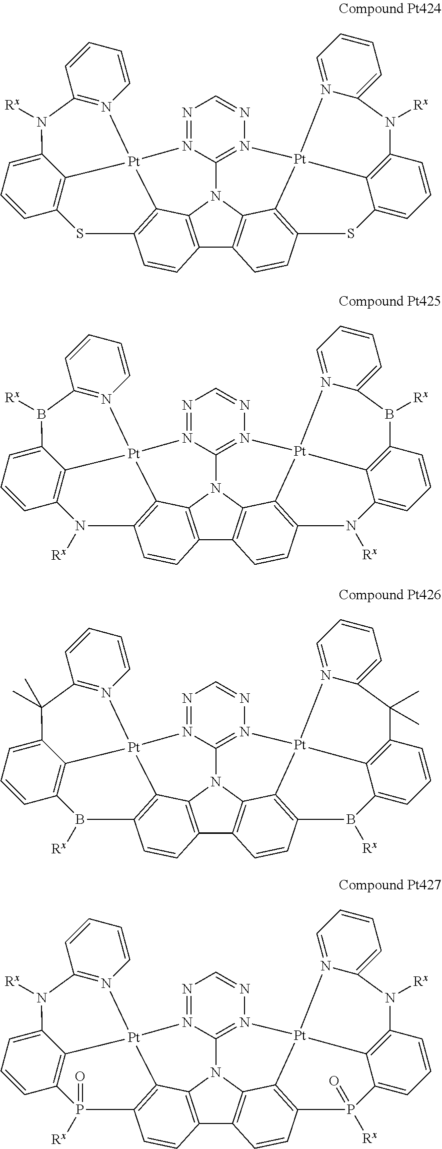

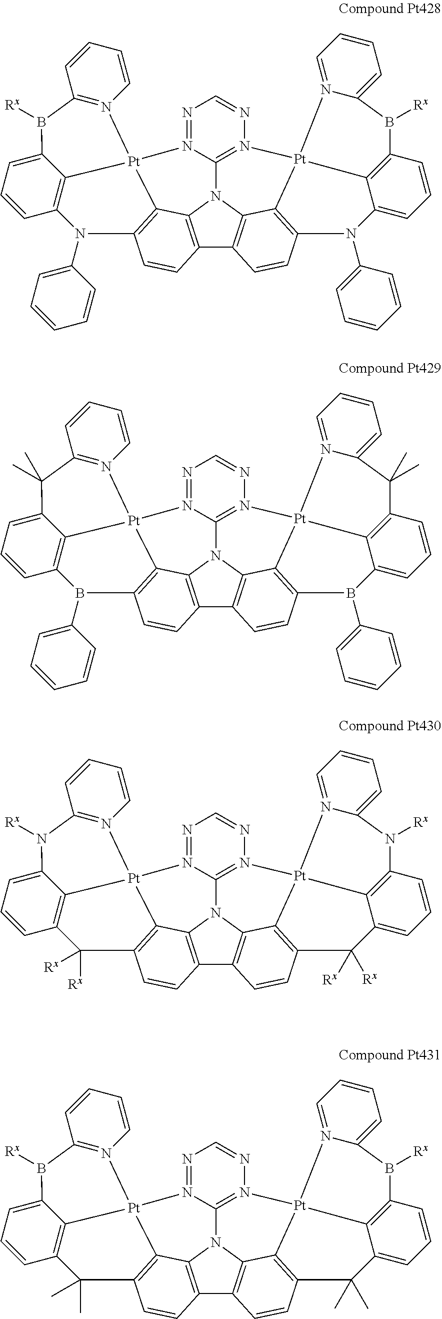

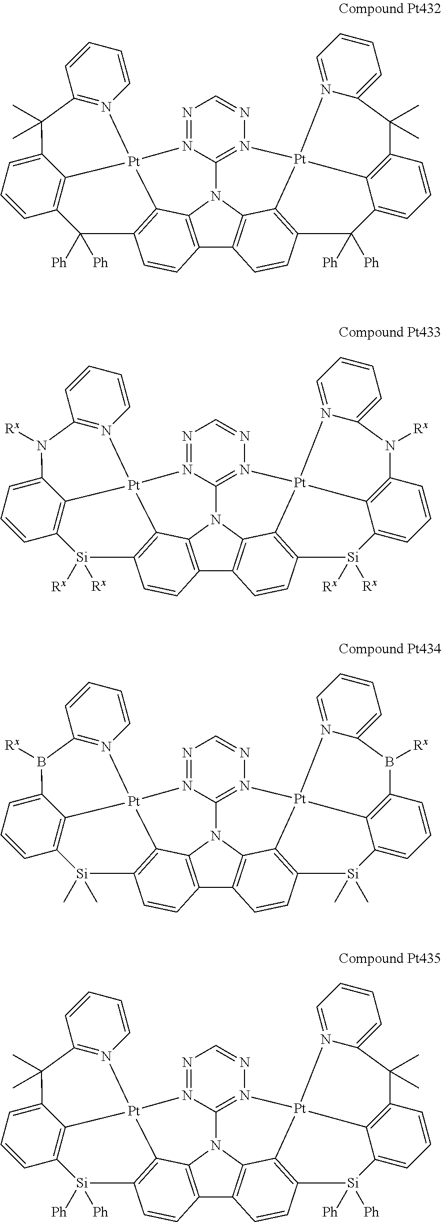

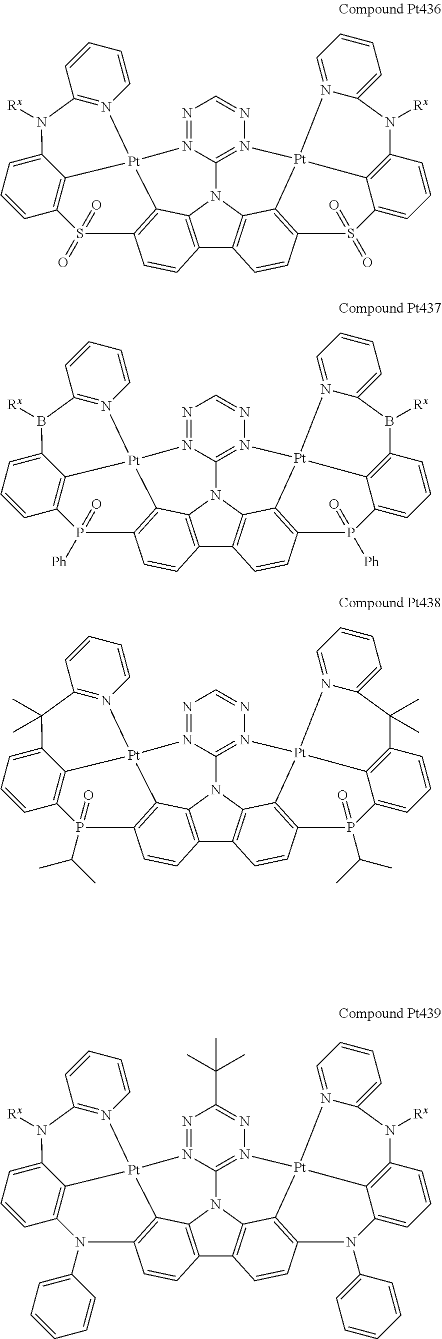

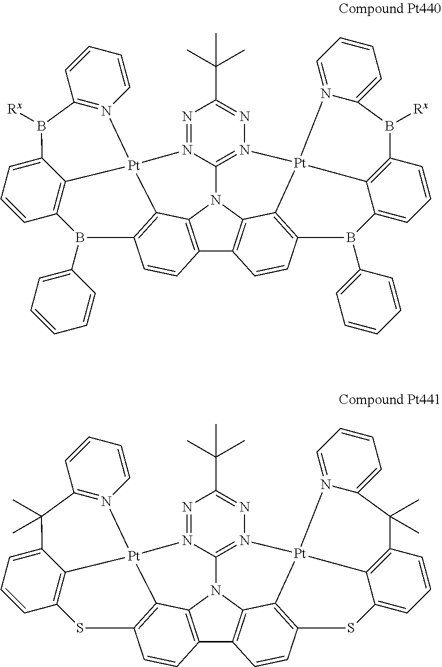

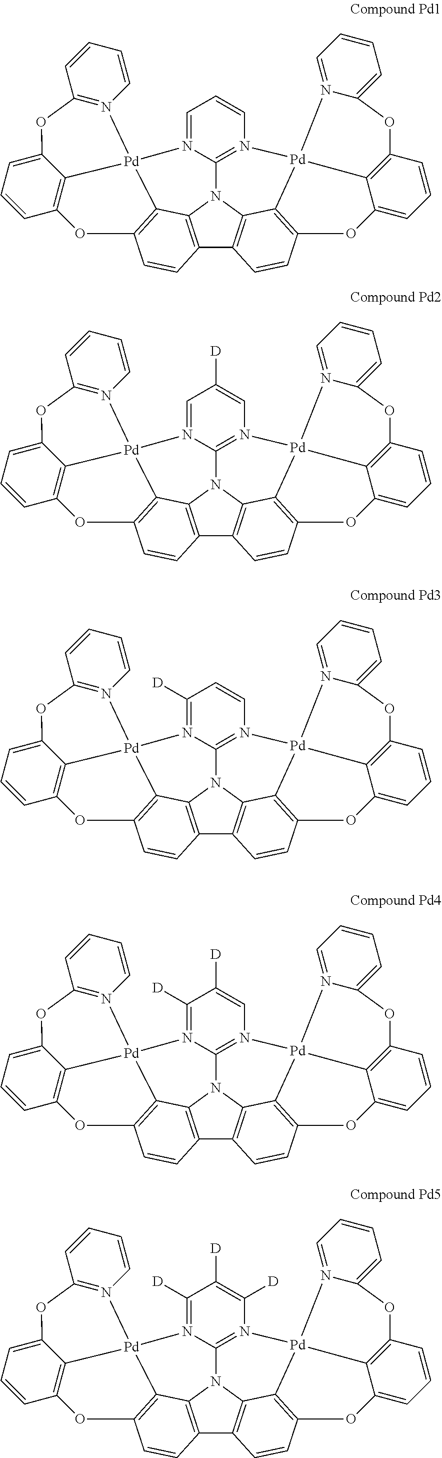

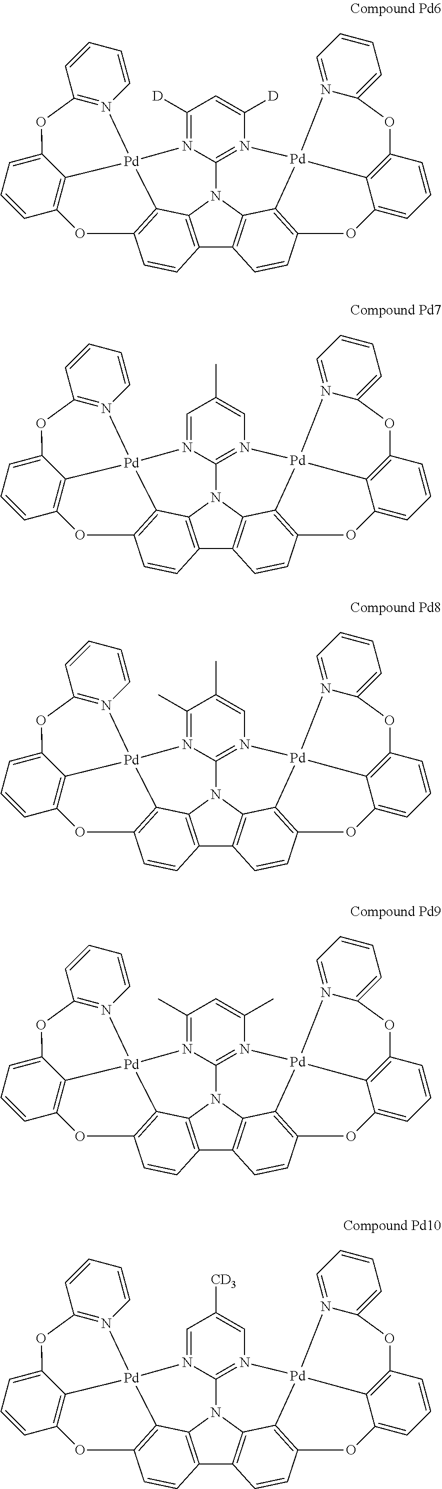

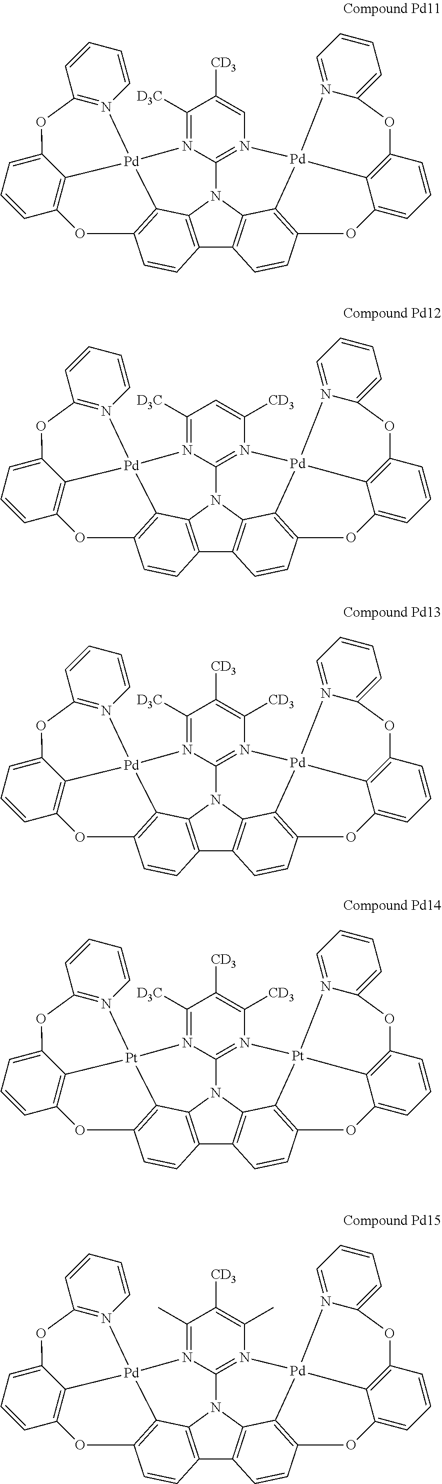

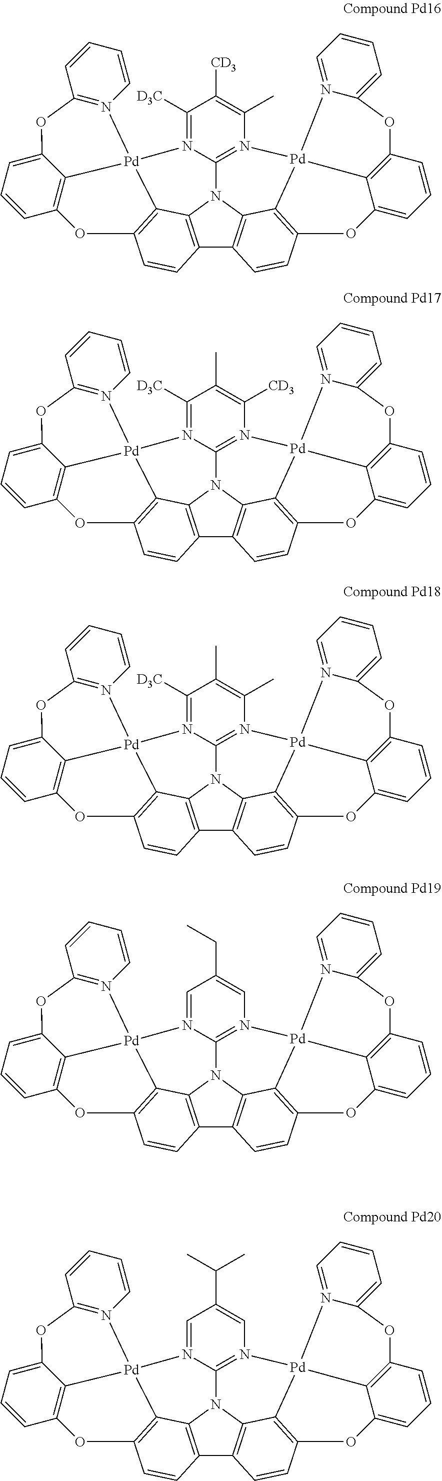

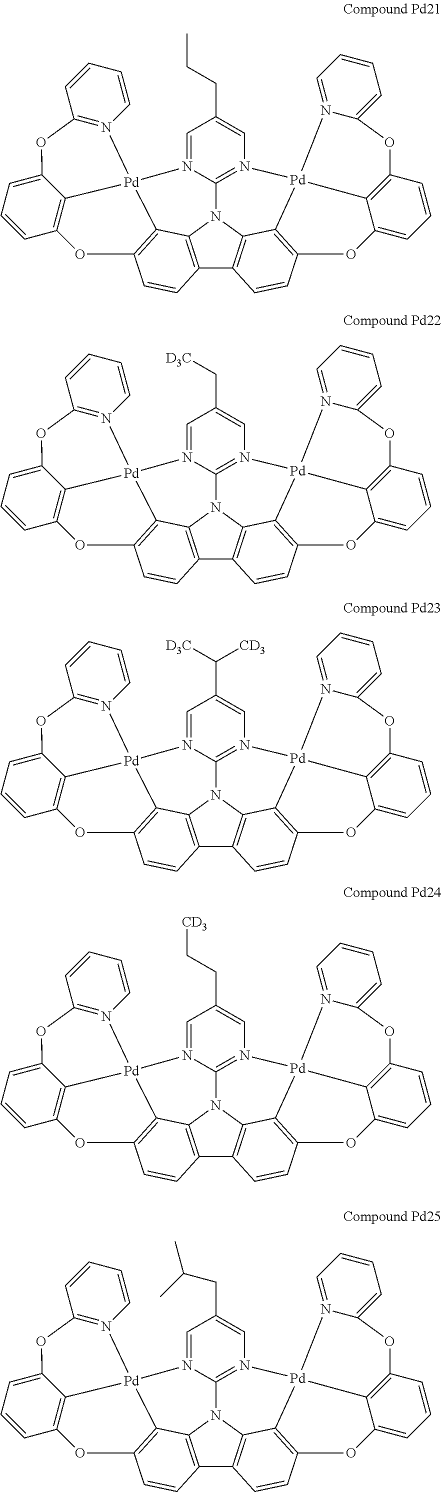

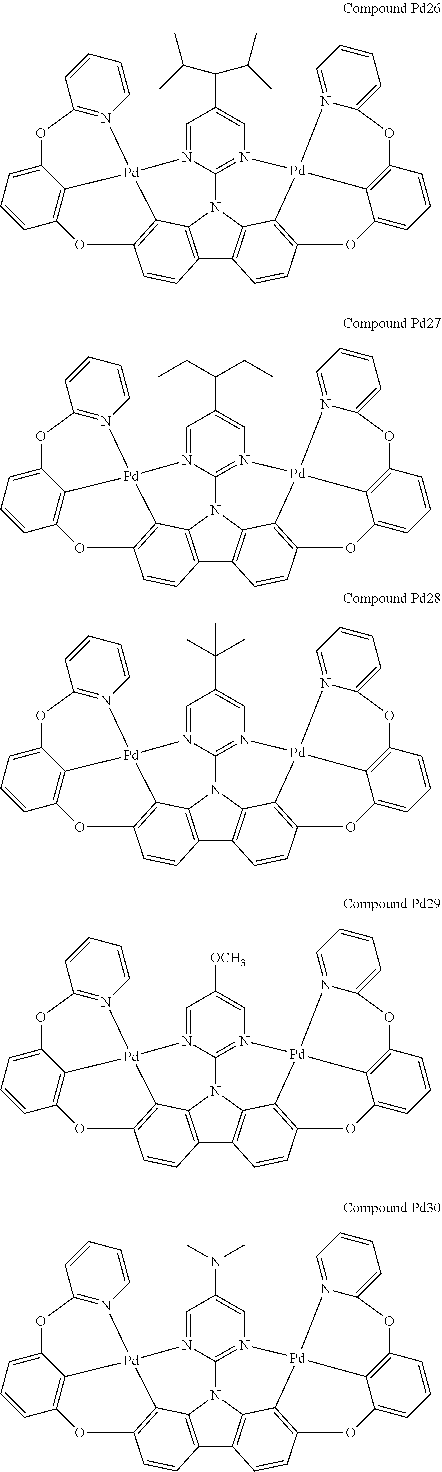

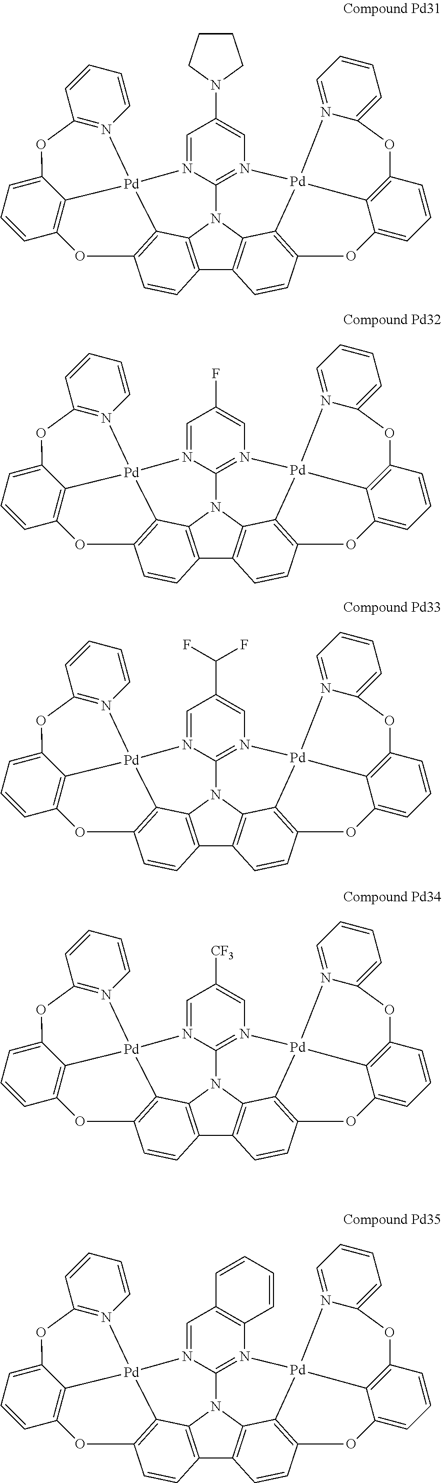

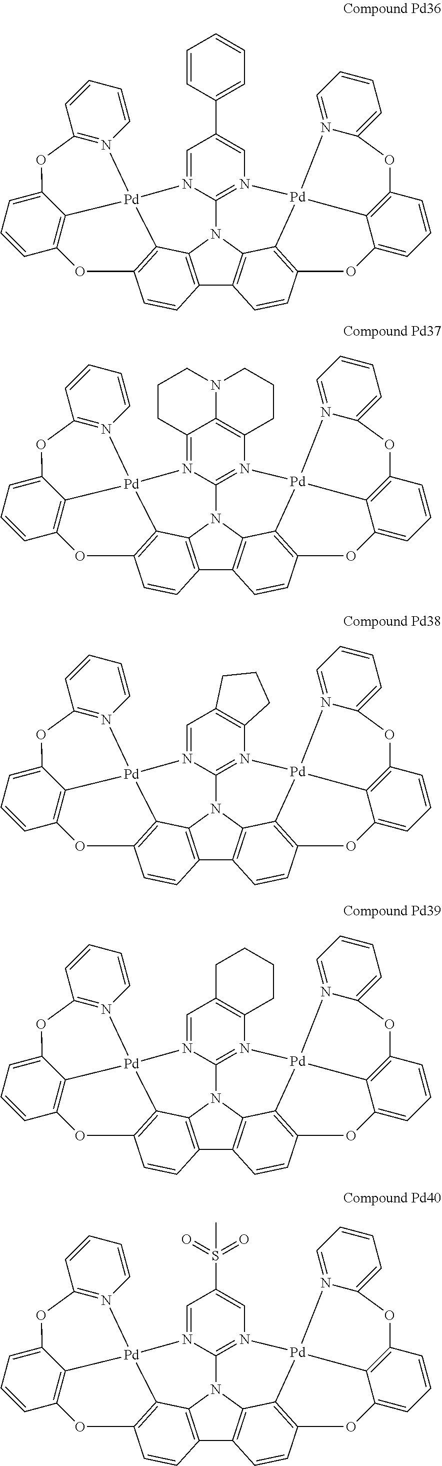

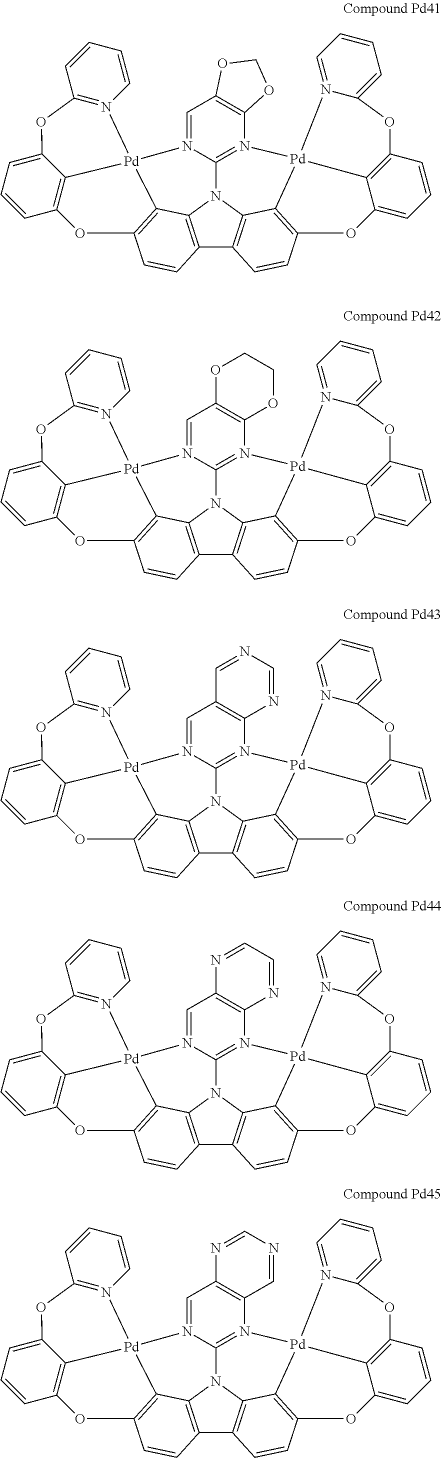

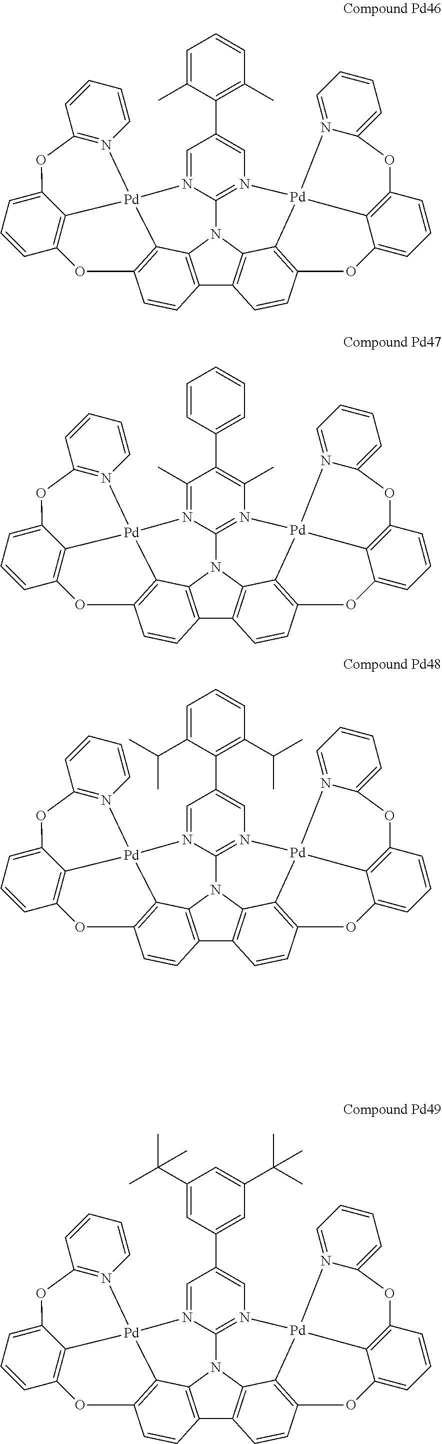

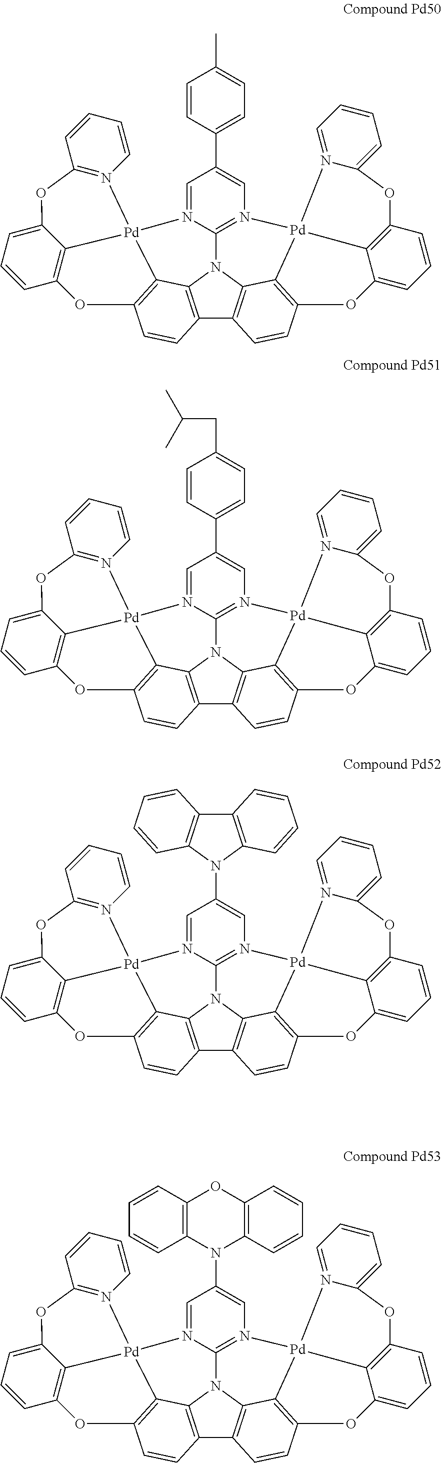

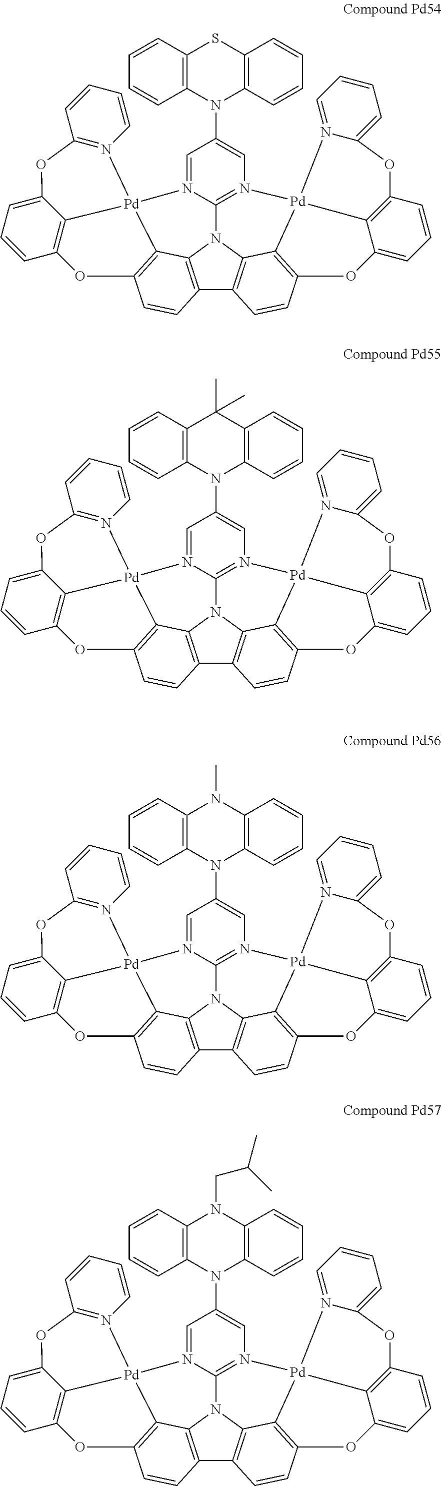

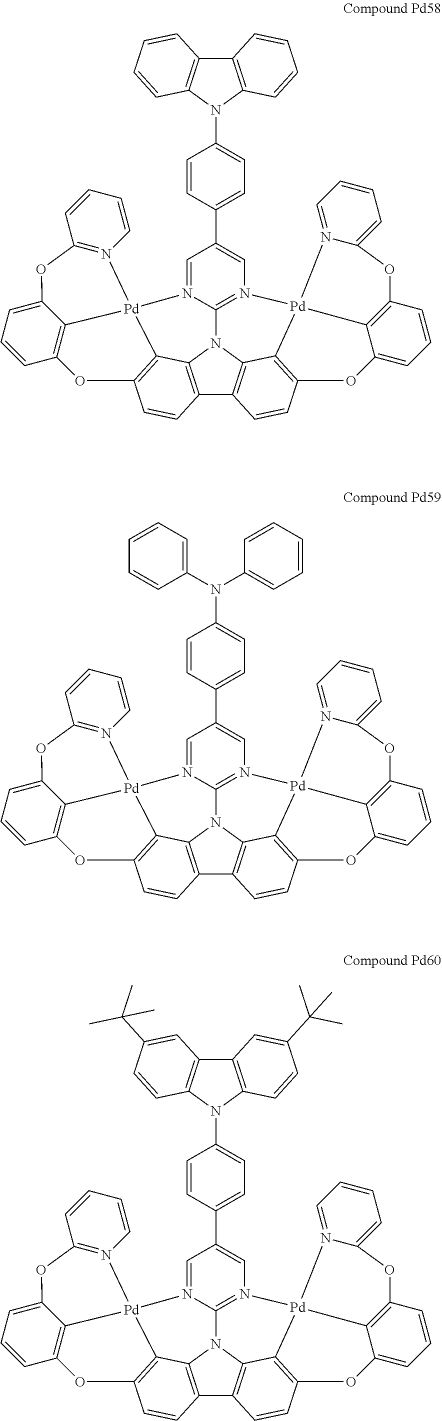

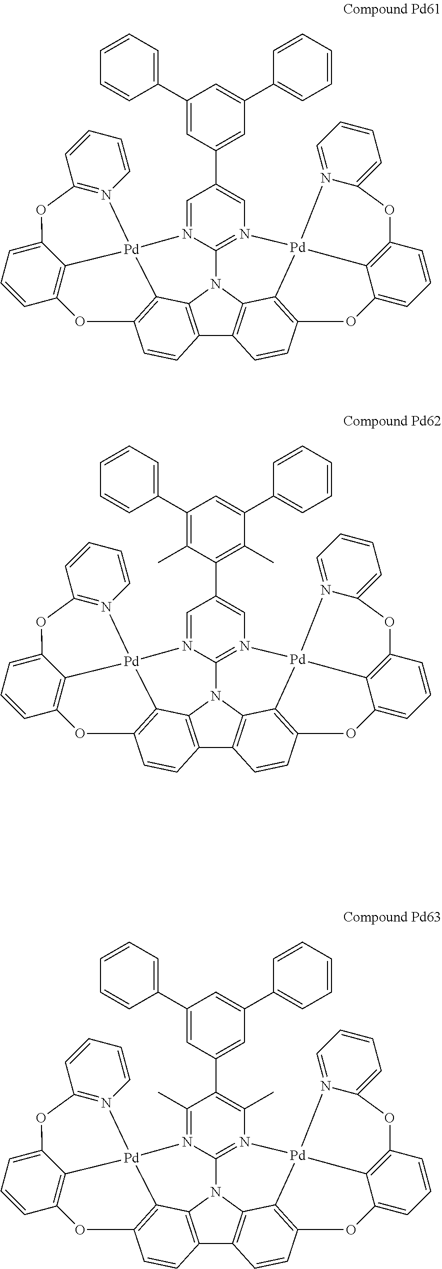

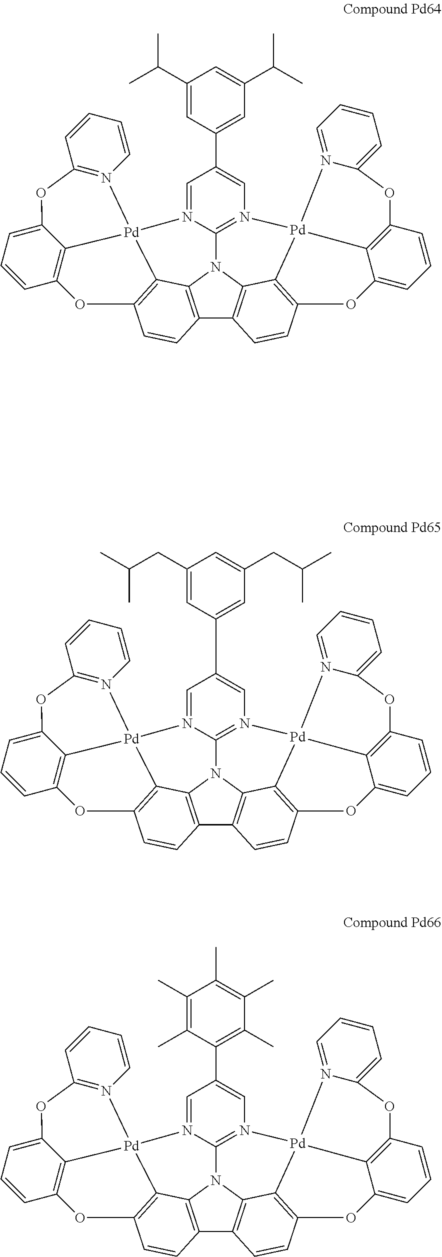

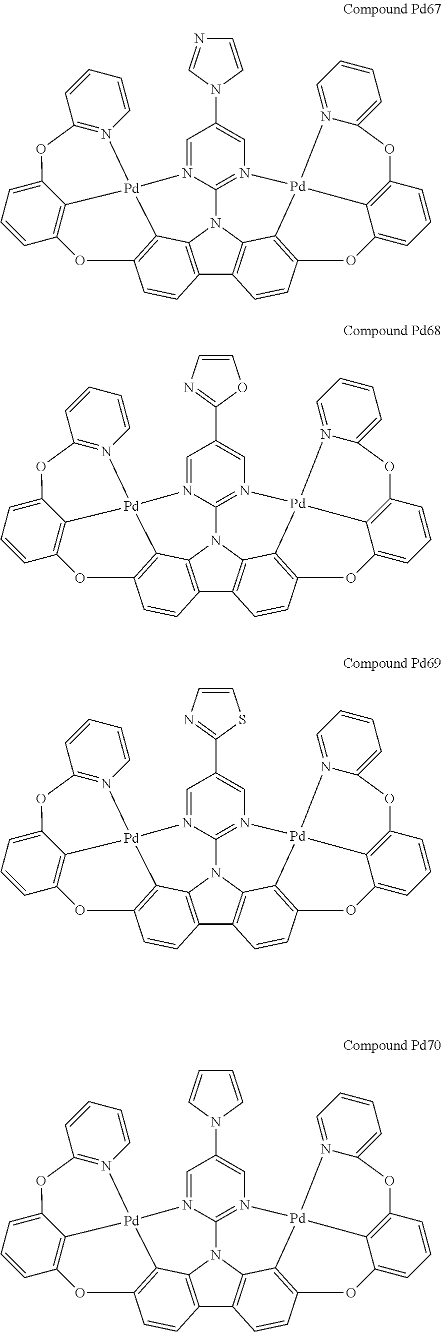

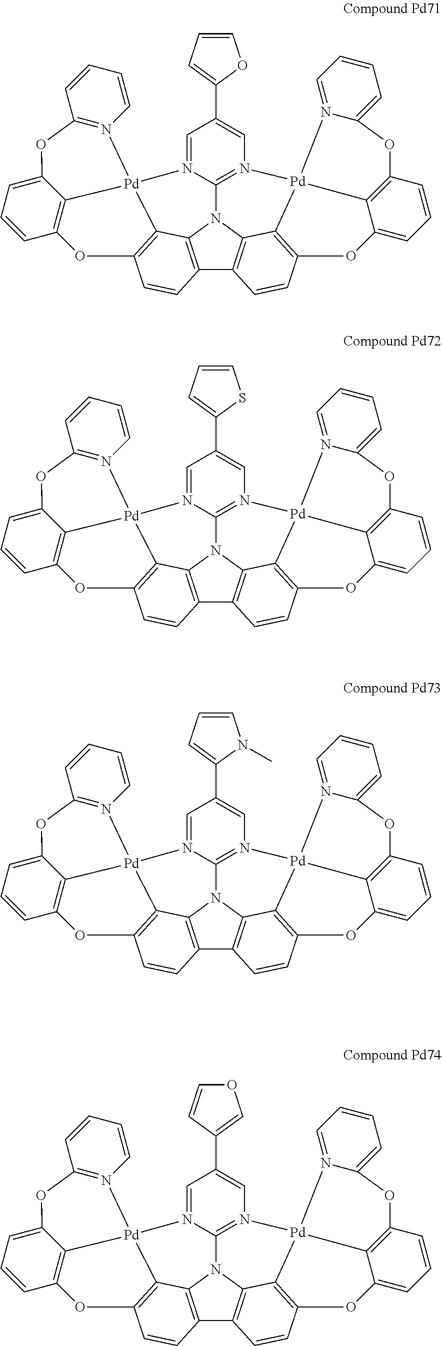

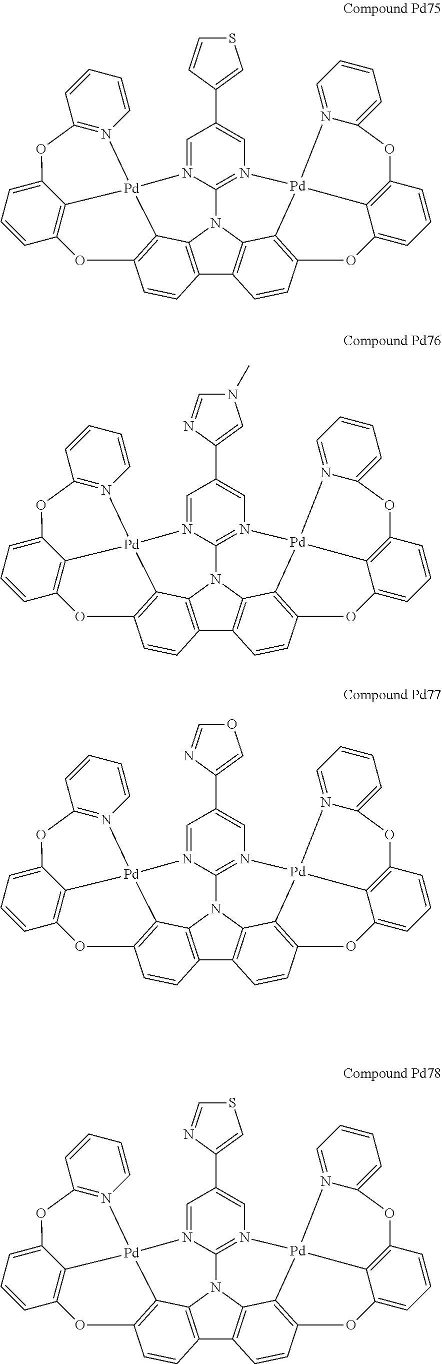

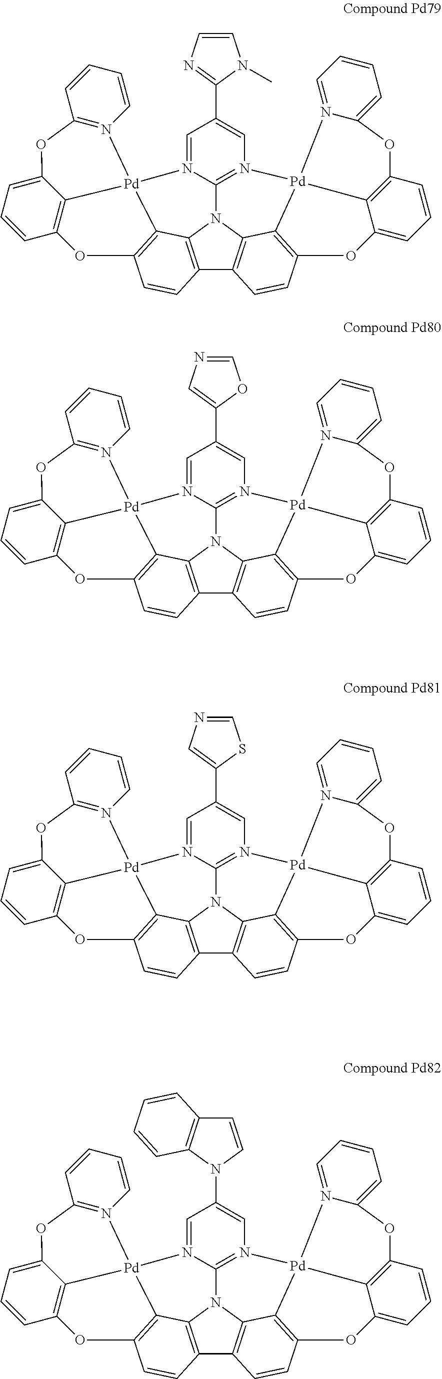

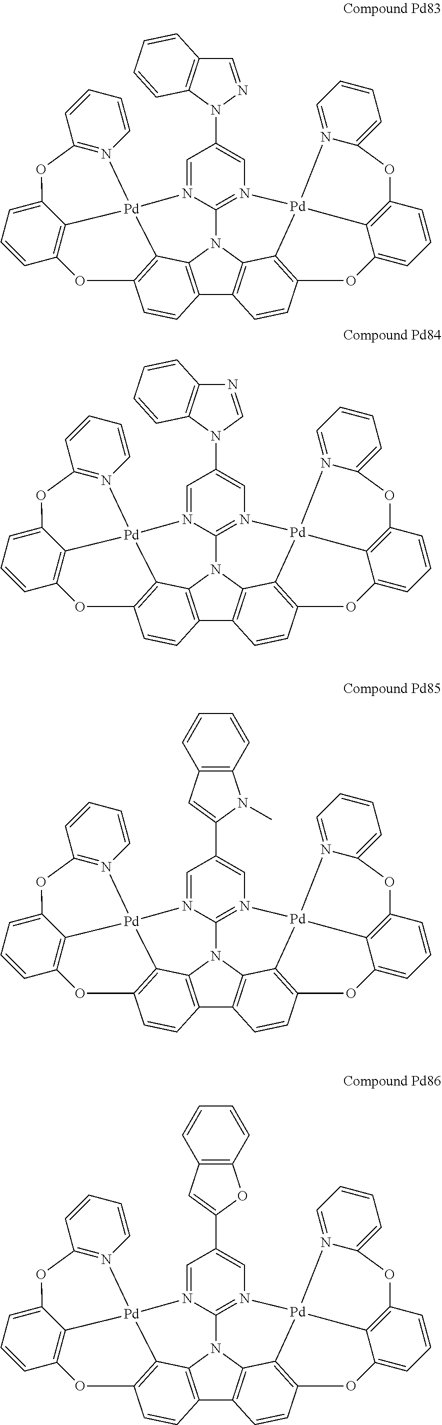

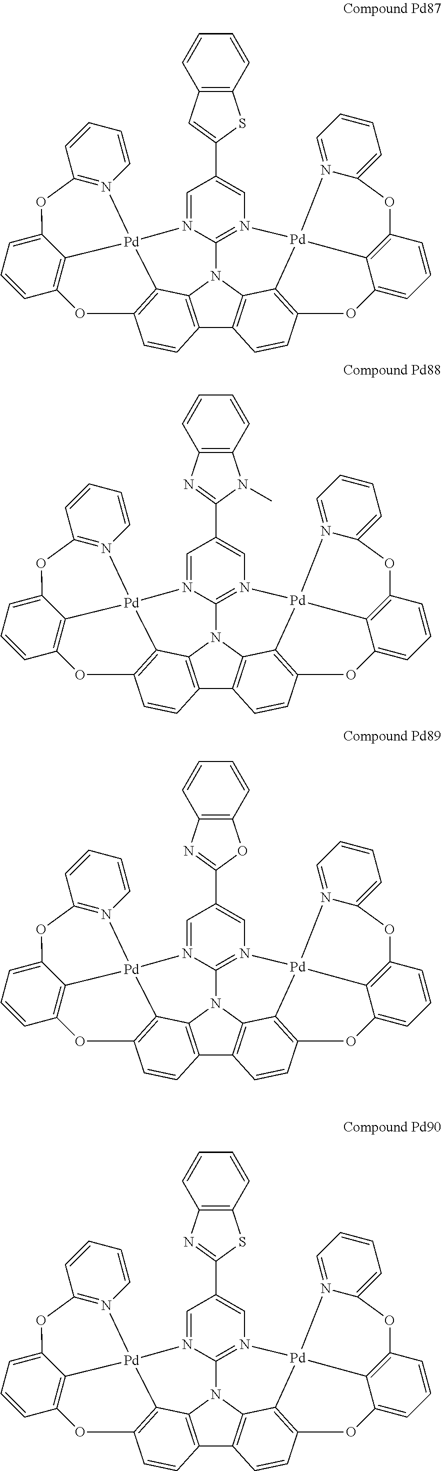

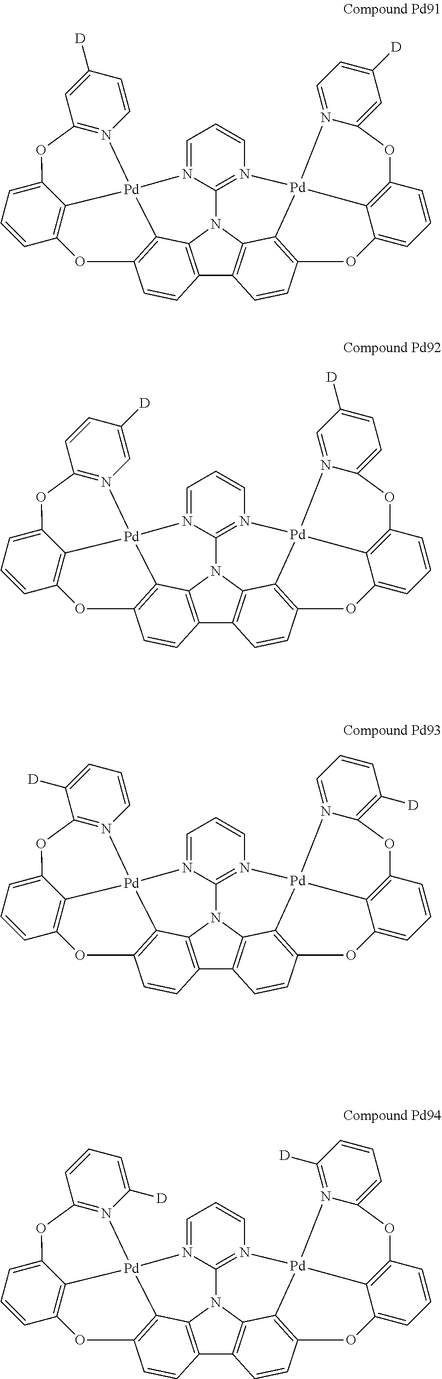

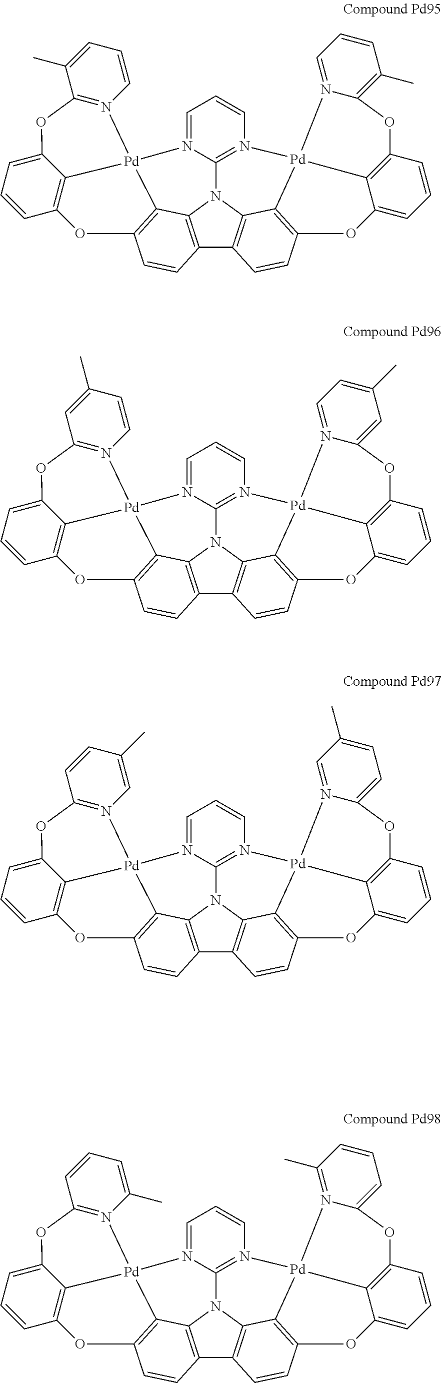

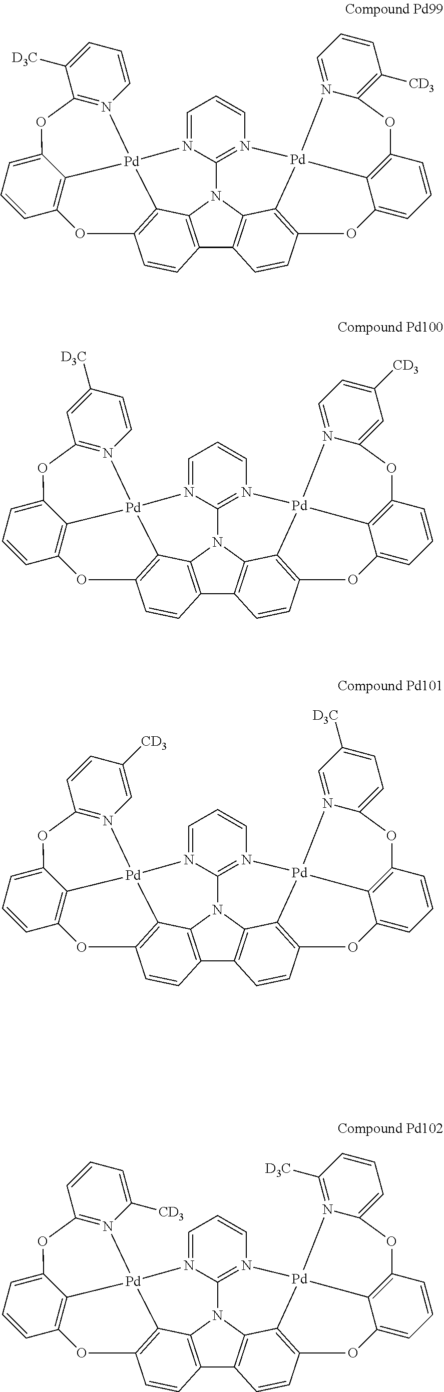

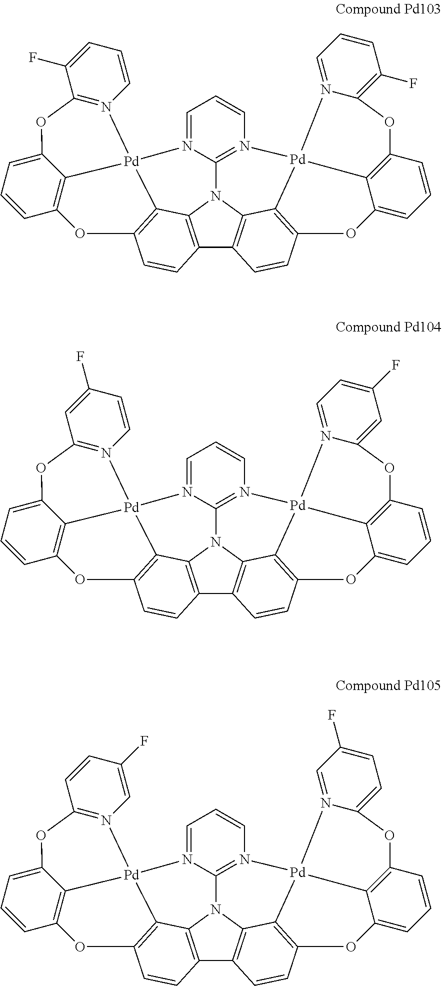

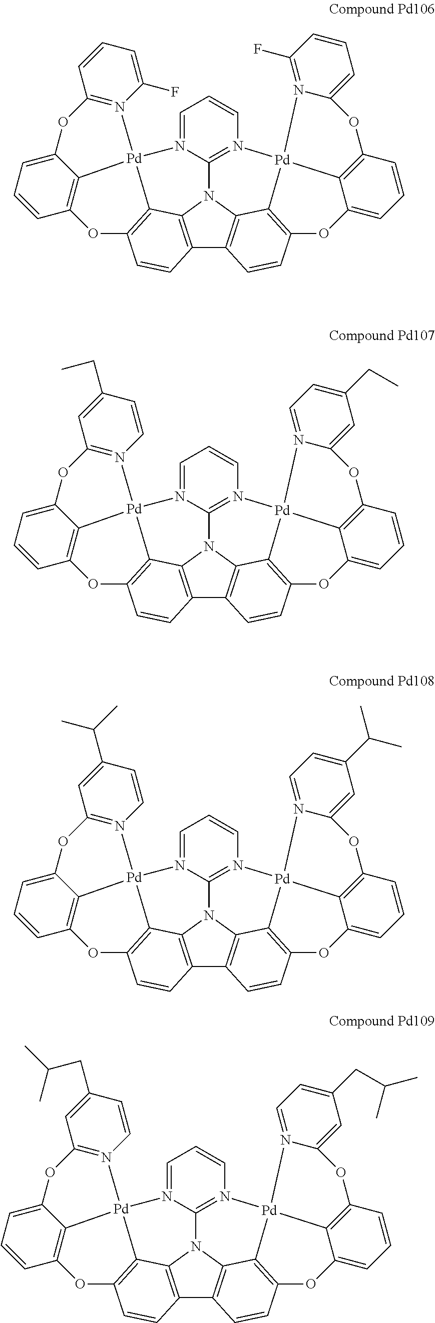

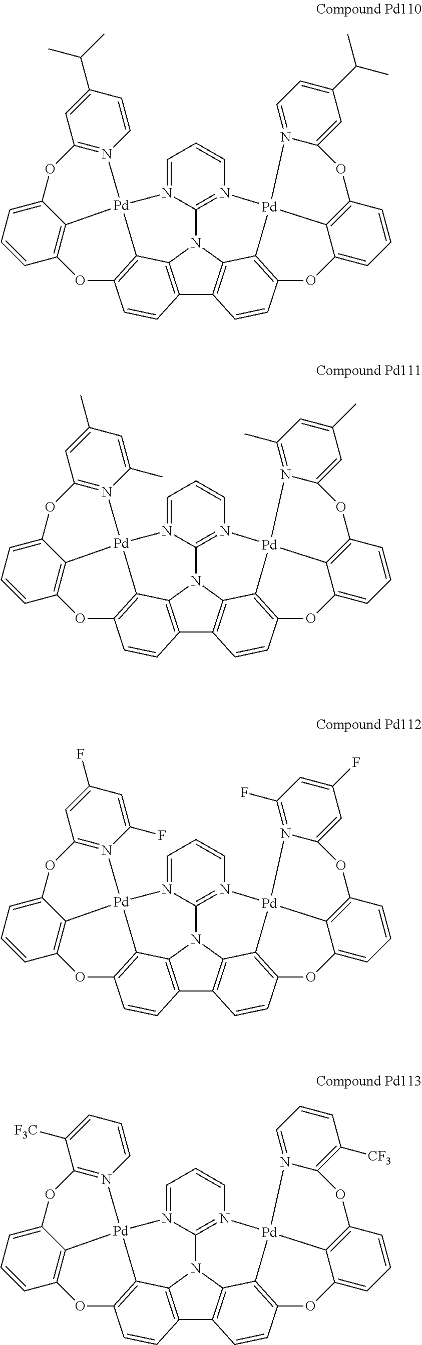

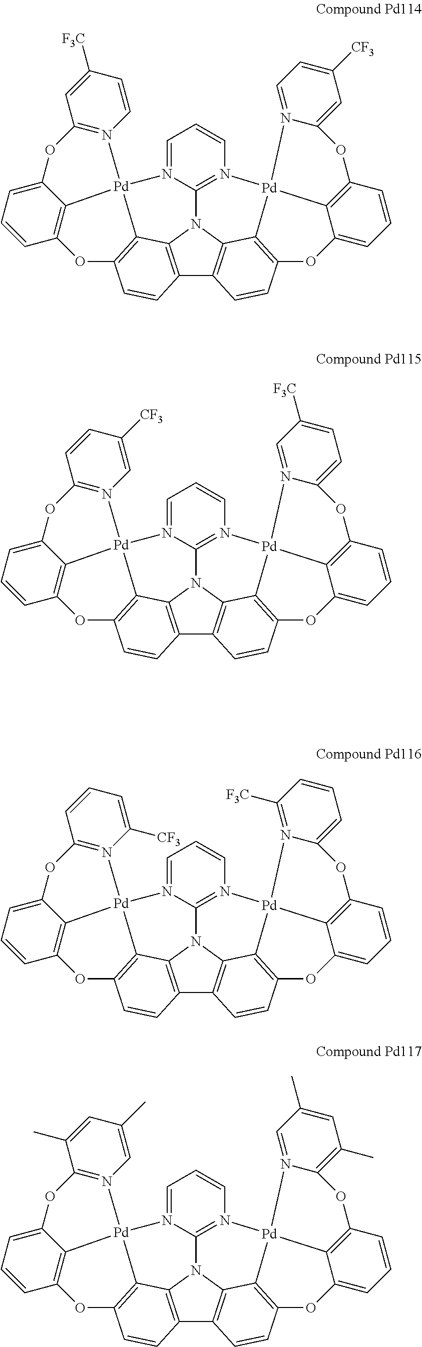

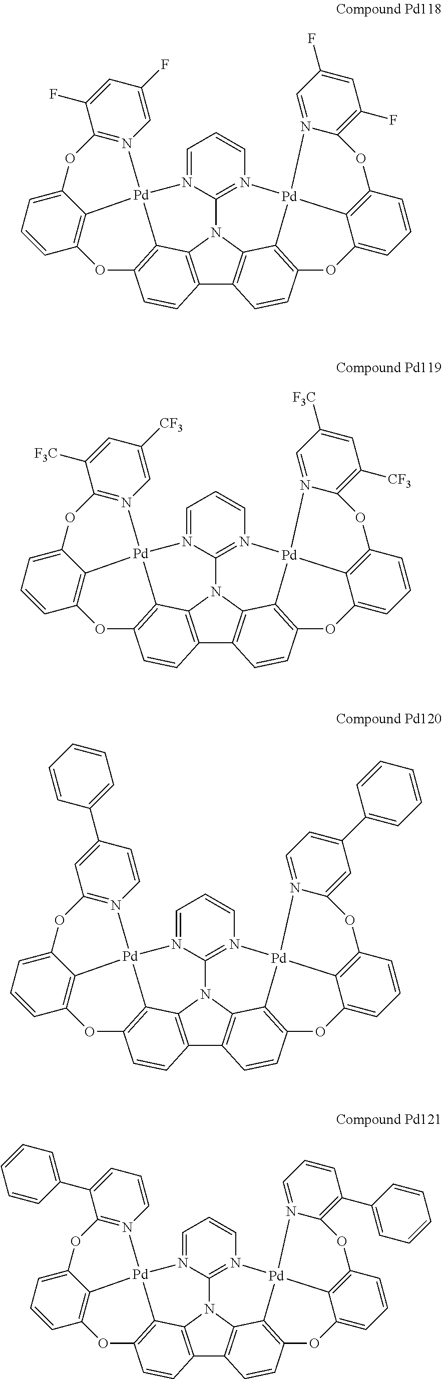

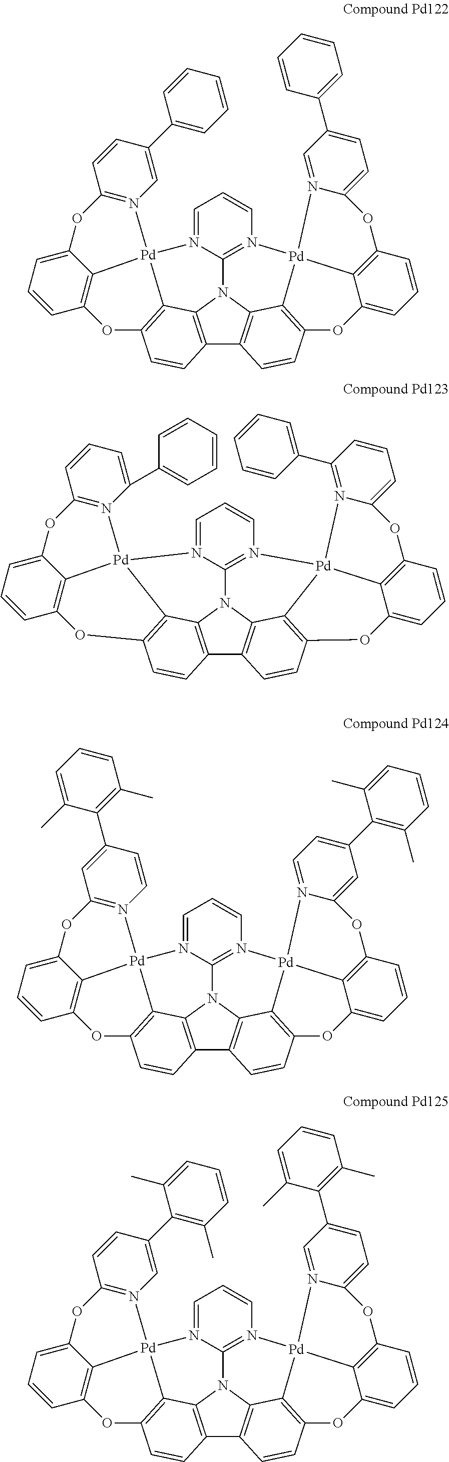

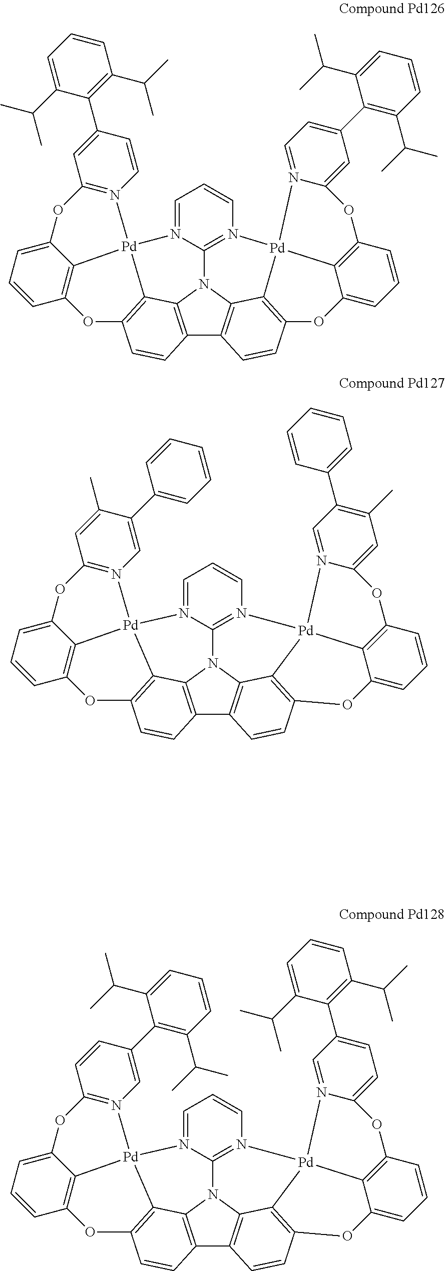

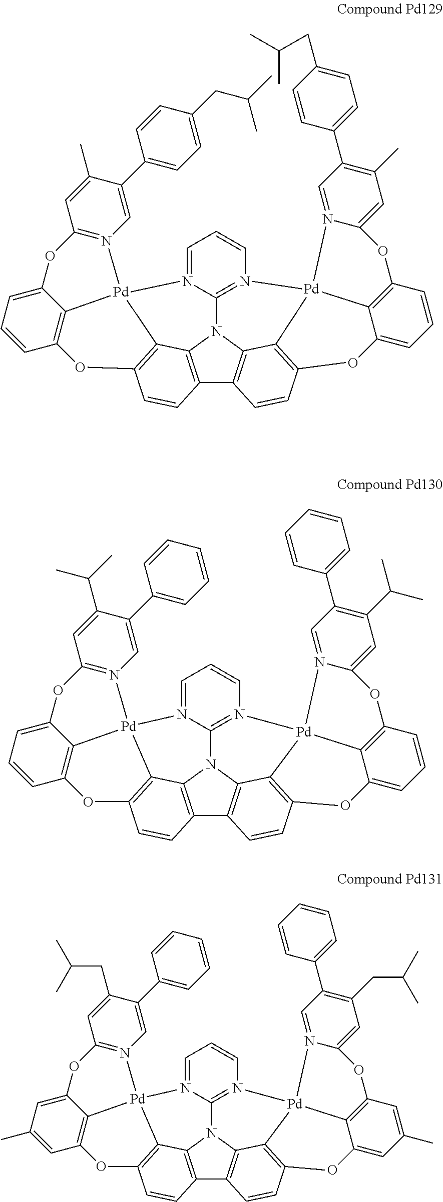

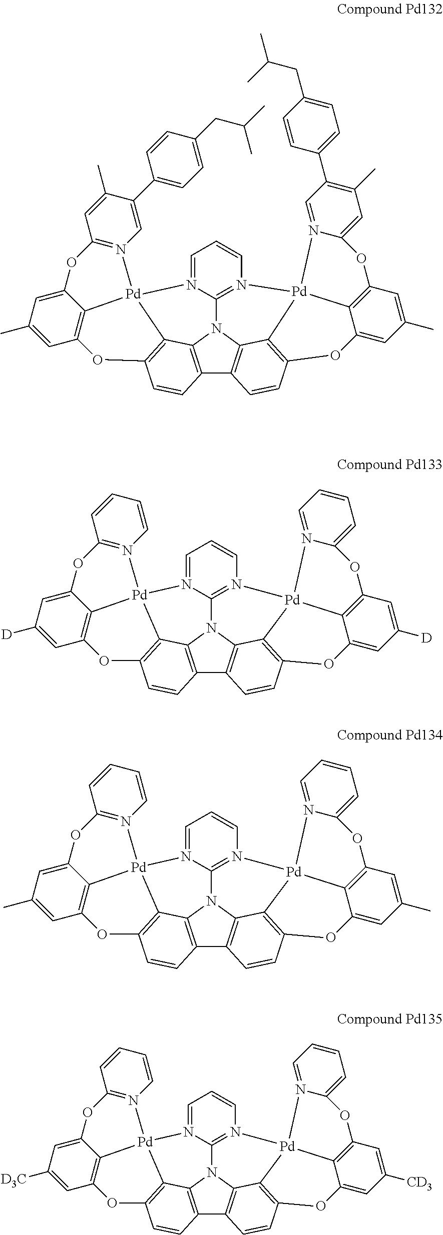

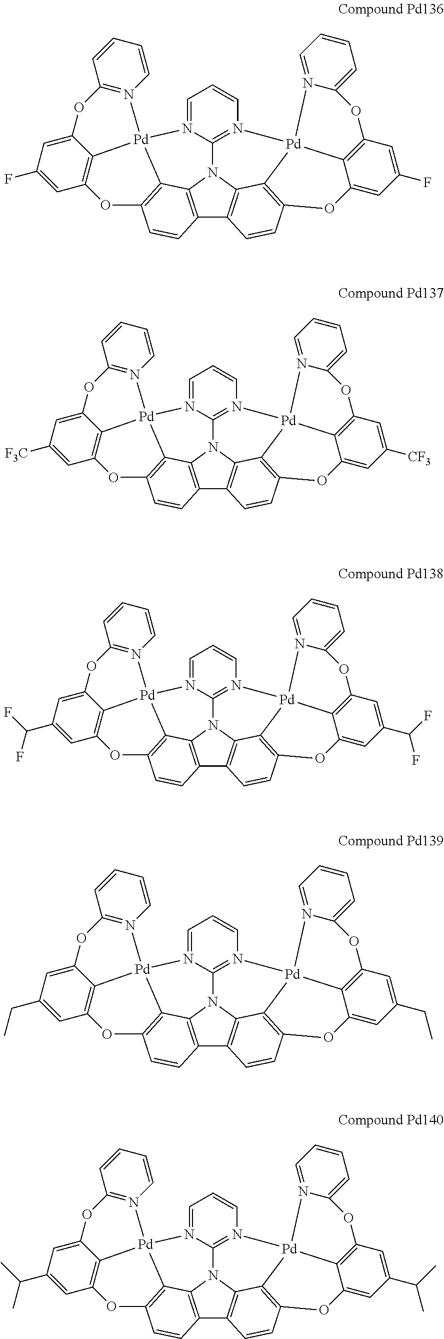

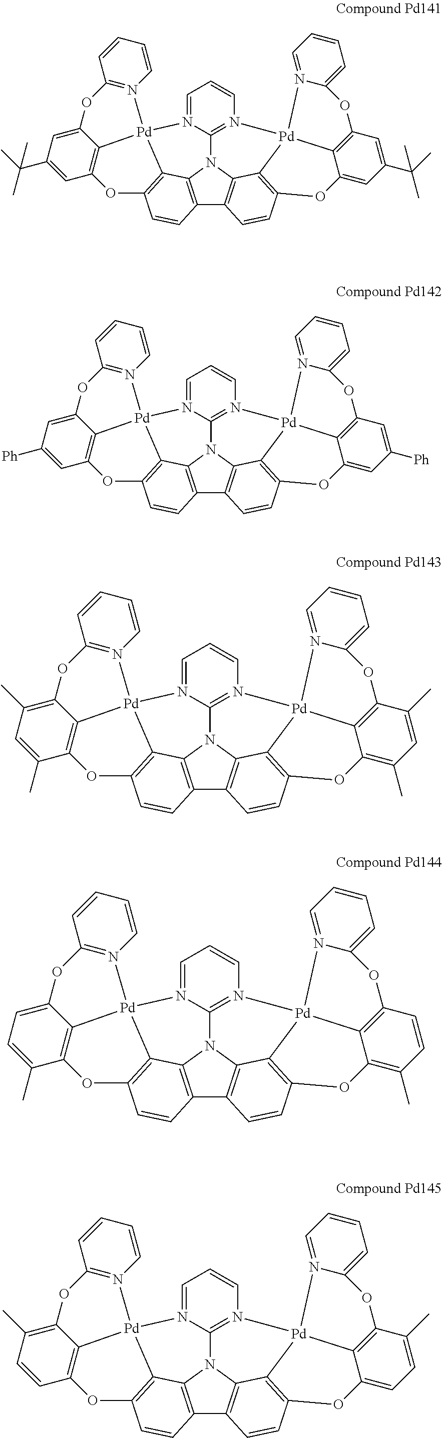

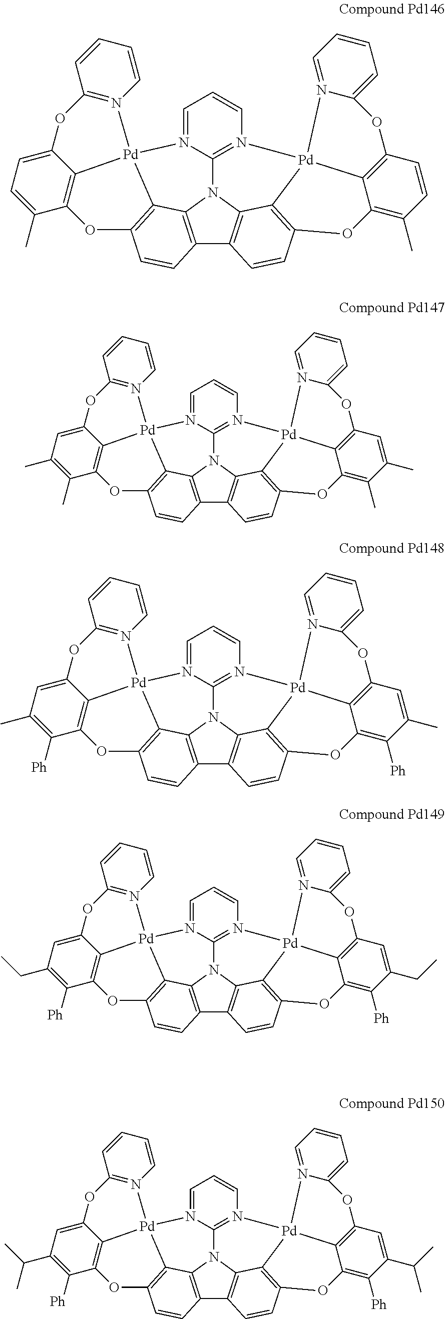

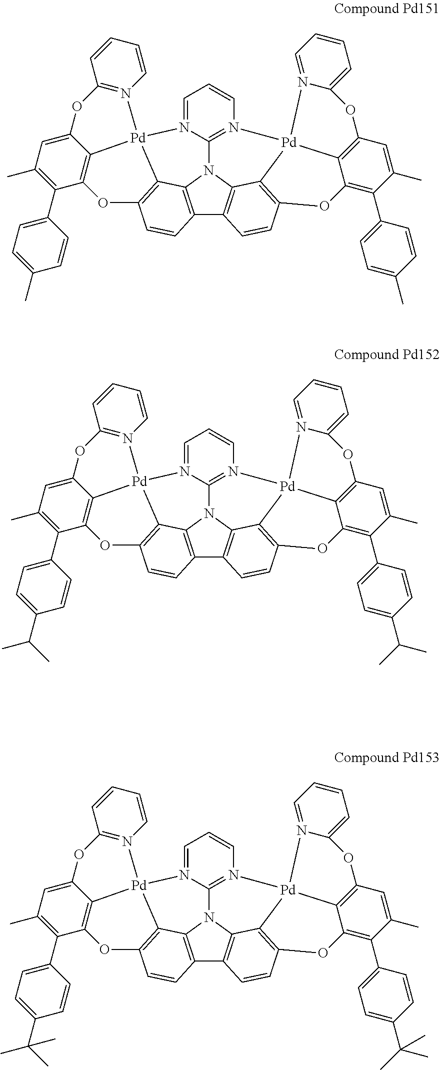

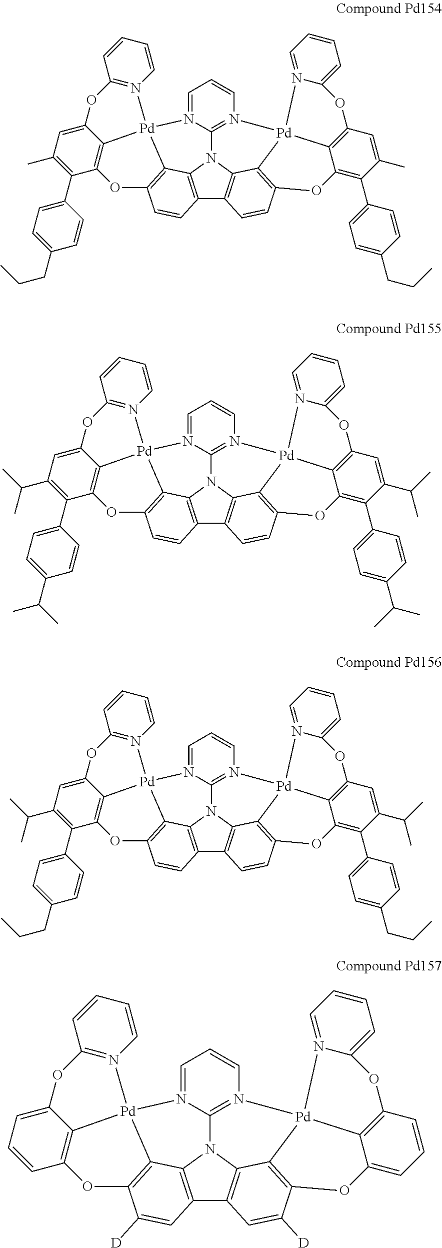

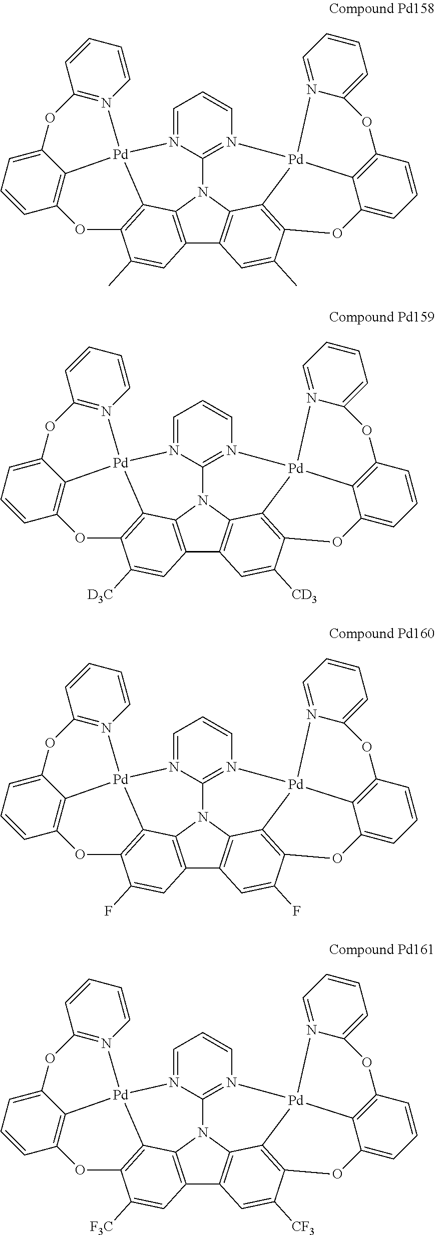

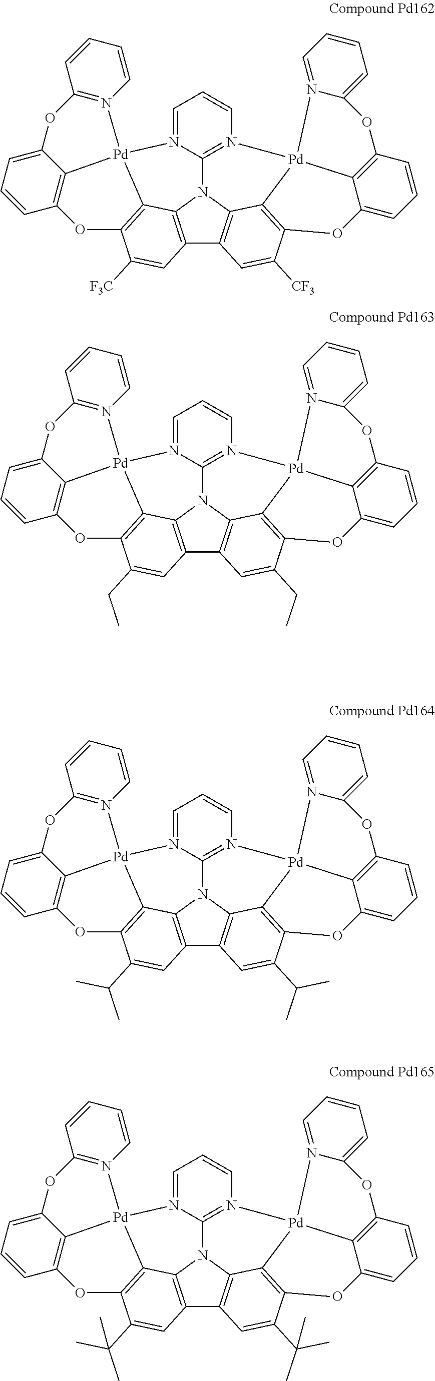

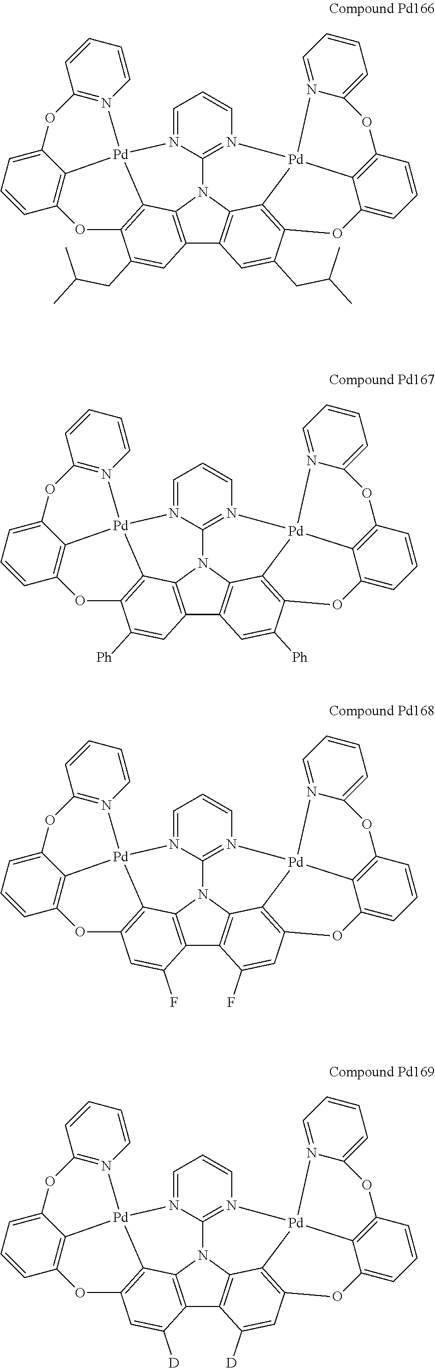

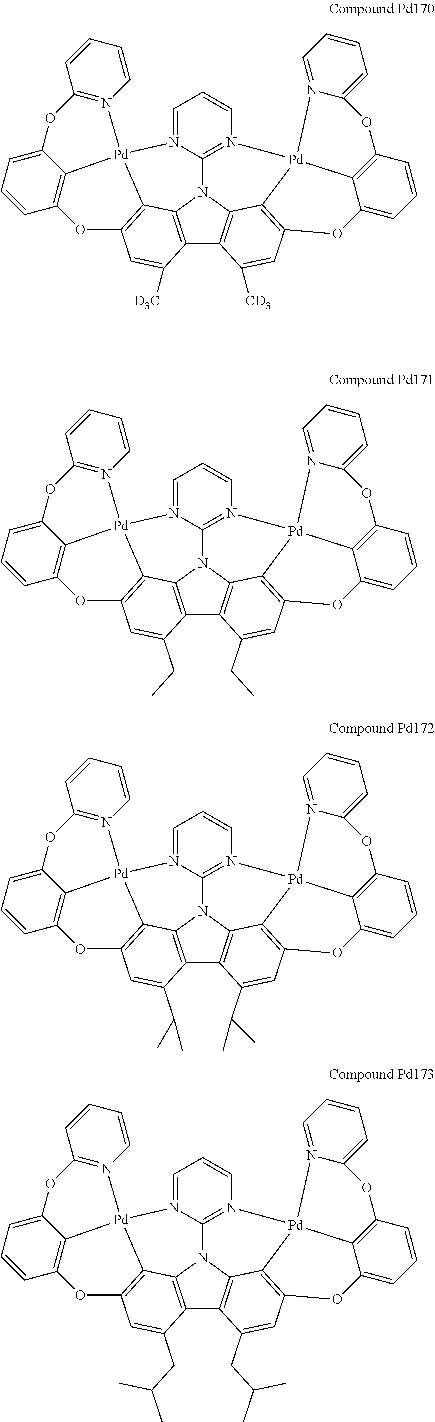

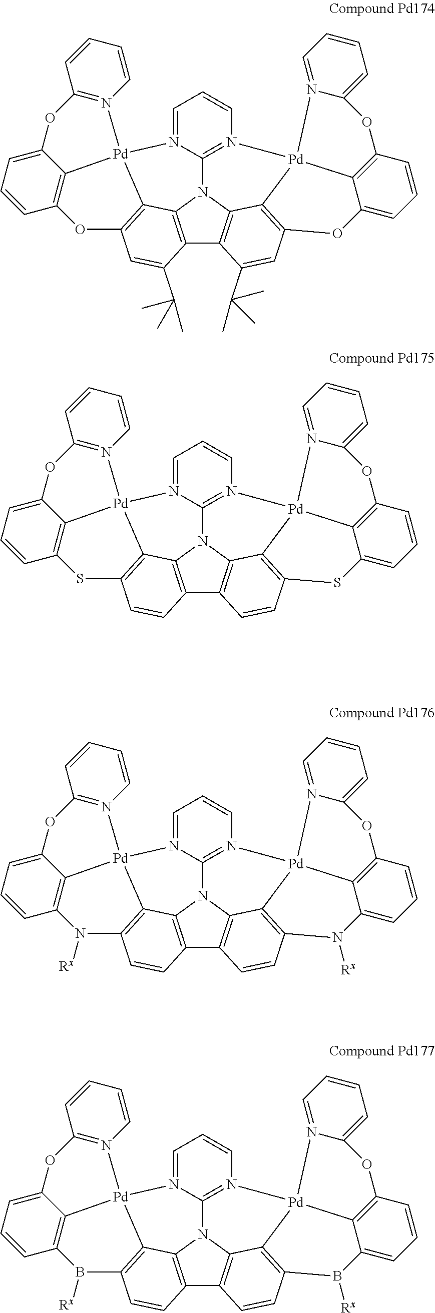

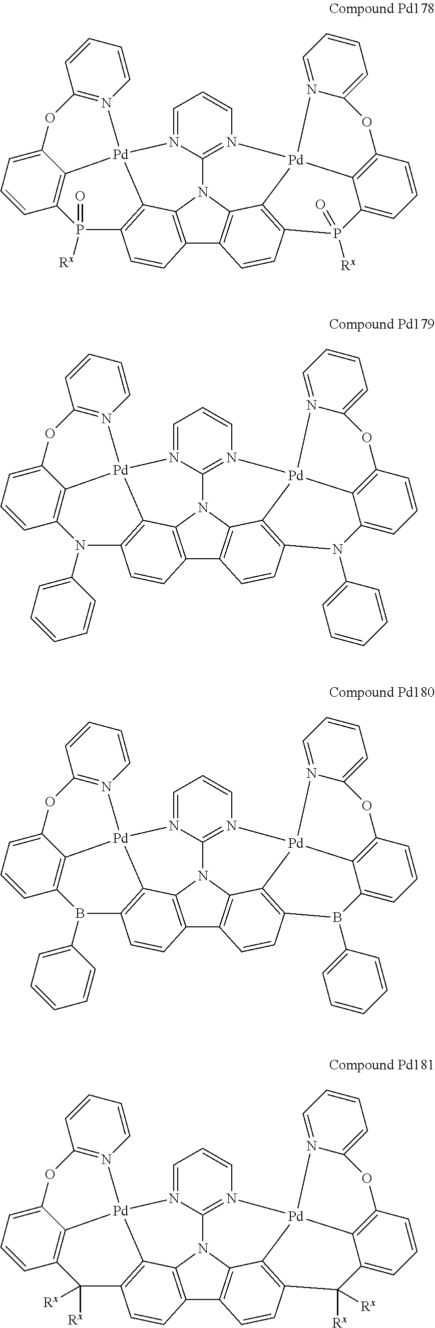

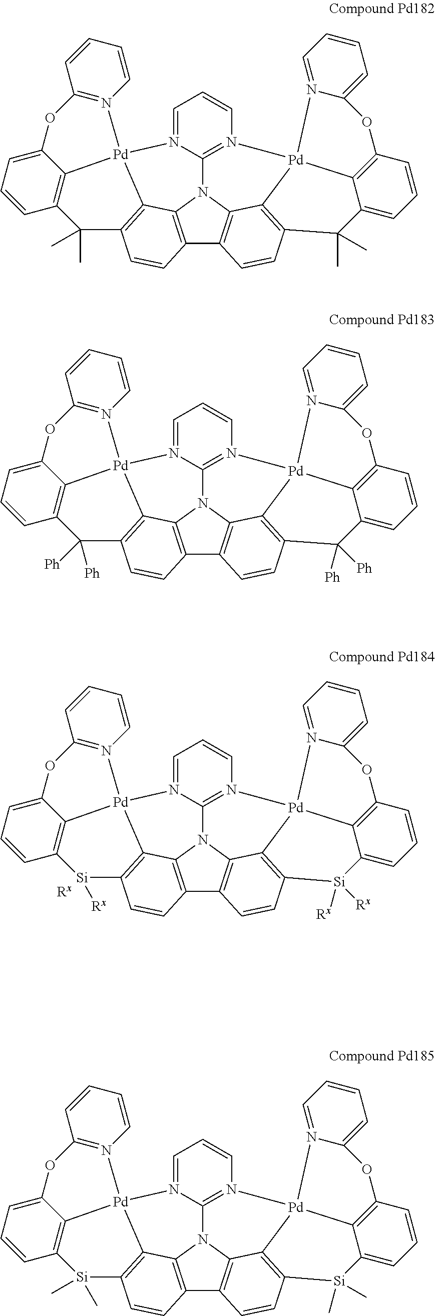

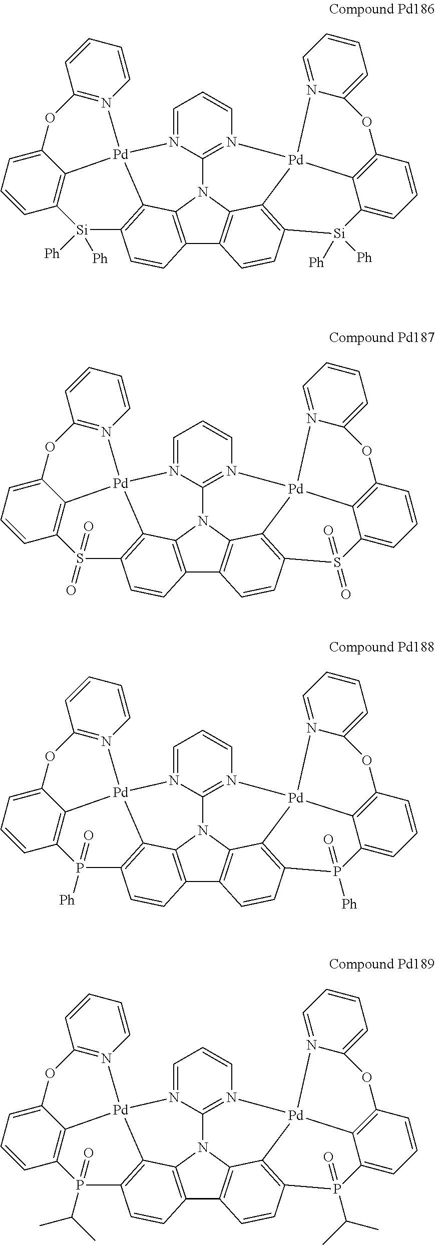

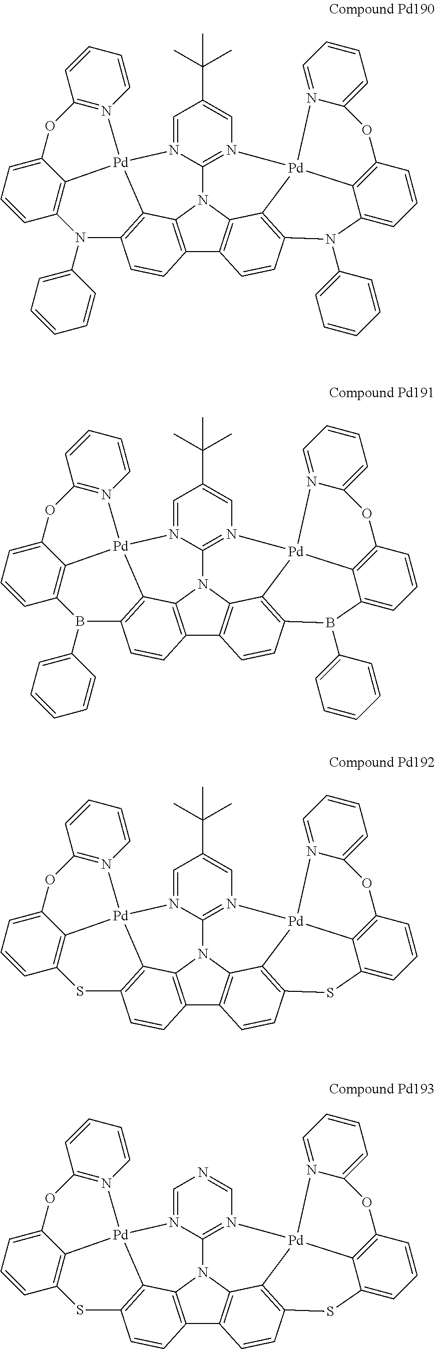

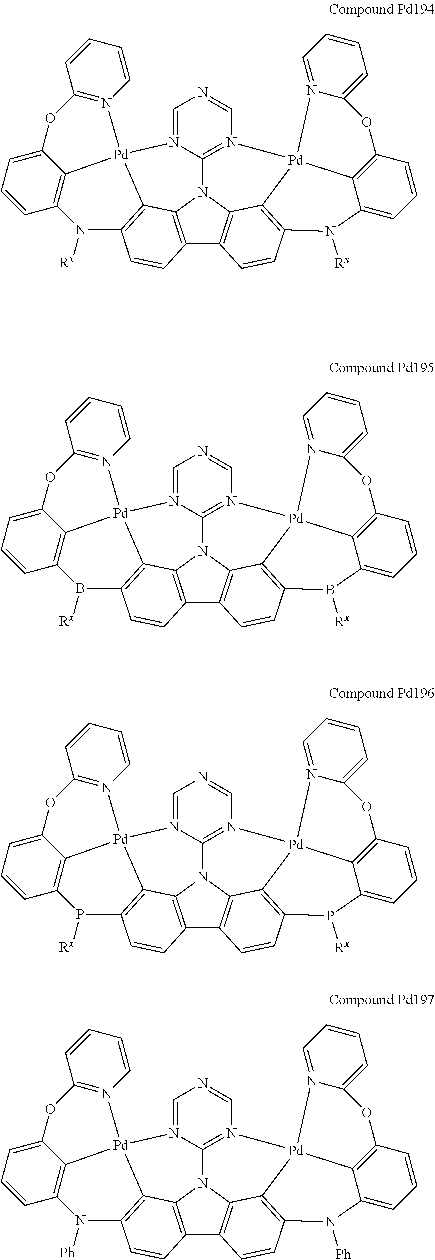

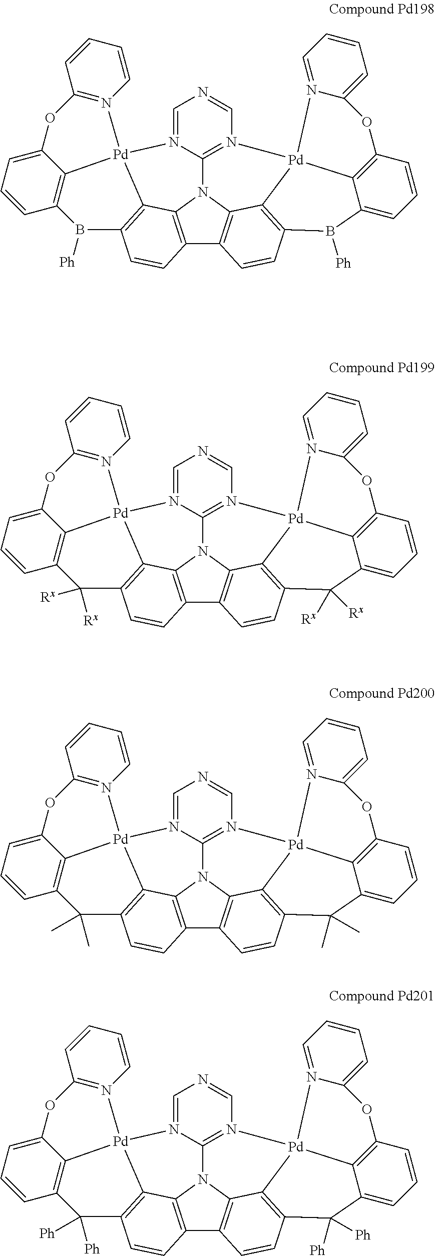

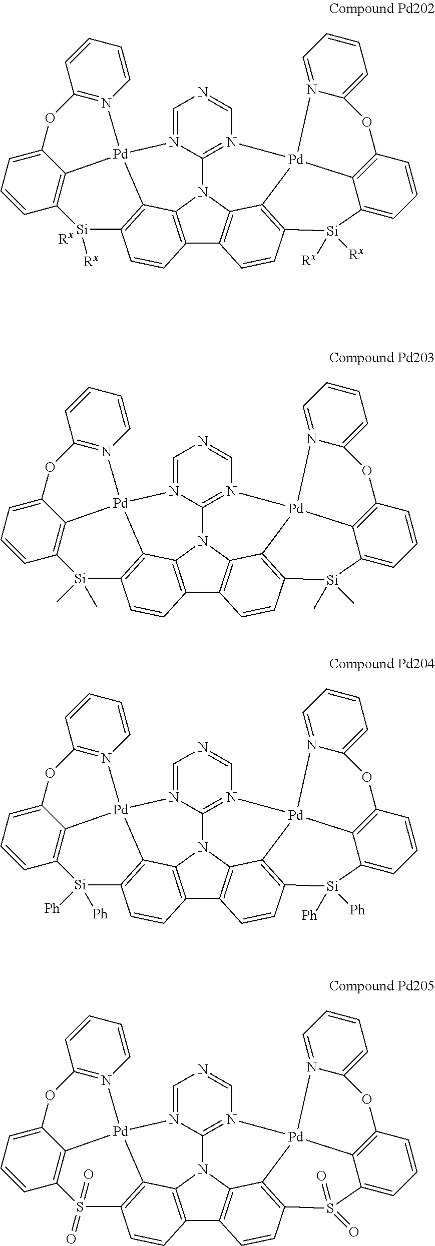

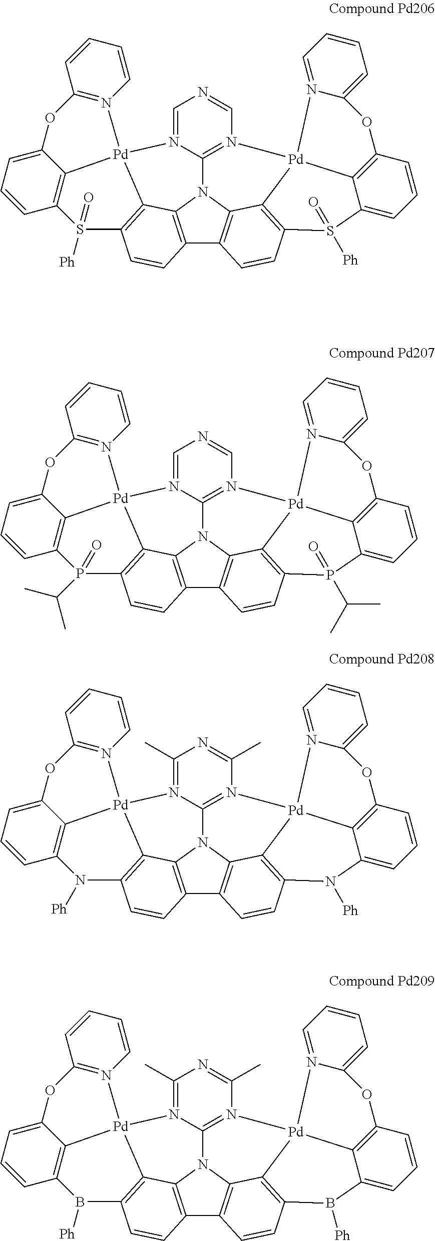

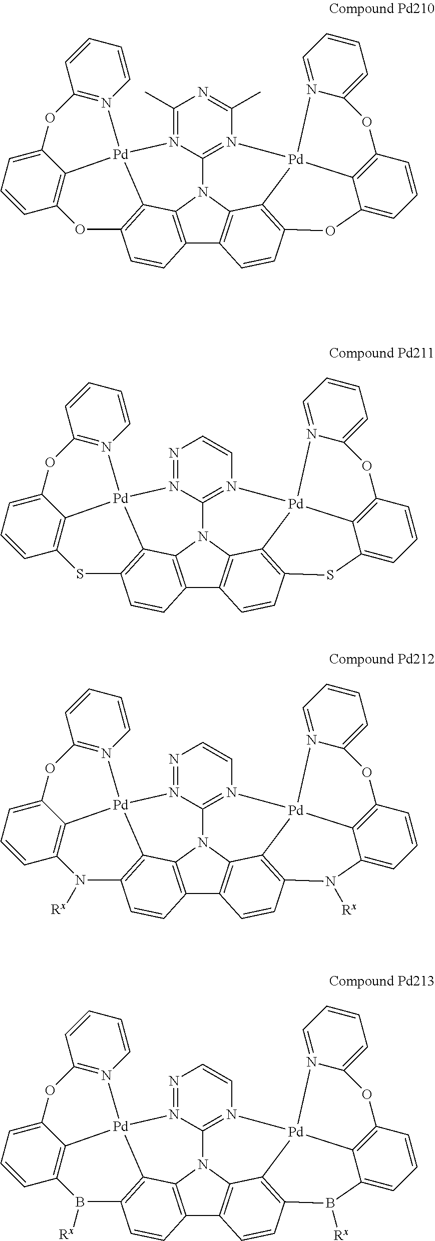

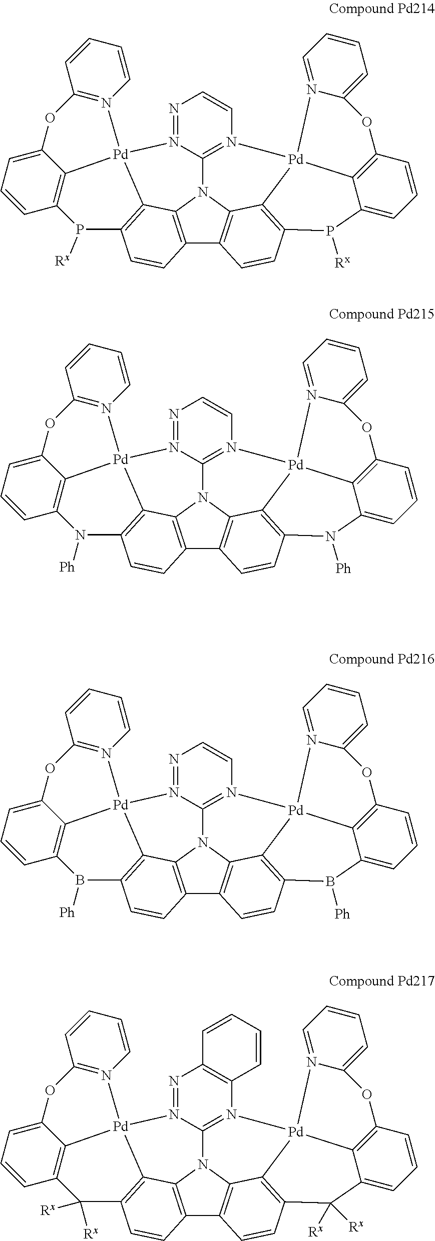

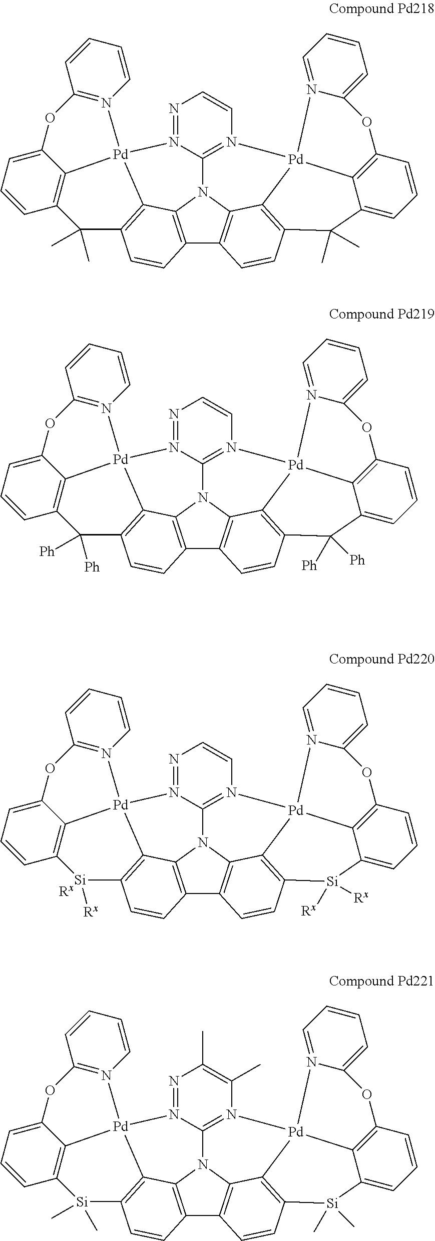

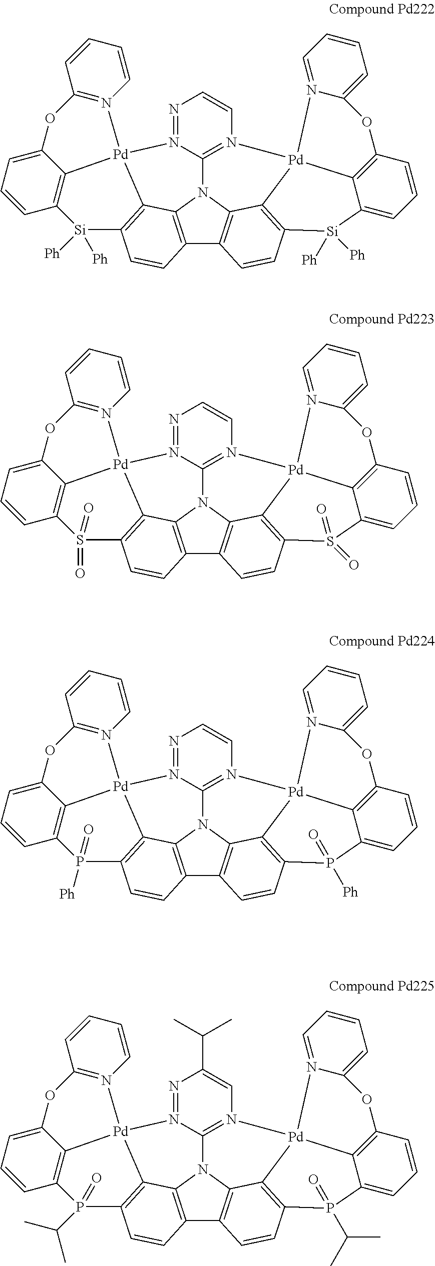

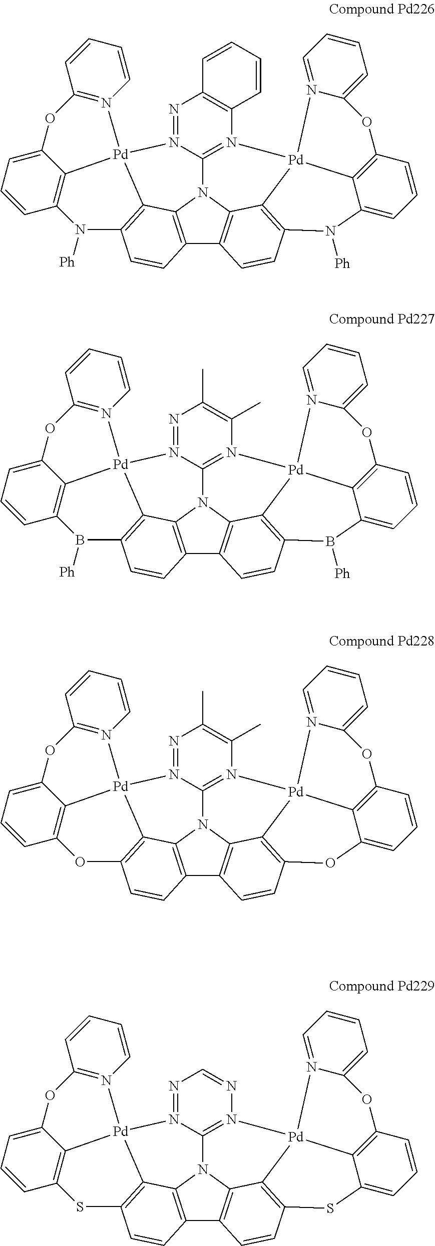

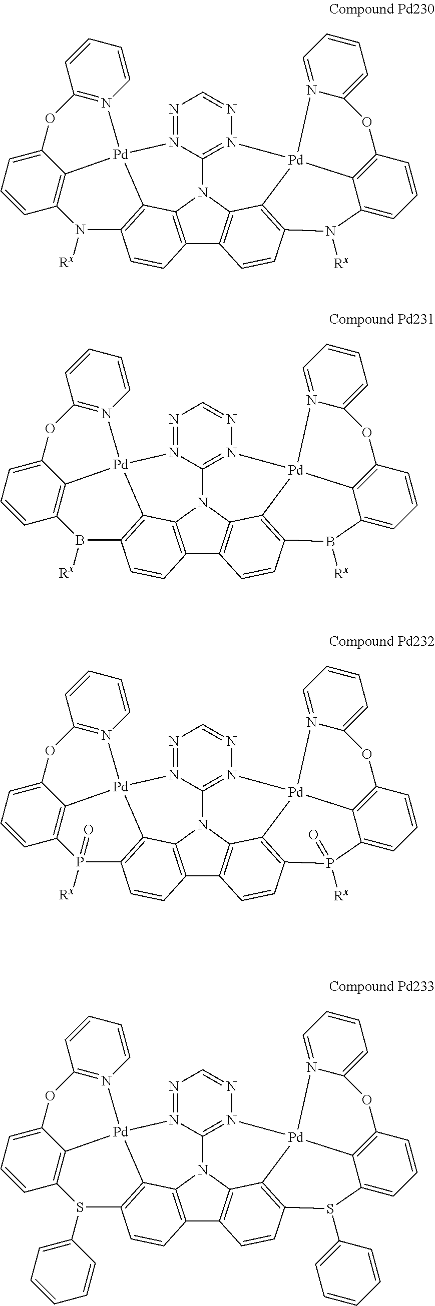

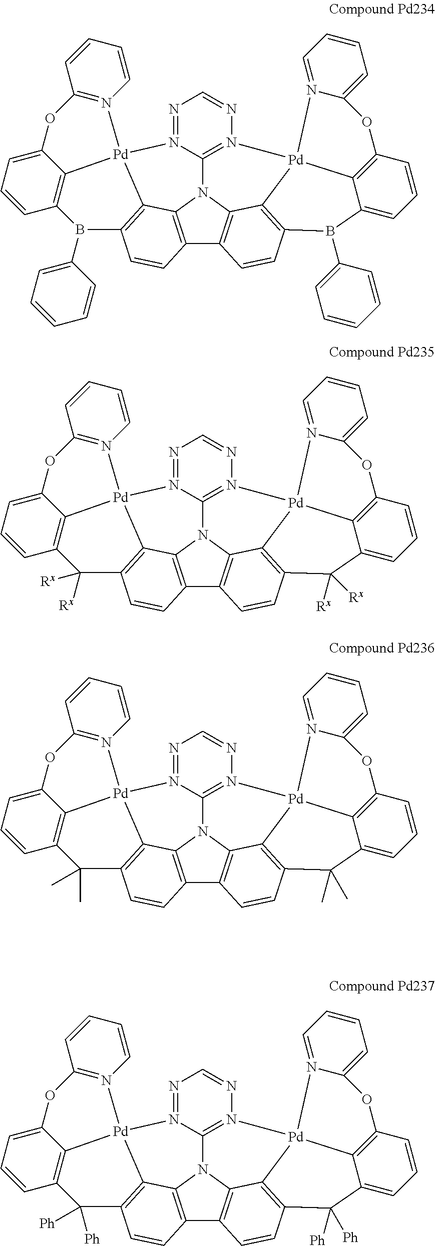

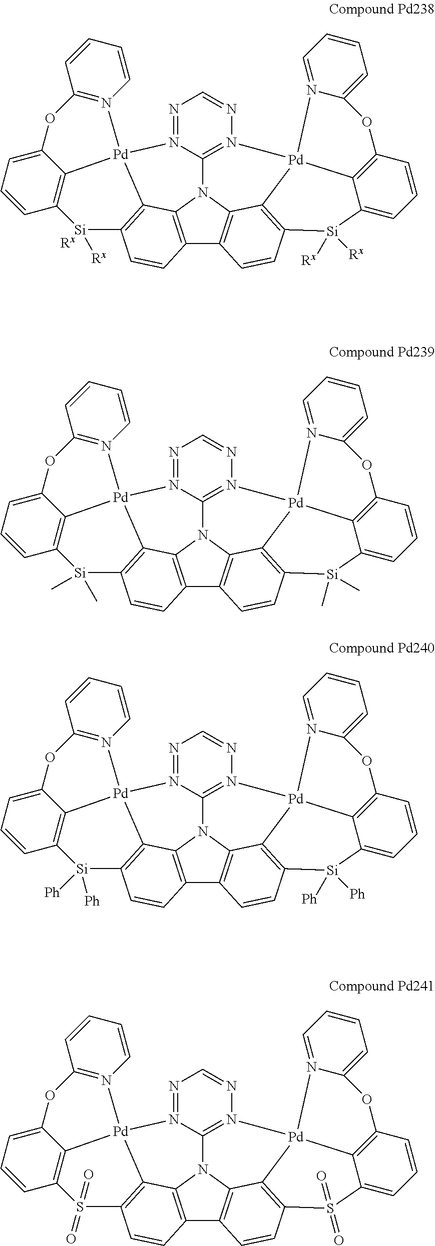

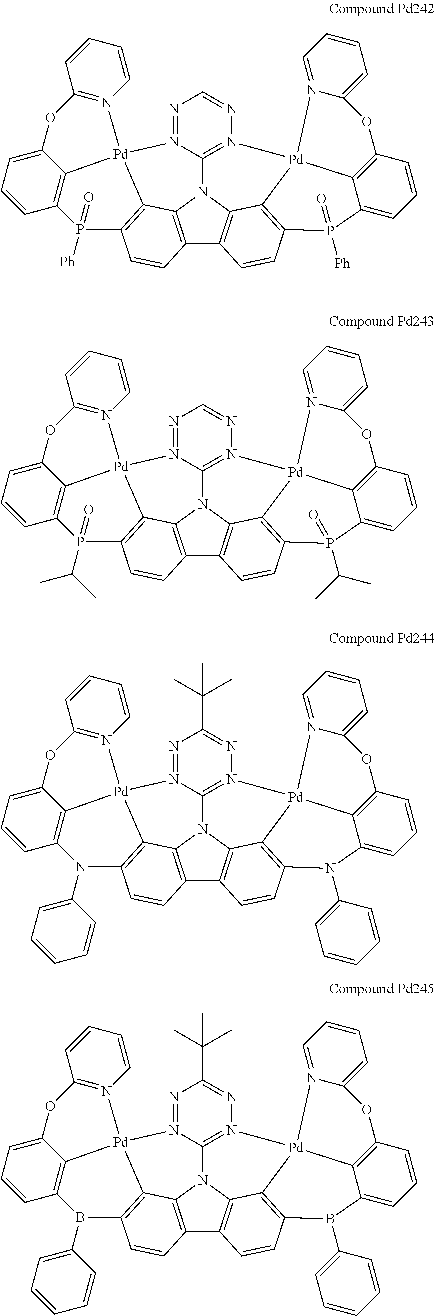

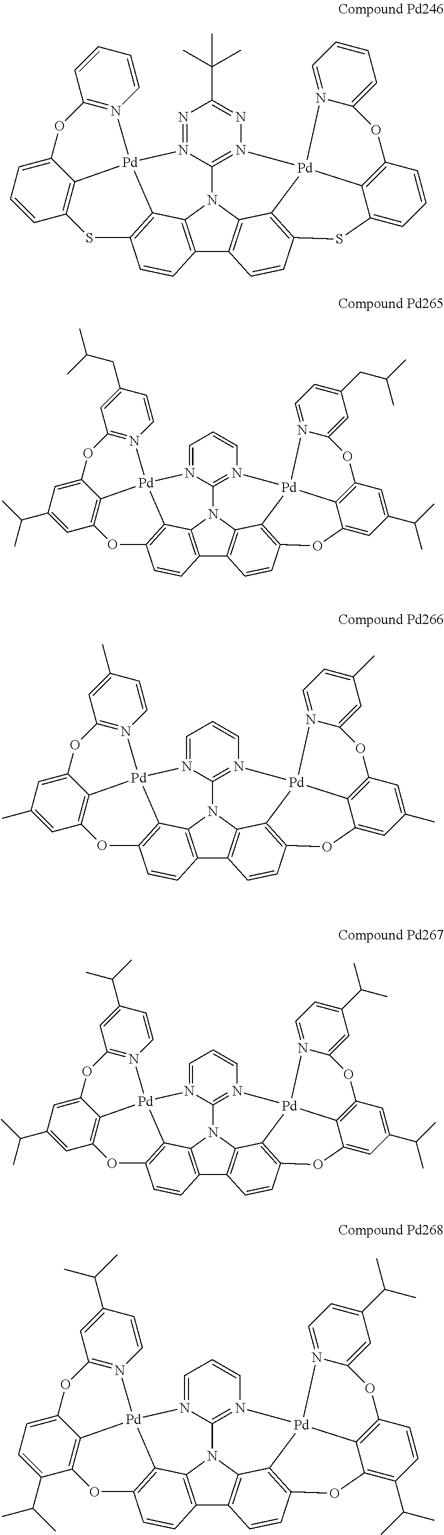

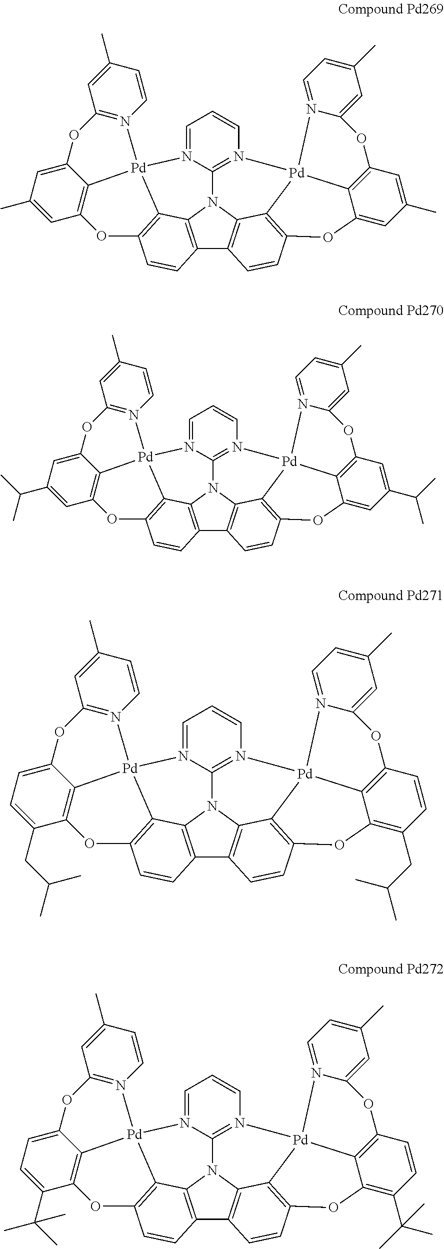

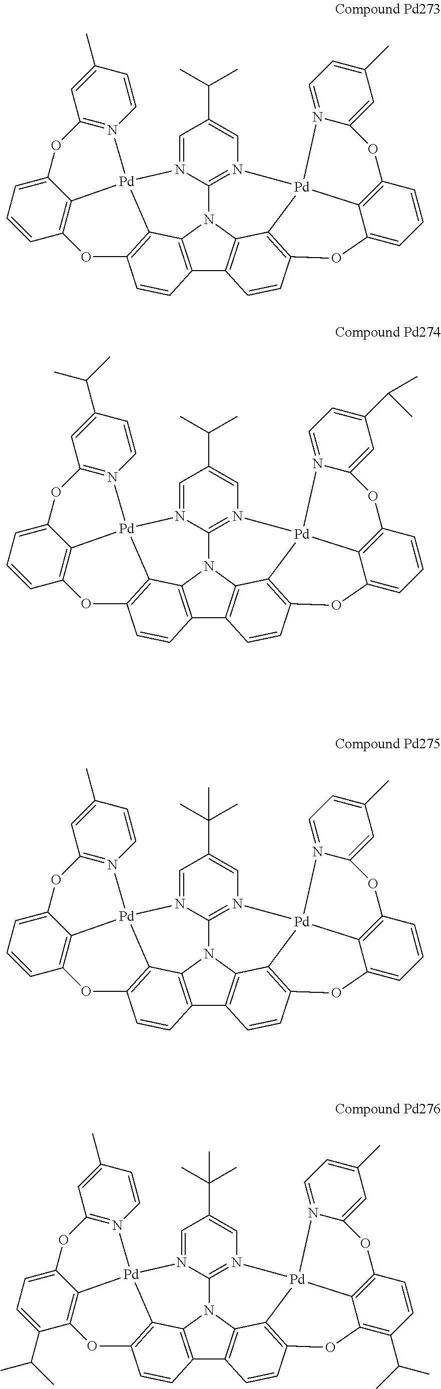

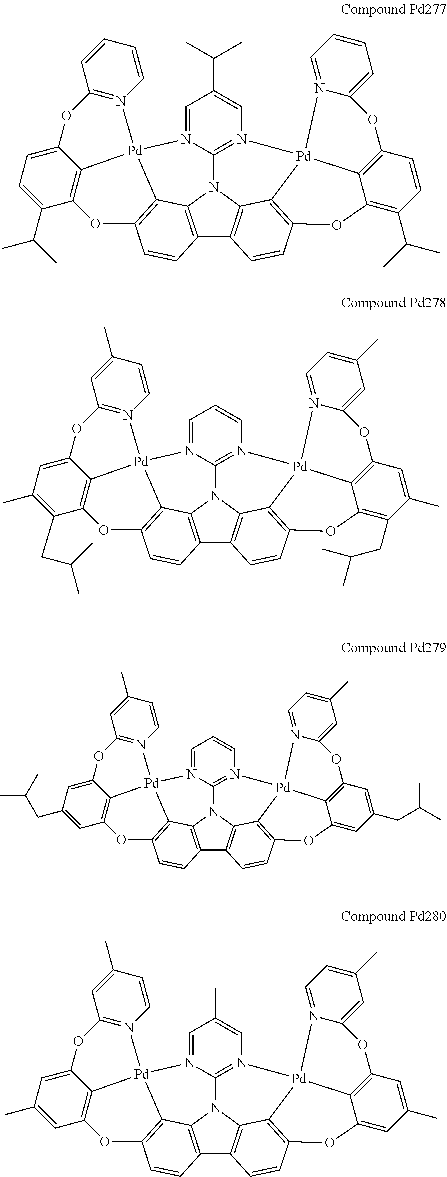

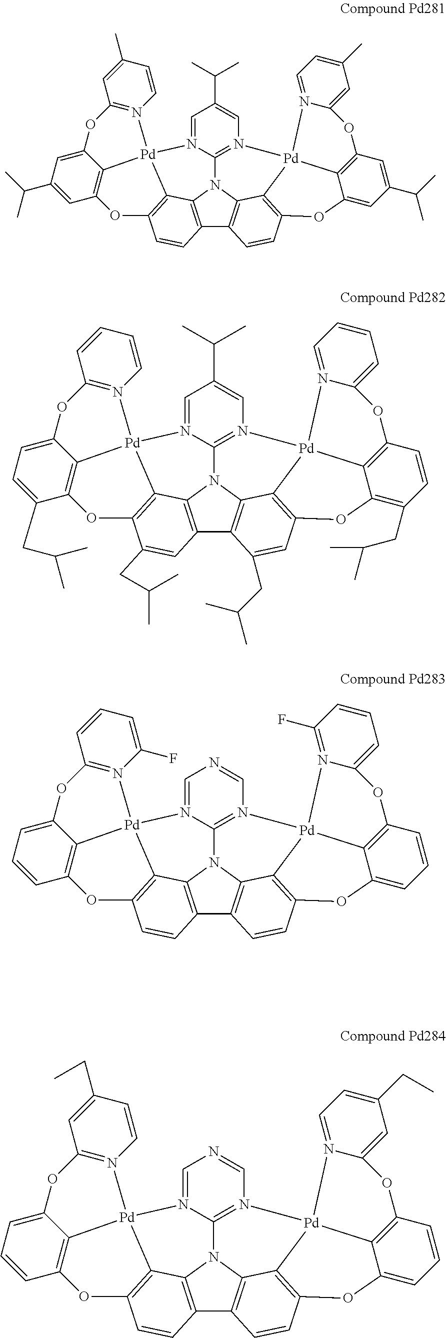

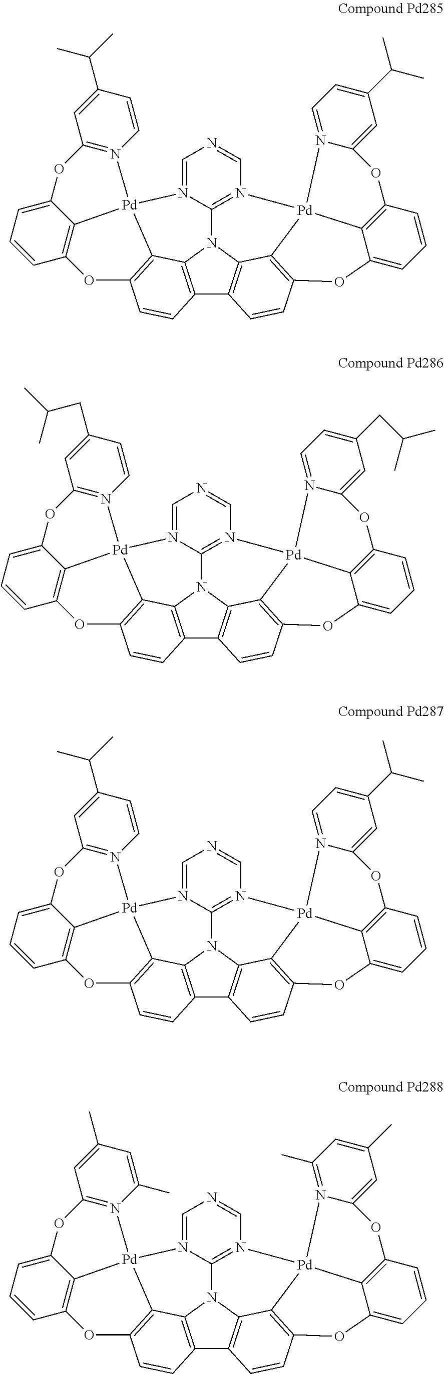

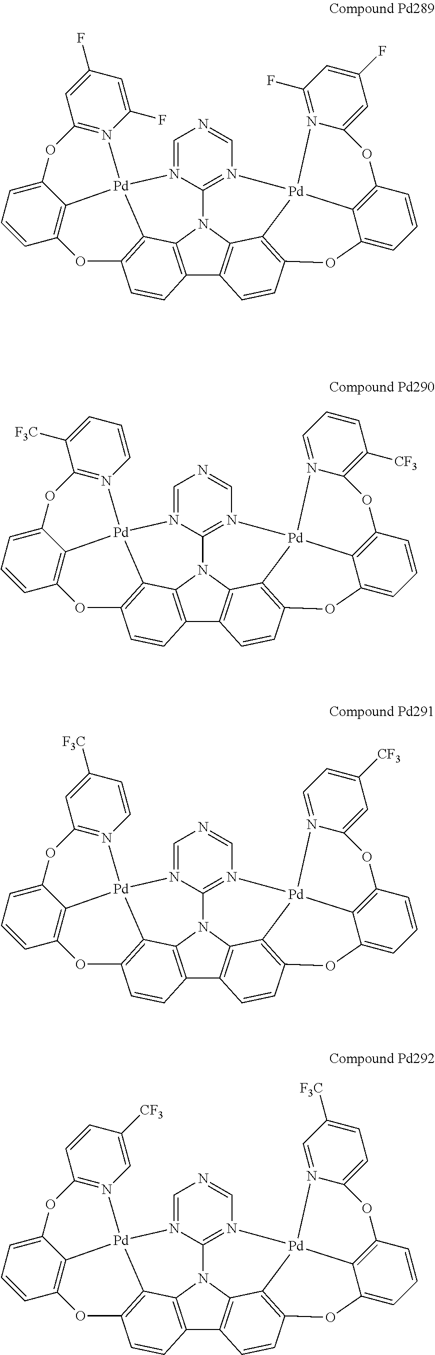

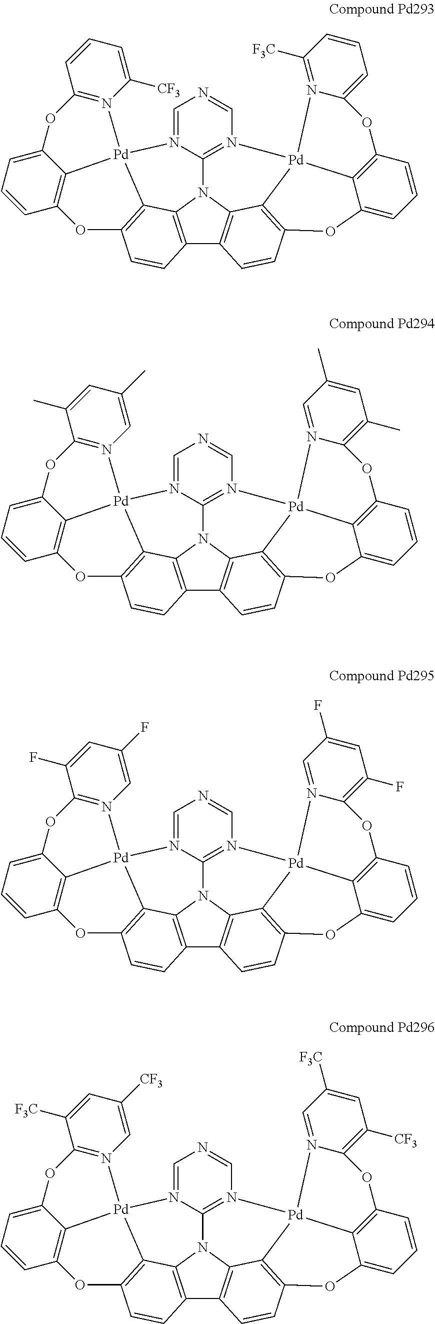

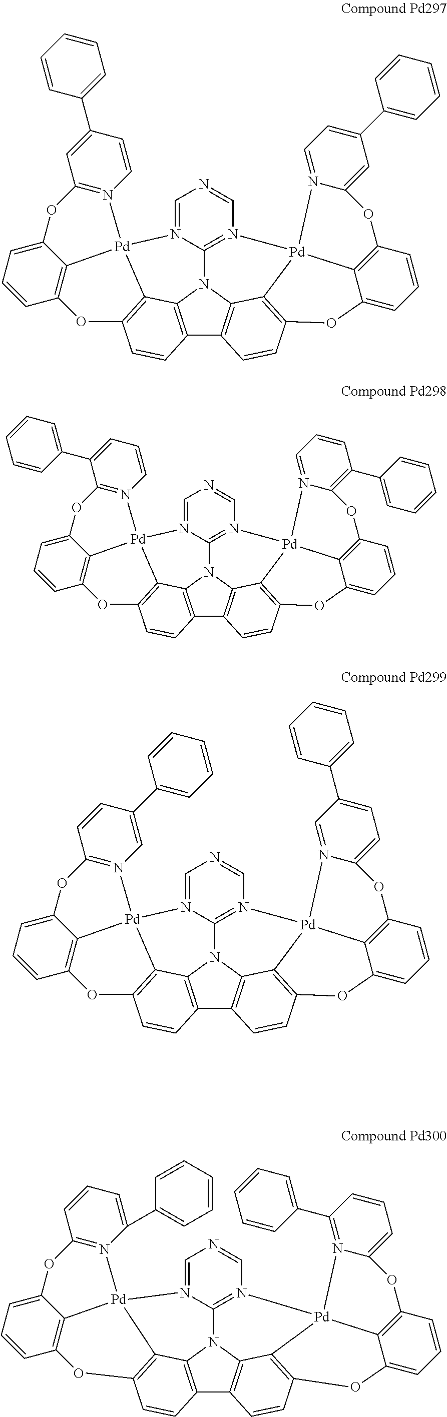

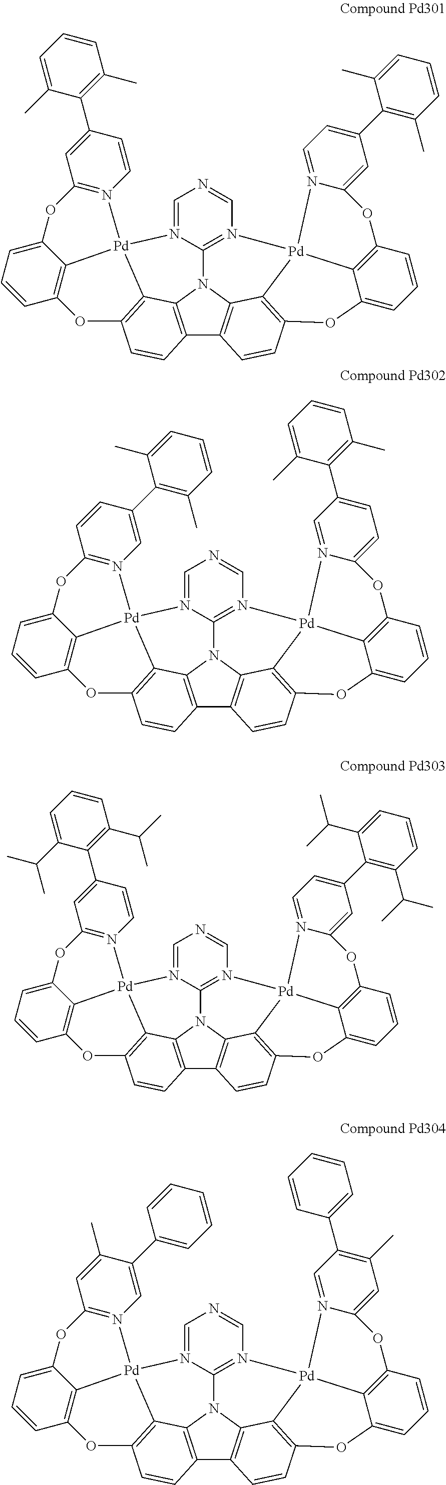

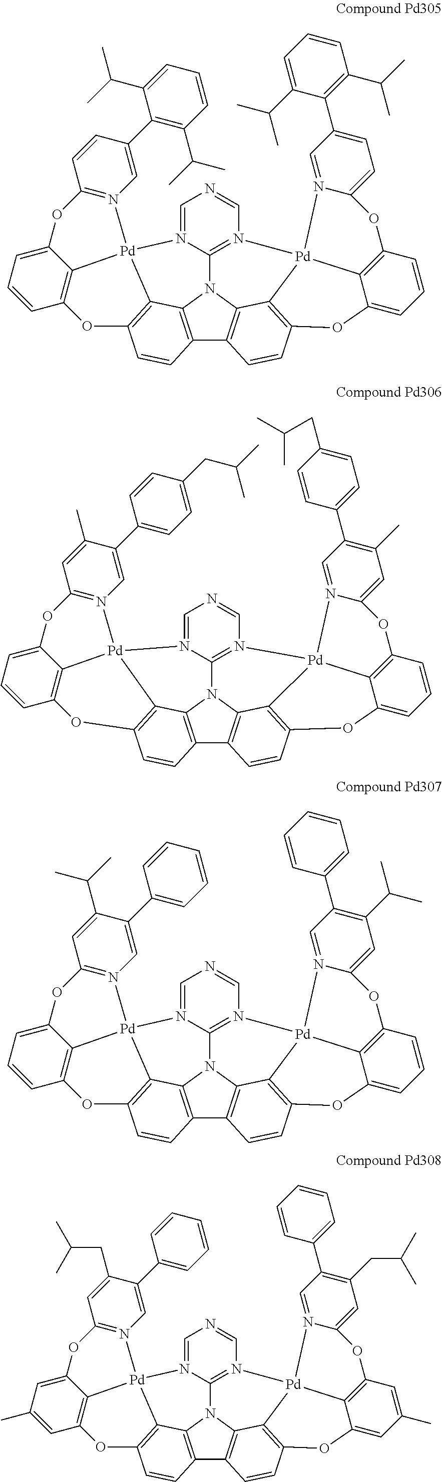

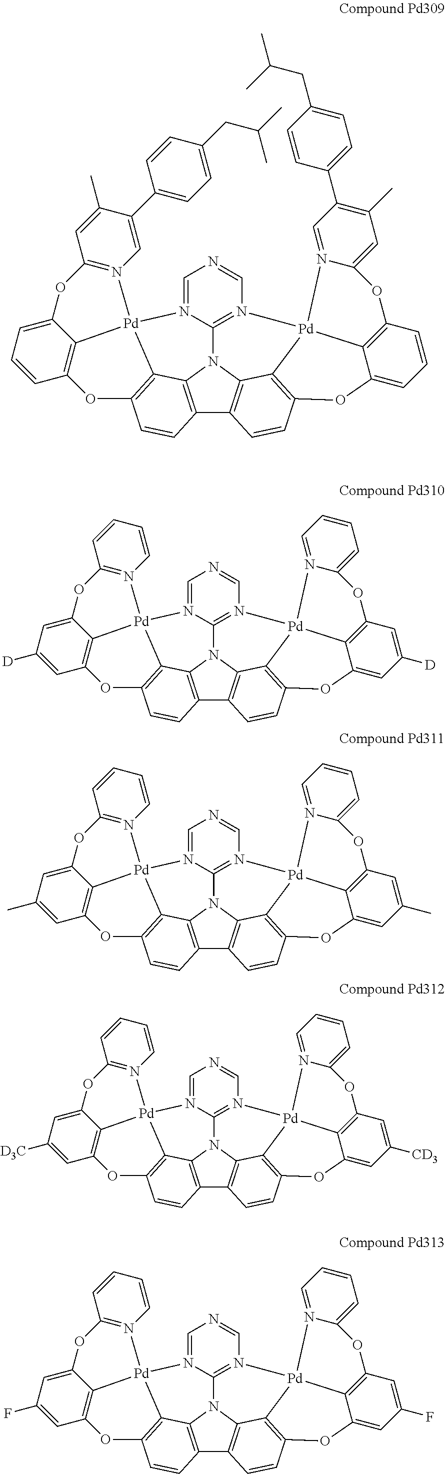

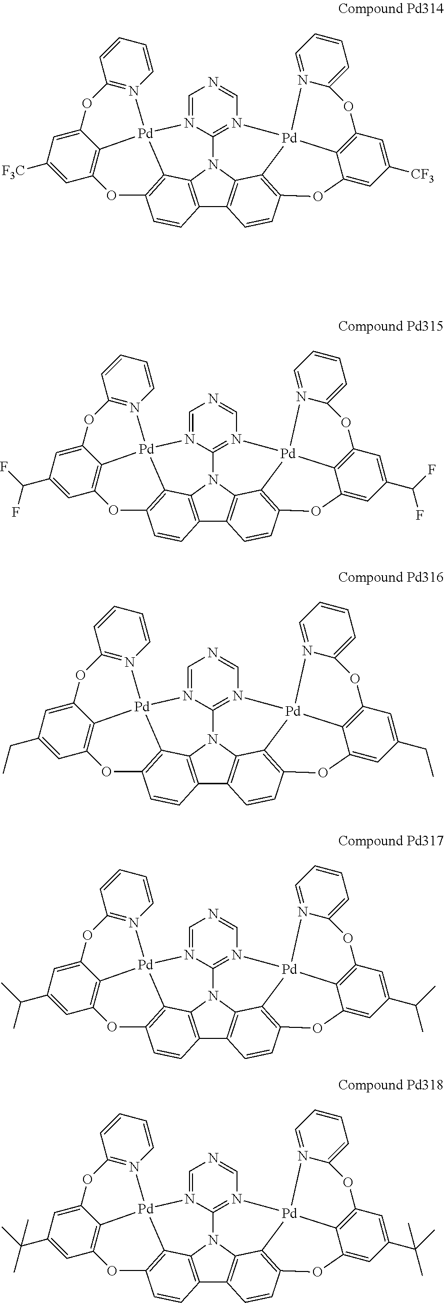

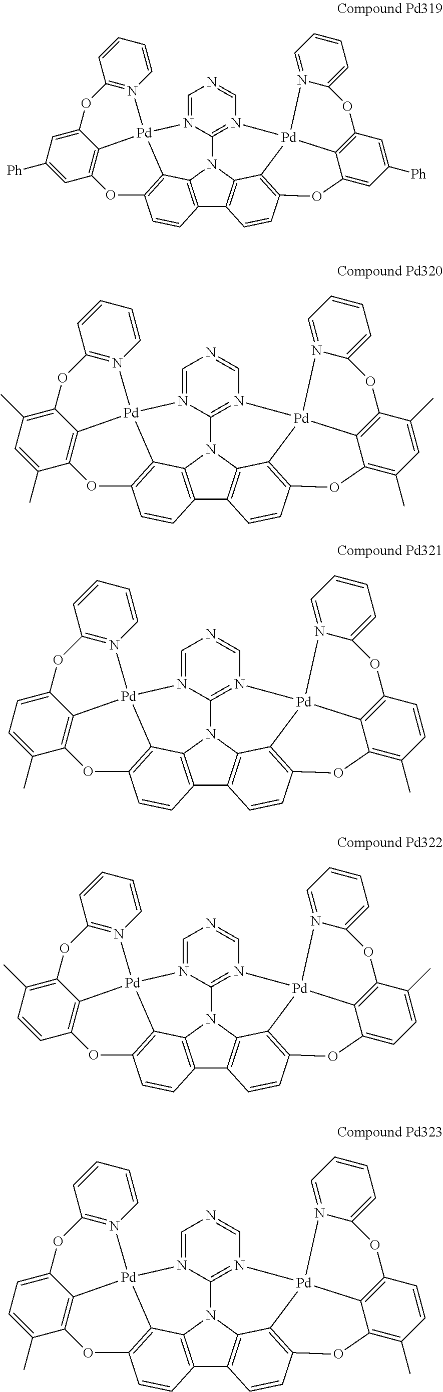

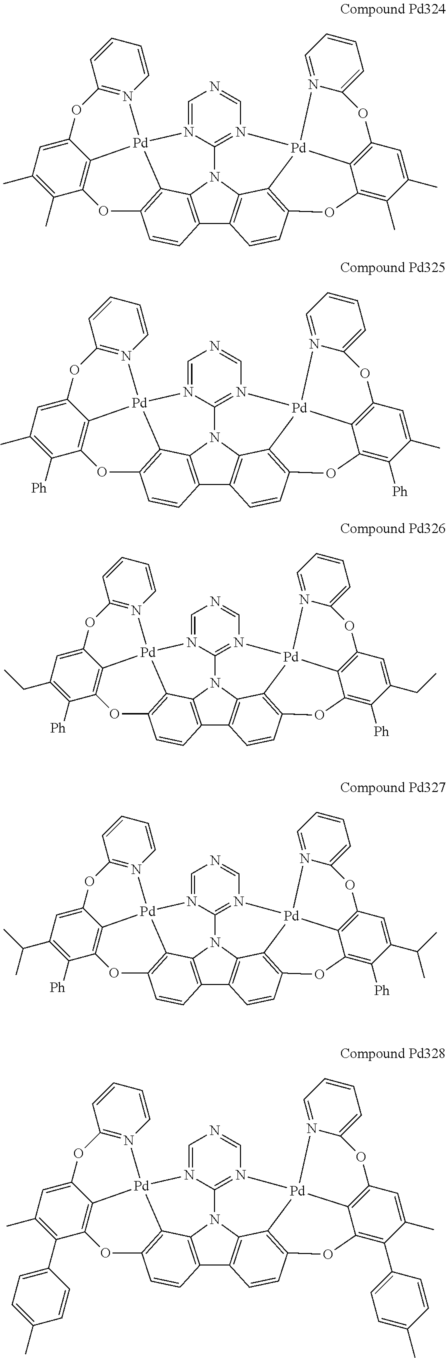

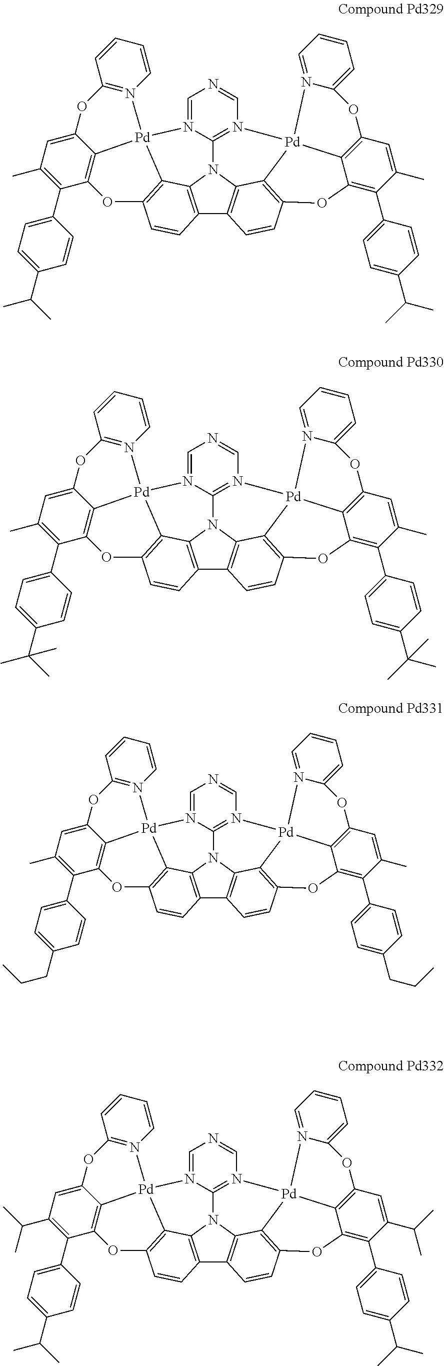

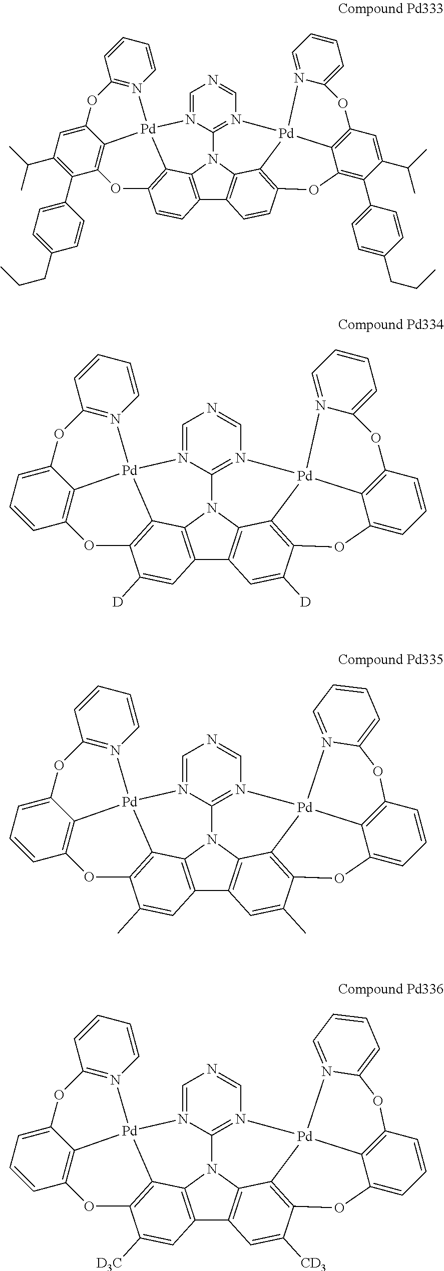

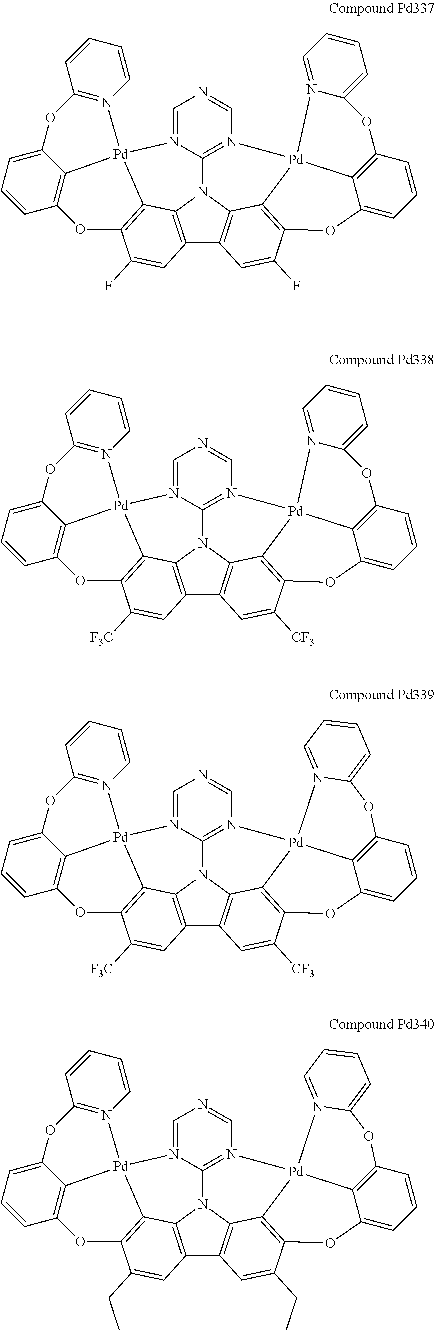

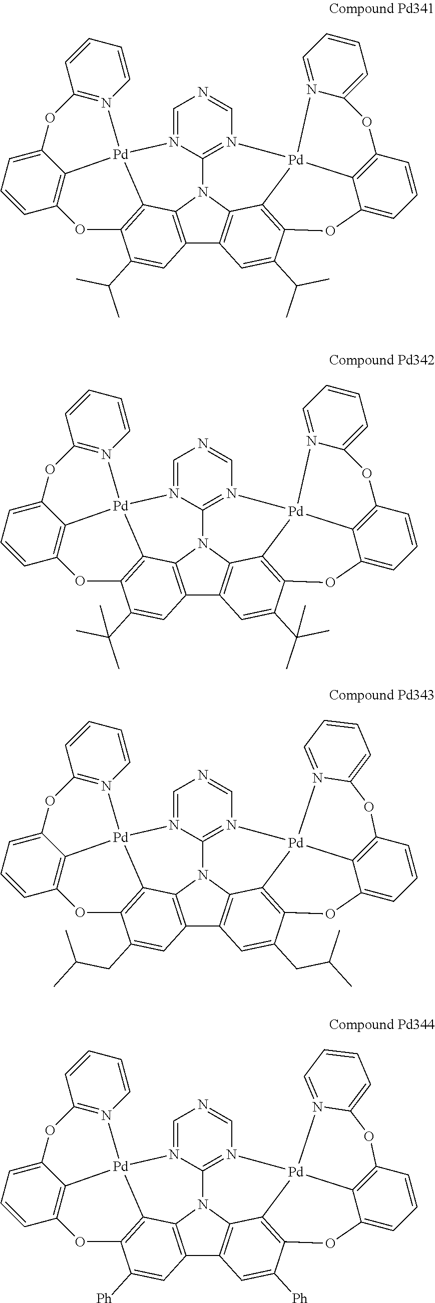

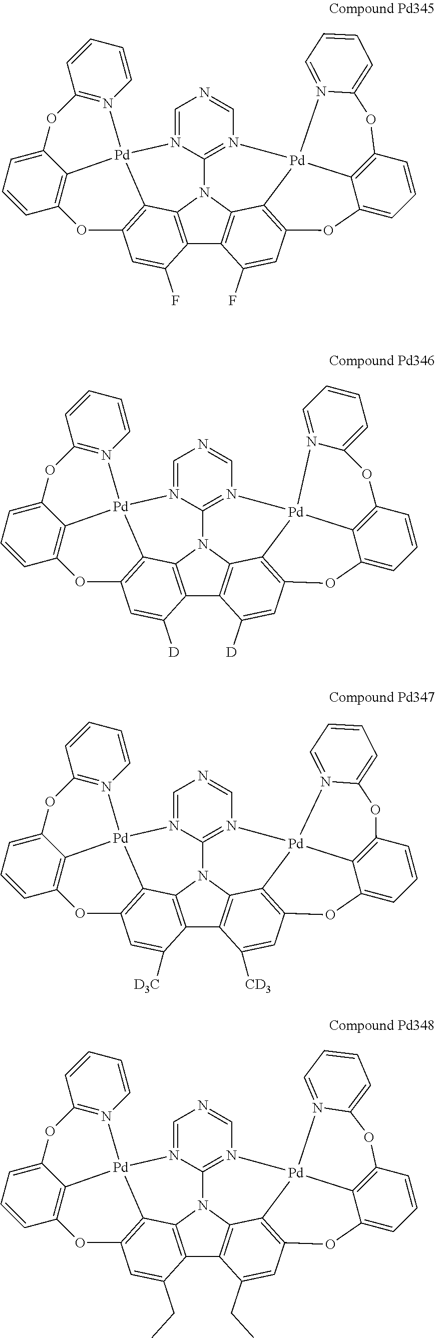

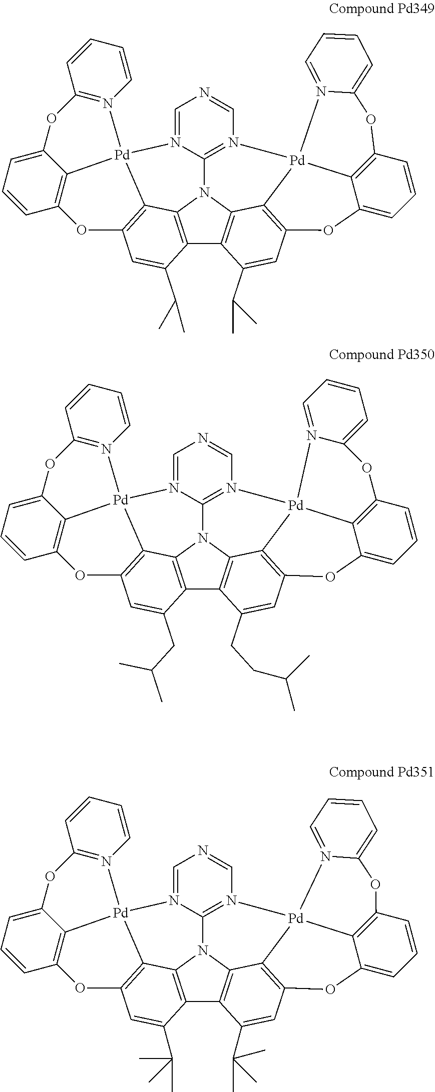

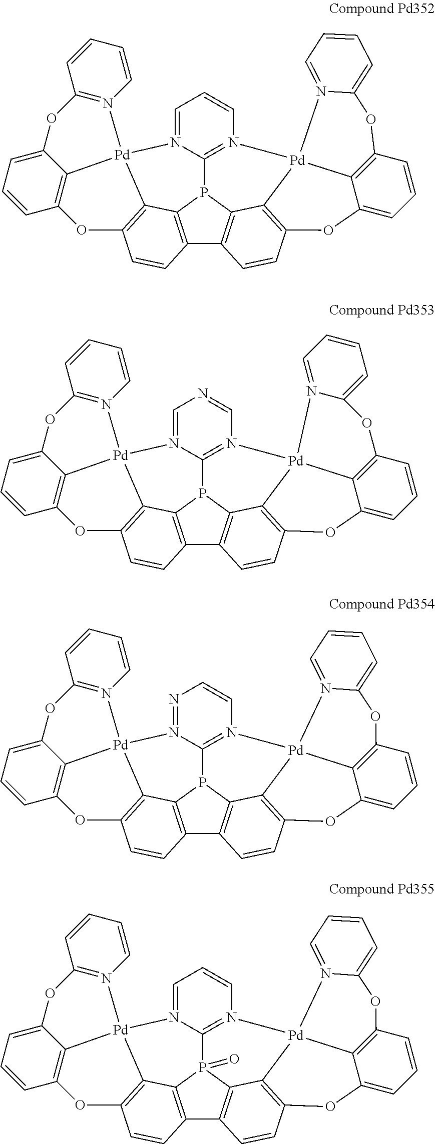

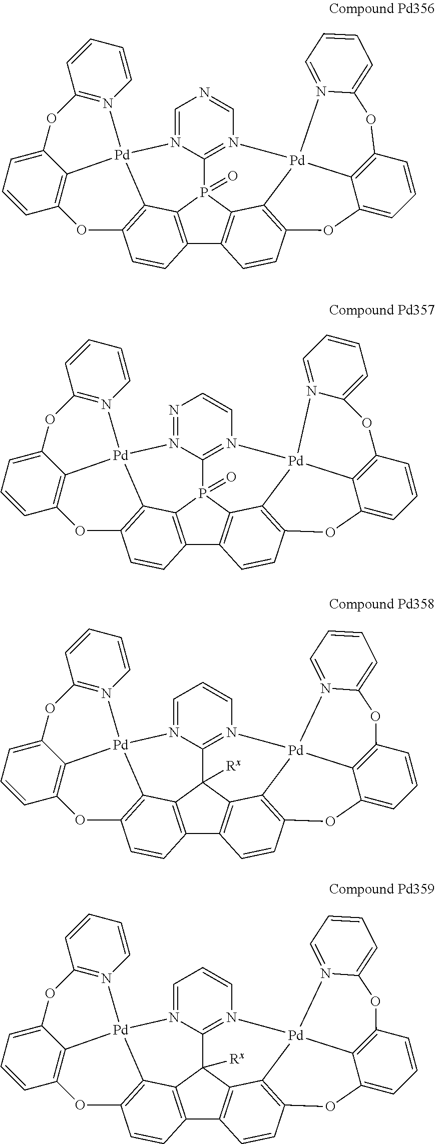

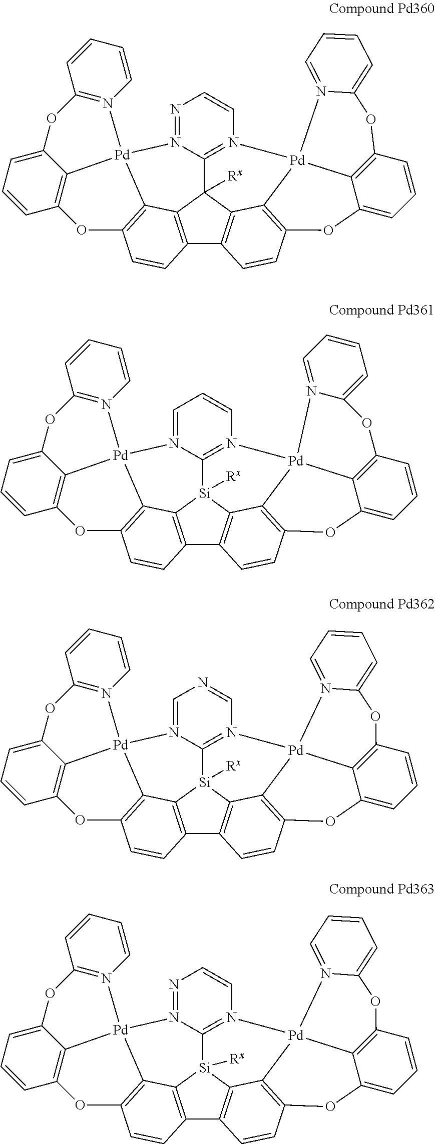

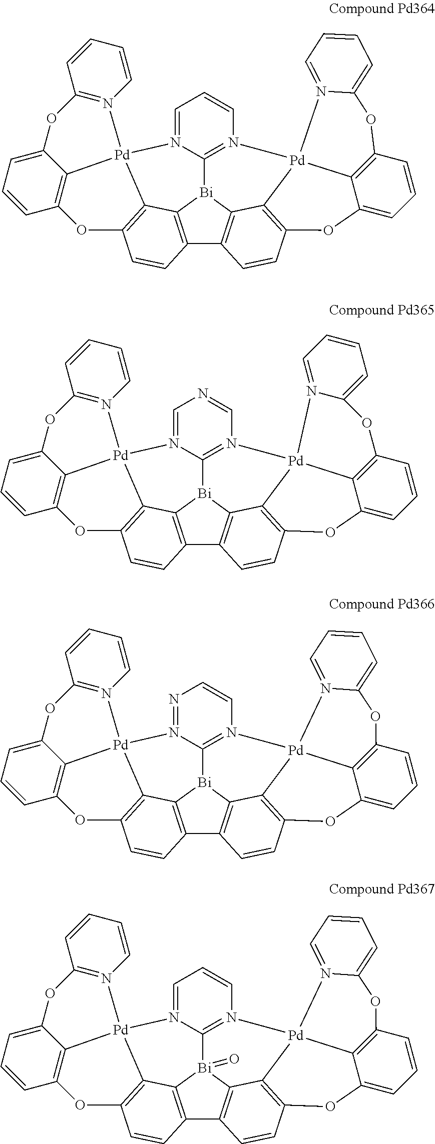

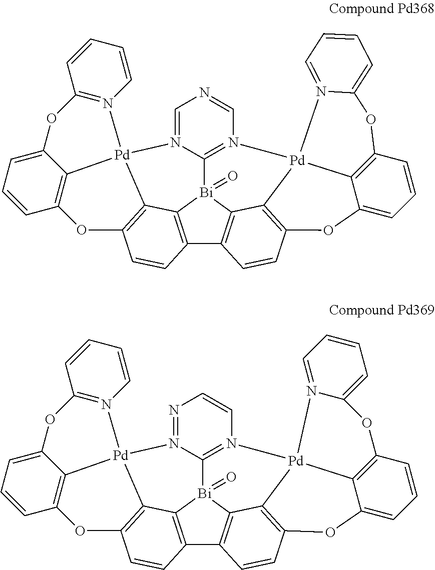

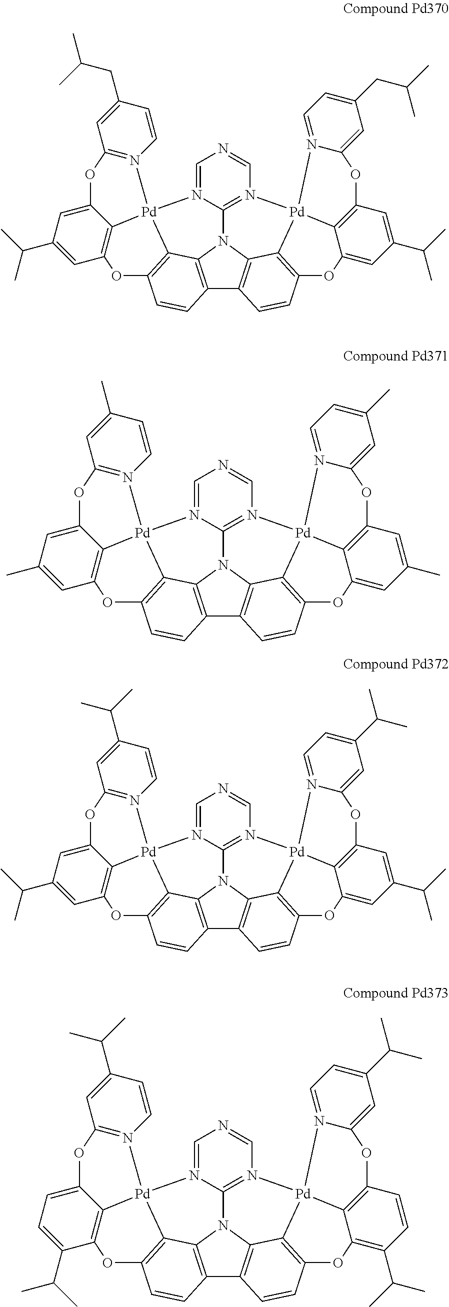

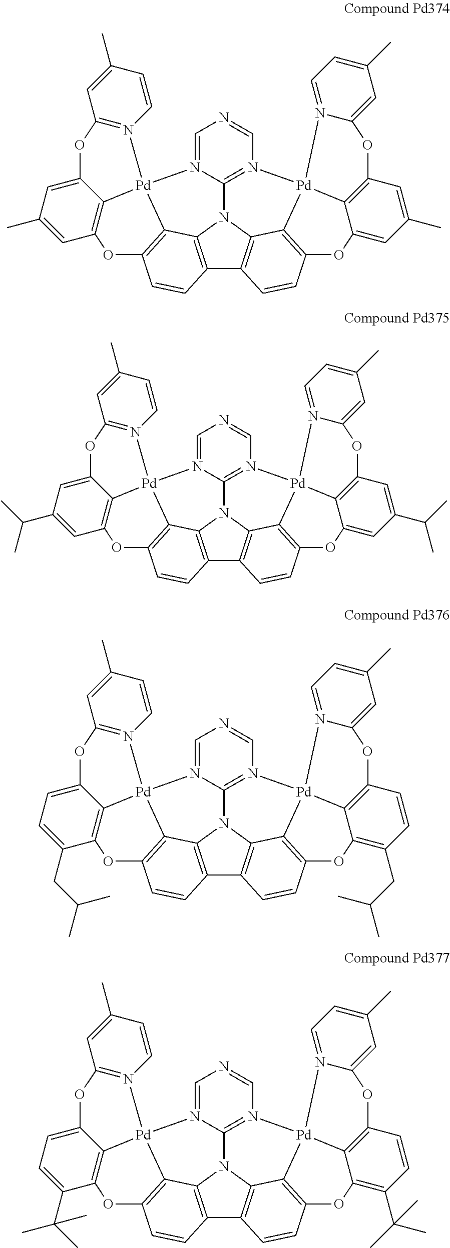

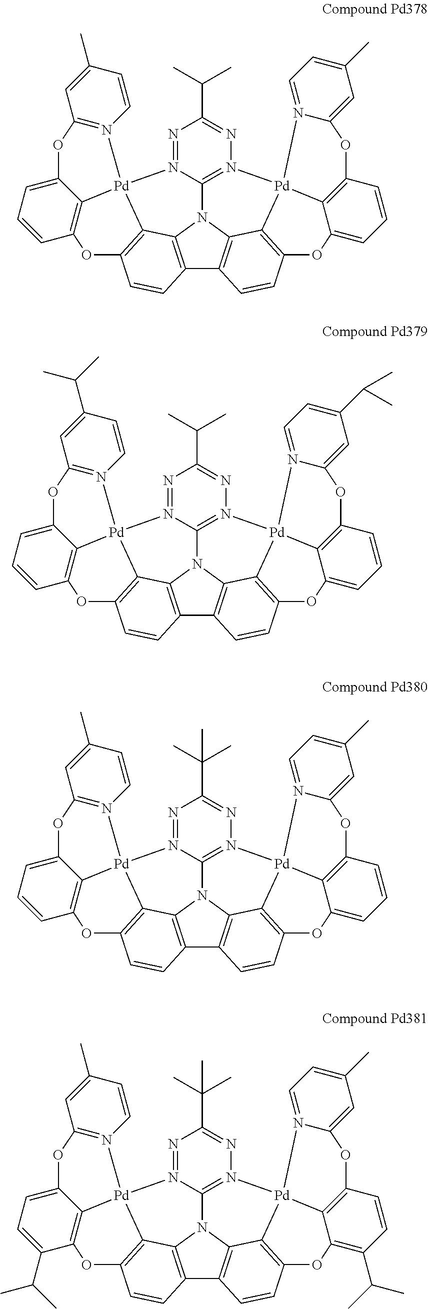

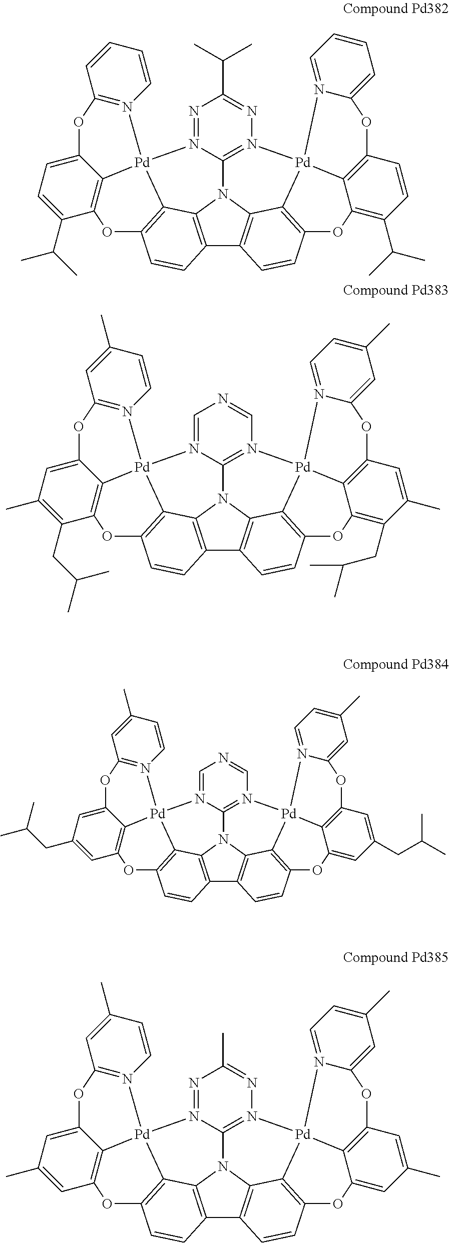

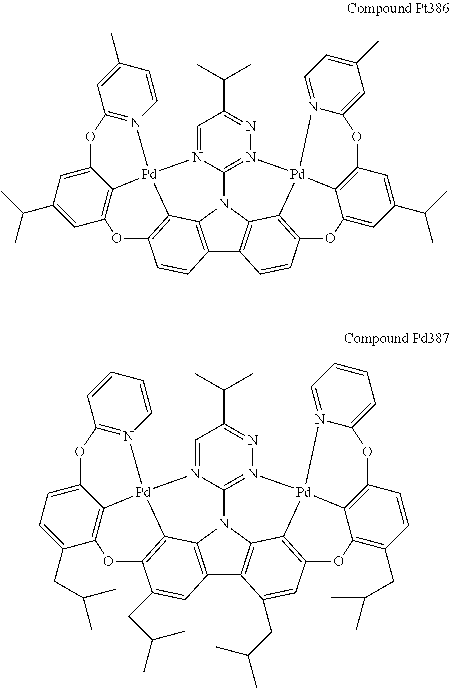

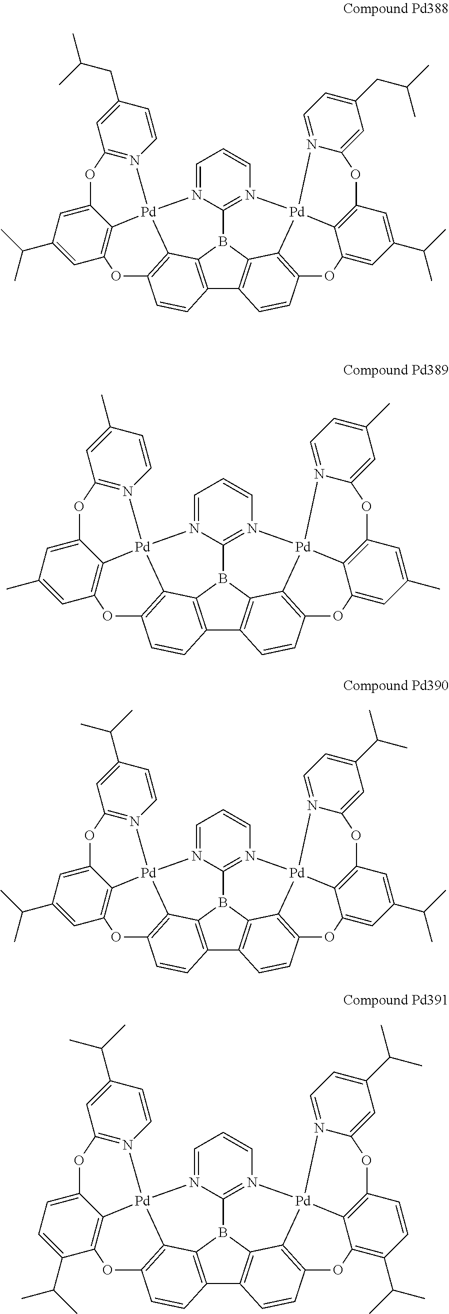

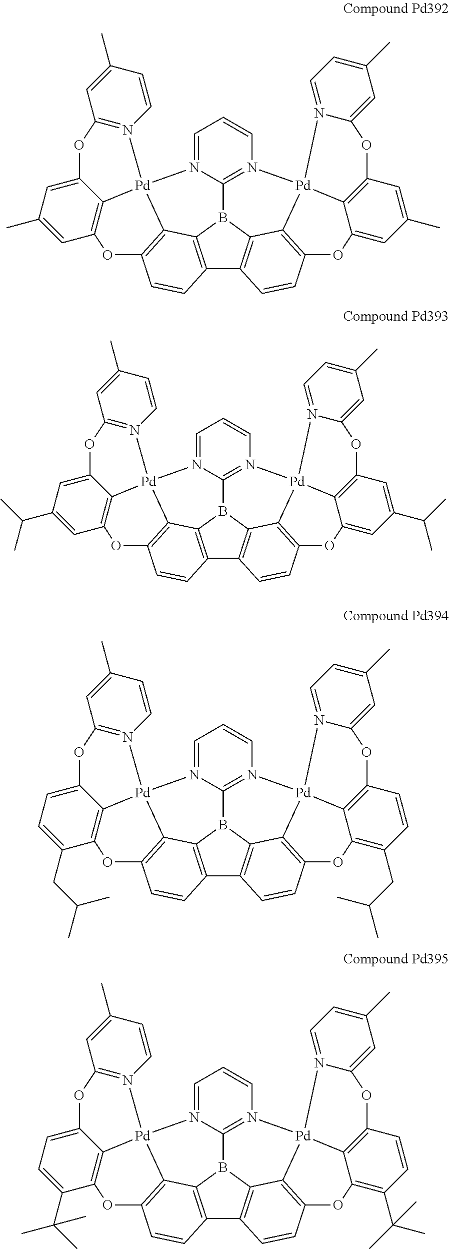

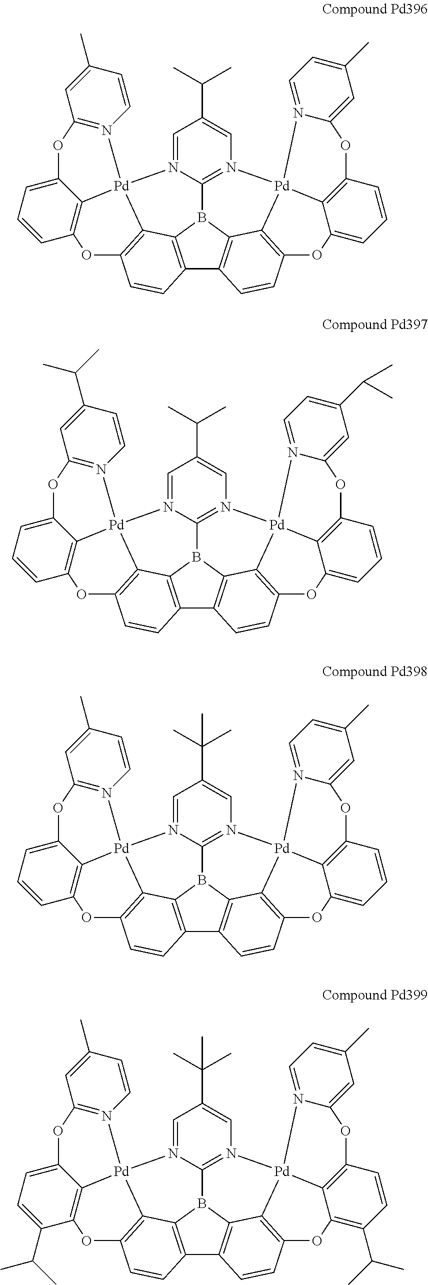

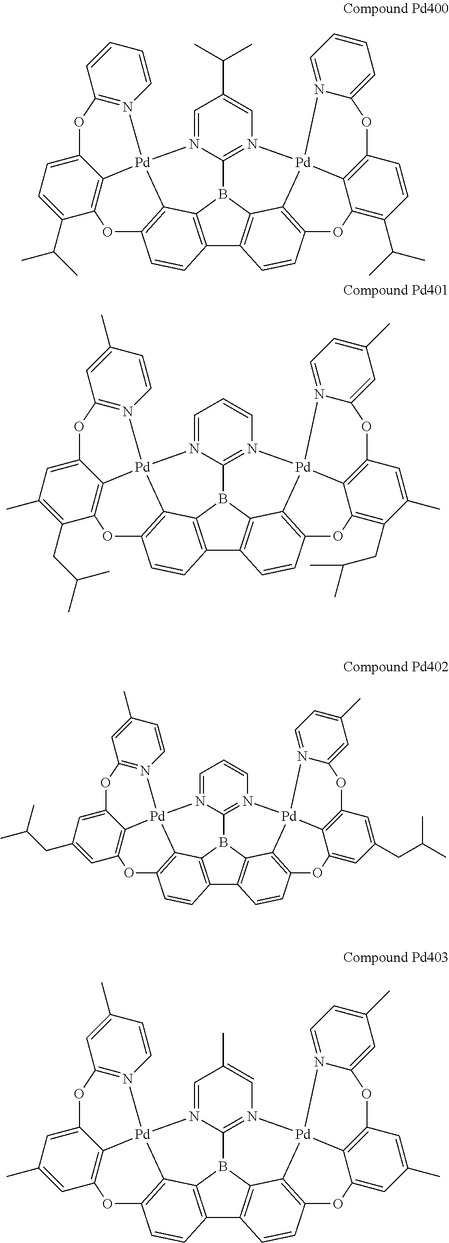

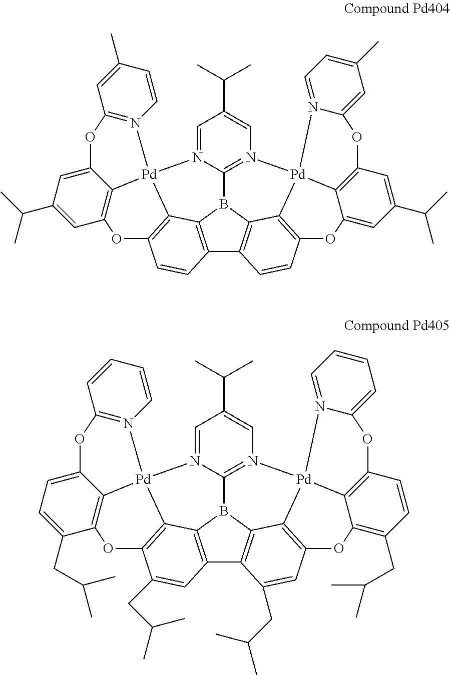

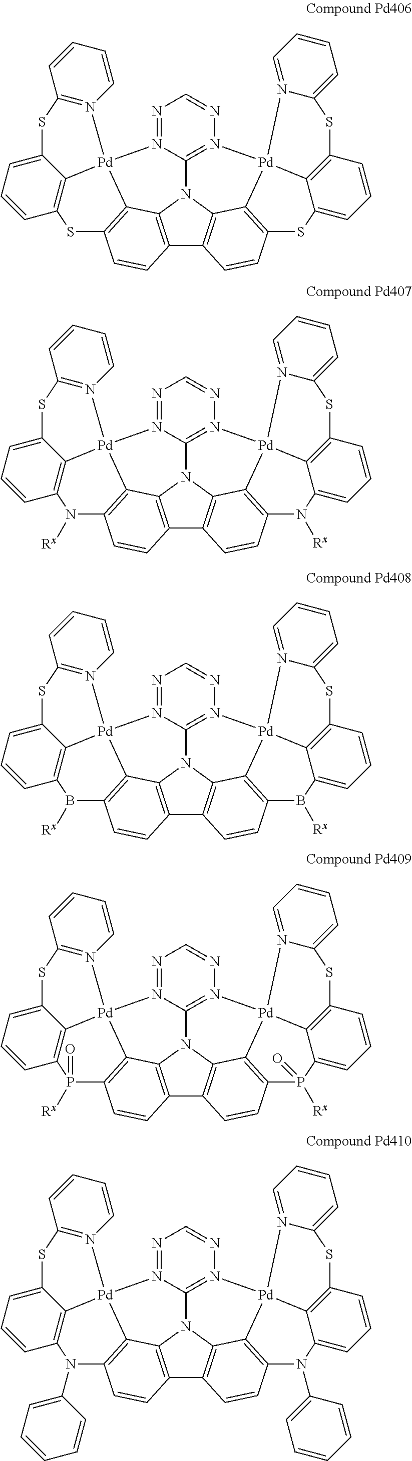

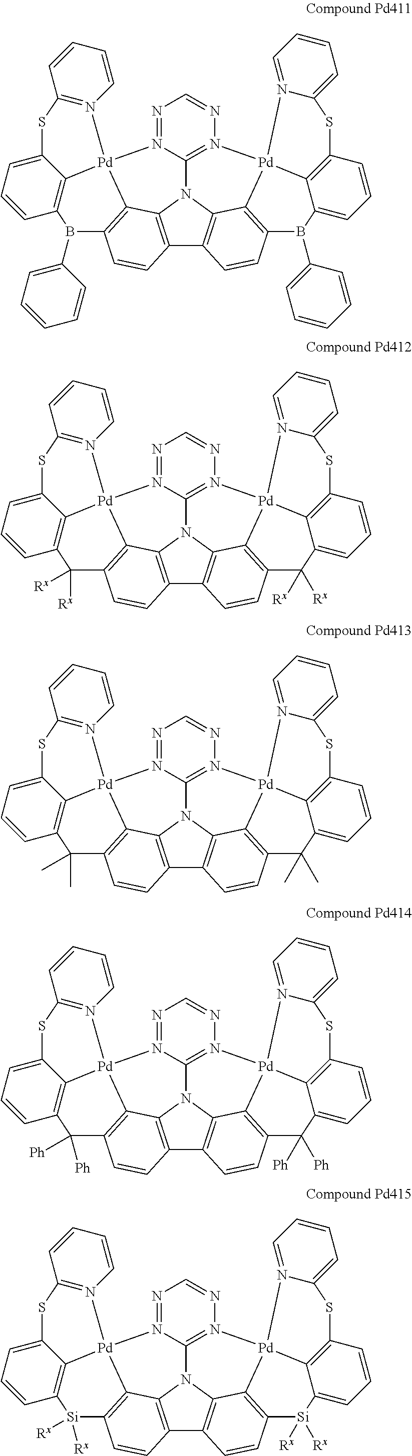

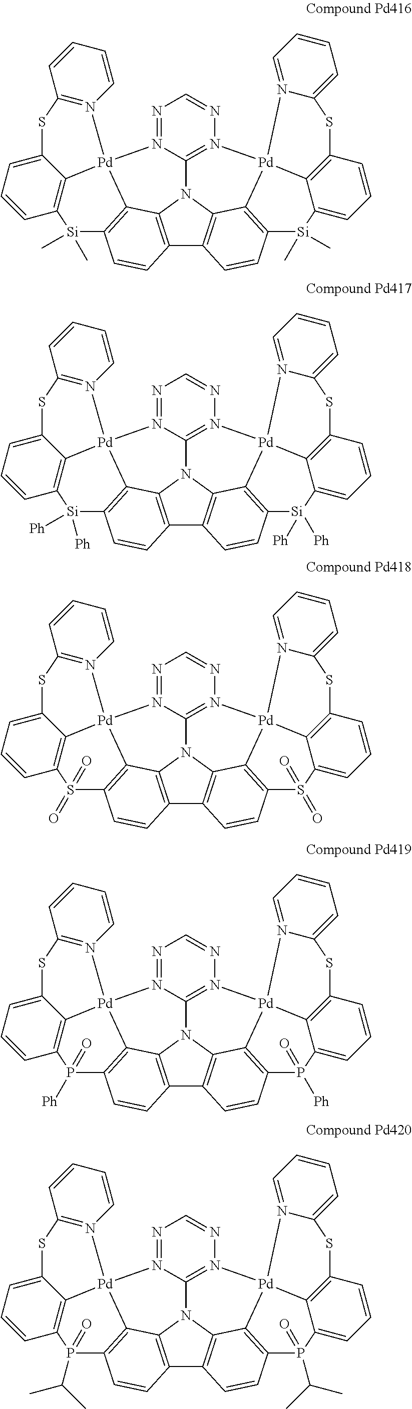

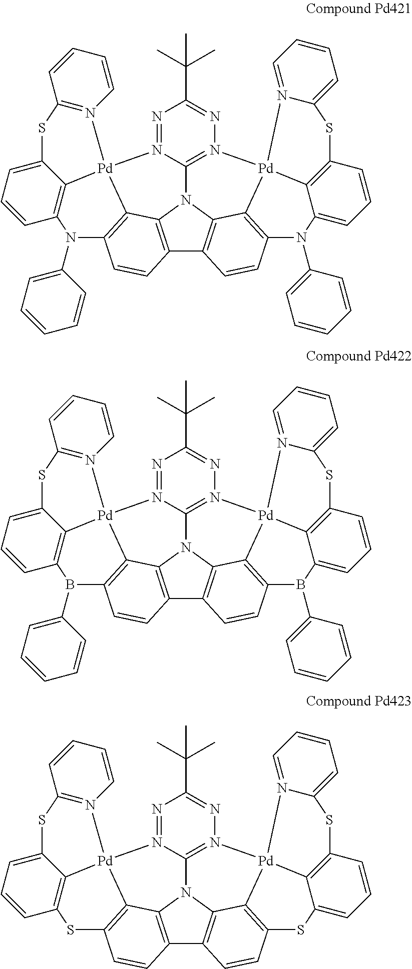

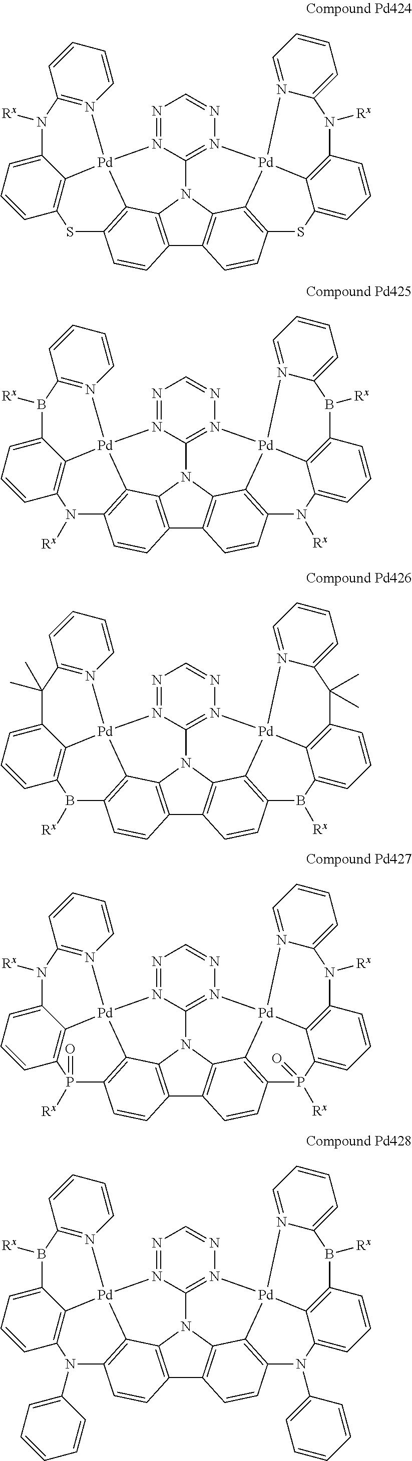

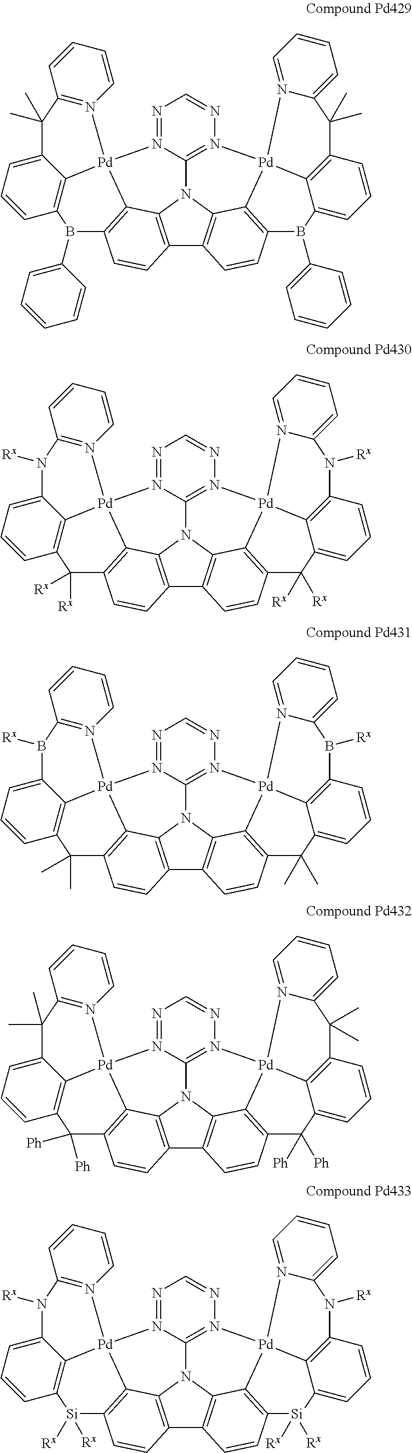

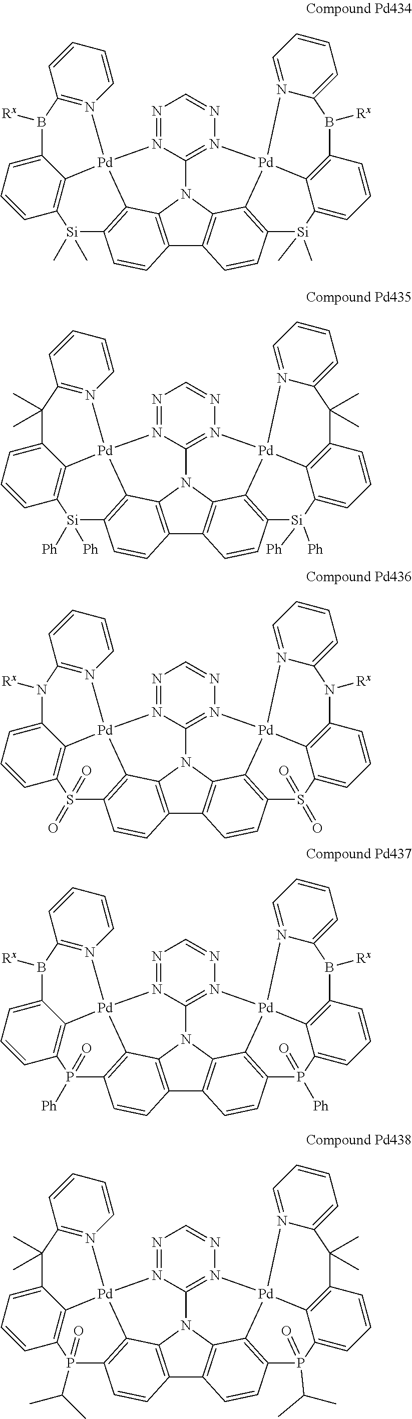

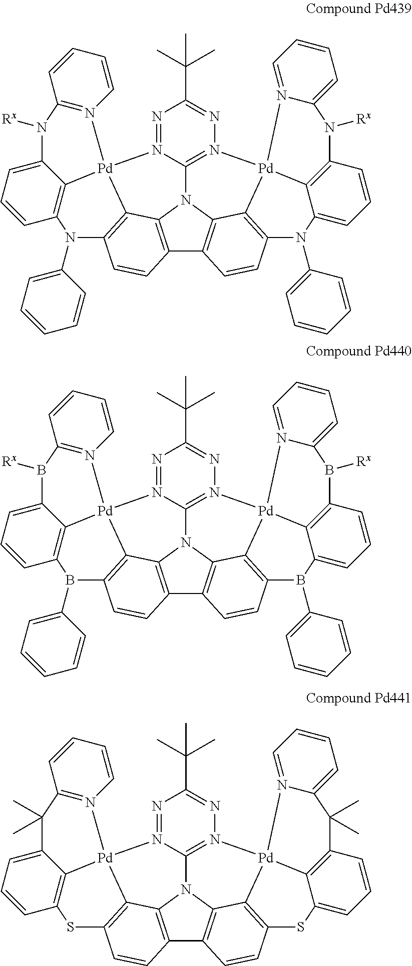

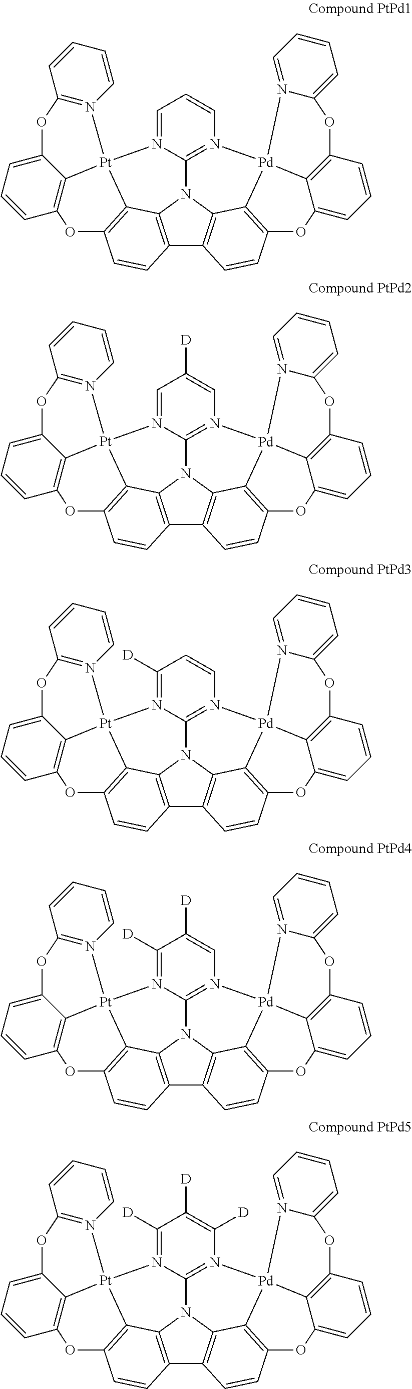

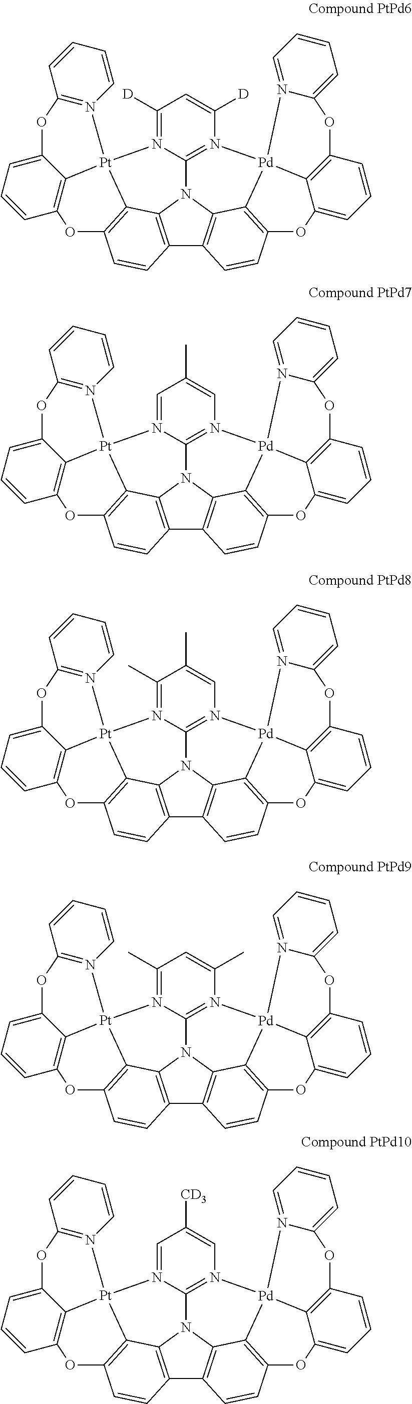

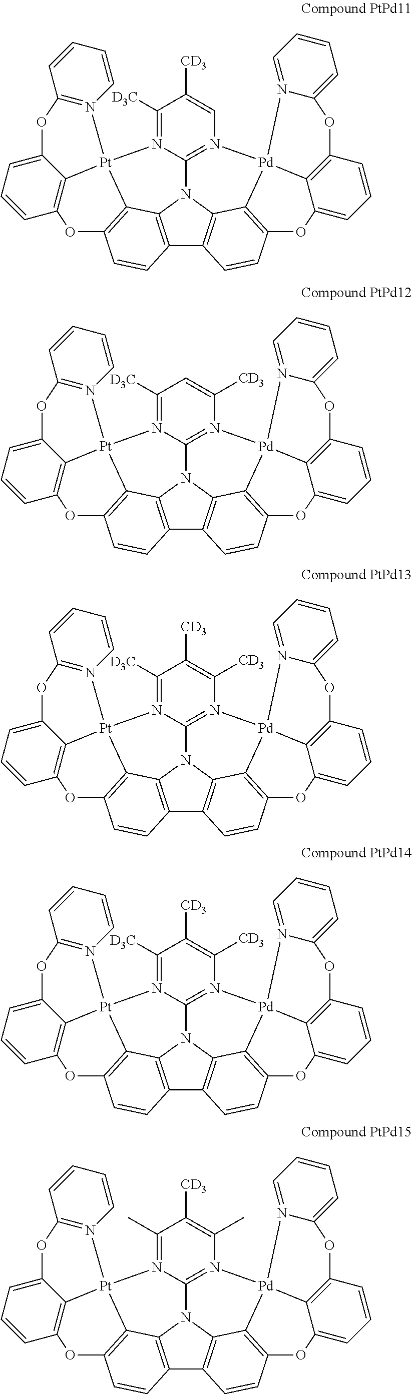

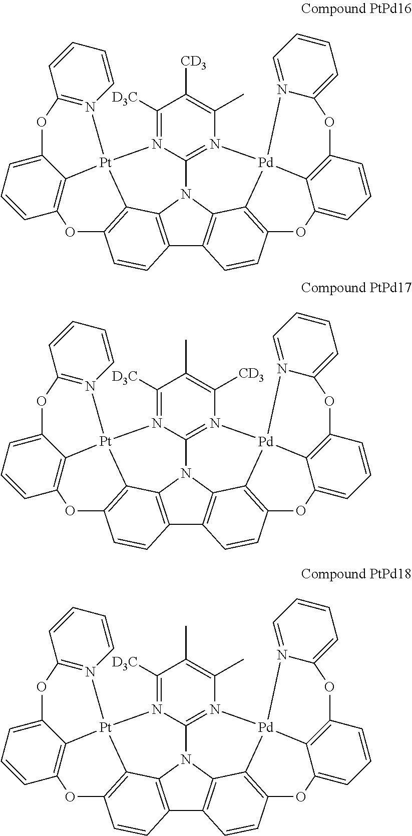

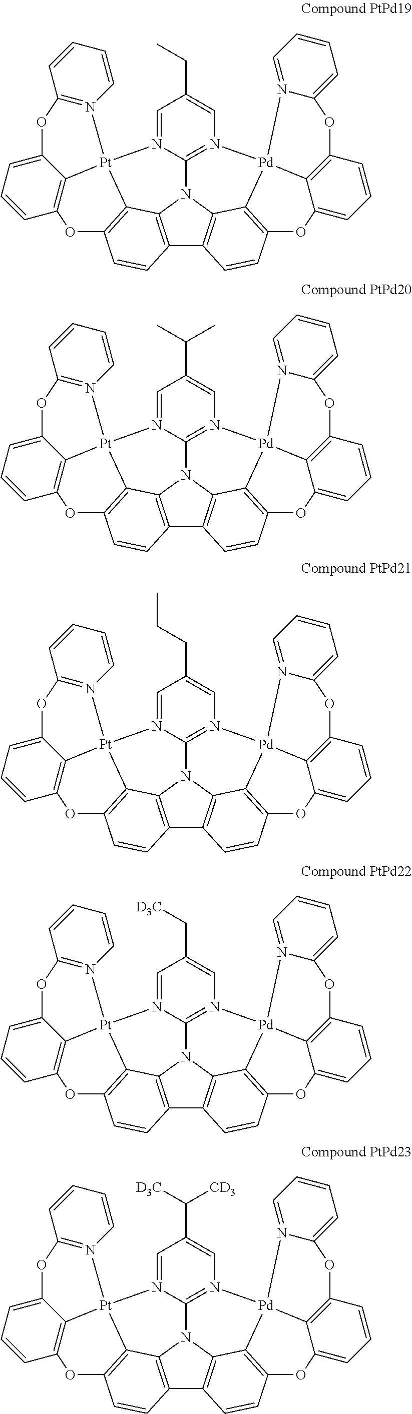

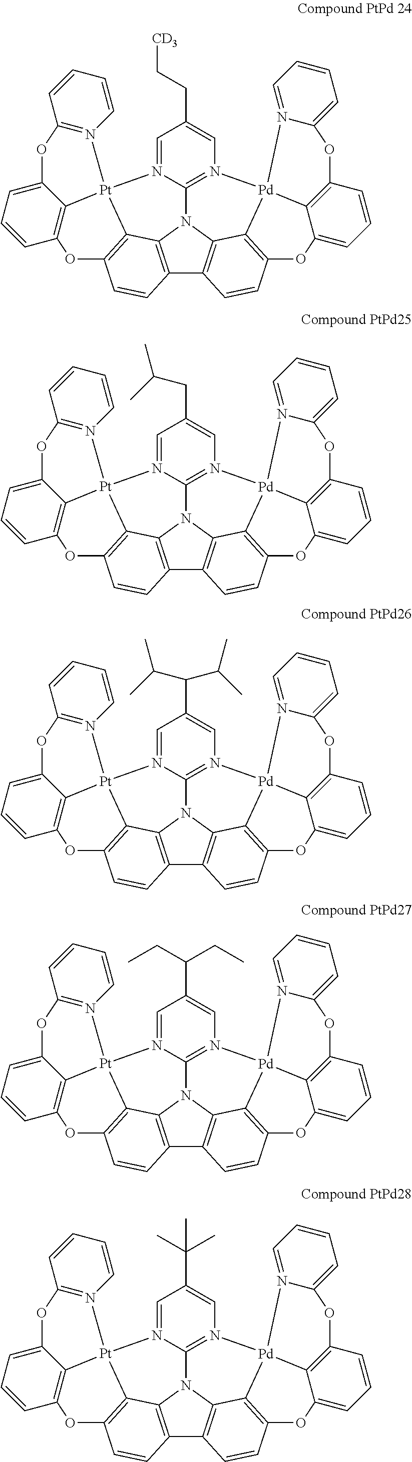

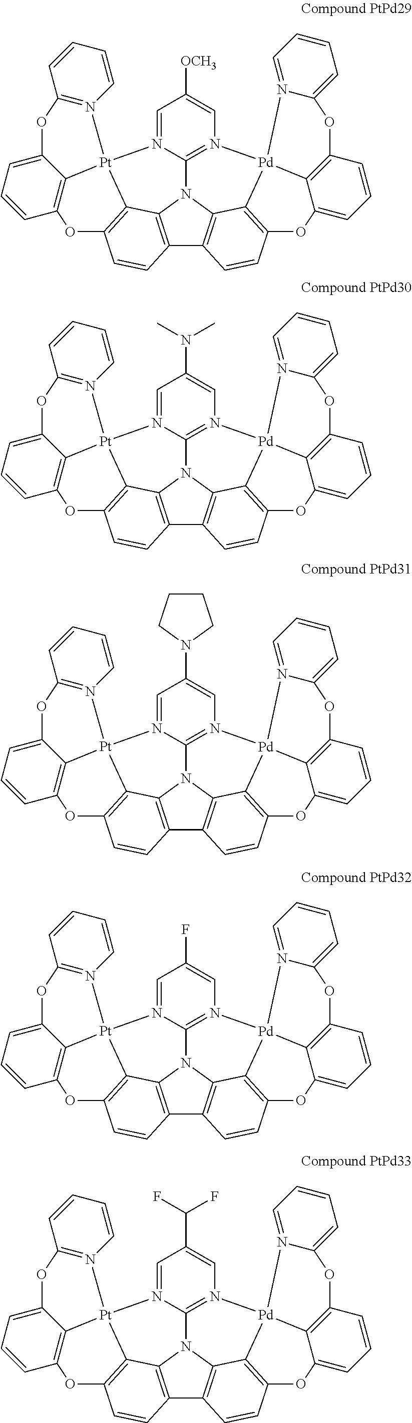

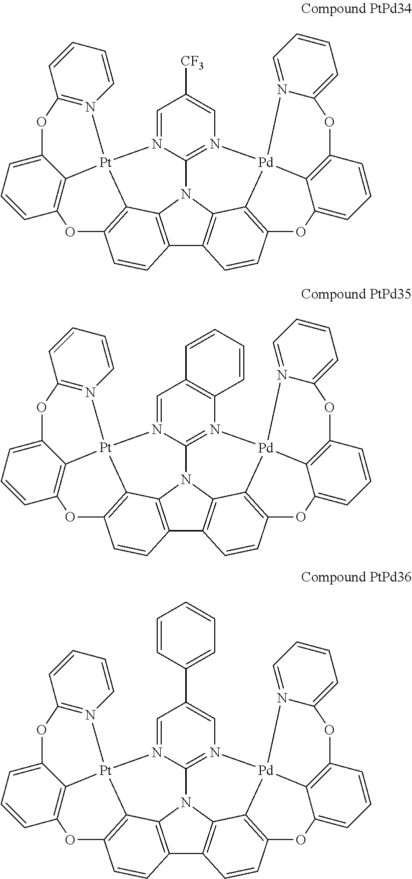

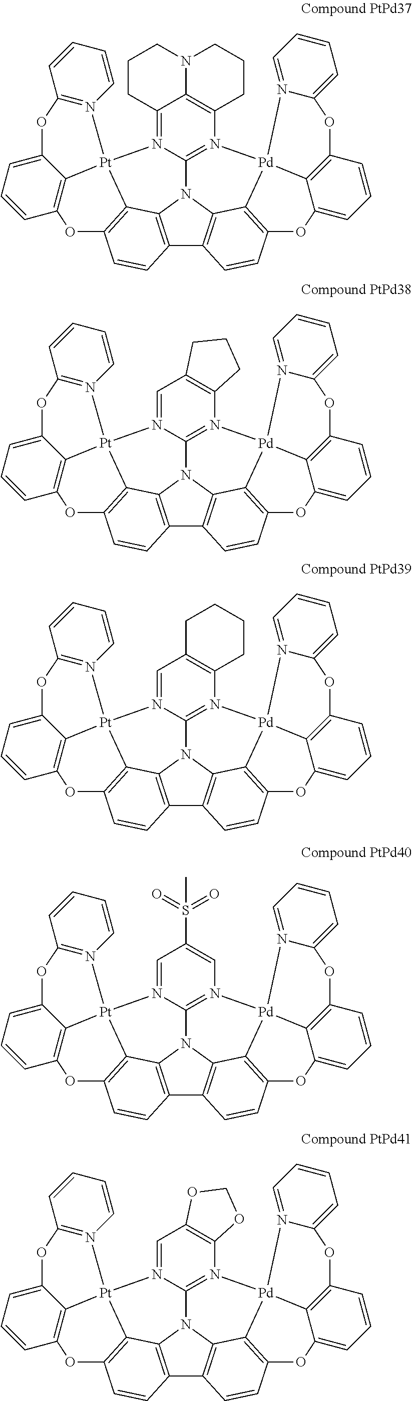

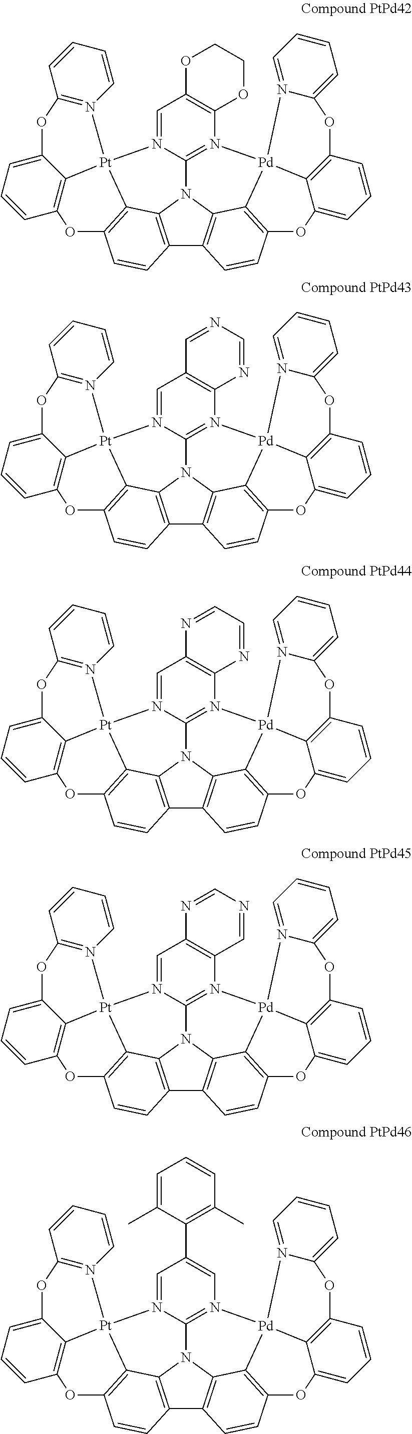

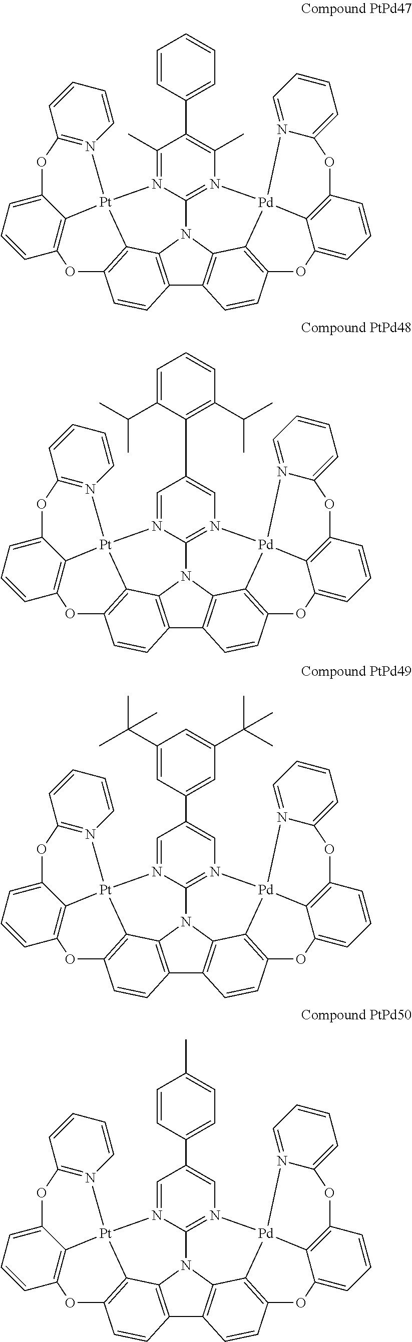

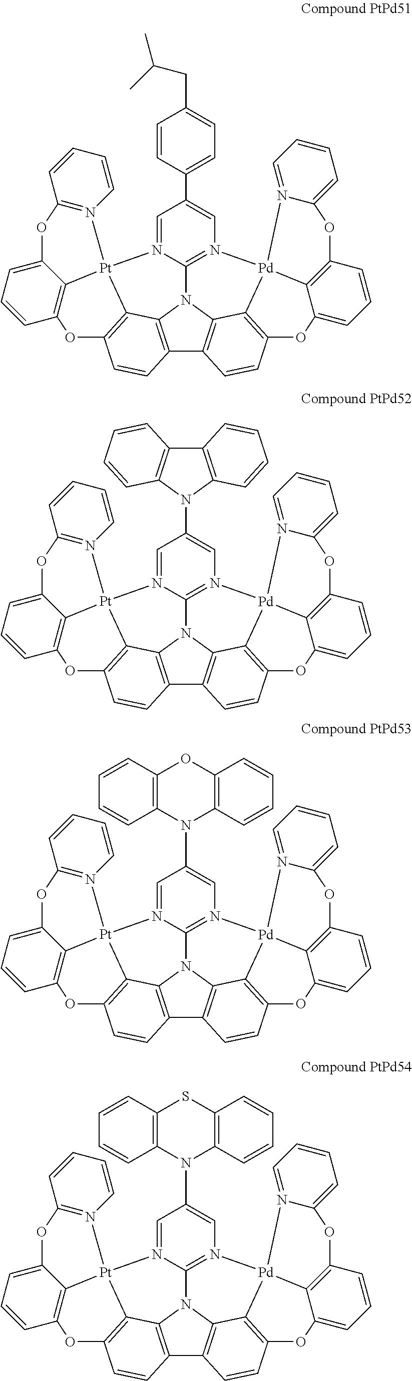

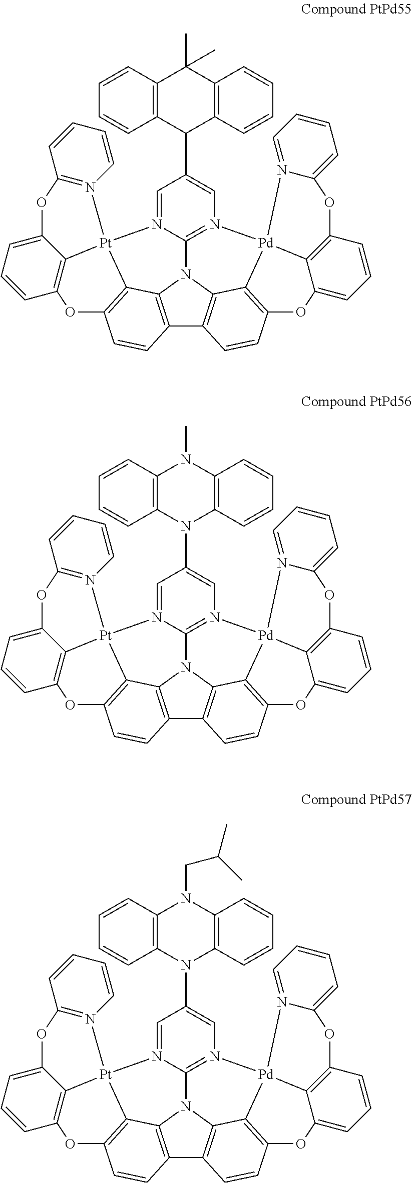

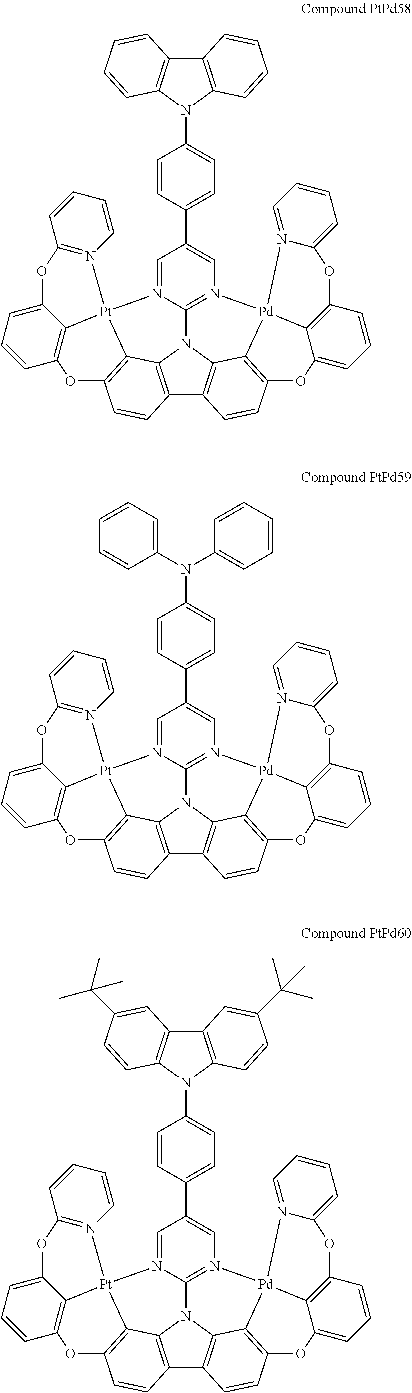

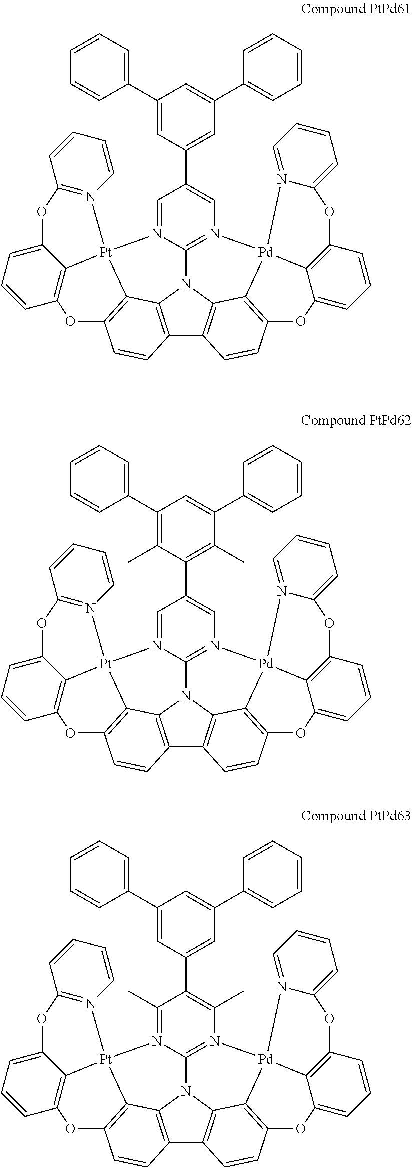

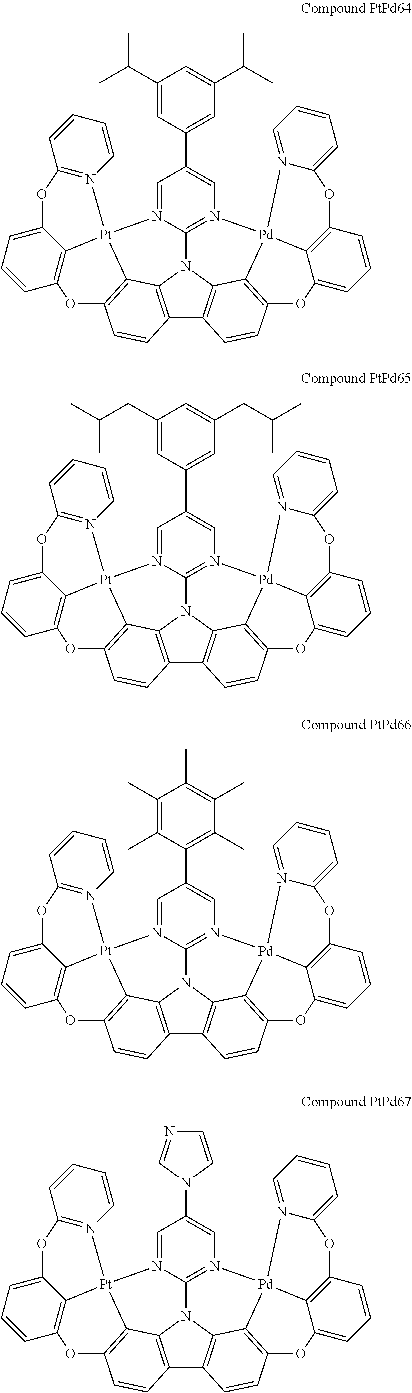

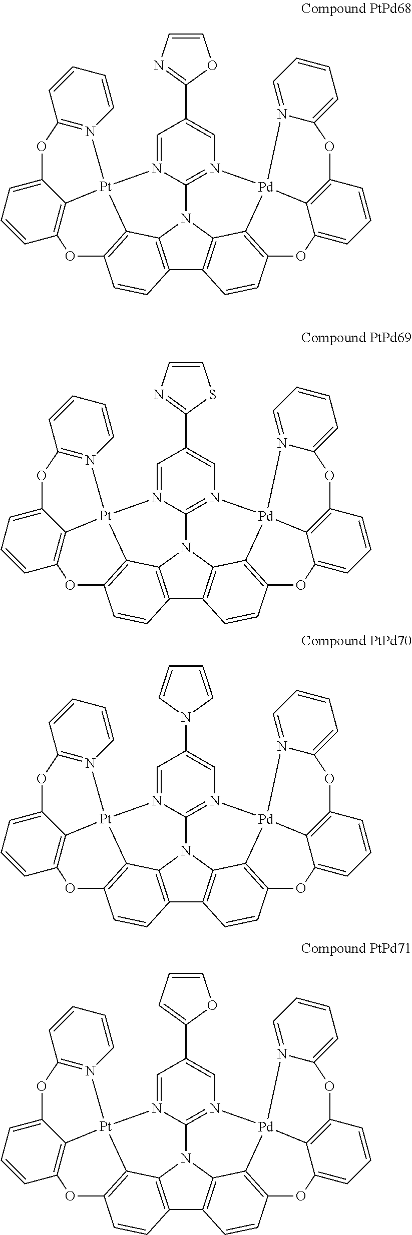

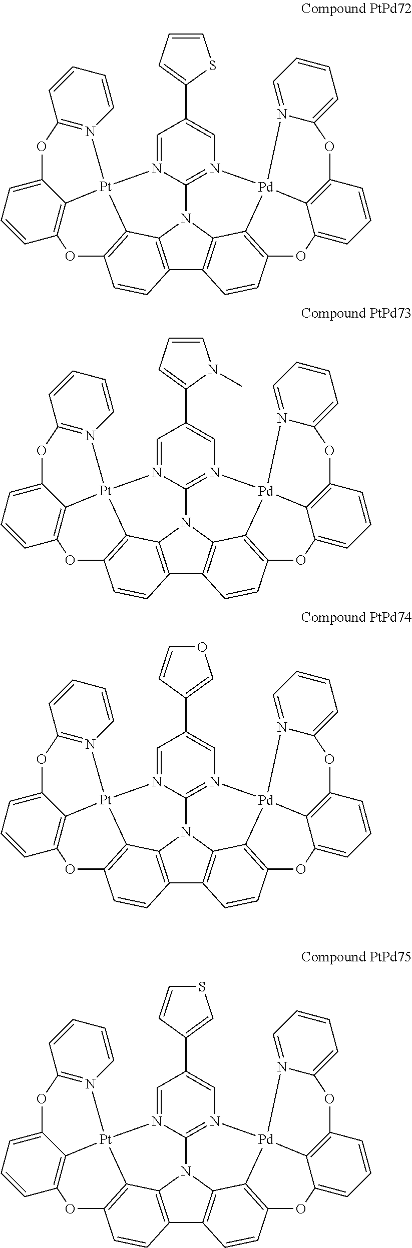

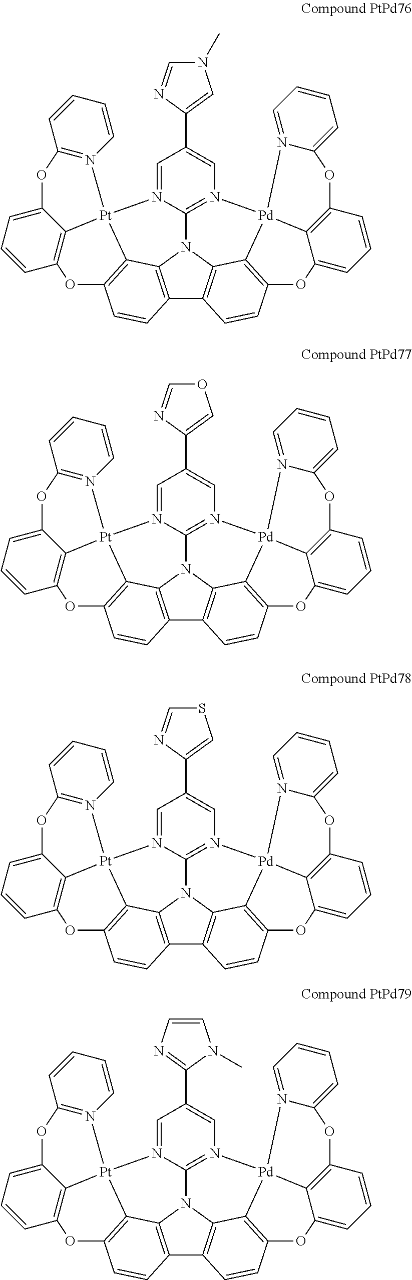

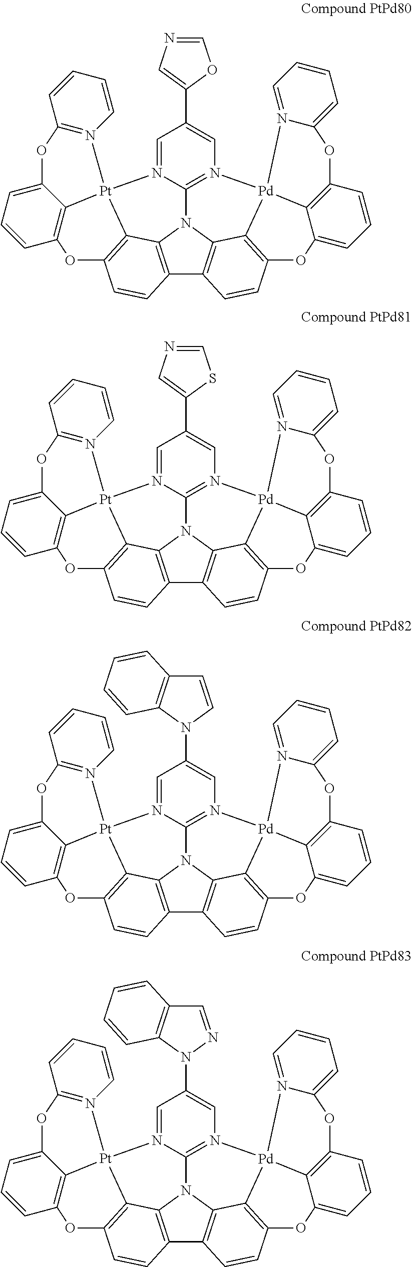

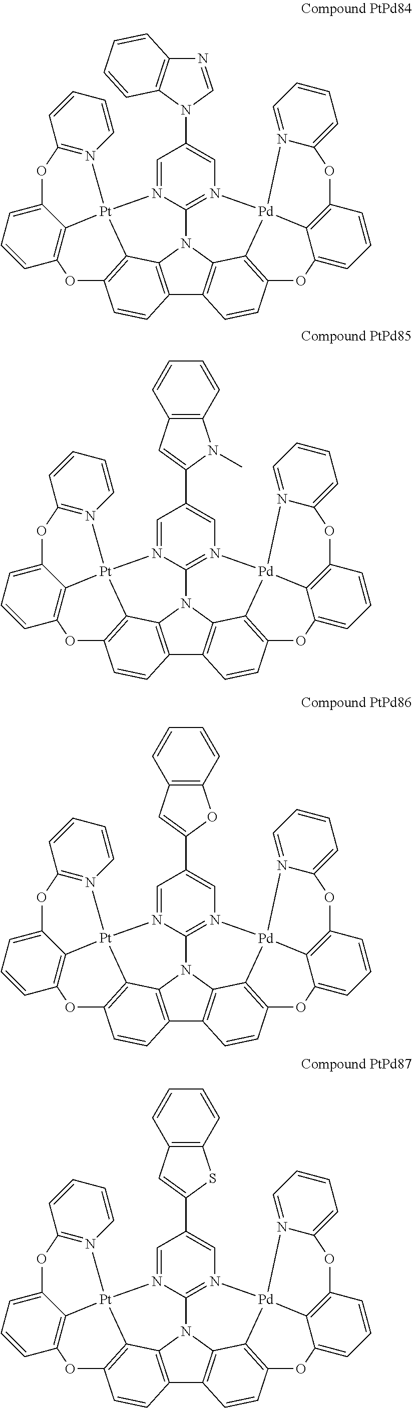

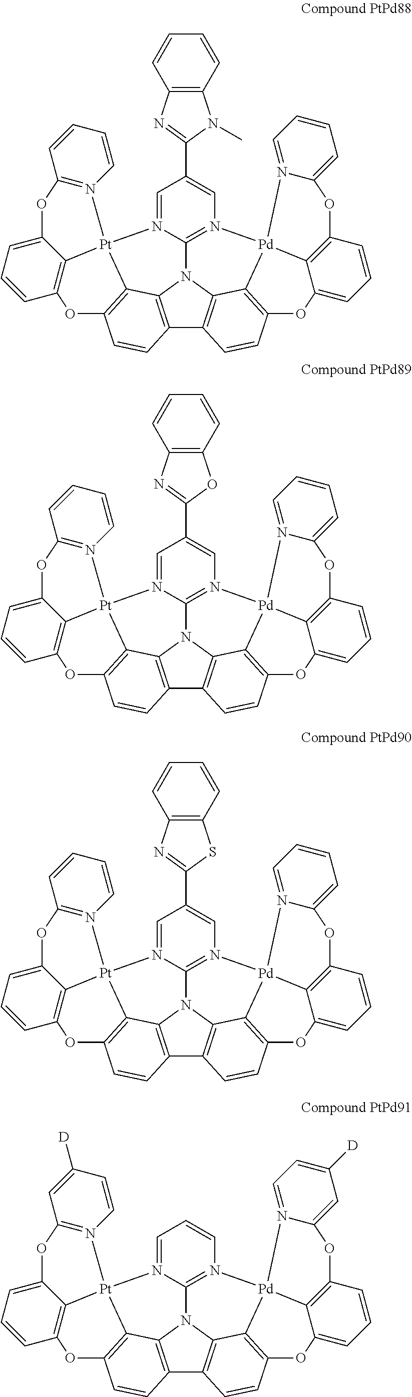

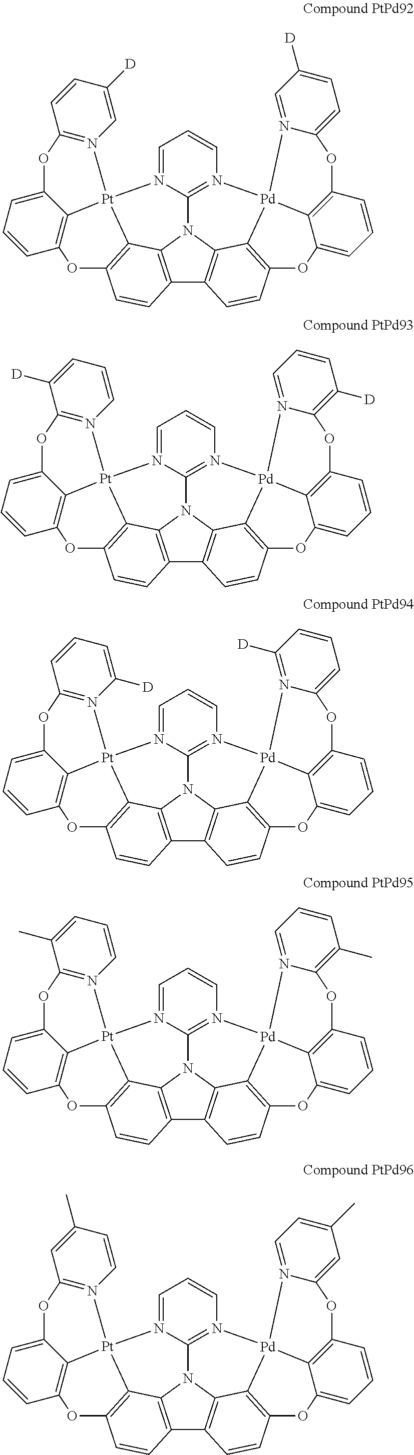

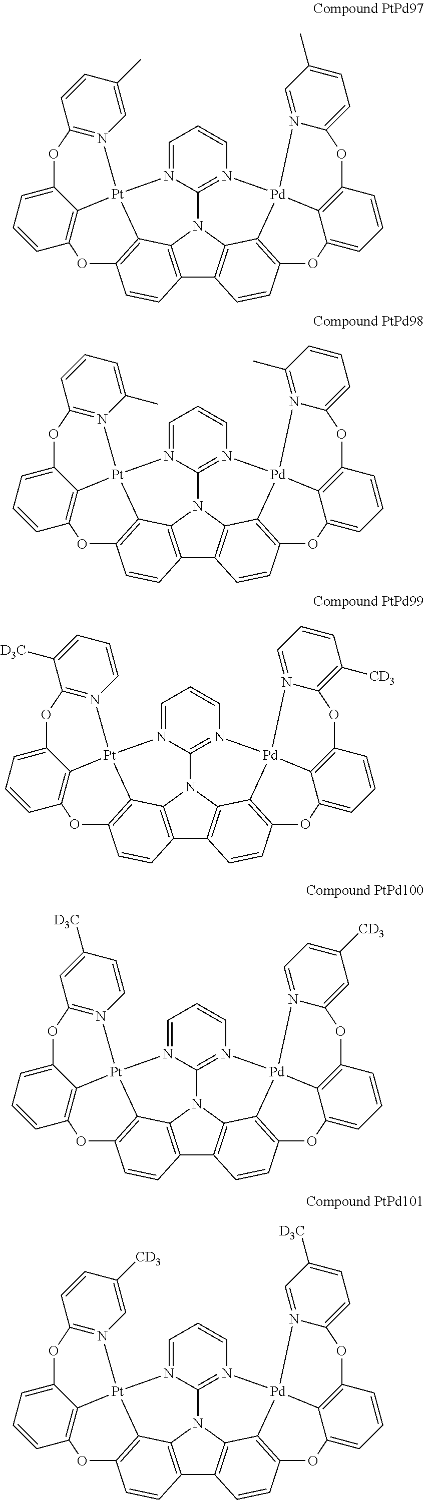

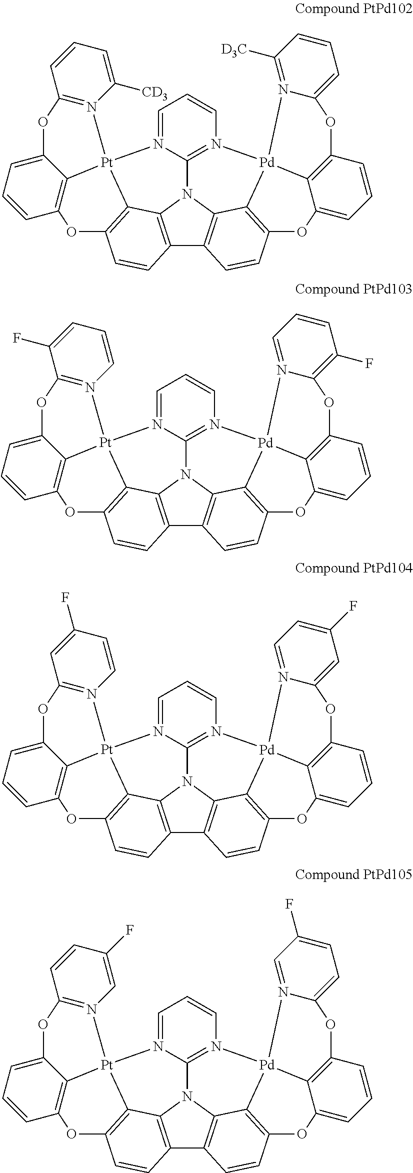

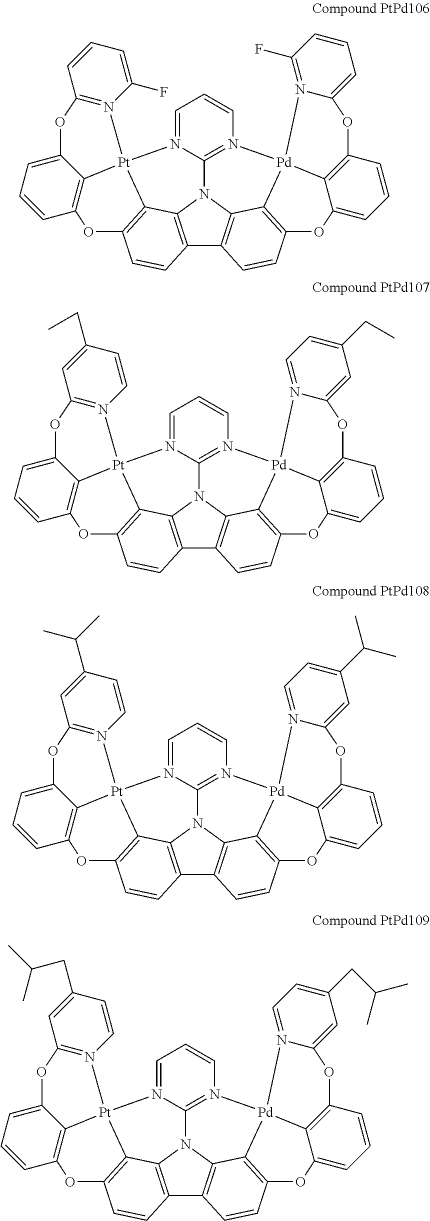

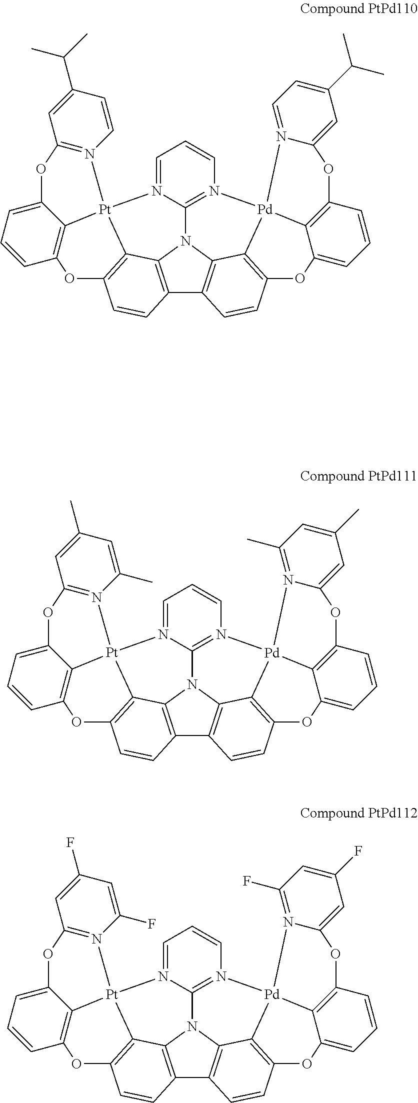

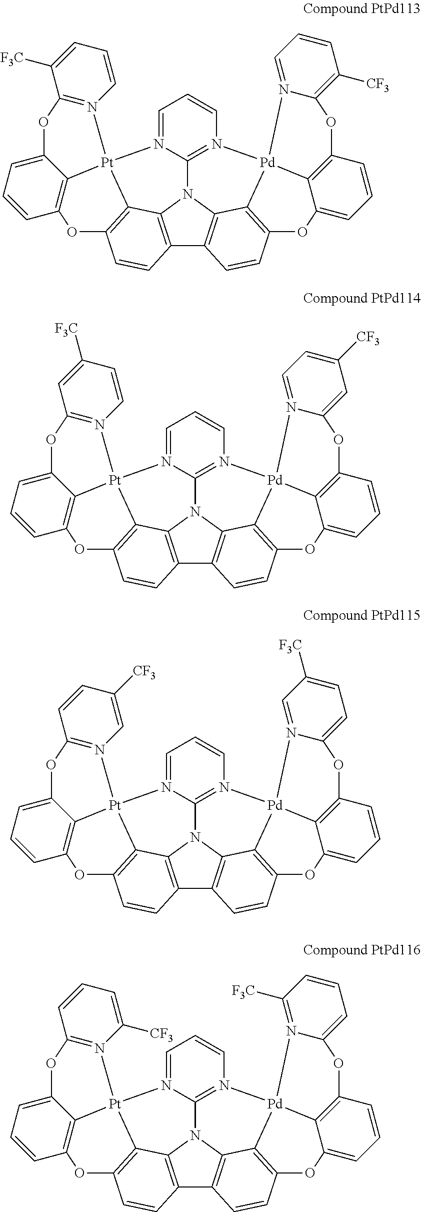

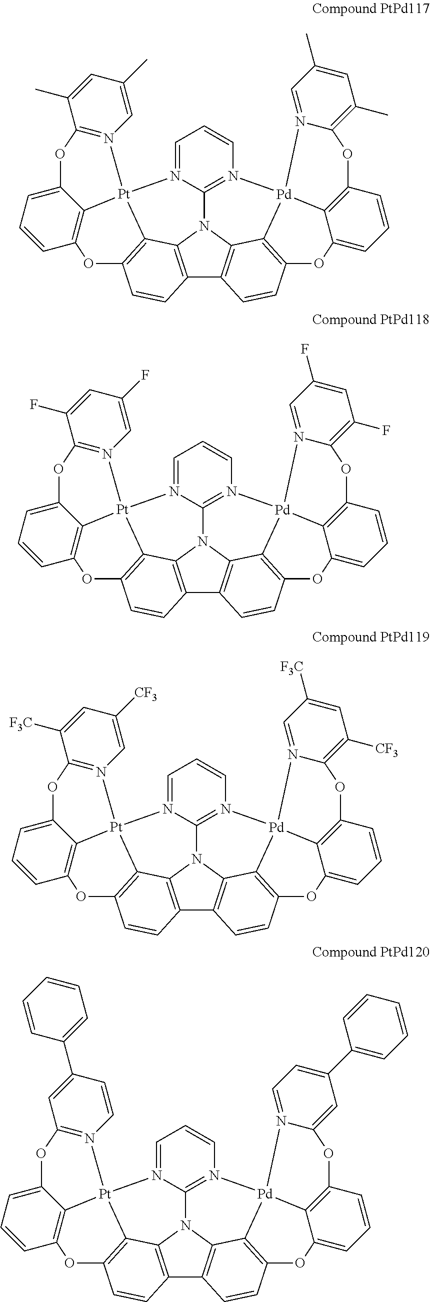

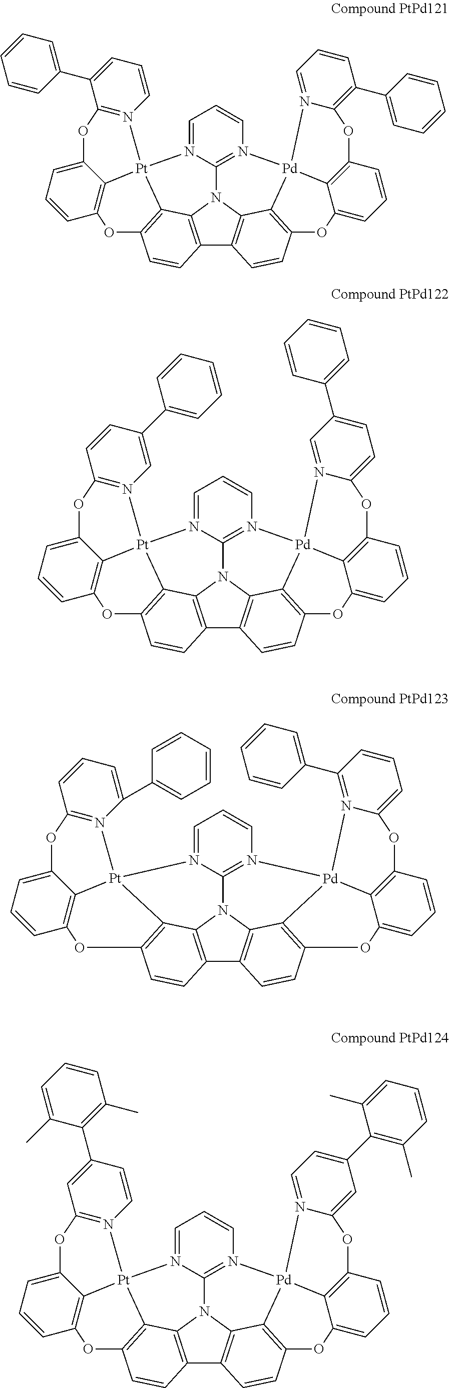

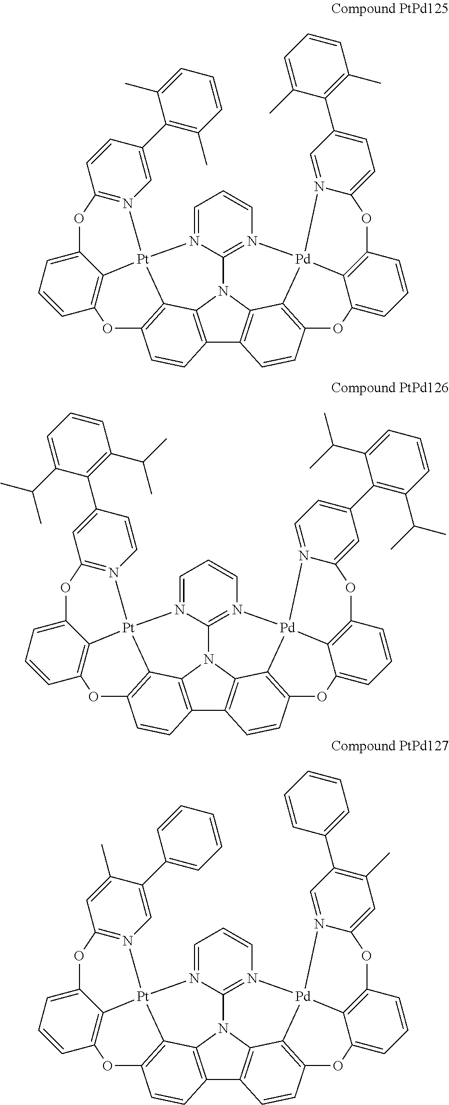

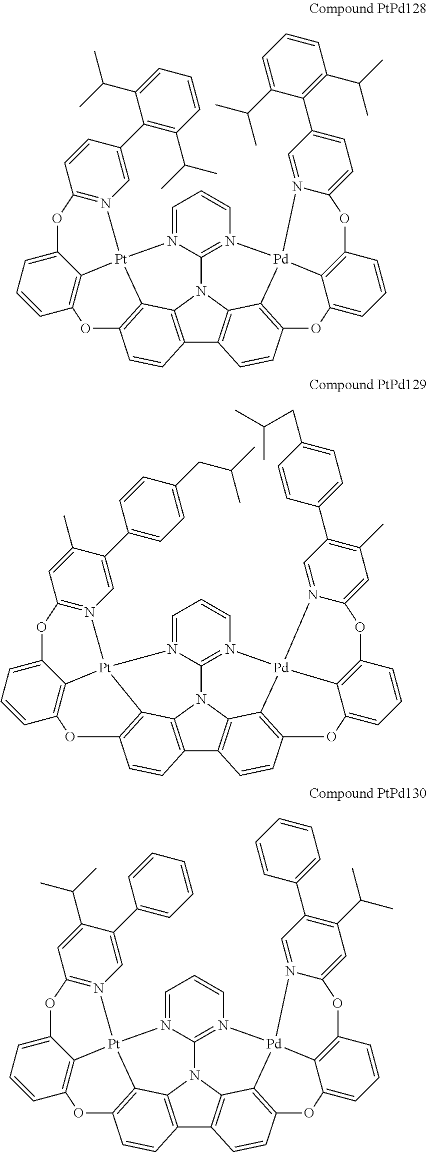

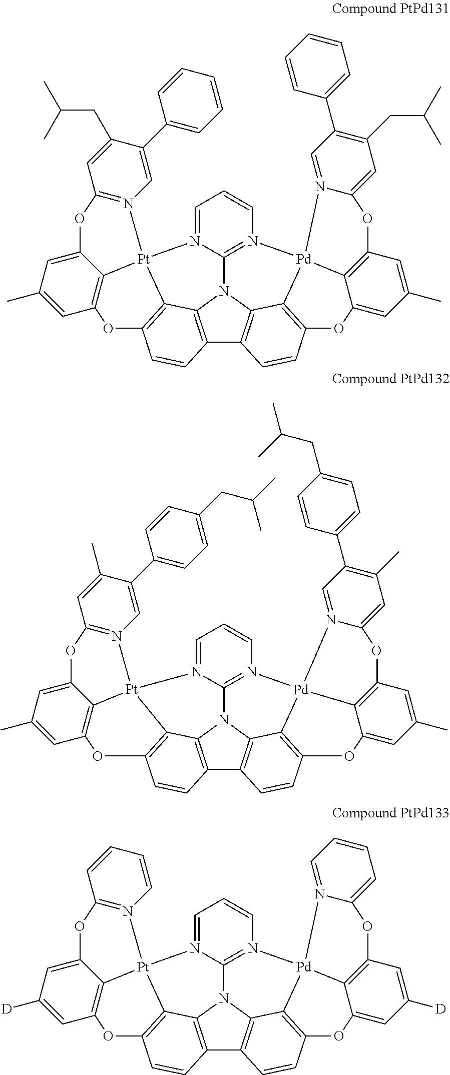

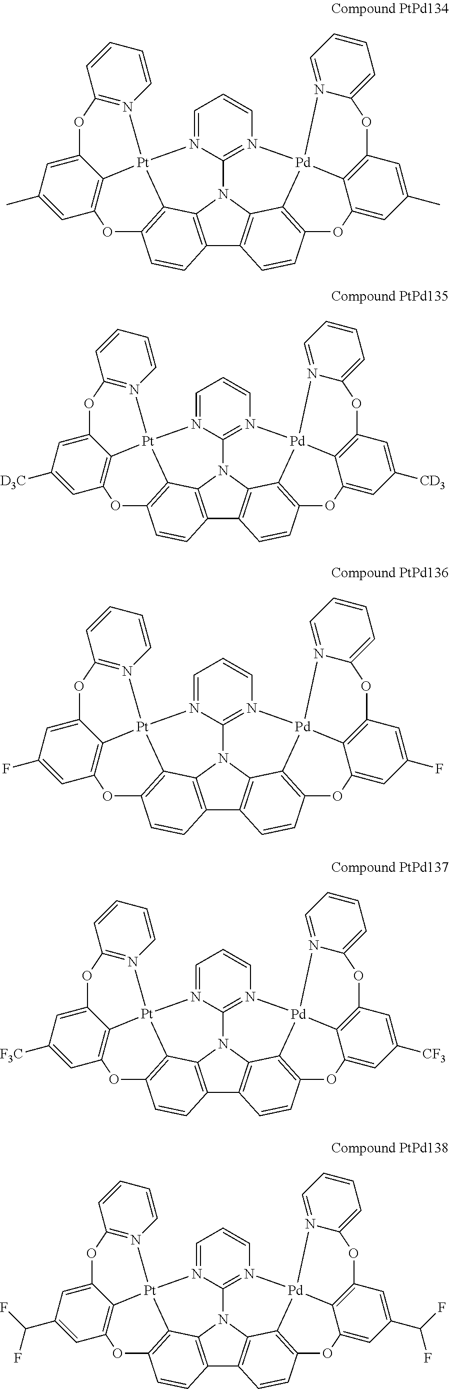

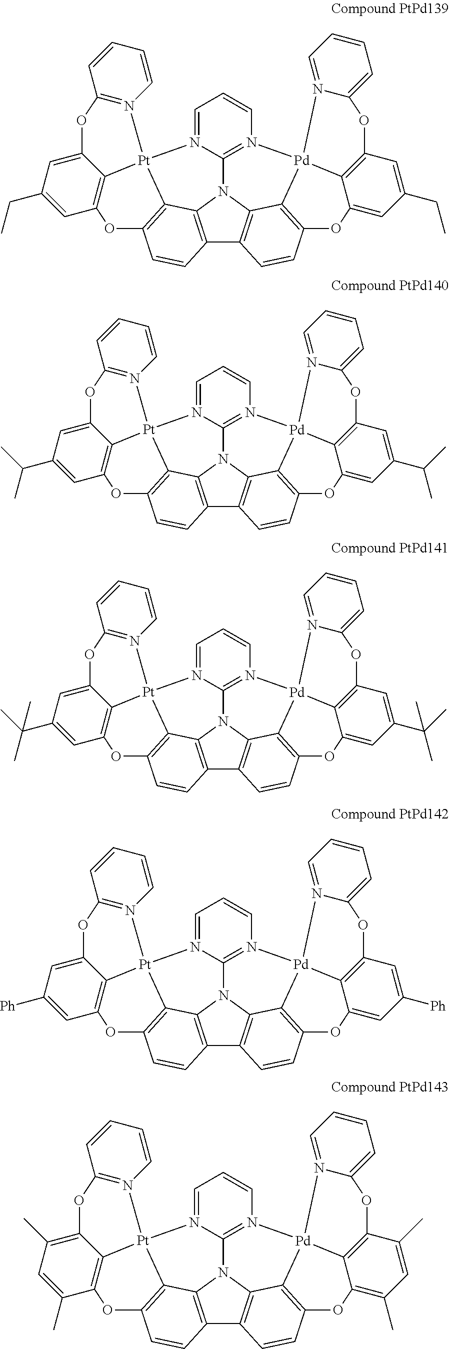

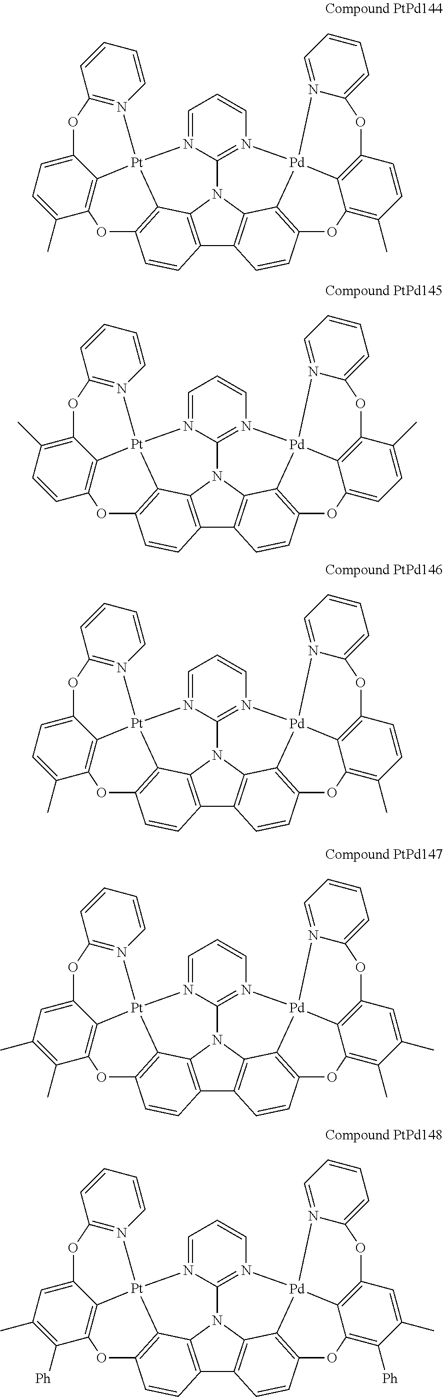

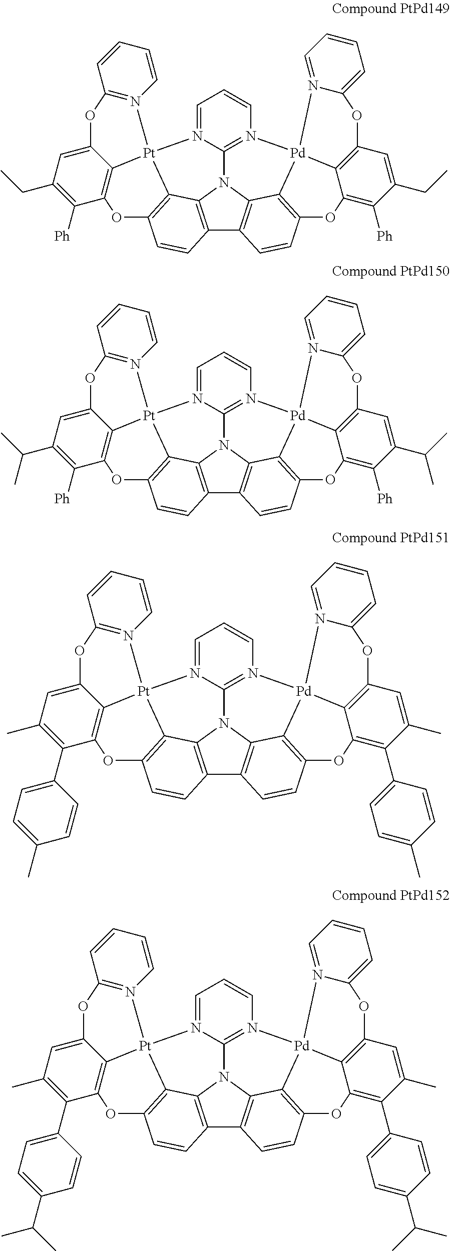

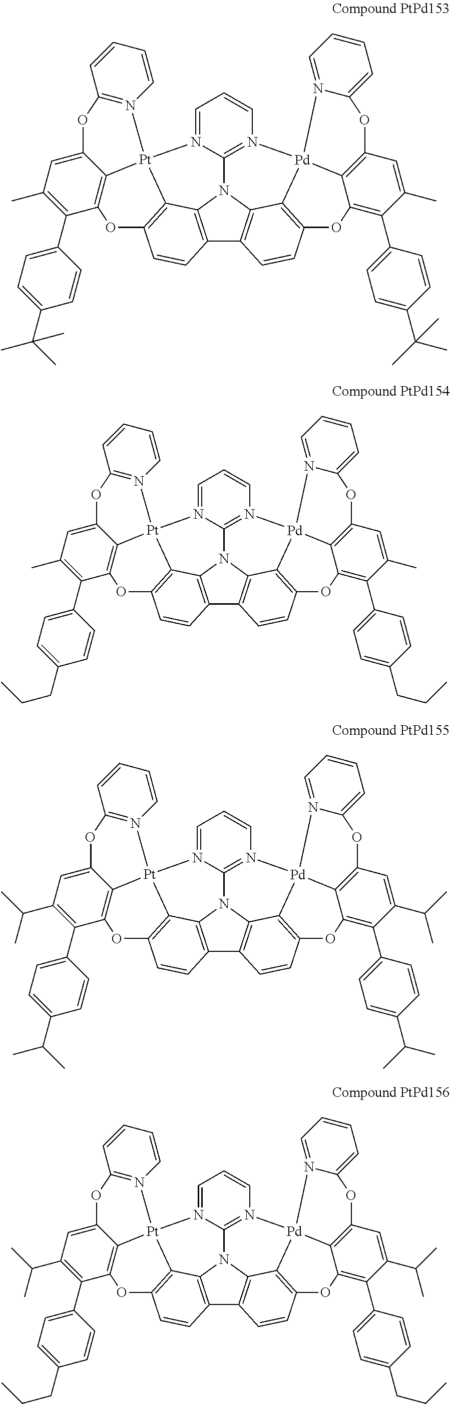

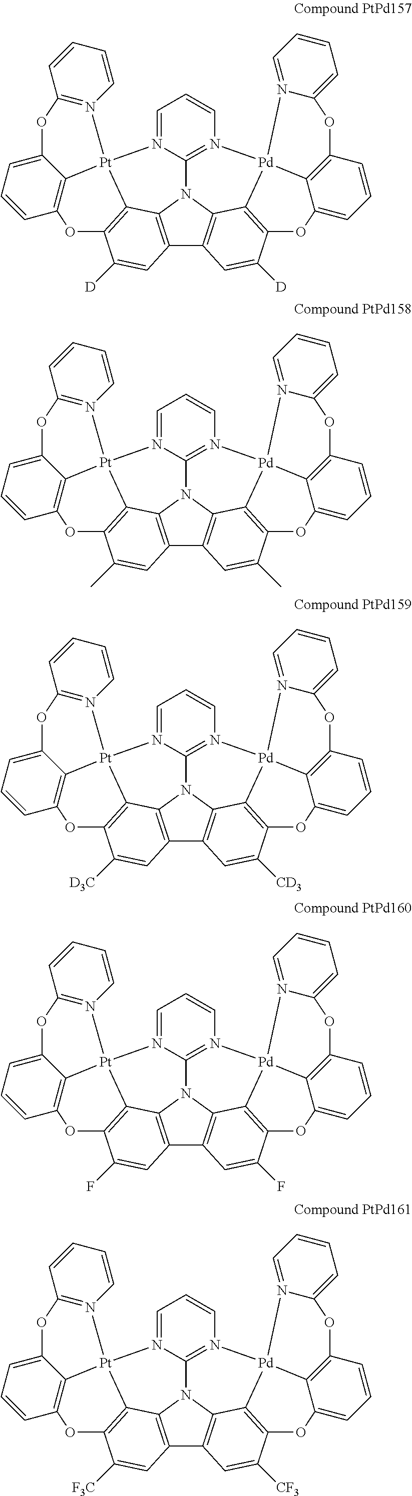

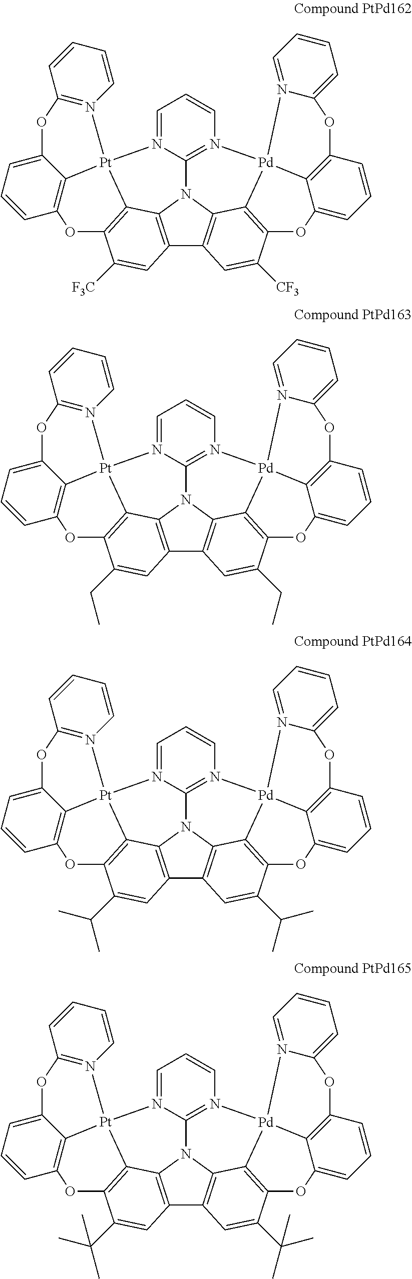

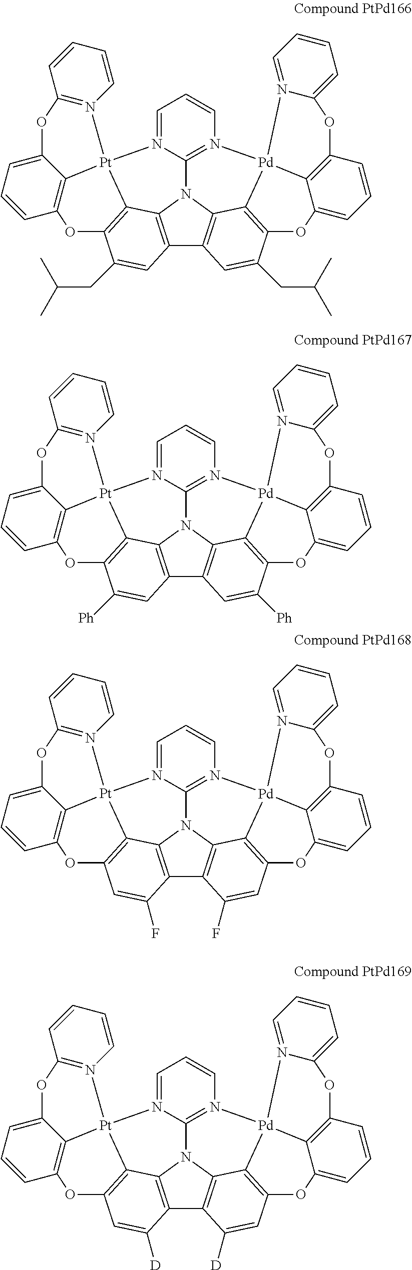

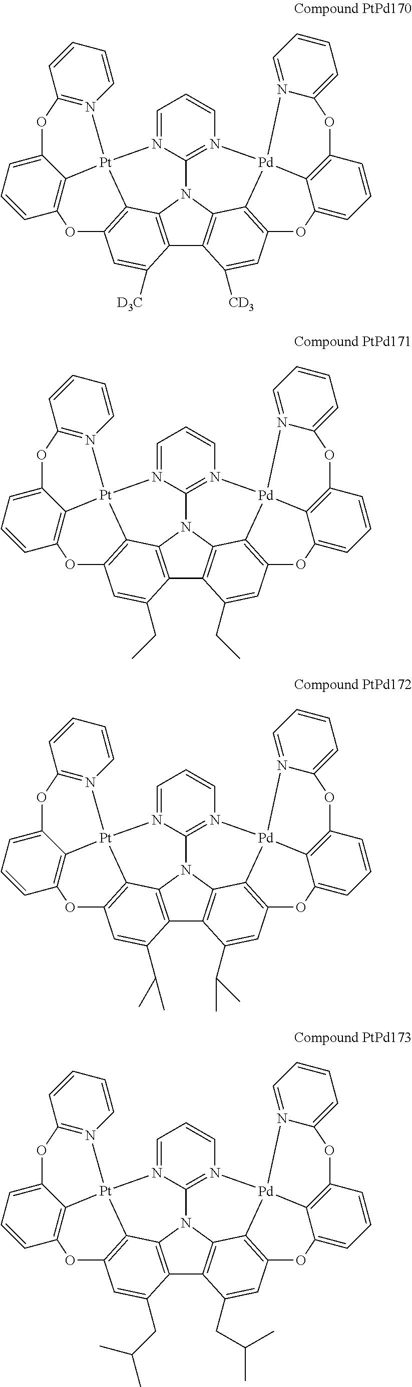

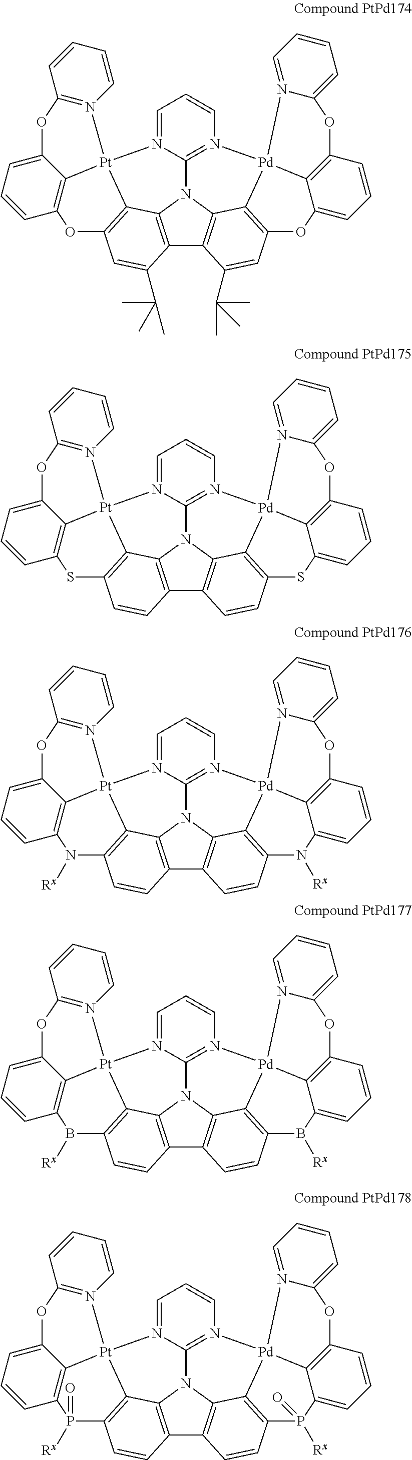

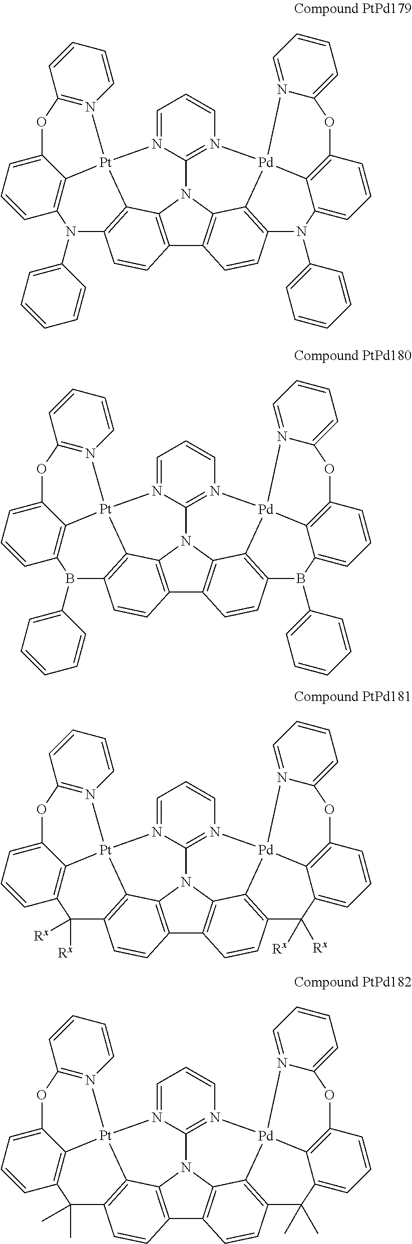

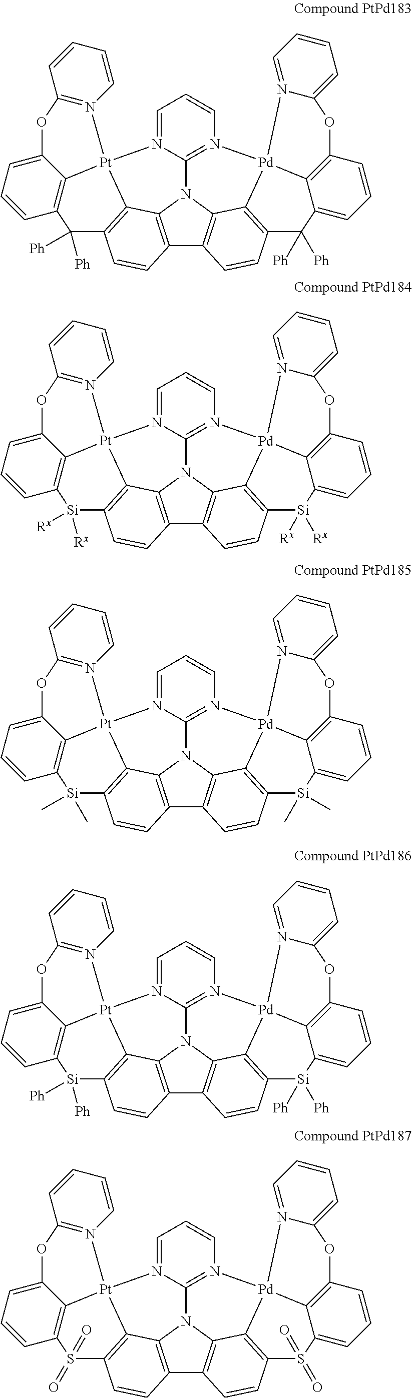

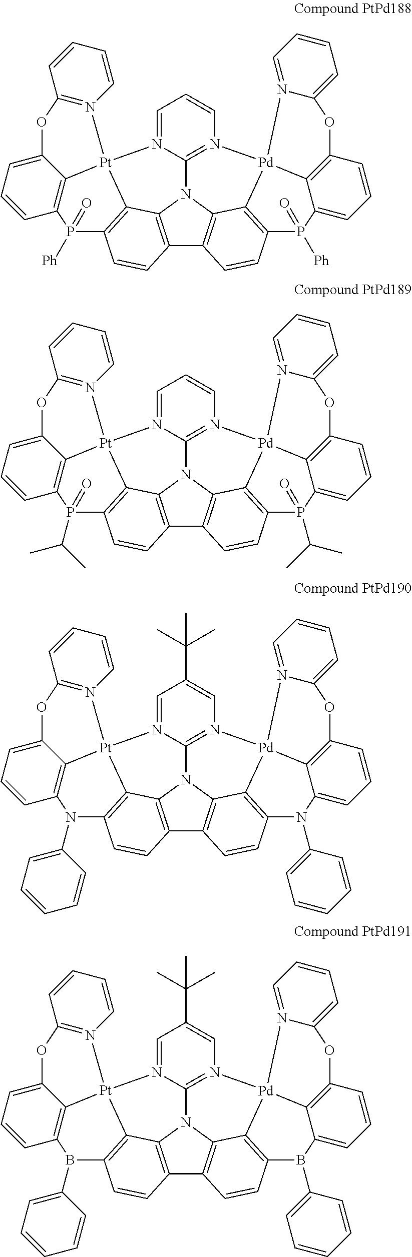

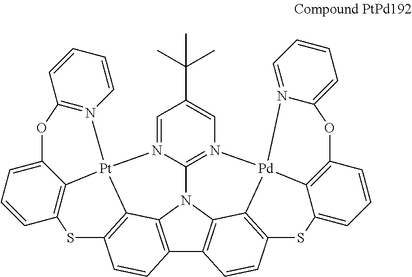

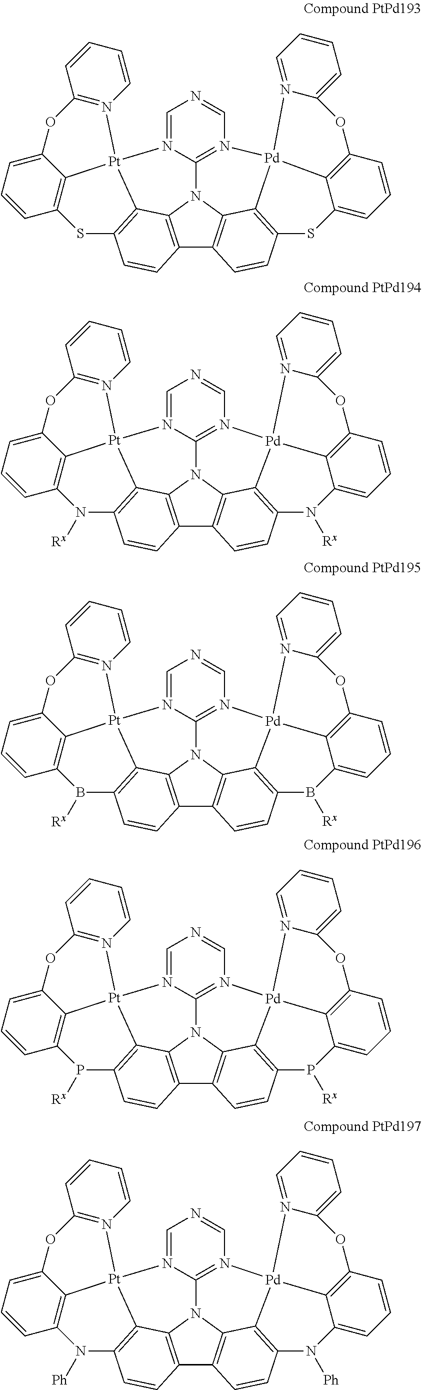

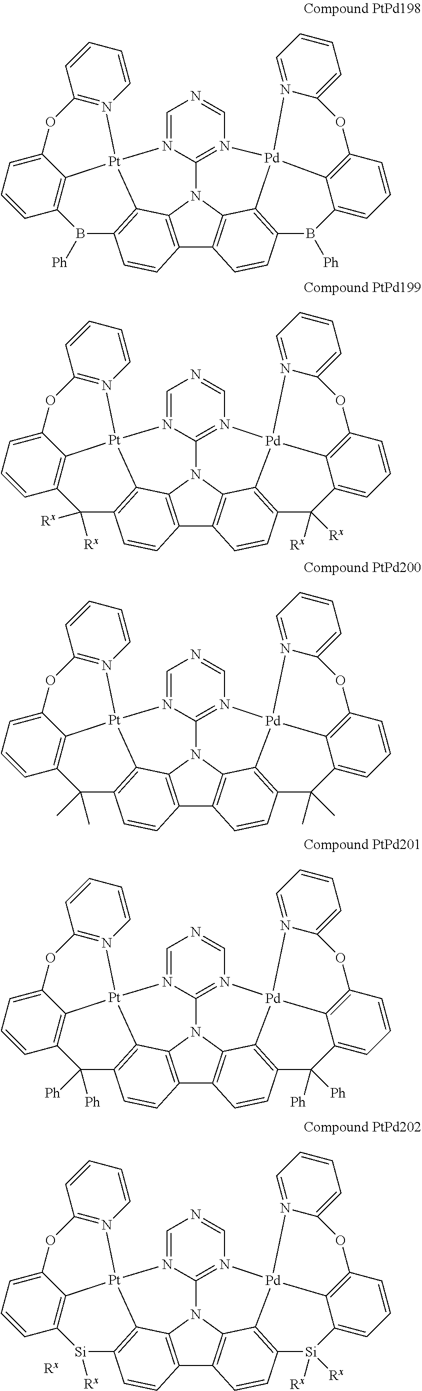

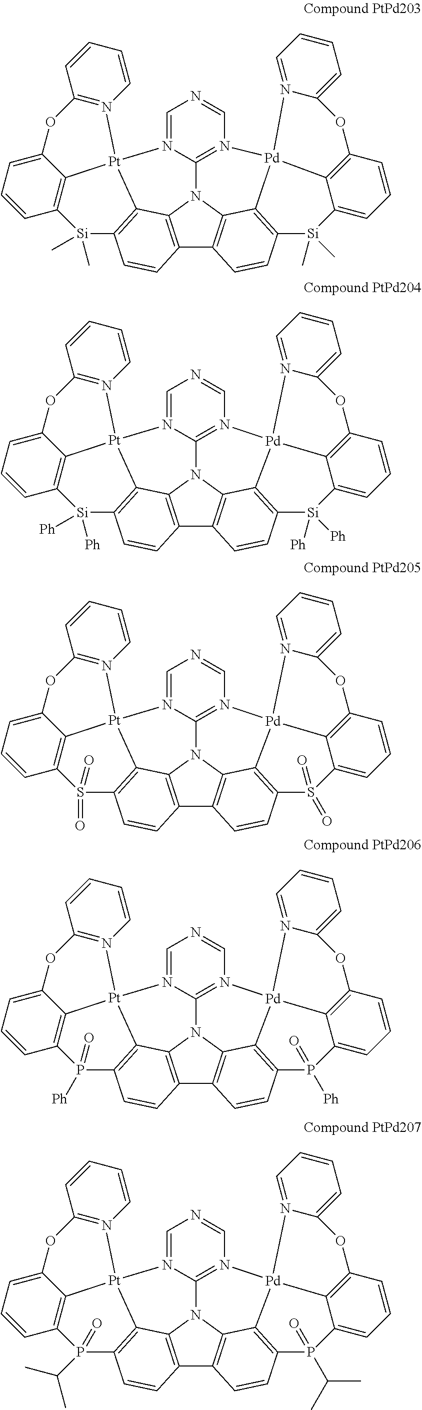

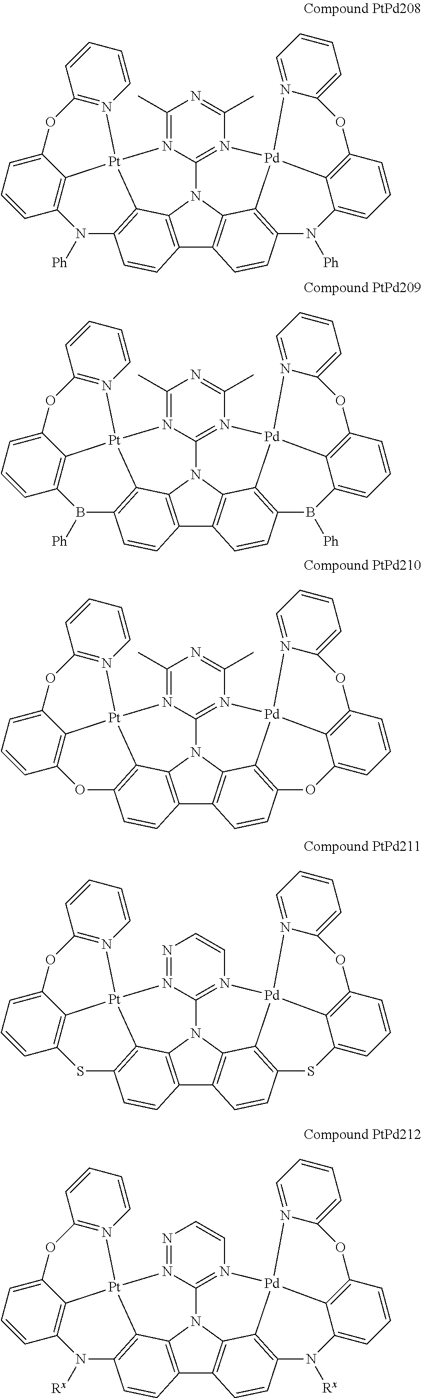

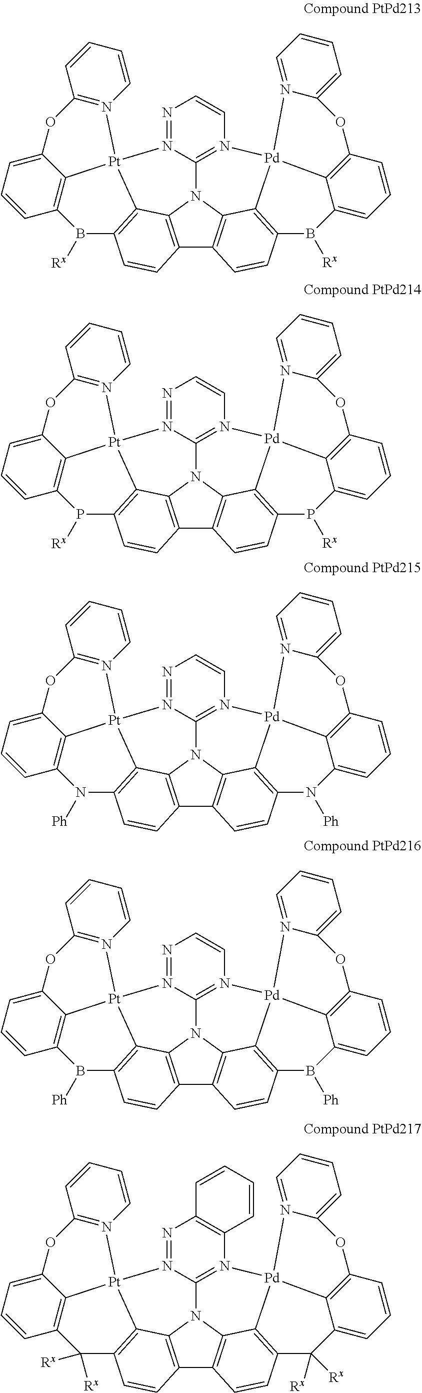

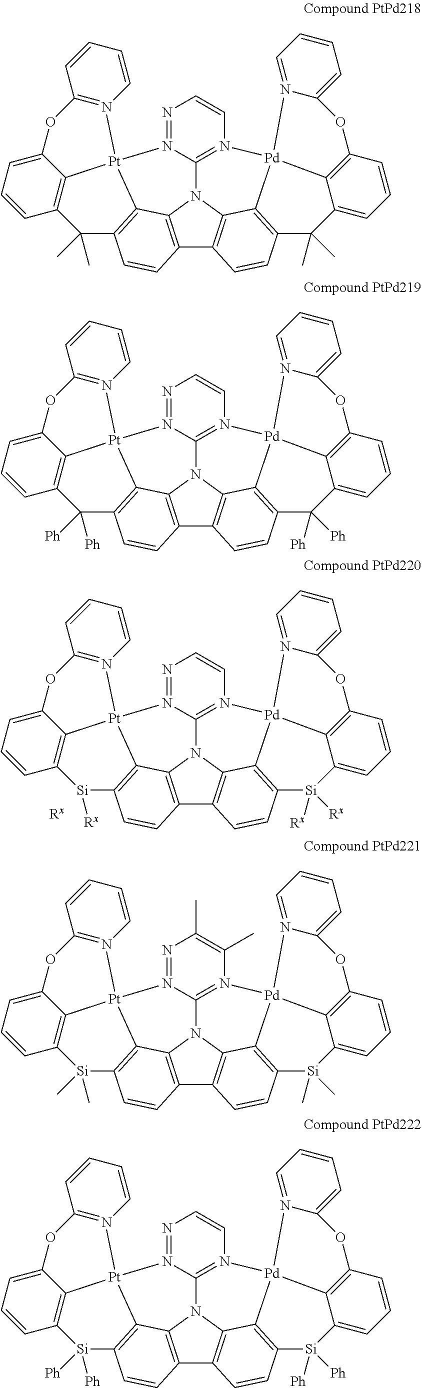

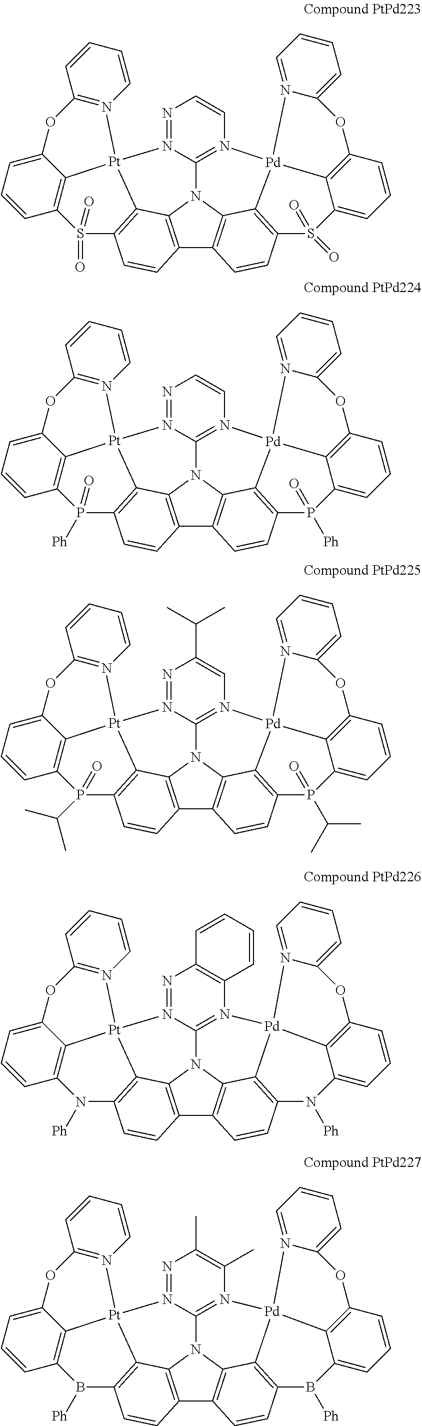

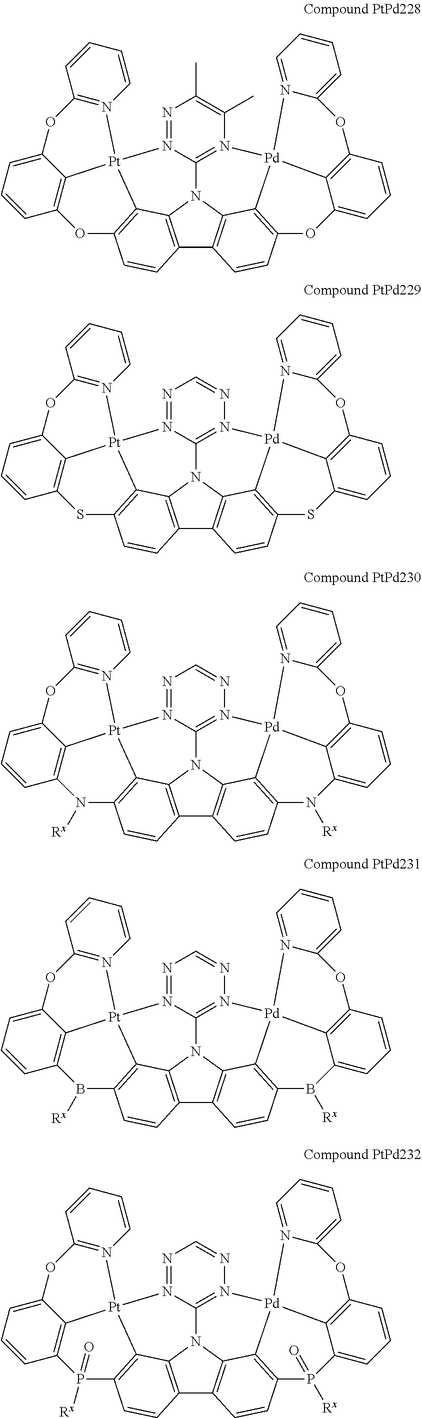

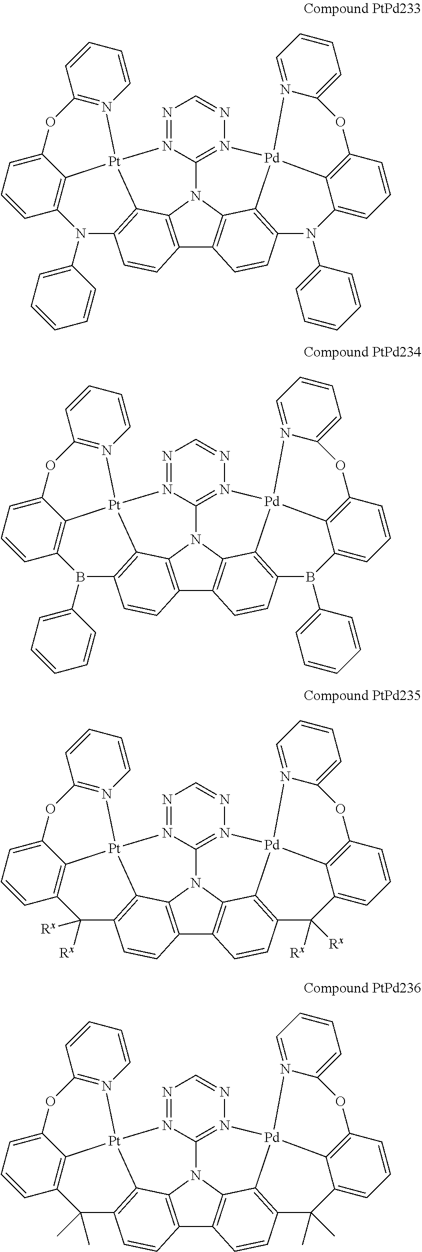

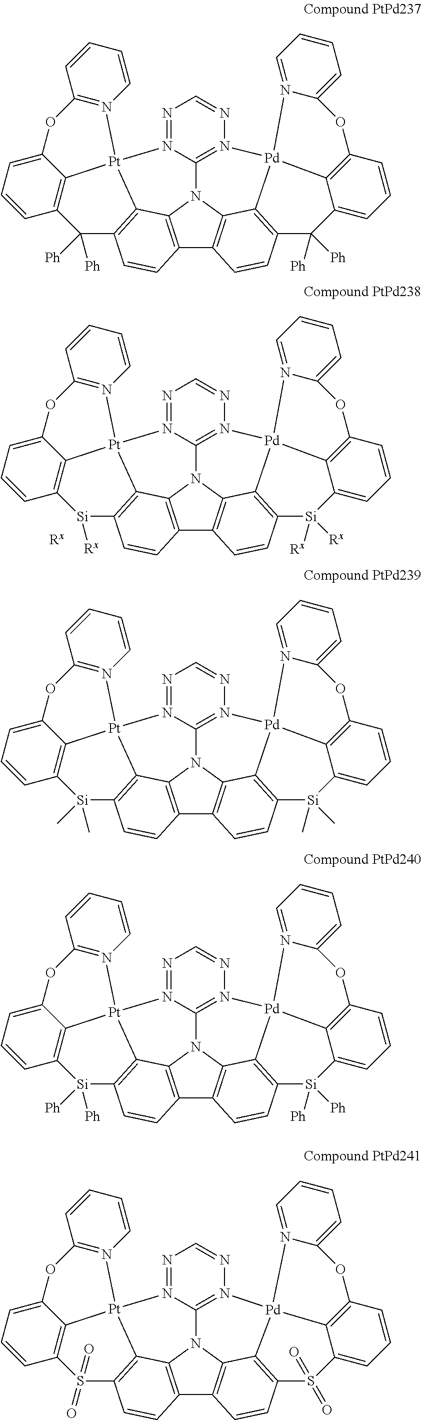

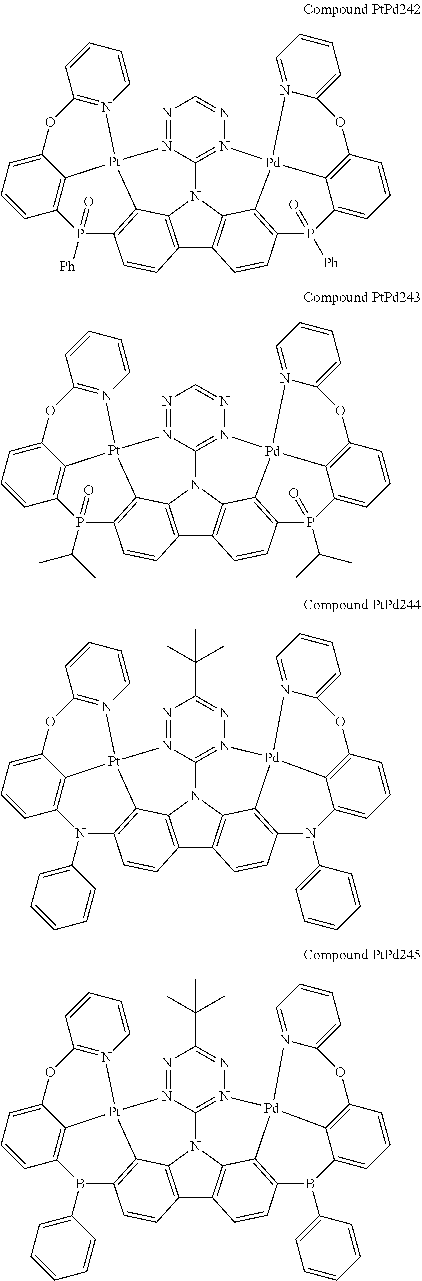

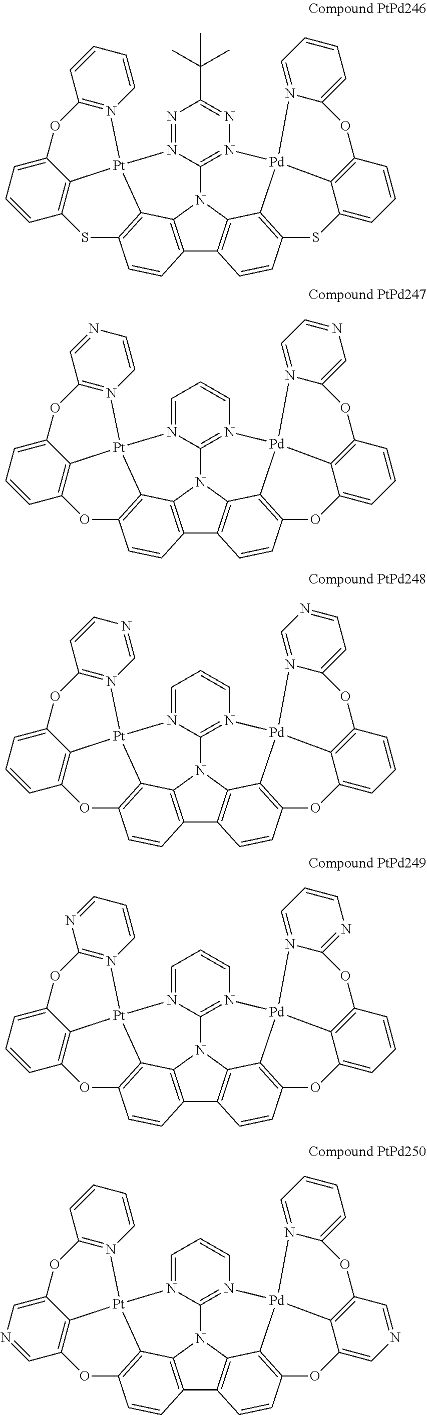

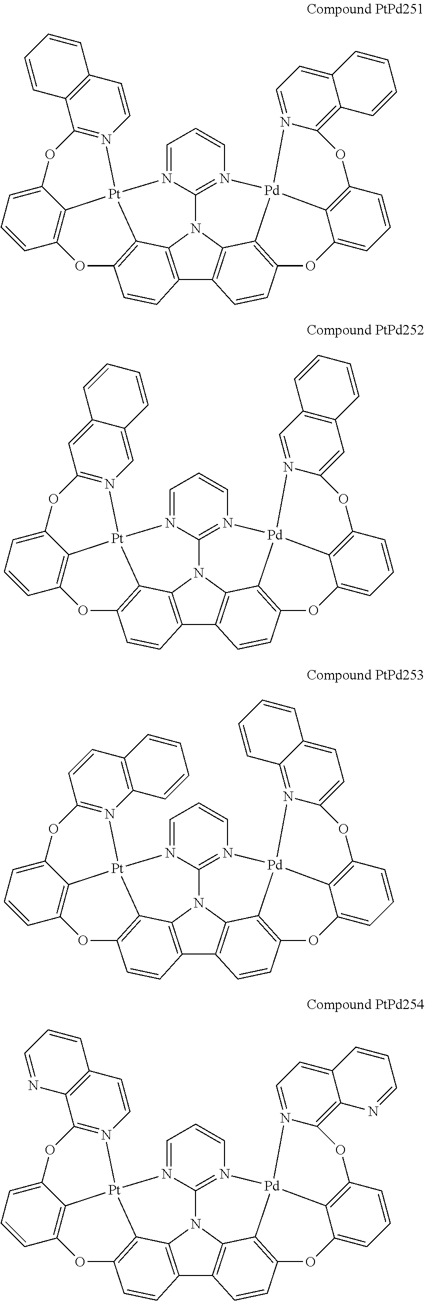

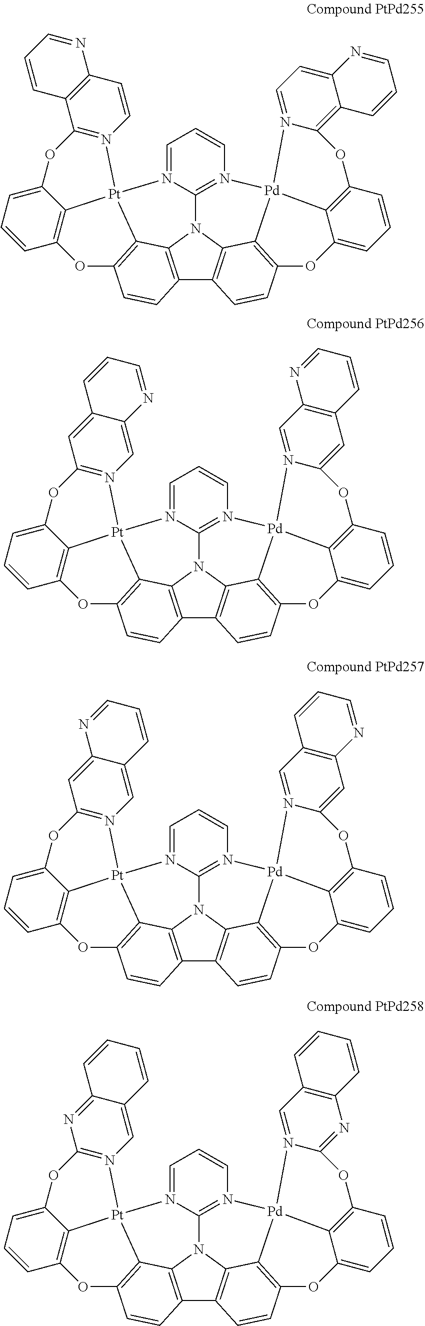

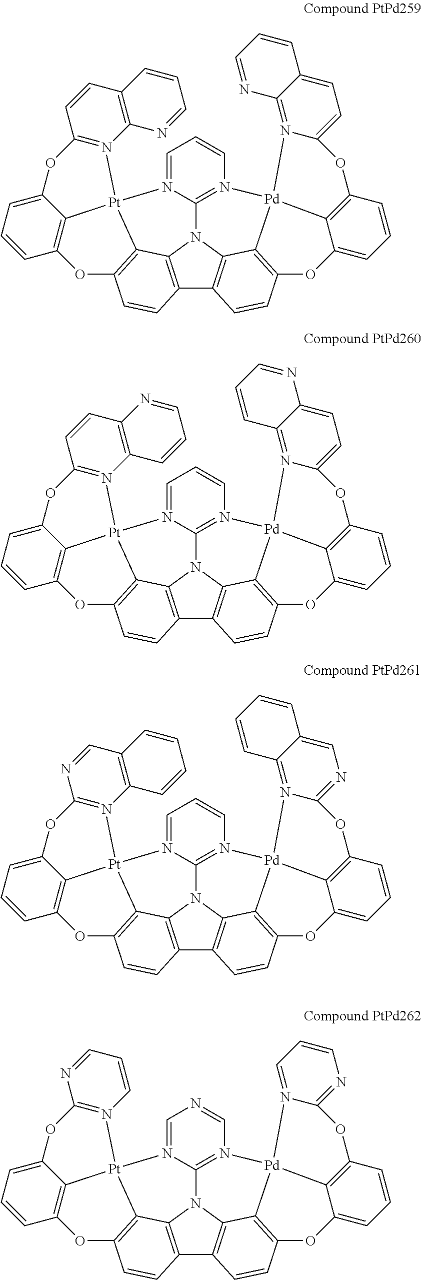

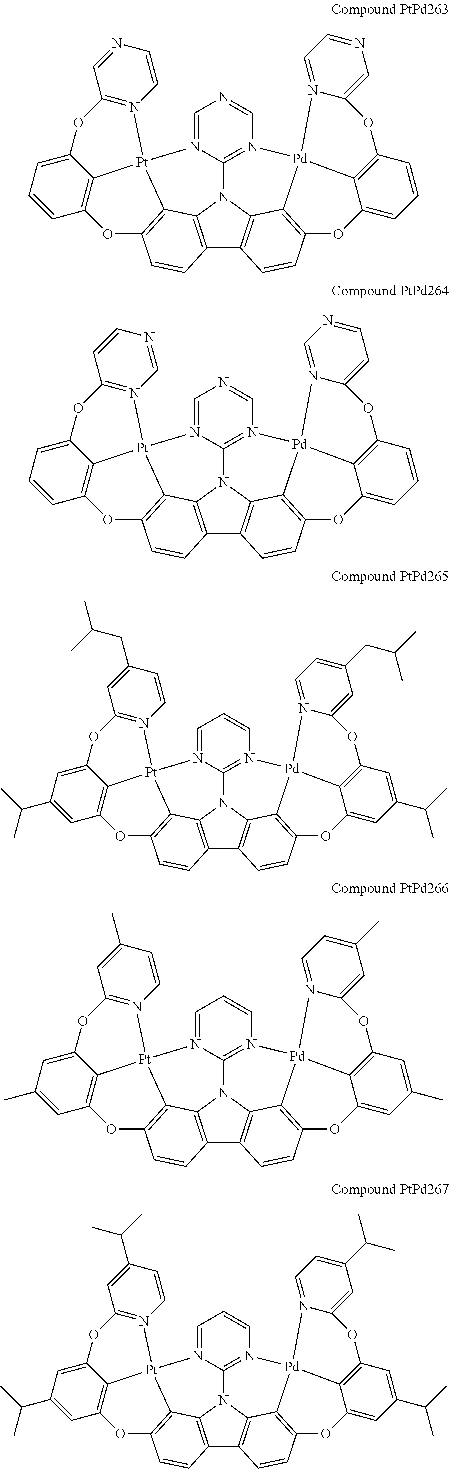

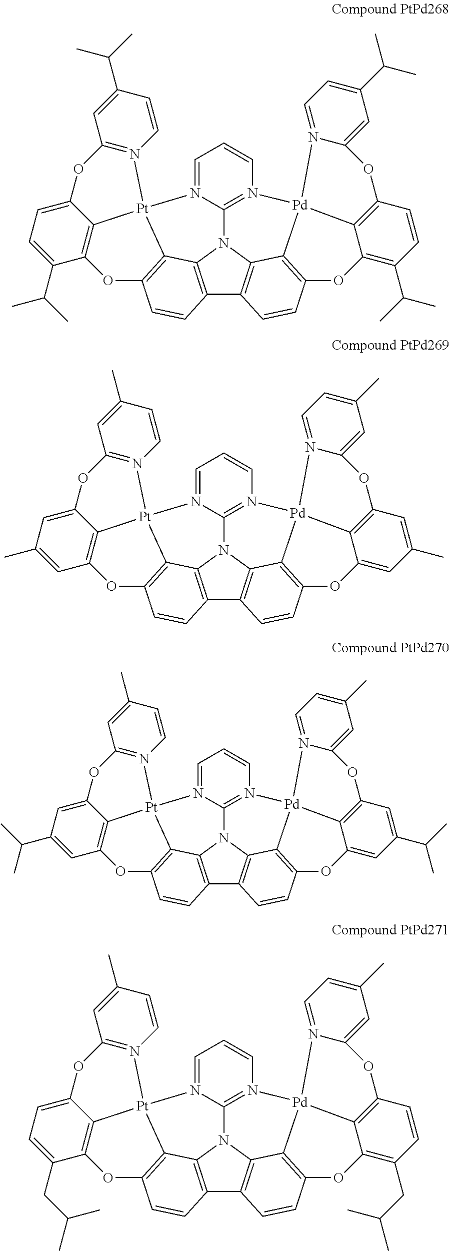

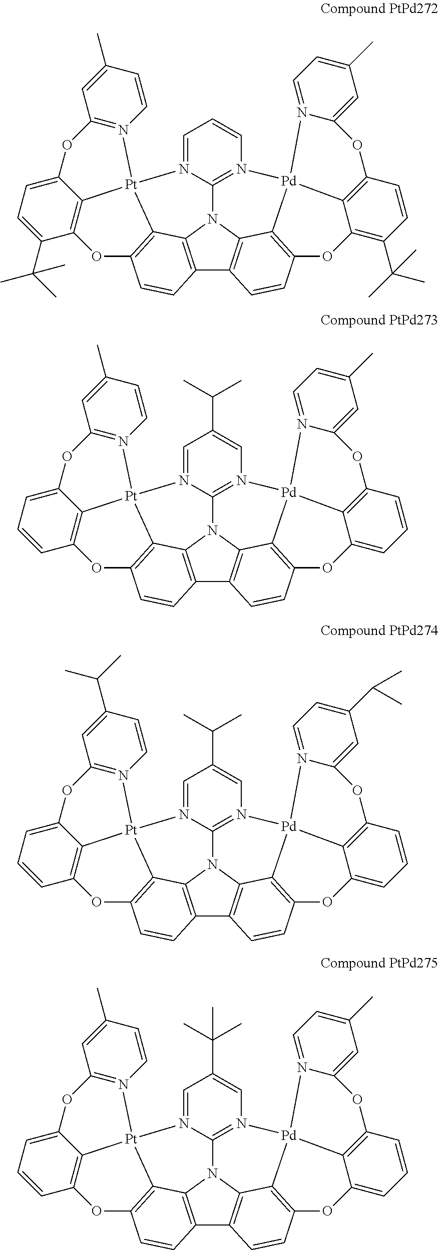

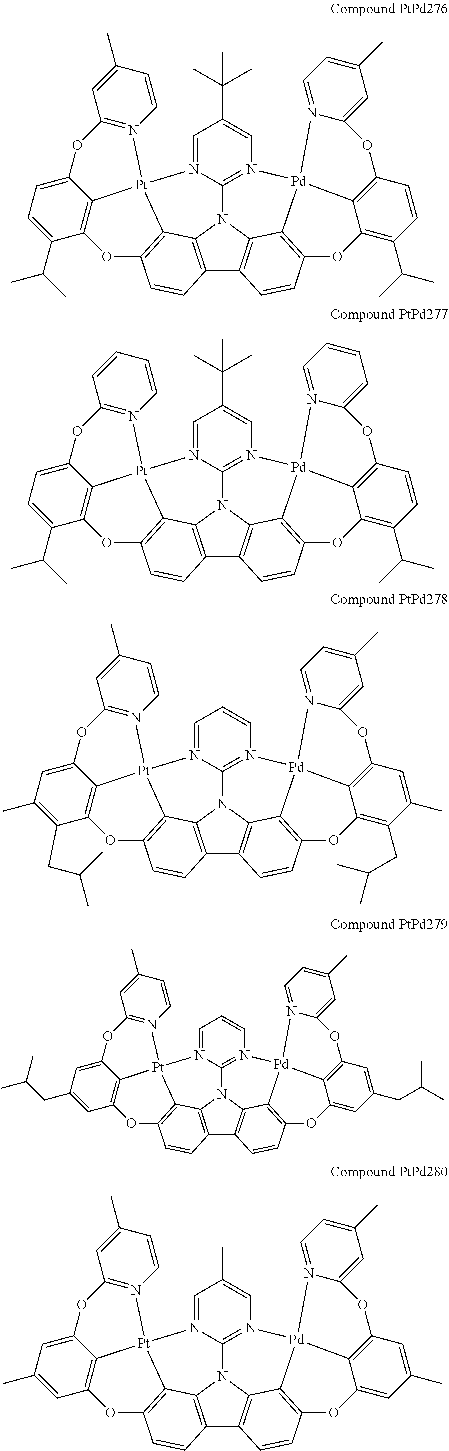

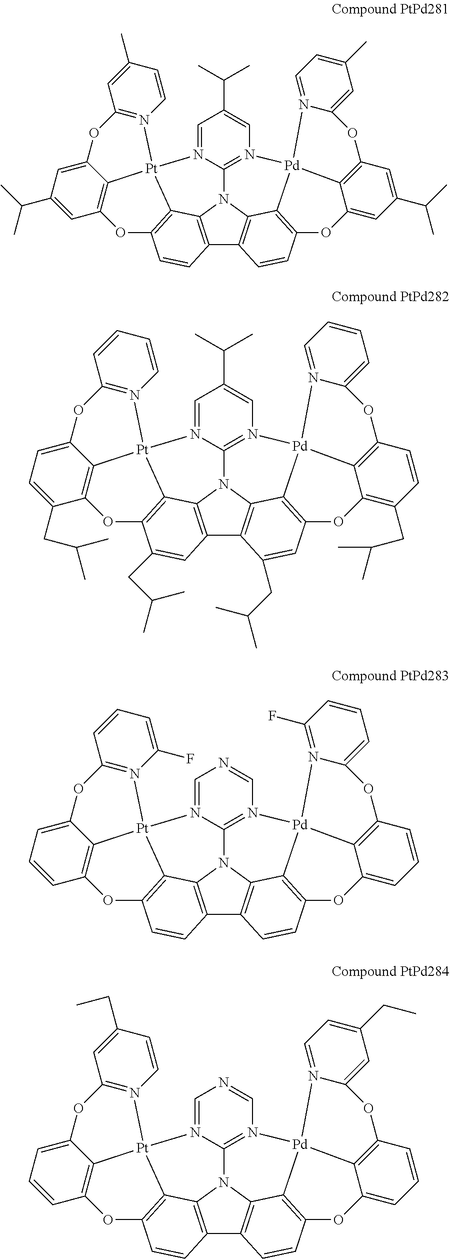

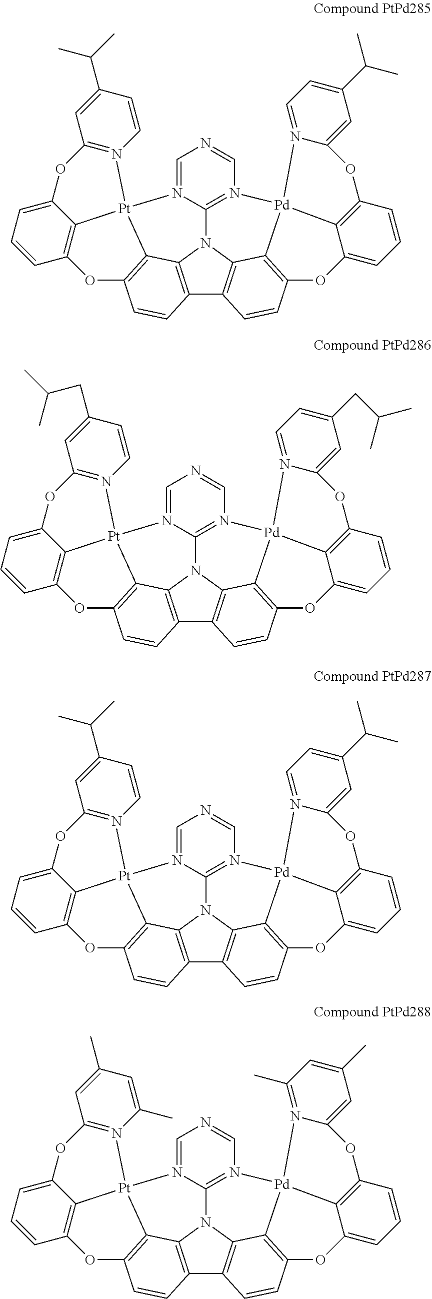

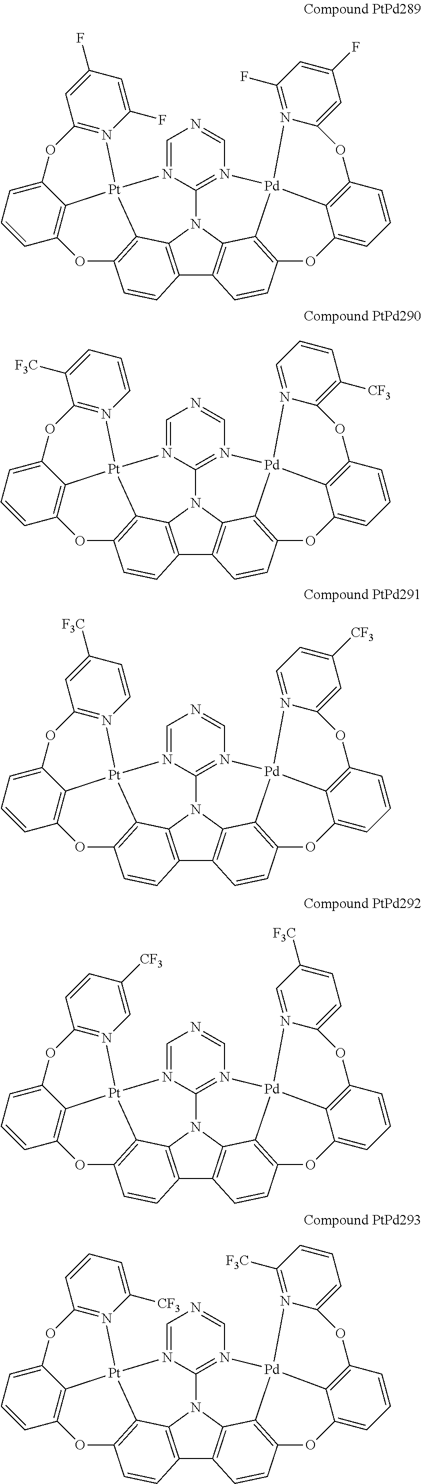

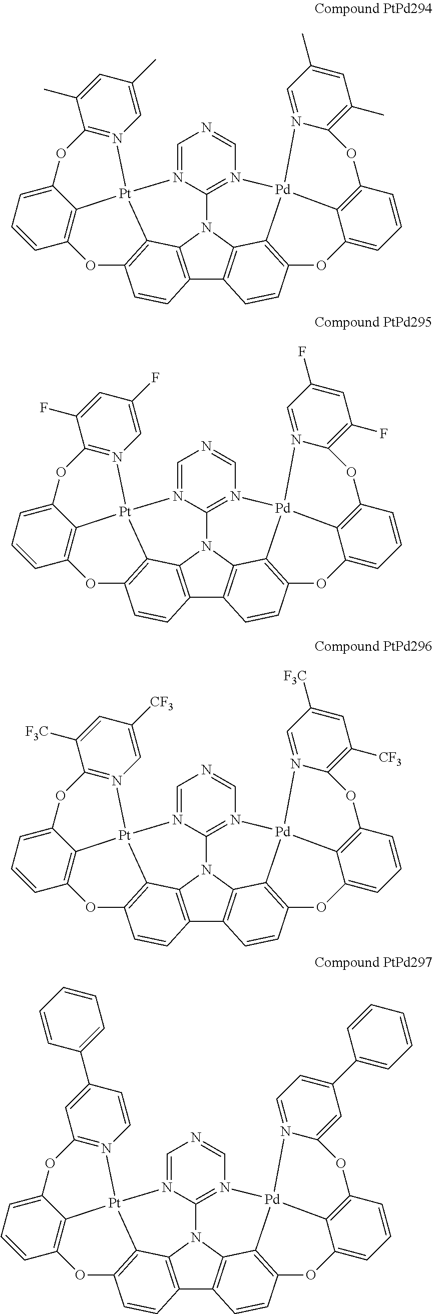

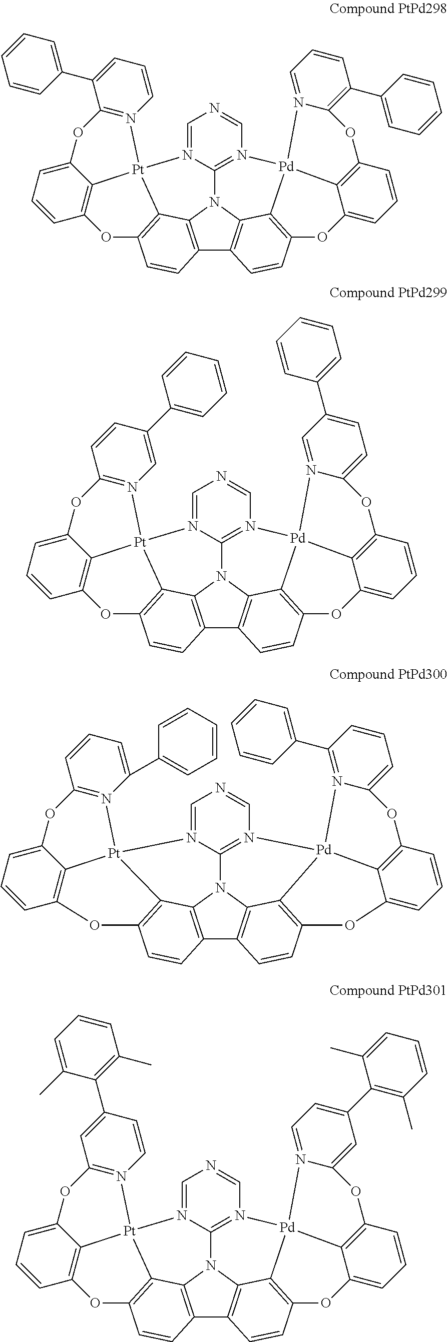

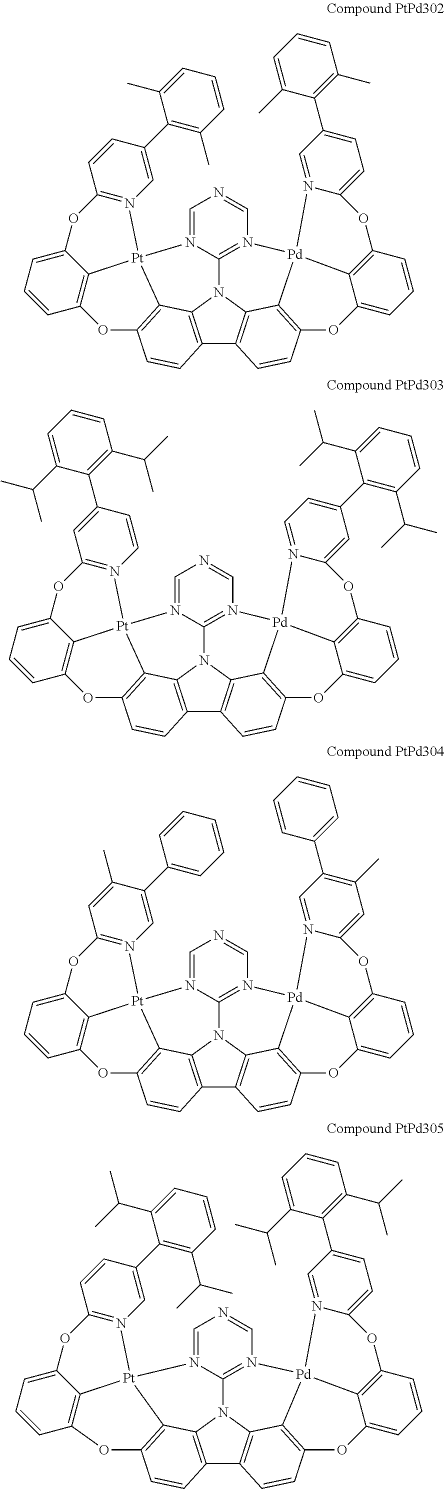

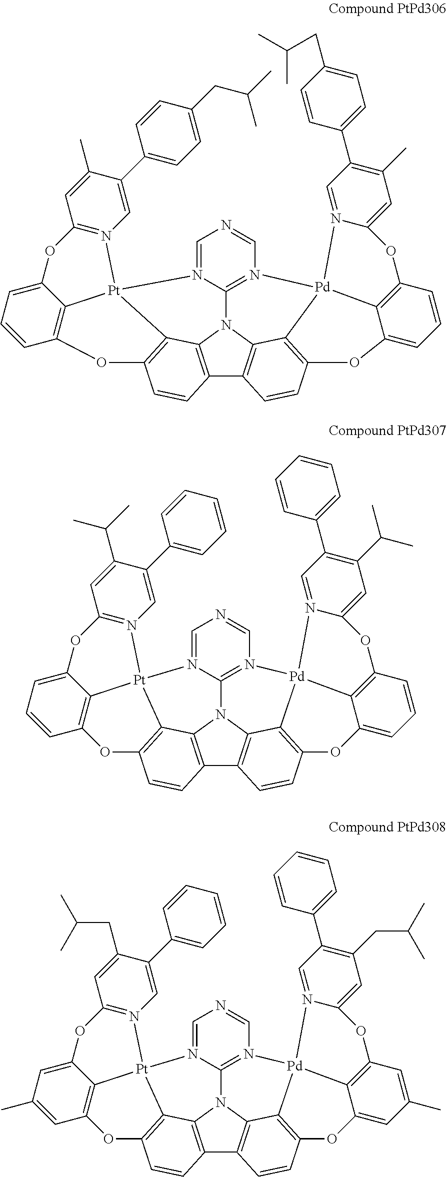

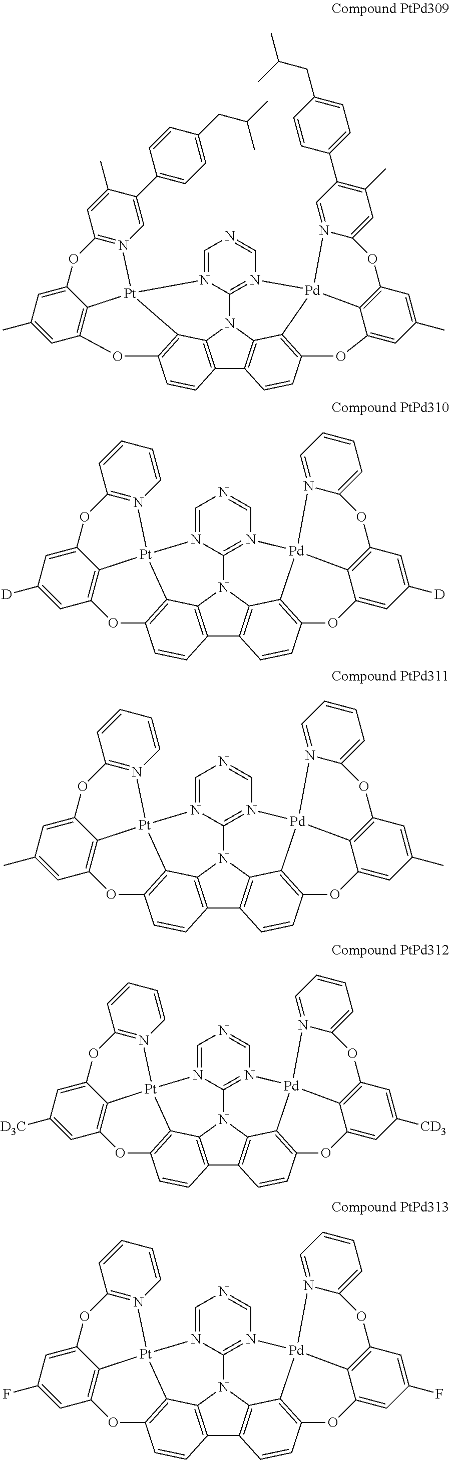

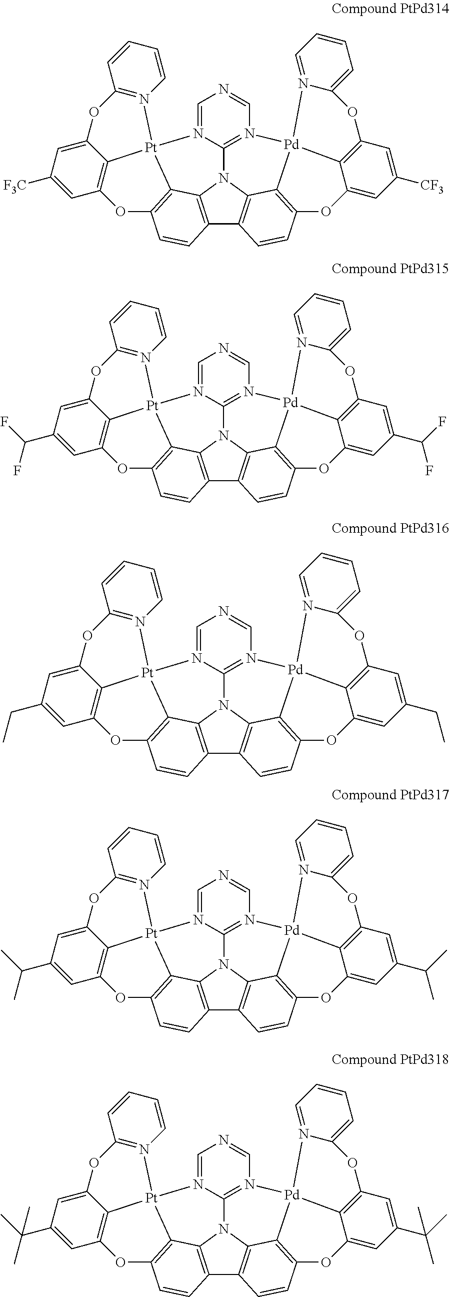

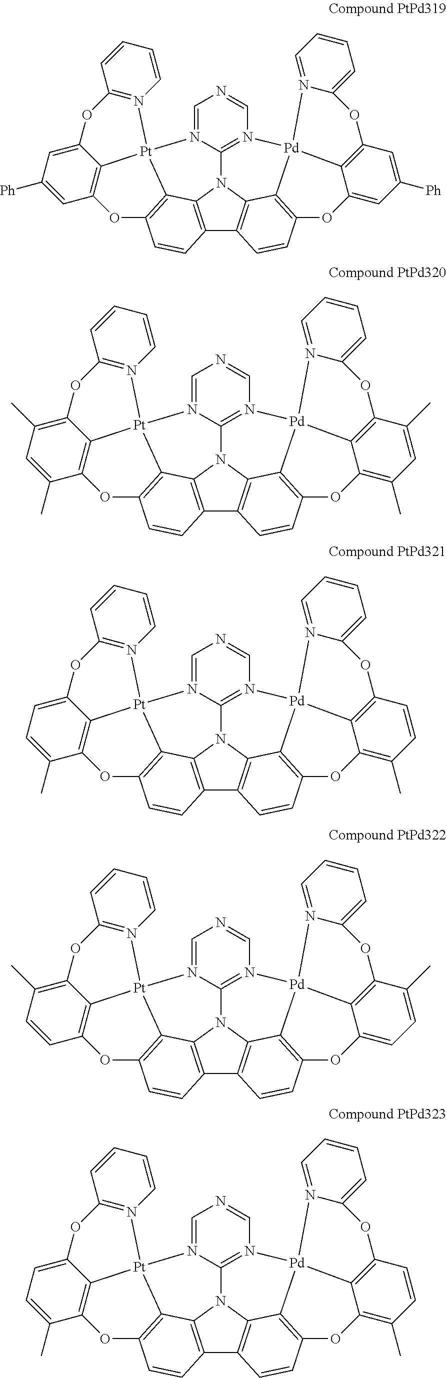

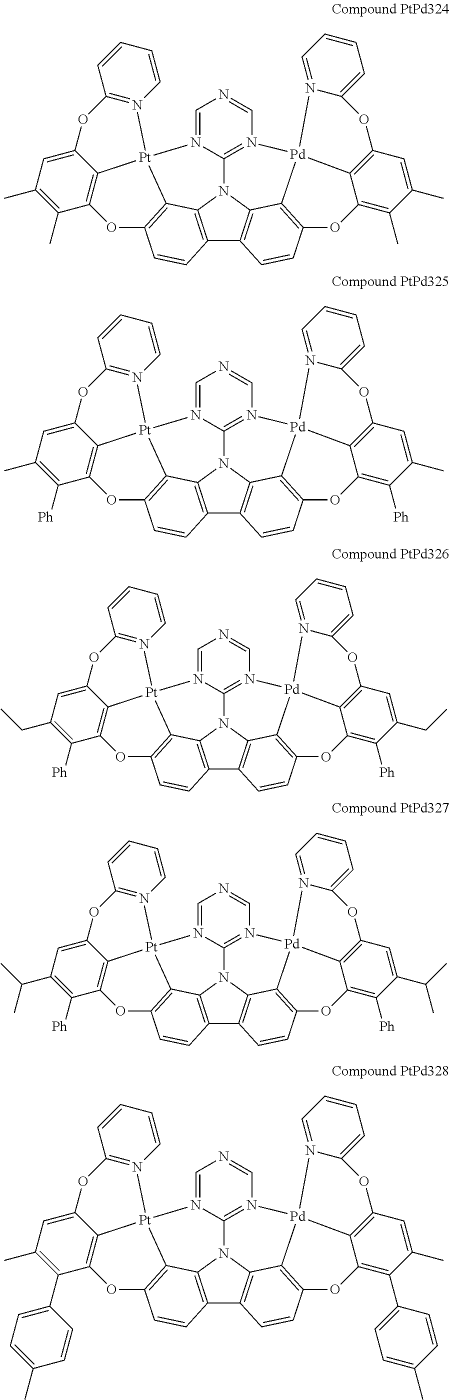

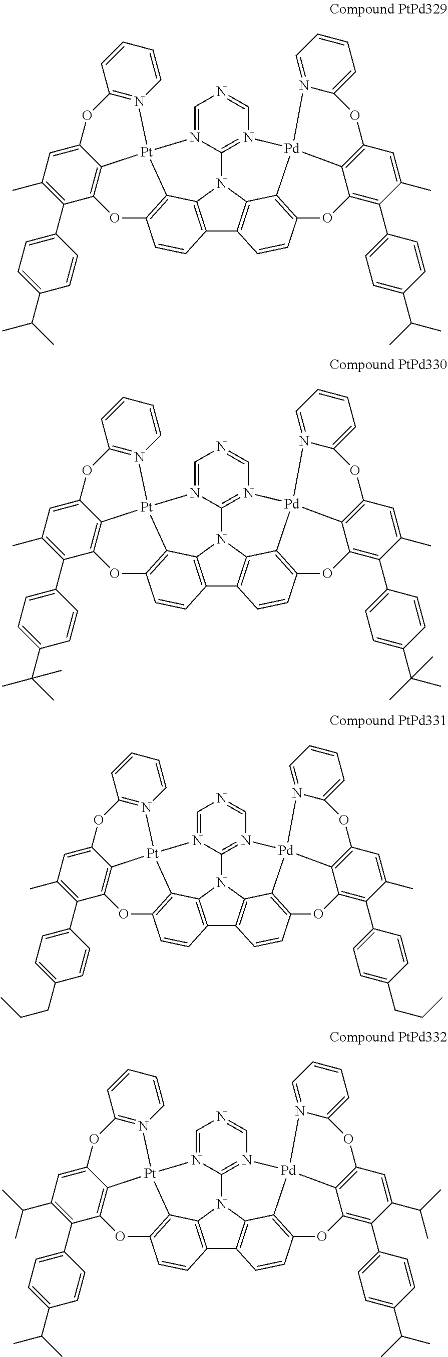

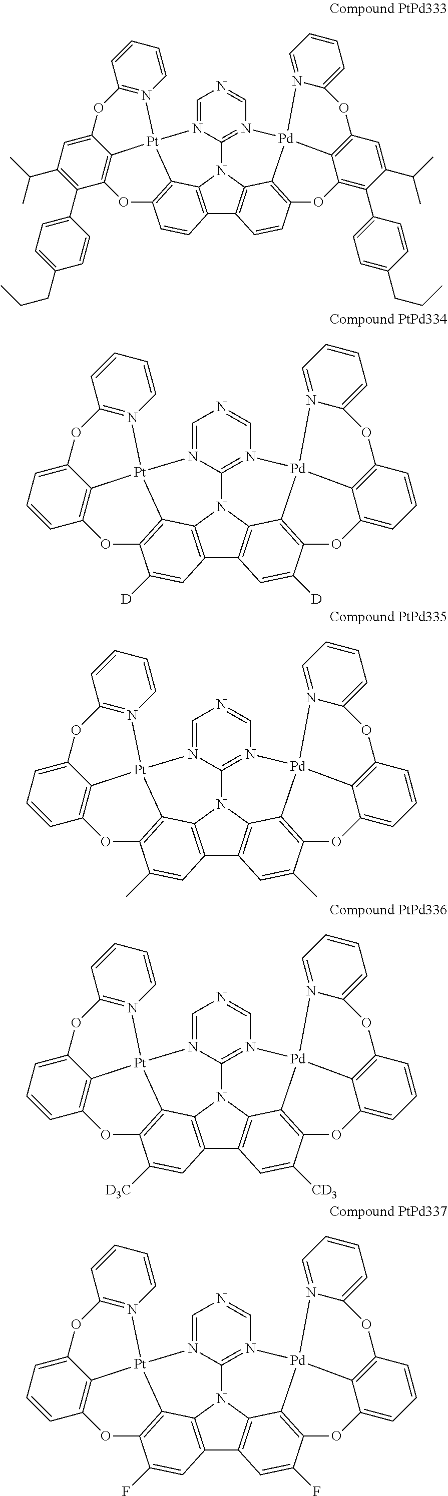

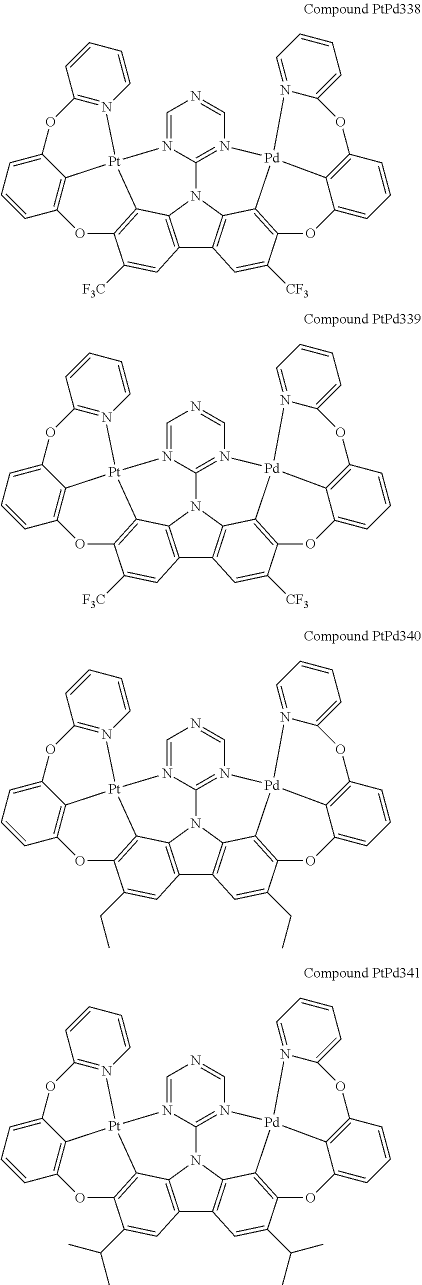

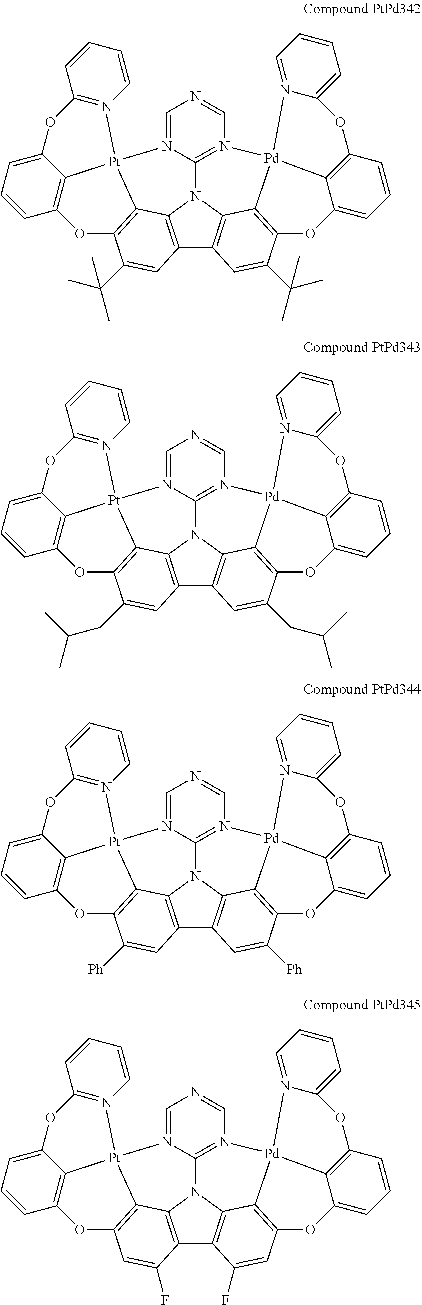

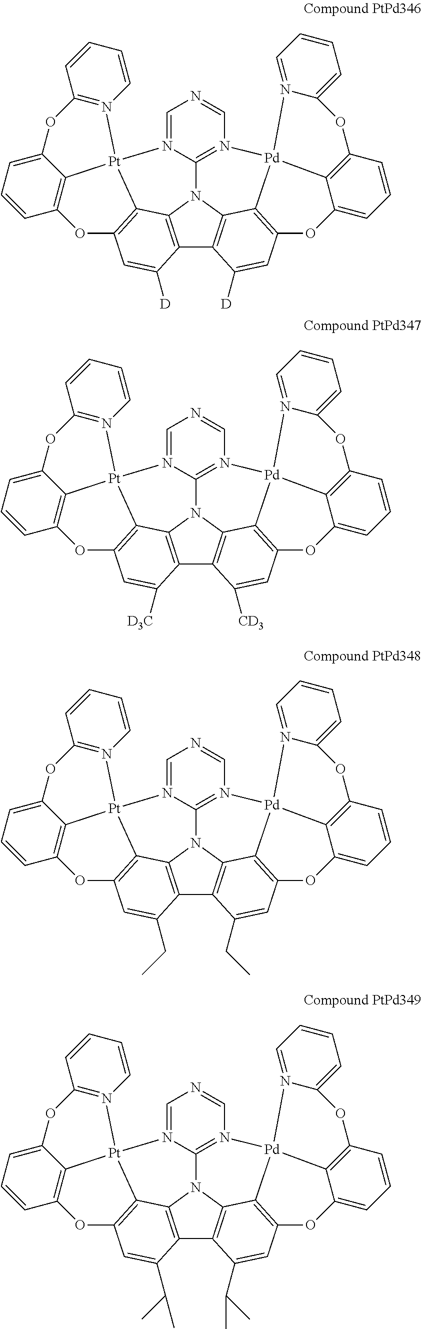

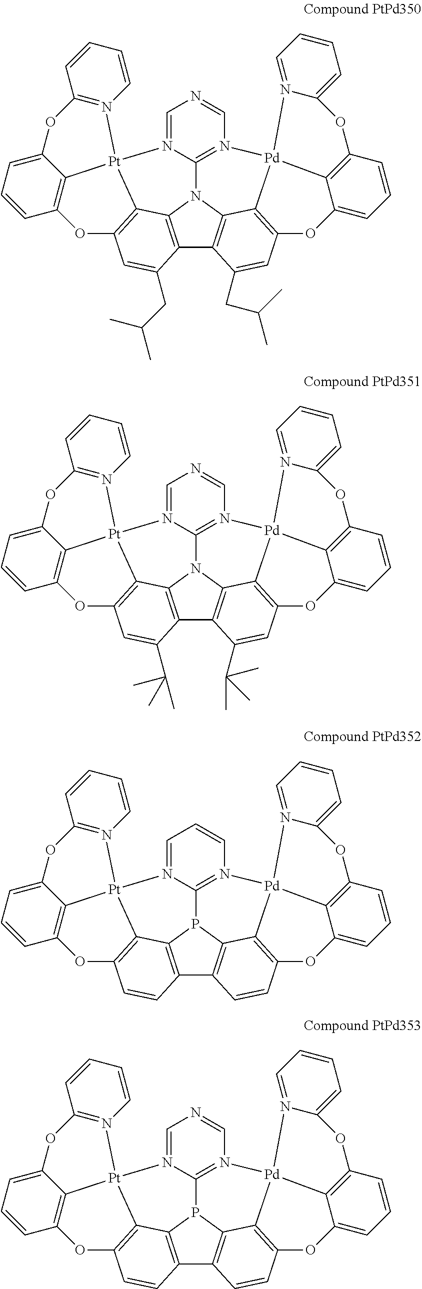

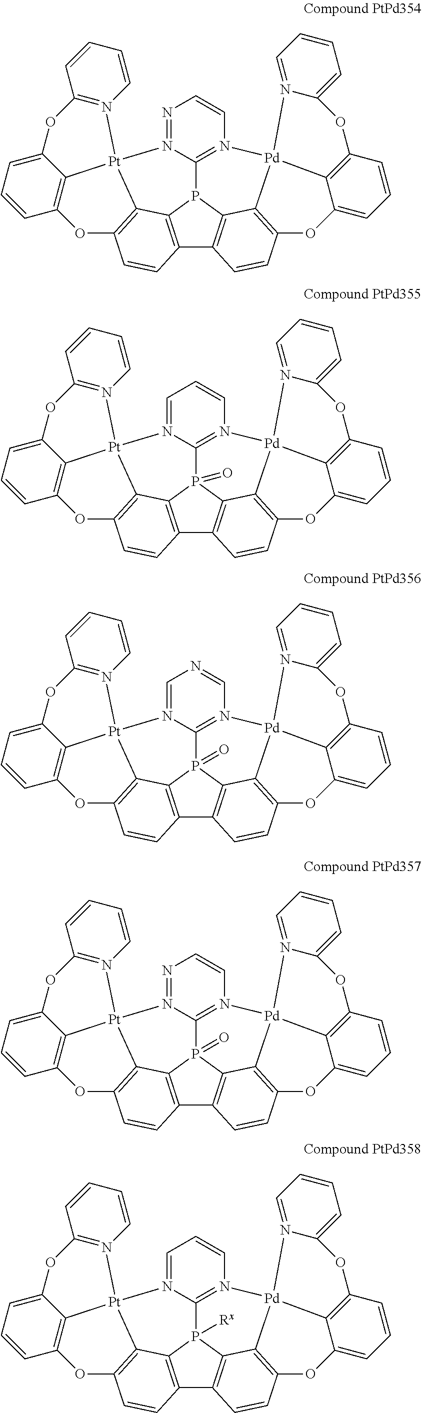

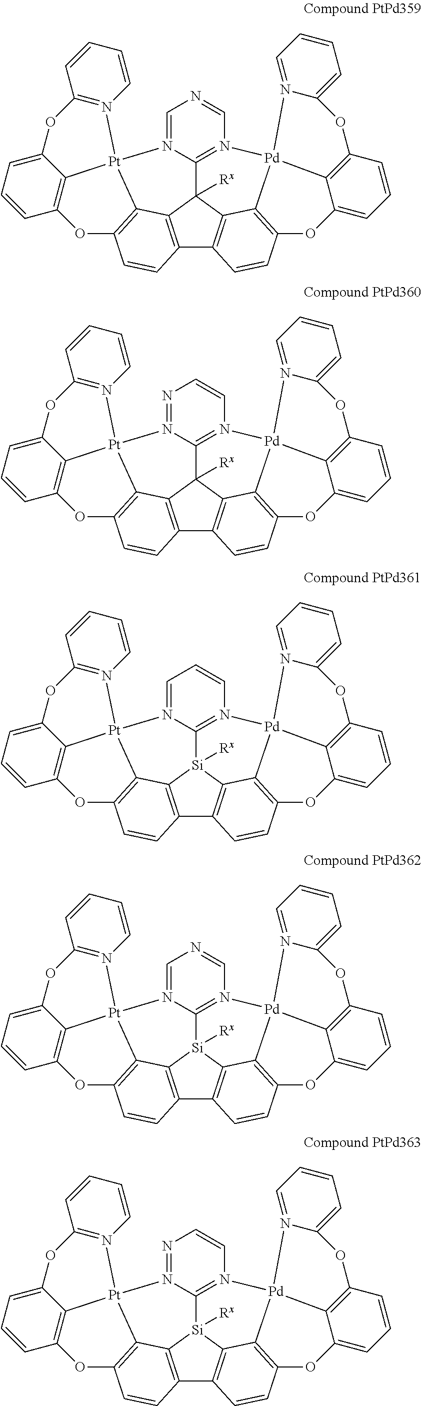

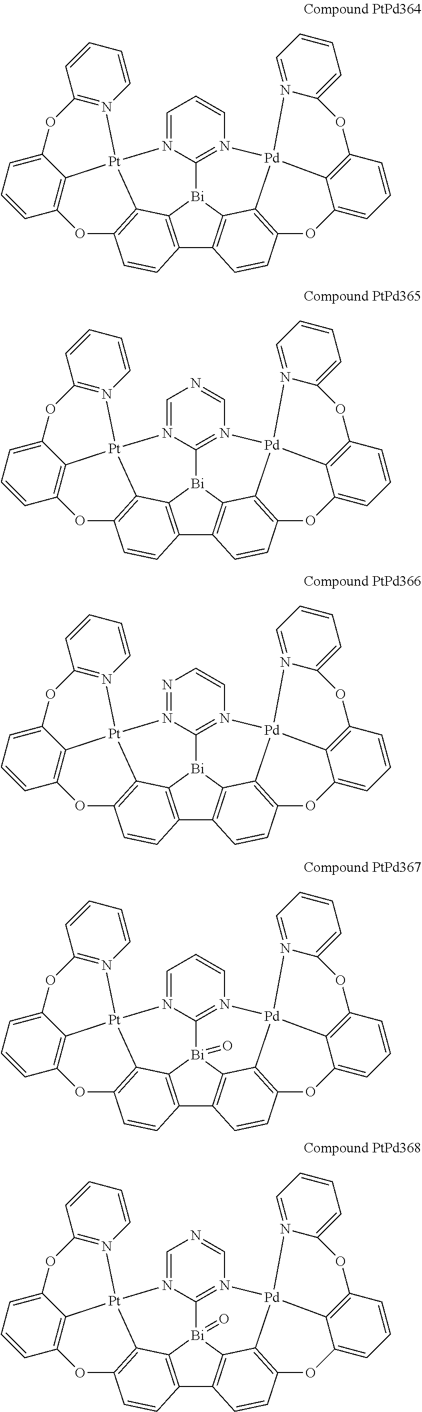

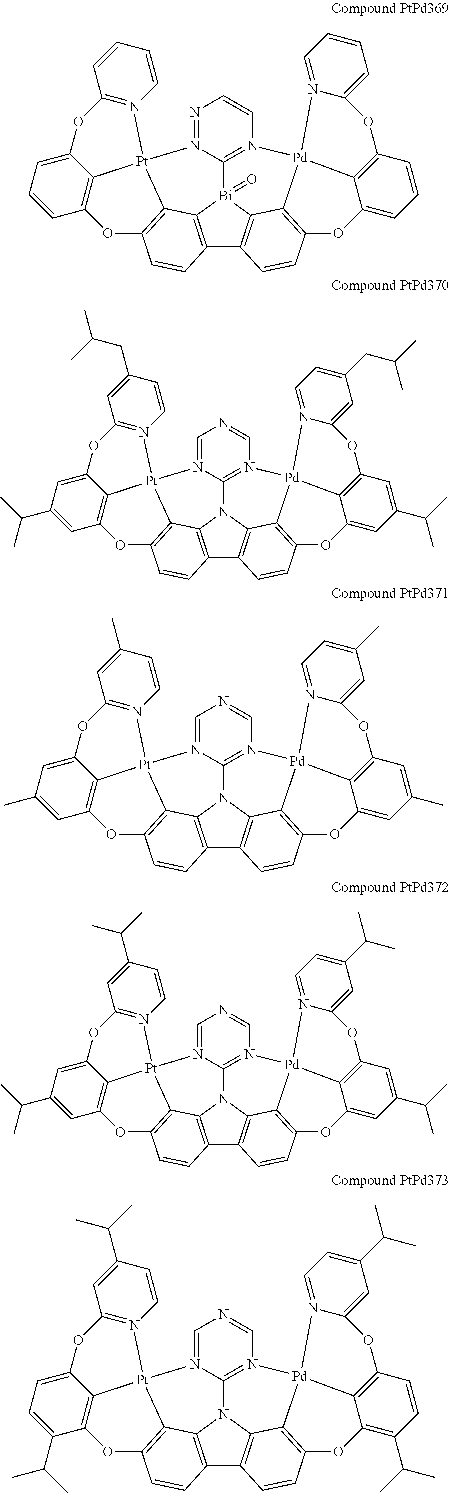

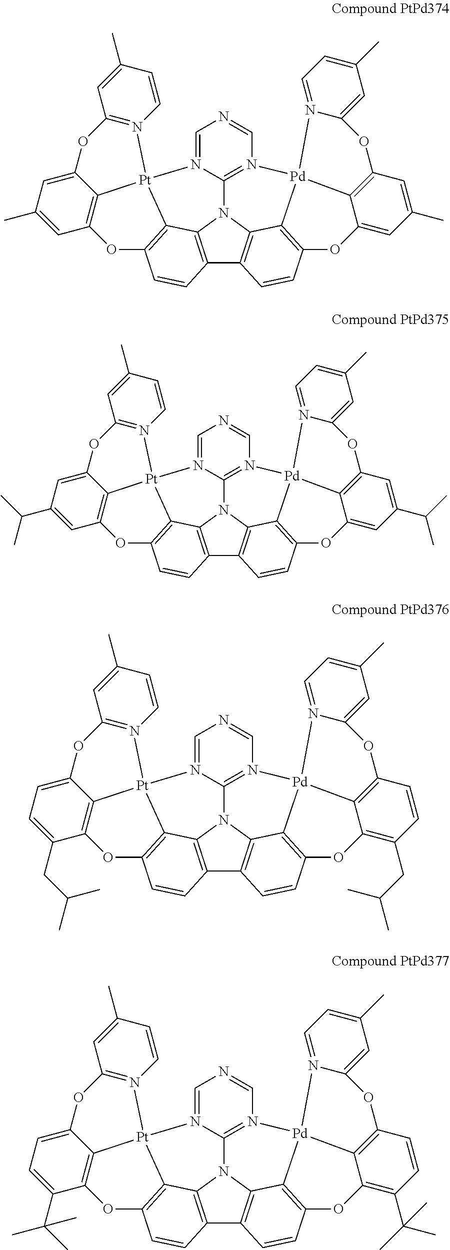

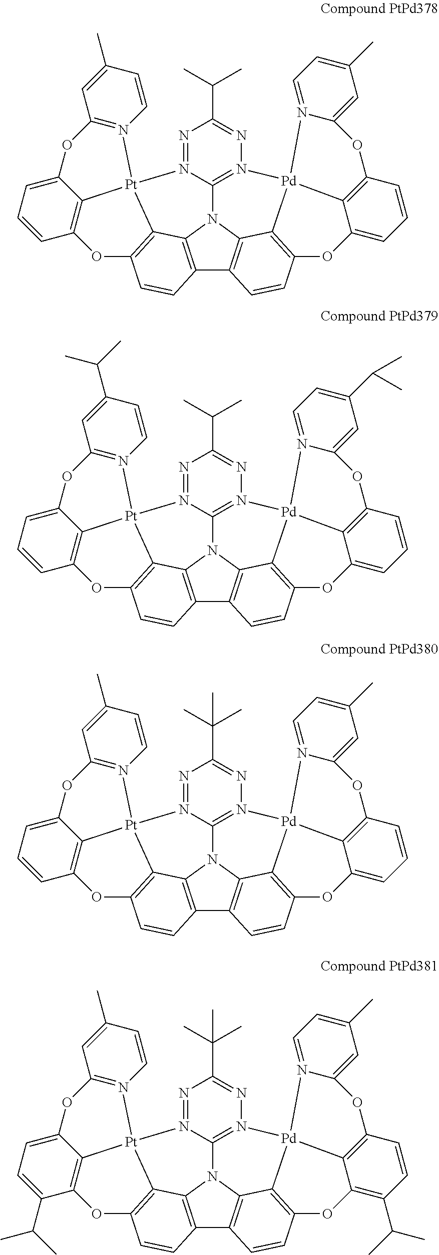

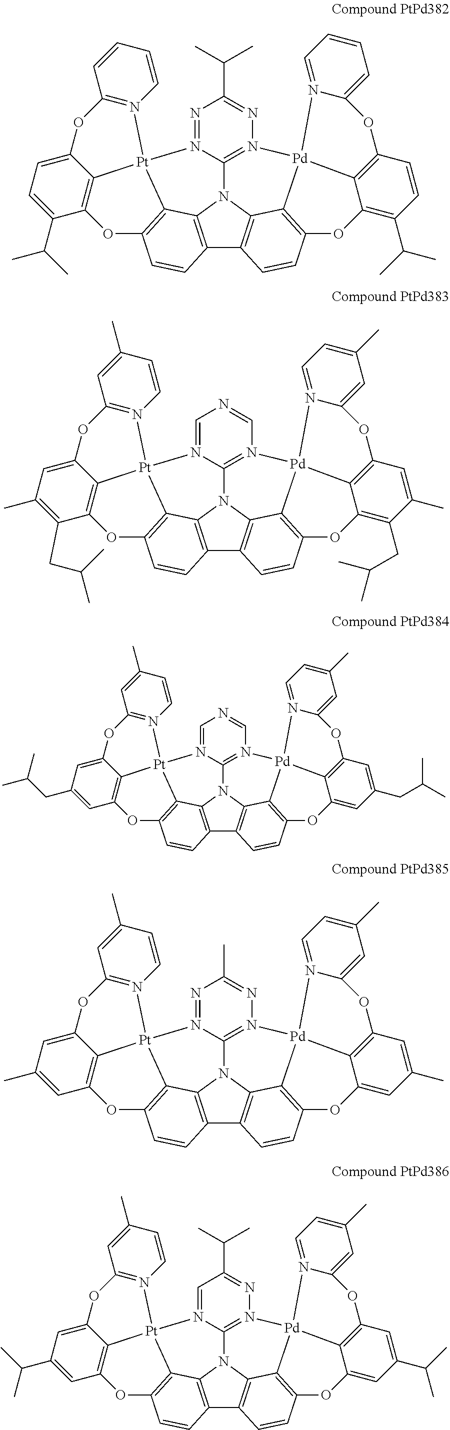

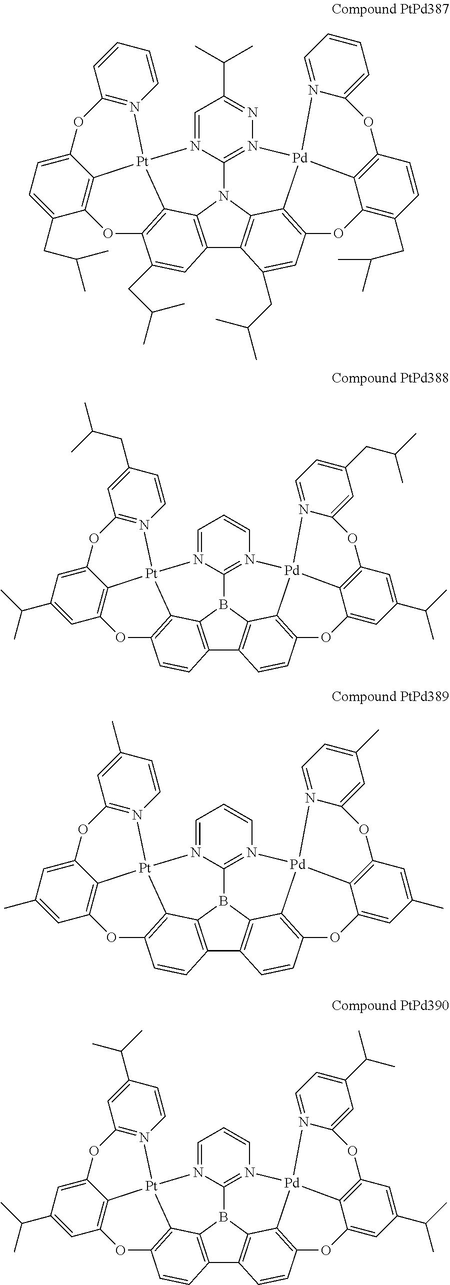

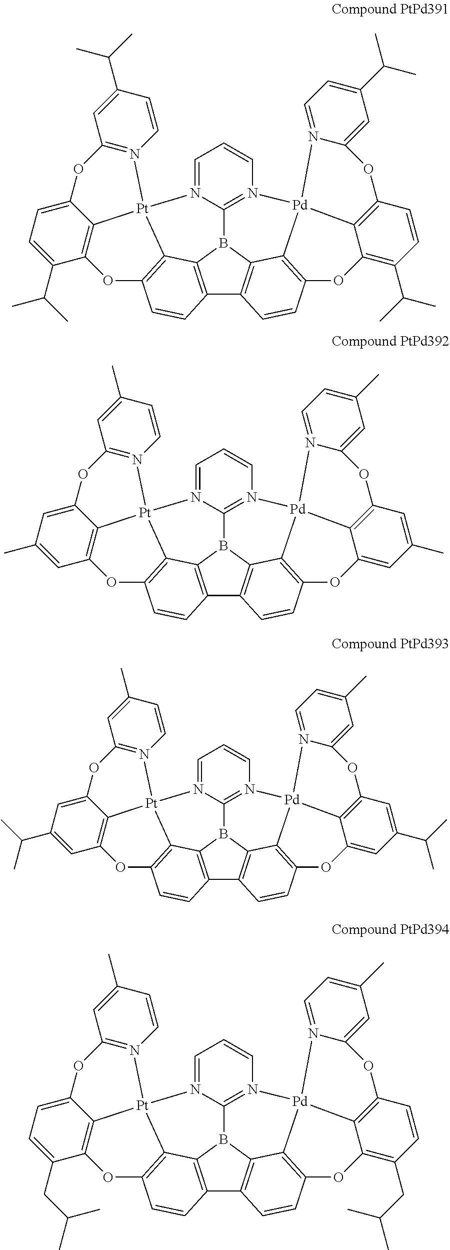

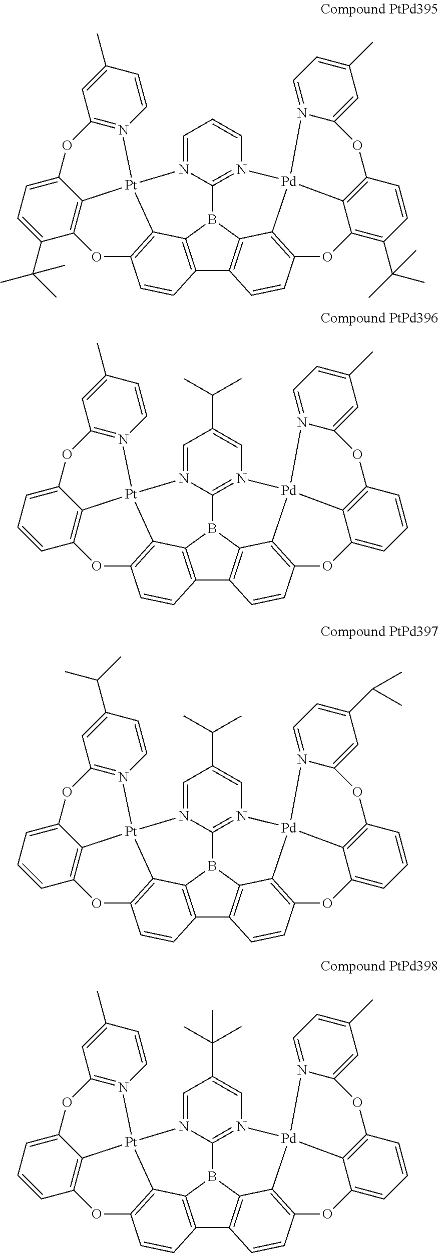

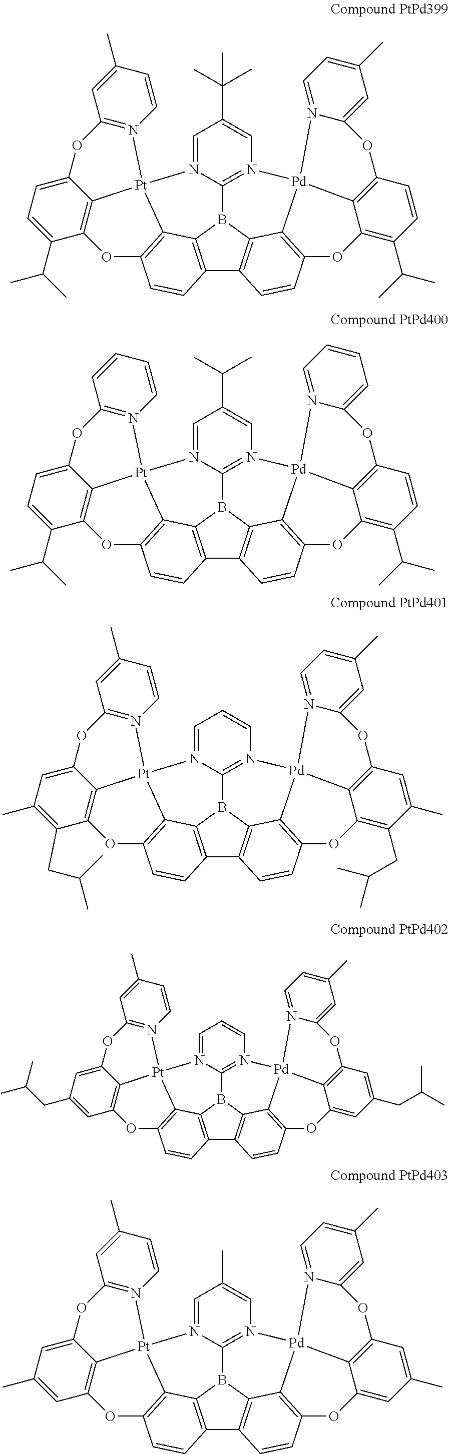

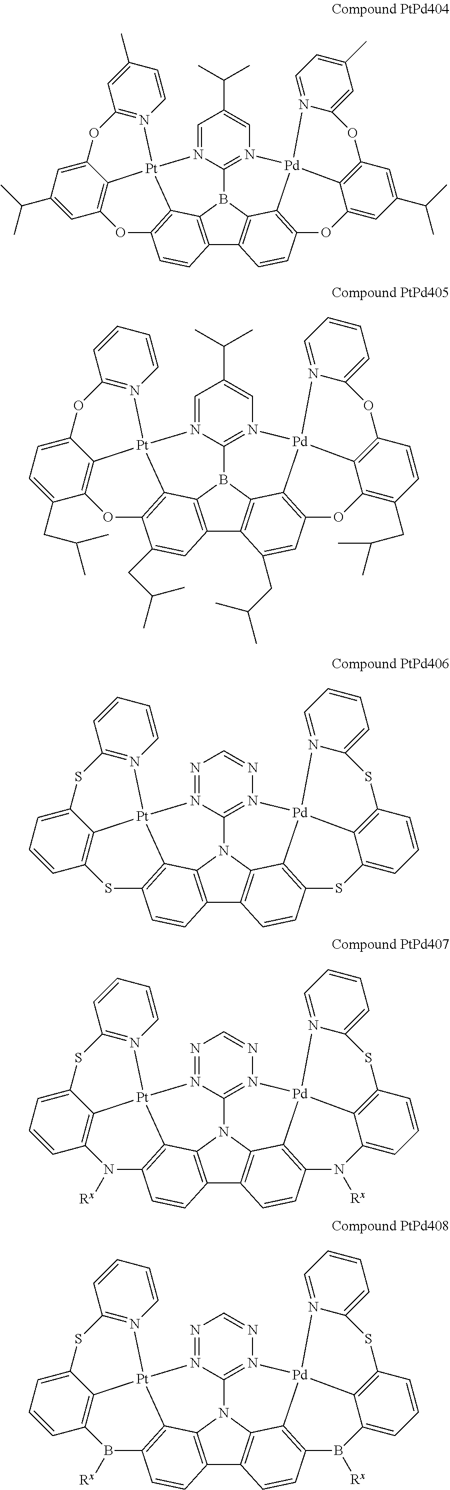

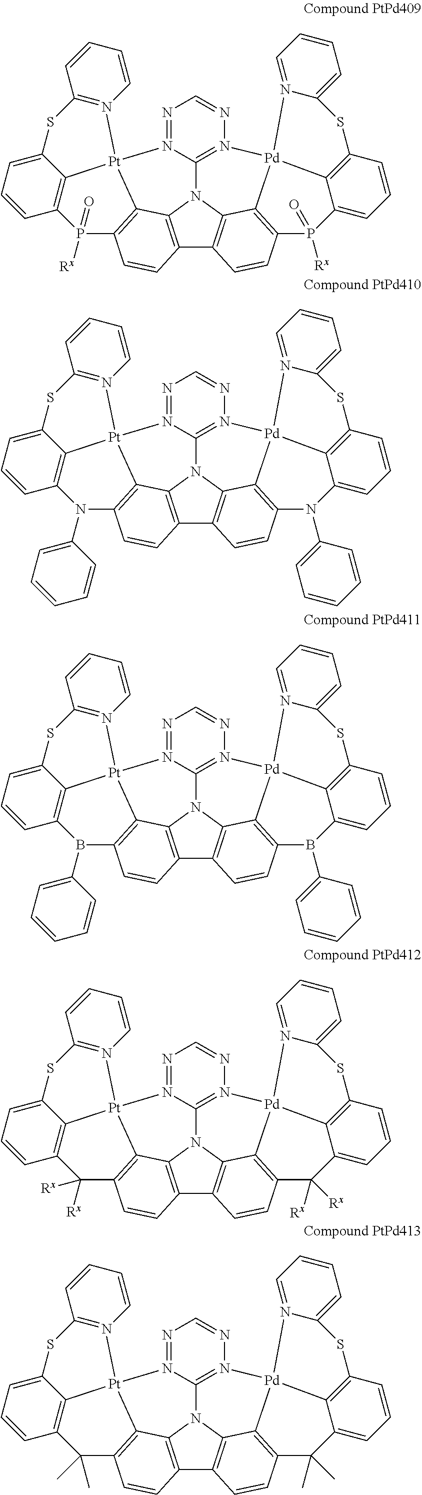

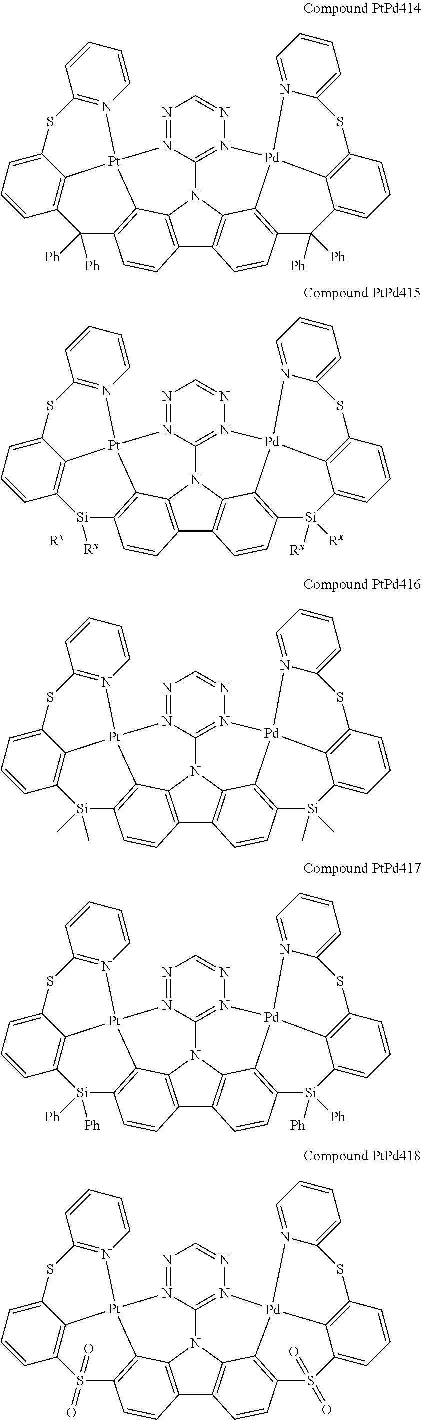

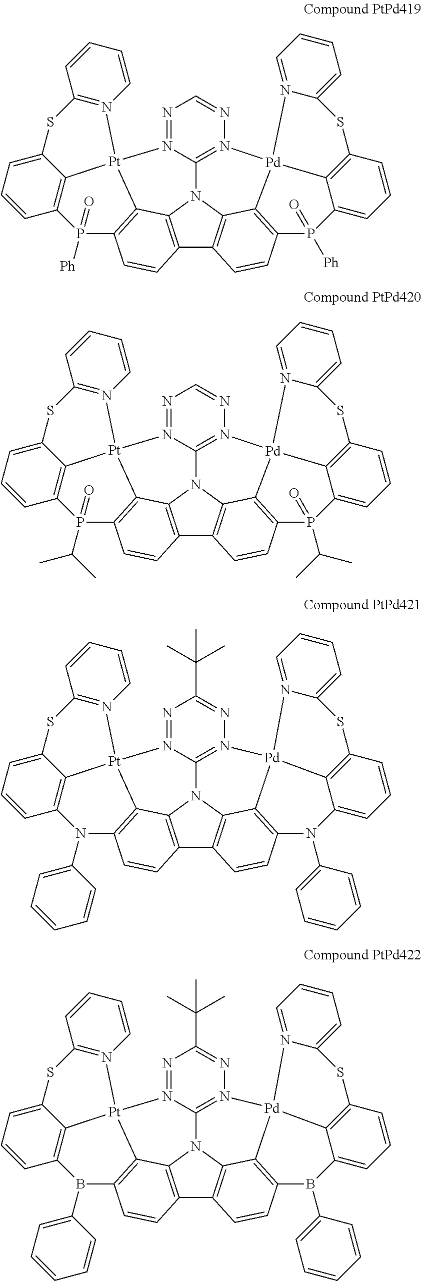

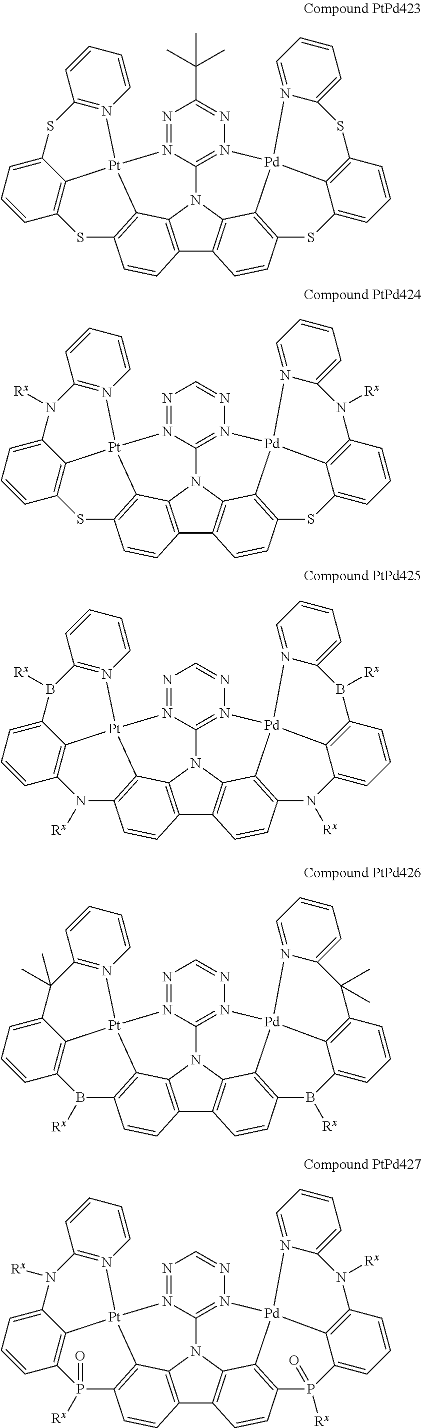

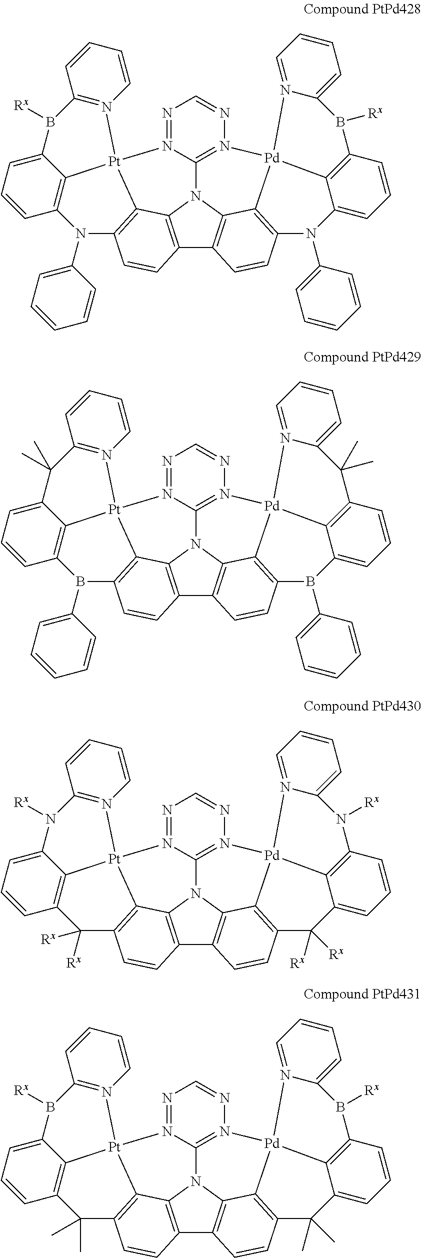

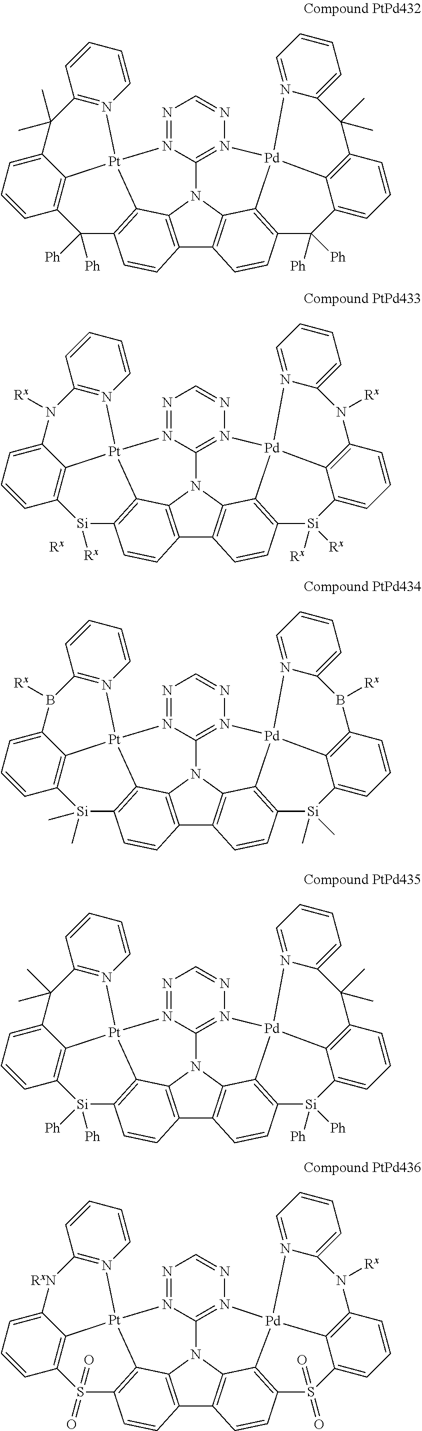

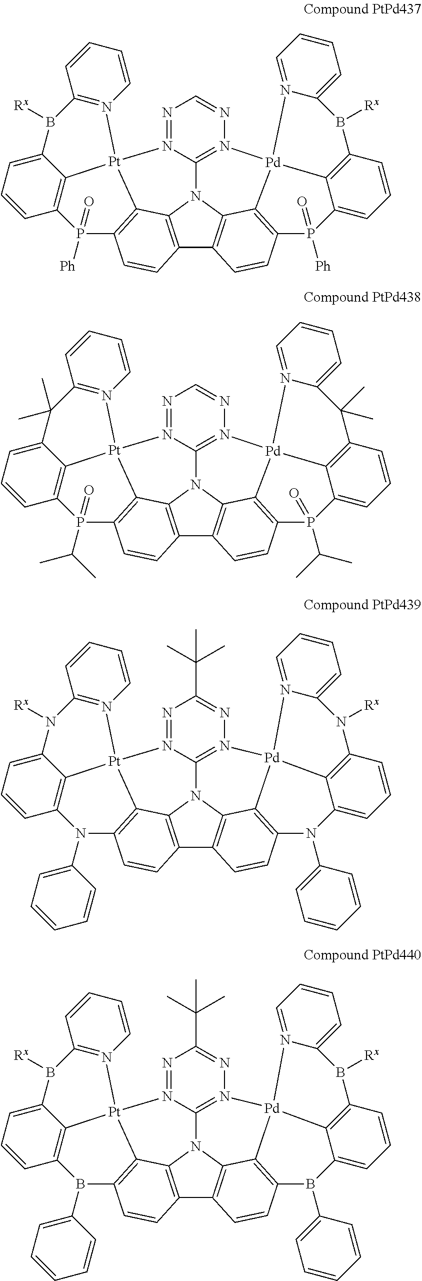

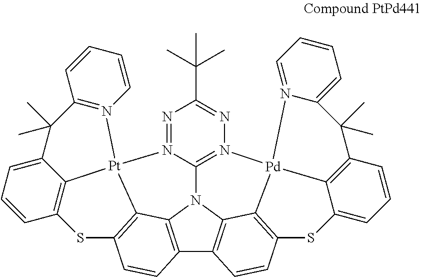

In which, R^{x} is selected from hydrogen, deuterium, halogen, hydroxyl, mercapto, nitro, cyanide, amino, carboxyl, sulfonyl, hydrazine, ureyl, substituted or unsubstituted C₁˜C₂₄ alkyl, substituted or unsubstituted C₂˜C₂₄ alkenyl, substituted or unsubstituted C₂˜C₂₄ alkynyl, substituted or unsubstituted C₆˜C₃₆ aryl group, substituted or unsubstituted C₃˜C₁₈ heterocyclic group, substituted or unsubstituted C₃˜C₃₆ hetero-aryl, substituted or unsubstituted C₁˜C₂₄ alkoxy, substituted or unsubstituted C₁˜C₂₄ alkyl thioyl, substituted or unsubstituted C₂˜C₂₄ oxy, substituted or unsubstituted C₂˜C₂₄ alkynyl, substituted or unsubstituted C₆˜C₃₆ aryl, substituted or unsubstituted C₂˜C₂₄ alkoxy carbonyl, substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl group, substituted or unsubstituted C₁˜C₃₆ sulfonylamino, substituted or unsubstituted C₁˜C₃₆ phosphoryl amine, substituted or unsubstituted C₂˜C₂₄ alkoxy carbonyl amine, substituted or unsubstituted C₇˜C₃₇ aryoxy carbonyl amino groups, substituted or unsubstituted methylsilyl alkyl, substituted or unsubstituted C₁˜C₁₈ monoalkylamines, substituted or unsubstituted C₂˜C₃₆ dialkylamino, substituted or unsubstituted C₆˜C₃₆ monoaryl amine, substituted or unsubstituted C₁₂˜C₇₂ bis aryl amine, substituted or unsubstituted C₁˜C₃₆ ureylene, substituted or unsubstituted C₂˜C₃₆ imino; the substituents are selected from deuterium, halogen, hydroxyl, mercapto, nitro, cyanide, amino, carboxyl, sulfonyl, hydrazine, ureyl, C₁˜C₆ alkyl, C₆˜C₁₂ aryl group.

The preparation method of the metal complex in the embodiment of the invention is further provided, the intention of the specific synthesis example is only to disclose the contents of the invention instead of being intended to limit the scope. Although great efforts have been made to ensure the accuracy of values (e.g. quantities, temperatures, etc.), some errors and deviations should be taken into account. Unless otherwise stated, the number of shares is weight, the temperature is in degrees Celsius or at ambient temperature, and the pressure is at or near atmospheric pressure.

There are various methods for preparing compounds disclosed by the present invention described in an embodiment. These methods are provided to illustrate various preparation methods instead being intended to limit any of the methods described in the embodiment of the present invention. Therefore, one or more disclosed compounds can be easily modified by the technical personnel in the domain of the invention or by using different methods. The following aspects are illustrative only instead of being intended to limit the scope of this disclosure. The temperature, catalyst, concentration, reactant composition, and other process conditions may be varied, and the technical staff in the field of the content of the disclosure can easily select suitable reactants and conditions for desired complexes.

¹H spectra were recorded by 400 MHz in CDCl₃ or DMSO-d6 solution on Varian Liquid State NMR instrument, and ¹³C NMR spectra were recorded at 100 MHz, and the chemical shifts were compared with the residual protiated solvents. If CDCl₃ is used as solvent, tetramethylsilane (δ=0.00 ppm) is used as internal standard to record ¹H NMR spectra; DMSO-d₆ (δ=77.00 ppm) was used as the internal standard for recording ¹³C NMR spectra. If H₂O (δ=3.33 ppm) is used as solvent, the residual H_2O (δ=3.33 ppm) is used as internal standard to record ¹H NMR; DMSO-d₆ (δ=39.52 ppm) was used as the internal standard for recording 13C NMR spectra. The following abbreviations (or combinations) are used to explain the multiplicity of ¹H NMR: s=single, d=double, t=triple, q=quadruple, p=quintuple, m=multiple, br=width.

The embodiment of the invention provides a preparation method of a metal complex, which comprises at least the following steps:

Step 1, preparation of precursor substances as shown in the general formulas A and B;

Step 2, preparation of precursor substances as shown in the general formula C and the general formula D;

Step 3, the intermediate as shown in the general forumula Ligand is obtained by substitution reaction of the precursor substance shown in the general formula A and the general formula D, or by substitution reaction of the precursor substance shown in the general formula B and formula C.

Step 4, the intermediate shown in the general formula Ligand is reacted with palladium salt or platinum salt to obtain a compound where A¹, A², A³, A⁴ are oxygen and X is nitrogen.

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

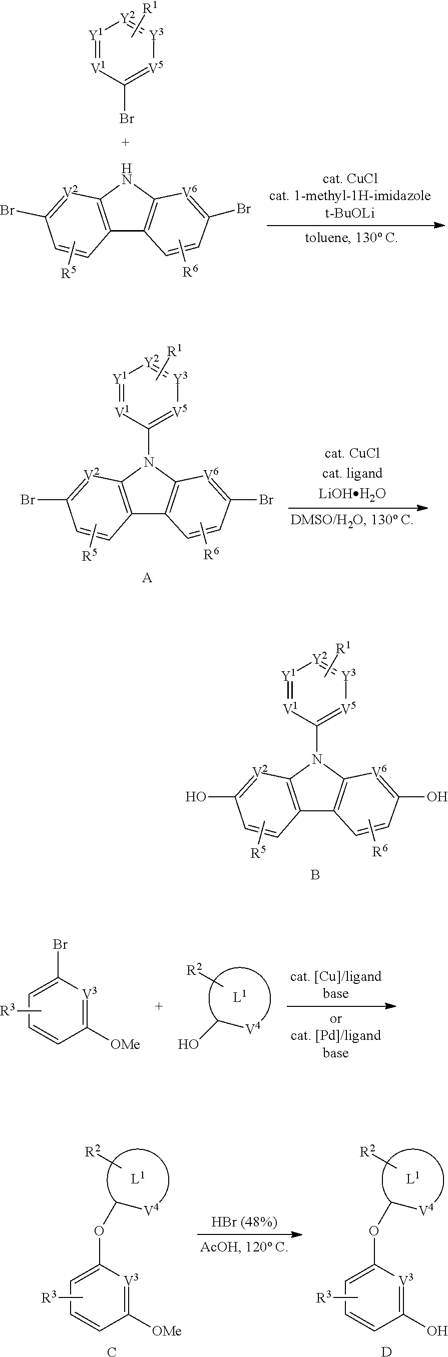

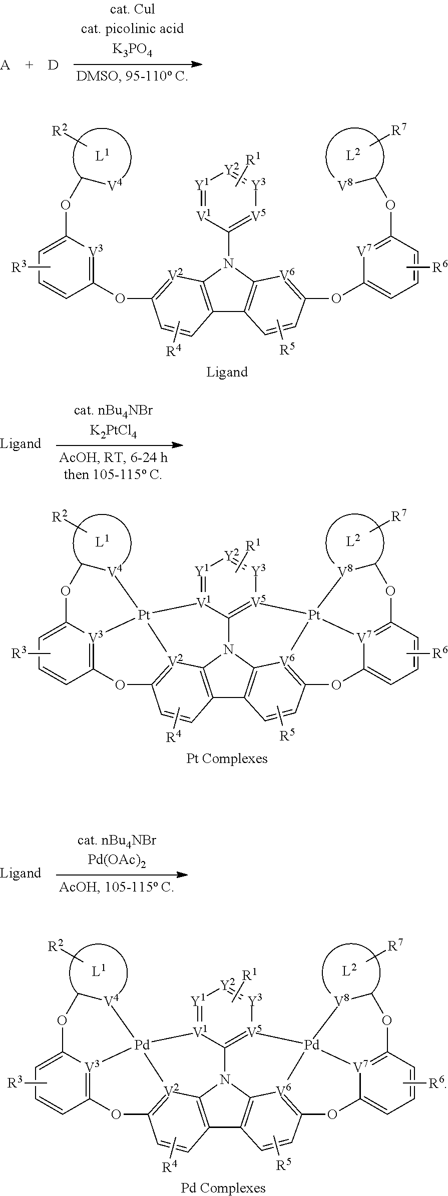

The embodiment of the invention also provides a preparation method of the metal complex, which comprises at least the following steps:

Step 1, preparation of precursor substances as shown in the general formulas A and B;

Step 2, preparation of precursor substances such as general formula E and general formula F;

Step 3, the substitution reaction is conducted to the precursor substance shown in general formula A and F, or the substitution reaction is conducted to the precursor substance indicated in general formula B and E, and the intermediate as shown in the general formula Ligand is obtained.

Step 4, the intermediate as shown in the general formula Ligand is reacted with palladium salt or platinum salt to obtain the compounds where A¹, A⁴ is nitrogen, A², A³ is oxygen and X is nitrogen.

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

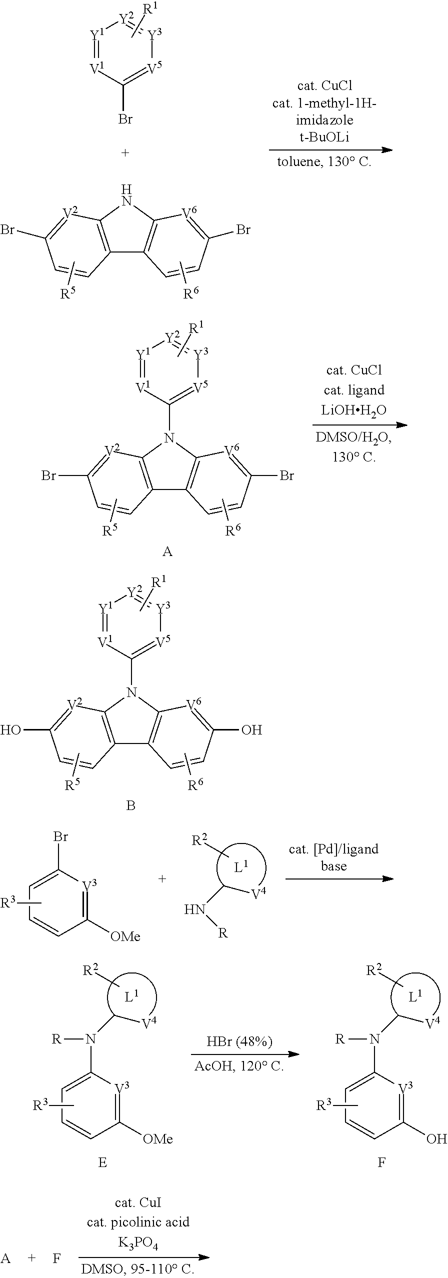

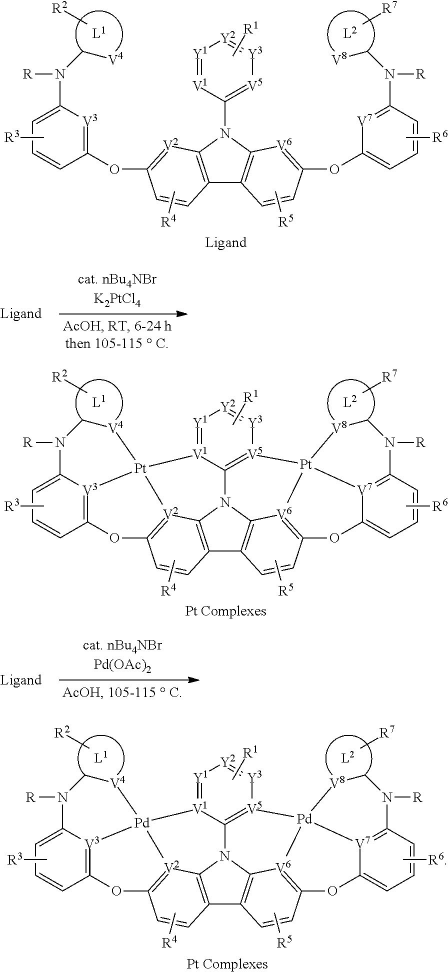

The preparation method of binuclear organometallic complexes in the embodiment of the invention comprises at least the following steps:

Step 1, preparation of precursor substances as shown in the general formulas A and B;

Step 2, preparation of precursor substances as shown in general formula G and general formula H;

Step 3: the substitution reaction is conducted to the precursor substance shown in general formula A and H, or the substitution reaction is conducted to the precursor substance indicated in general formula B and G, and the intermediate as shown in the general formula Ligand is obtained;

Step 4, the intermediate as shown in the general formula Ligand is reacted with palladium salt or platinum salt to obtain the compounds where A¹, A⁴ is —S—, A², A³ is oxygen and X is nitrogen.

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

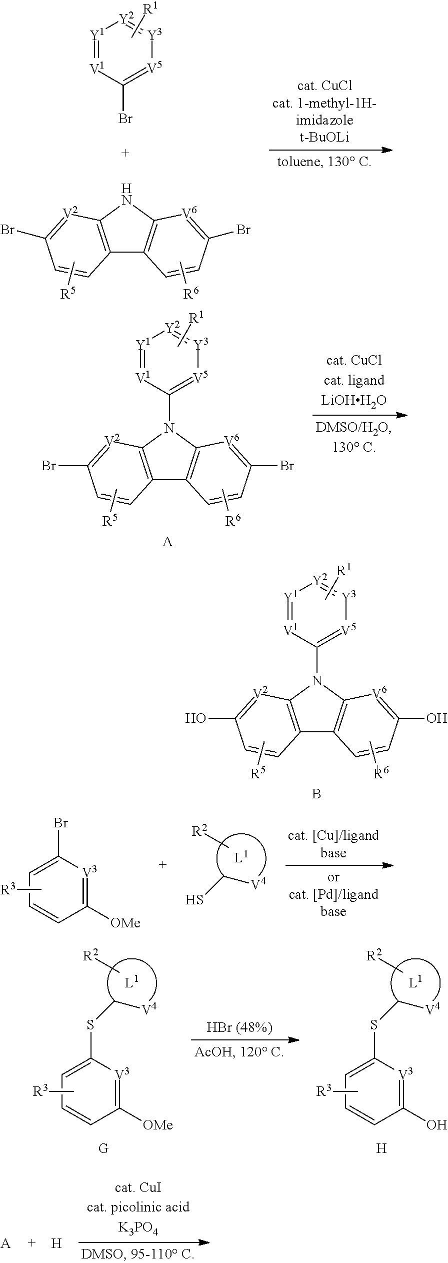

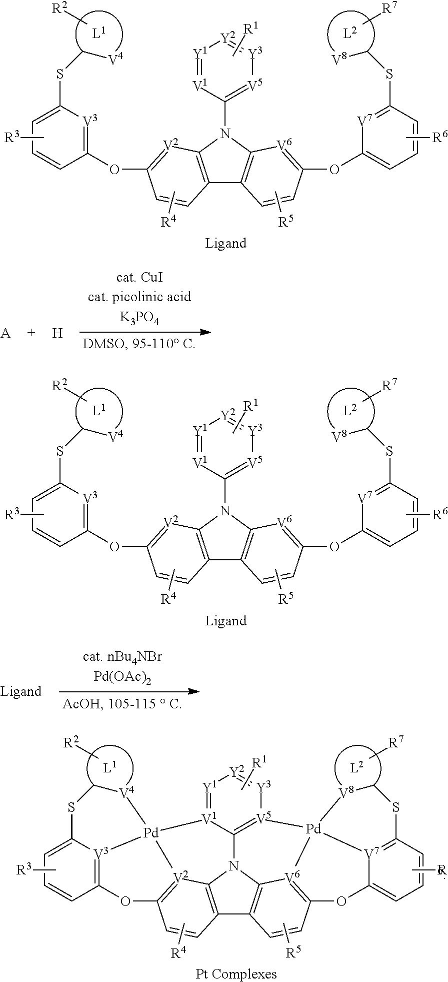

The preparation method of binuclear organometallic complexes in the embodiment of the invention comprises at least the following steps:

Step 1, preparation of precursor substances as shown in the general formulas A and B;

Step 2, preparation of precursor substances as shown in general formula I and general formula J;

Step 3, the substitution reaction is conducted to the precursor substance shown in general formula A and J, or the substitution reaction is conducted to the precursor substance indicated in general formula B and I, and the intermediate as shown in the general formula Ligand is obtained.

Step 4, the intermediate as shown in the general Ligand is reacted with palladium salt or platinum salt to obtain compounds where A¹, A⁴ are —BR^{c}—, and A², A³ are oxygens and X is nitrogen.

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

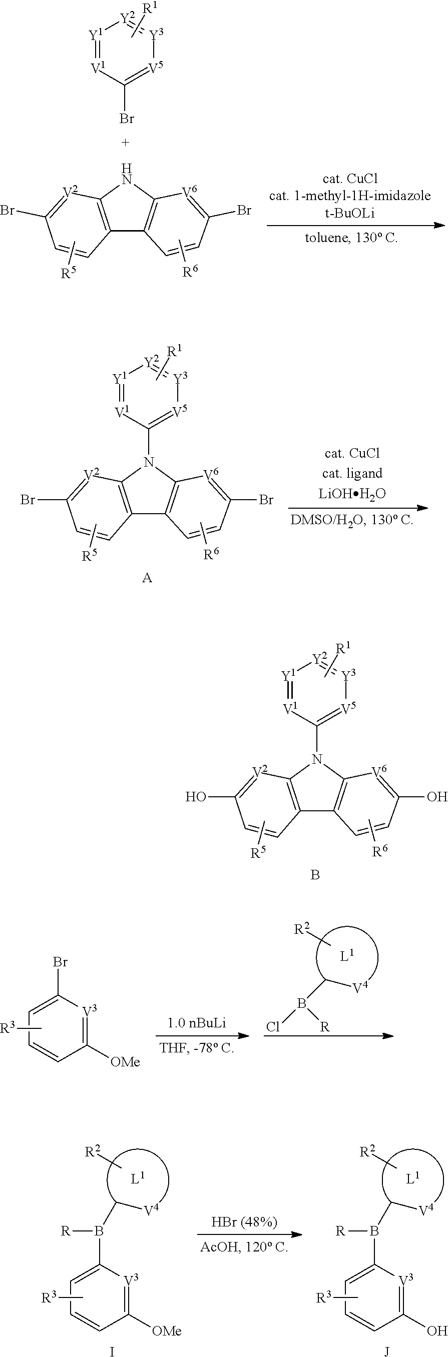

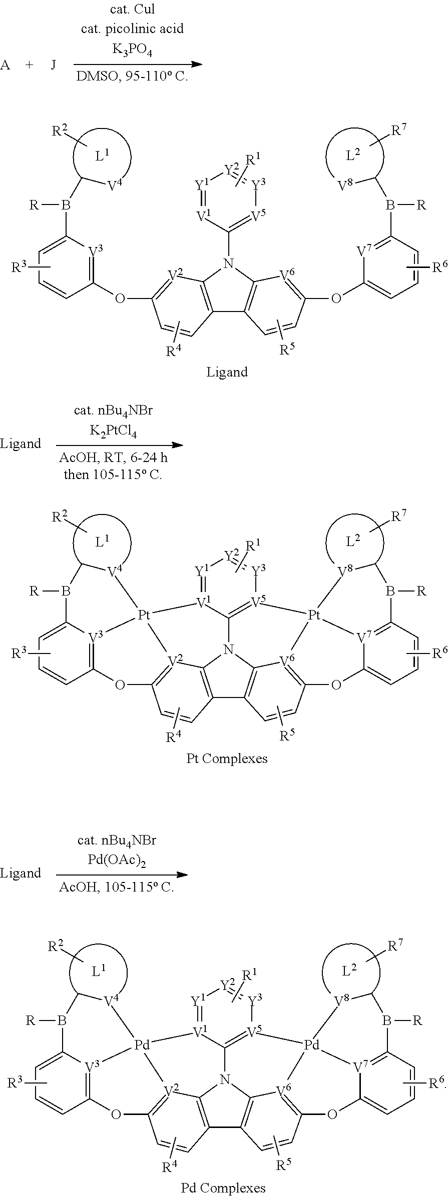

The preparation method of binuclear organometallic complexes in the embodiment of the invention comprises at least the following steps:

Step 1, preparation of precursor substances as shown in the general formulas A and B;

Step 2, preparation of precursor substances as shown in general formula K and general formula L;

Step 3, the substitution reaction is conducted to the precursor substance shown in general formula A and L, or the substitution reaction is conducted to the precursor substance indicated in general formula B and K, and the intermediate as shown in the general formula Ligand is obtained.

Step 4, the intermediate as shown in the general Ligand is reacted with palladium salt or platinum salt to obtain compounds where A¹, A⁴ are —CRaRb—, and A², A³ are oxygens and X is nitrogen.

The following generic synthesis routes is shown as follows, with n₁, n₂, n₃, n₄, n₅, n₆, and n₇ as 1. It should be understood that R¹, R², R³, R⁴, R⁵, R⁶, R⁷ can also be set up in multiple ways:

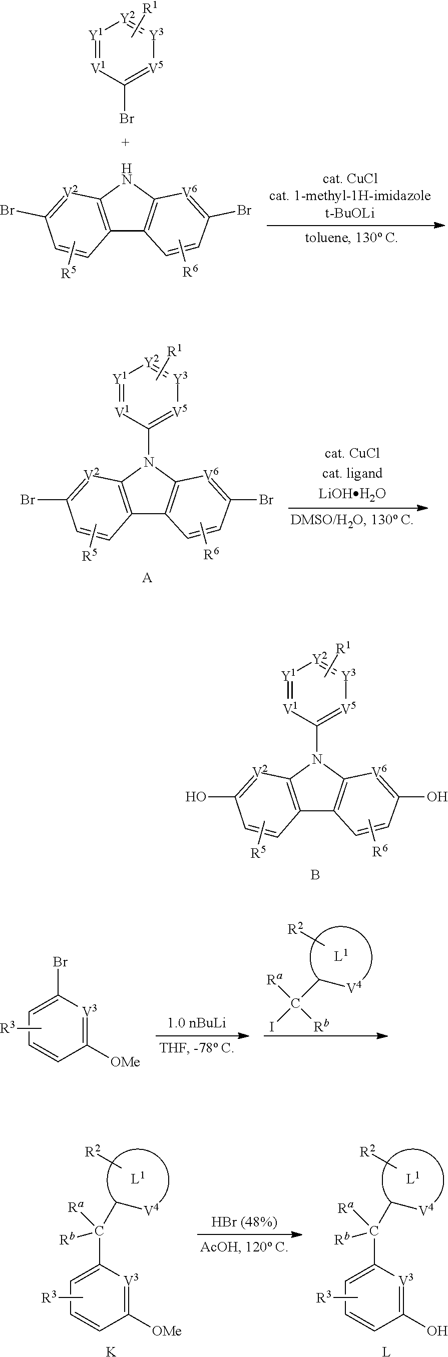

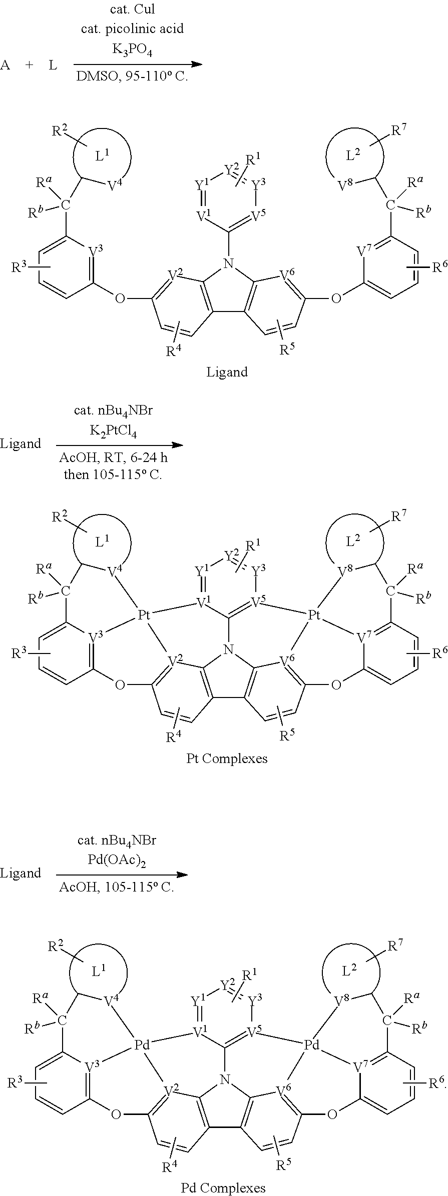

Embodiment of synthesis 1: Compound Pd1 and Compound Pt1 can be synthesized as follows:

(1) Synthesis of Compound A-1

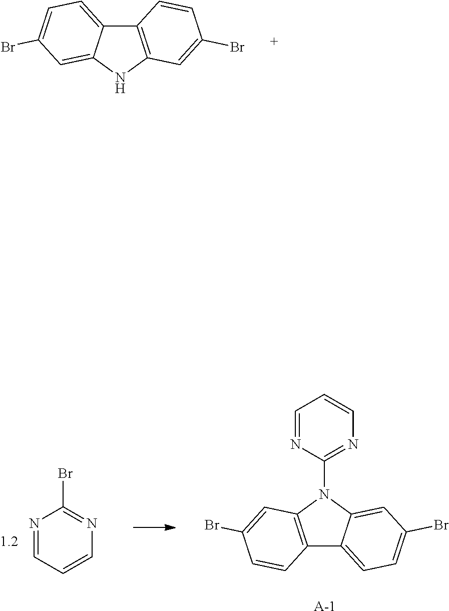 [SMILES: Brc1ccc2c(c1)[nH]c1cc(Br)ccc12 ; Brc1ncccn1 ; Brc1ccc2c3ccc(Br)cc3n(-c3ncccn3)c2c1 ; "A-1"]

2,7-dibromocarbazolium (1.66 g, 5.10 mmol, 1.0 equivalent), 2-bromopyrimidine (0.97 g, 6.10 mmol, 1.2 equivalent), cuprous iodide (19.4 mg, 0.10 mmol, 0.02 equivalent), Tert-butanol lithium butanol (0.82 g, 10.2 mmol, 2.0 mg/L) are added to the dry three-necked flask with a reflux condenser tube and a magnetic rotor in turn, and the nitrogen is pumped and exchanged for three times, then 1-methyl imidazolium (16.0 UL, 0.20 mmol, 0.04 equivalent) and toluene (20 mL) are added. The reaction mixture is agitated and refluxed at 130° C. for 1 day, and TLC thin layer chromatography is used to monitor the reaction of raw material 2,7-dibromocarbazole to complete the reaction. Saturated sodium sulfite solution is quenched, filtrated, and ethyl acetate is used for washing insoluble sufficiently, and the organic phase is separated from the mother liquid, and anhydrous sodium sulfate is dried, filtrated, and the solvent is removed by vacuum distillation. The crude product is selected and purified by silica gel column chromatography. The eluant (petroleum ether/dichloromethane=5:1-3:2) is obtained. The white solid obtained is 2.03 g, with the yield of 99%. ¹H NMR (500 MHz, DMSO-d₆): δ 7.47 (t, J=4.5 Hz, 1H), 7.58 (dd, J=8.5, 1.5 Hz, 2H), 8.22 (d, J=3.0 Hz, 2H), 9.02 (d, J=1.5 Hz, 2H), 9.05 (d, J=5.0 Hz, 2H). ¹³C NMR (100 MHz, CDCl₃): δ 116.66, 119.75, 120.47, 120.59, 124.00, 125.80, 139.81, 158.02, 158.60. HRMS (EI): calcd for C₁₆H₉N₃Br₂ [M]⁺ 400.9163, found 400.9178.

(2) Synthesis of Compound B-1

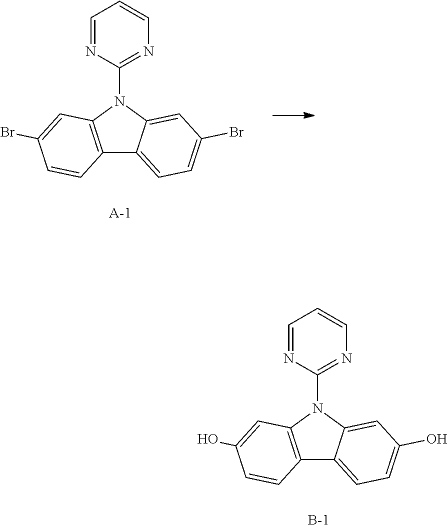

2,6-dibromo-9-(-2-pyrimidinyl) carbazolium (4.0g, 10.0 mmol, 1.0 equivalent), cuprous iodide (190.5 mg, 1.0 mmol, 0.10 equivalent), ligand N¹,N²-dihydroxy(4-hydroxyl-2,6-dimethylbenzene) oxalamide (328.3 mg). 1.00 mmol, 0.10 equivalent), lithium hydroxide monohydrate (4.2 g, (10.0) mmol, 10.0 equivalent) nitrogen are added into dry reaction tubes with magnetic rotors in turn, and it is pumped for three times. Then DMSO (70 mL) and deionized water (30 mL) are added. The reaction mixture is reacted at 110° C. for 3 days. TLC thin-layer chromatography is used to monitor 2,6-dibromo-9-(2-pyrimidinyl) carbazole. After cooling, 100 mL ethyl acetate and 100 mL deionized water are added to the reaction system, respectively, and transferred to the funnel solution, and the ethyl acetate is extracted by 50 (mL×3). The organic phase is combined with anhydrous sodium sulfate by drying, filtration, vacuum distillation, in order to remove the solvent, and the crude product is separated and purified by silica gel column chromatography. The eluent is obtained (petroleum ether/ethyl acetate=5:1-1:1). The white solid is 1.96 g, with the yield of 71%. ¹H NMR (500 MHz, DMSO-d₆): δ 6.77 (dd, J=8.5, 2.0 Hz, 2H), 7.38 (t, J=5.0 Hz, 1H), 7.78 (d, J=8.5 Hz, 2H), 8.19 (d, J=2.0 Hz, 2H), 8.97 (d, J=5.0 Hz, 2H), 9.46 (s, 2H). ¹³C NMR (126 MHz, DMSO-d₆): δ 102.80, 110.90, 116.71, 117.79, 119.03, 139.62, 115.66, 158.30, 158.44. HRMS (ESI): calcd for C₁₆H₁₂N₃O₂ [M+H]⁺ 278.0924, found 278.0916.

(3) Synthesis of Compound C-1

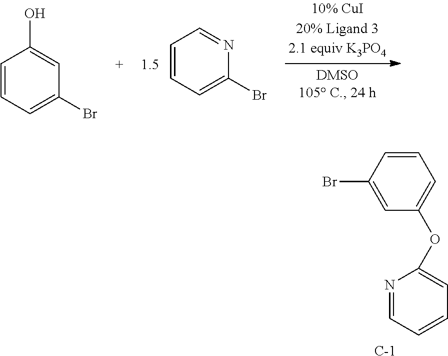

Copper iodide (571.3 mg, 3.0 mmol, 0.10 equivalent), ligand nicotinic acid (738.7 mg, 6.0 mmol, 0.20 equivalent), potassium phosphate (13.37 g, 63.0 mmol, 2.1 equivalent) are added to the dry three-necked flask with magnetic rotor nitrogen in turn, and the nitrogen is pumped and exchanged for three times, and then 3-bromophenol (5.19 g, 30.0 mmol, 1.0 equivalent), 2-bromopyridine (7.11 g, 45.0 mmol, 1.5 equivalent), DMSO (30 mL) are added in turn. The reaction mixture was agitated at 105° C. for 1 day to monitor 3-bromophenol by TLC thin-layer chromatography. After cooling, 20 mL ethyl acetate and 20 mL water are added for diluting, extracting and filtering, cleaning filter cake with ethyl acetate, cleaning DMSO in organic phase with water (100 mL), separating the organic phase from the liquid and separating the organic phase. The aqueous phase is extracted with ethyl acetate (50 mL×3), combined with organic phase, anhydrous sodium sulfate is dried, filtered, and the solvent is removed by vacuum distillation. The crude product is separated and purified by silica gel column chromatography. The eluent (petroleum ether/ethyl acetate=20:1-10:1) is used to obtain a yellowish liquid of 6.54 g with a yield of 93%. ¹H NMR (500 MHz, DMSO-d₆): δ 7.08 (dd, J=8.5 Hz, 1H), 7.14-7.18 (m, 2H), 7.36-7.43 (m, 3H), 7.88 (ddd, J=9.0, 8.0, 2.0 Hz, 1H), 8.17 (ddd, J=4.5, 2.0, 0.5 Hz, 1H).

(4) Synthesis of Ligands:

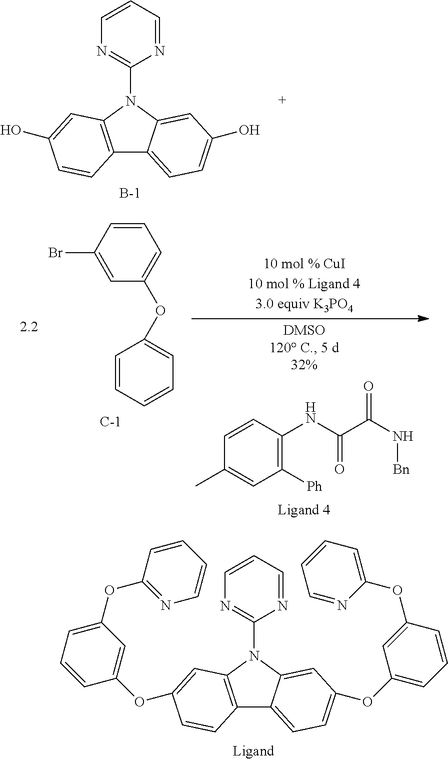

2,7-dihydroxy-9-(2-pyrimidinyl) carbazole (503.2 mg, (1.81) mmo, 1.0 equivalent) 2-(3-chloride)bromophenoxy) pyridine (998.4 mg, 3.99 mmol, 2.2 equivalent), iodide copper (34.5 mg, (0.18 mmol, 0.10 equivalent), ligand 4 (62.3 mg, 0.18 mmol, 0.10 equivalent), potassium phosphate (1.15 g, 5.43 mmol, 3.0 equivalent) are added to the dry three-decked flask with magnetic rotor, and the nitrogen is pumped and exchangeed for three times, then DMSO (5.0 mL) is added. The reaction mixture is agitated at 120° C. for 5 days. TLC thin-layer chromatography is used to monitor the 2,7-dihydroxy-9-(2-pyrimidinyl) carbazole. After cooling, 40 mL DCM and 40 mL water are added for separating the organic phase, separating the organic phase, extracting the aqueous phase with DCM, combining with the organic phase, drying and filtering the anhydrous sodium sulfate. The solvent is removed by vacuum distillation. The crude product is separated and purified by silica gel column chromatography. The eluent (petroleum ether/ethyl acetate=5:1-3:1) is used to obtain a light yellow viscous liquid of 400.7 mg, wiht 32% yield. ¹H NMR (500 MHz, DMSO-d₆): δ 6.80 (t, J=2.0 Hz, 2H), 6.86-6.89 (m, 4H), 7.03 (dt, J=8.5, 1.0 Hz, 2H), 7.11-7.16 (m, 4H), 7.39-7.42 (m, 3H), 7.83(ddd, J=9.5, 7.5, 2.5 Hz, 2H), 8.15 (ddd, J=5.0, 2.0,1.0 Hz, 2H), 8.22 (d, J=8.5 Hz, 2H), 8.58 (d, J=2.5 Hz, 2H), 8.93 (d, J=5.0 Hz, 2H).

(5) Synthesis of Metal Pd Complex Compound Pd1:

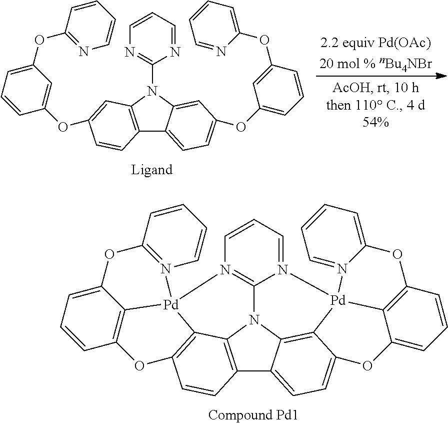

The ligand (176.8 mg, 0.29 mmol, 1.0 equivalent), Pd(AcO)₂ (143.2 mg, 0.64 mmol, 2.2 equivalent) and ⁿBu₄NBr (18.7 mg, 0.06 mmol, 0.2 equivalent) are added to the reaction tube with magnetic force rotor in turn. The nitrogen is pumped and exchanged for three times, and then 35 mL solvent acetic acid is added. The reaction mixture is stirred at room temperature for 10 hours and then at 110° C. for 4 days. The reaction mixture is cooled to room temperature and the solvent is removed by vacuum distillation. The crude product is separated and purified by silica gel column chromatography. The eluent is (petroleum ether/dichloromethane=1:1-1:8). Yellow solid 128.3 mg is obtained, with 54% yield. ¹H NMR (500 MHz, DMSO-d₆): δ 6.92 (dd, J=7.5, 1.0 Hz, 2H), 6.97 (dd, J=7.5, 1.0 Hz, 2H), 7.05 (t, J=5.5 Hz, 1H), 7.18 (t, J=7.5 Hz, 2H), 7.24 (d, J=8.5 Hz, 2H), 7.33-7.36 (m, 2H), 7.50 (d, J=8.0 Hz, 2H), 7.89 (d, J=8.5 Hz, 2H), 8.11-8.15 (m, 2H), 8.45 (dd, J=5.5, 1.0 Hz, 2H), 8.96 (d, J=5.5 Hz, 2H). MS (MALDI): calcd for C₃₈H₂₁N₅O₄Pd₂ [M]⁺ 823.0, found 823.0.

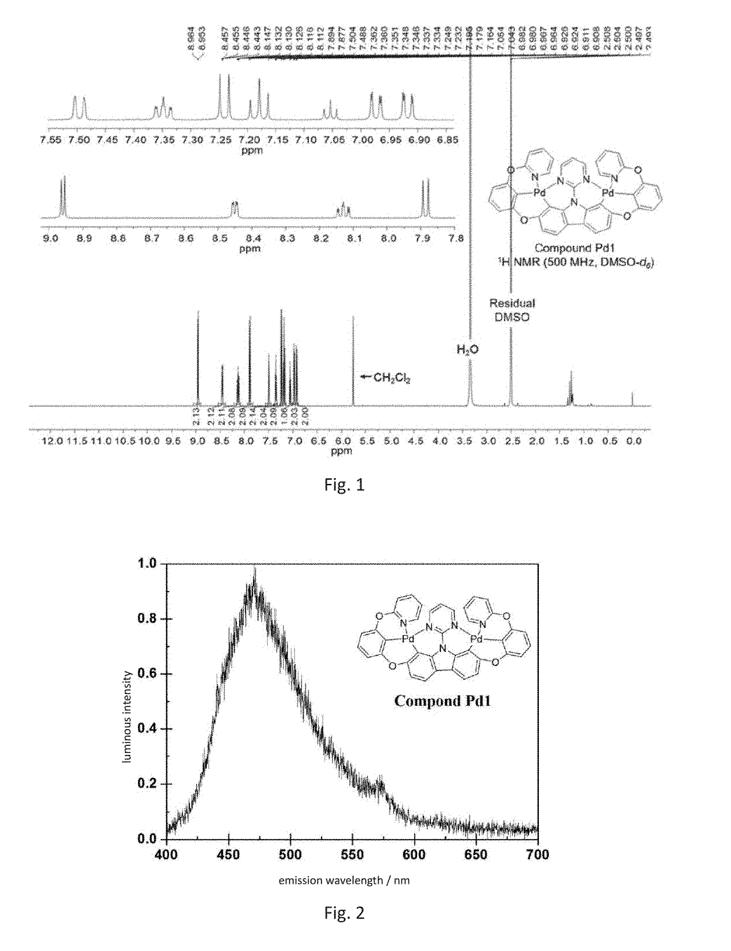

The ¹H NMR spectrum of Compound Pd1 in DMSO-d6 is shown in FIG. 1.

The luminescence spectra of Compound Pd1 at room temperature are shown in FIG. 2 (the luminous intensity is converted by normalized method and the main emission peak is 470 nm), which is a blue luminescent material.

(6) Synthesis of Metal Pt Complex Compound Pt1:

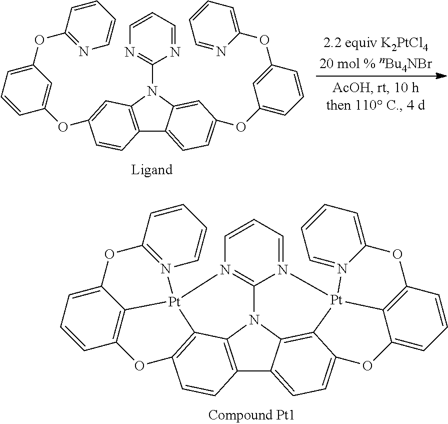

The ligand (176.8 mg, 0.29 mmol, 1.0 equivalent), K₄PtCl₄ (265.0 mg,0.64 mmol, 2.2 equivalent) and ⁴Bu₄NBr (18.7 mg, 0.06 mmol, 0.2 equivalen) obtained from above are added to the reaction tube with magnetic force rotor in turn, and then the nitrogen is pumped and exchanged for three times, and then 35 mL solvent acetic acid is added. The reaction mixture was stirred at room temperature for 10 hours and then at 110° C. for 4 days. The reaction mixture is cooled to room temperature and the solvent is removed by vacuum distillation. The crude product is separated and purified by silica gel column chromatography. The eluent is (petroleum ether/dichloromethane=1:1-1:8). The brown red solid is obtained by 45.1 mg, with 16% yield. MS (MALDI): calcd for C₃₈H₂₁N₅O₄Pt₂ [M]⁺ 1001.1, found 1001.1.

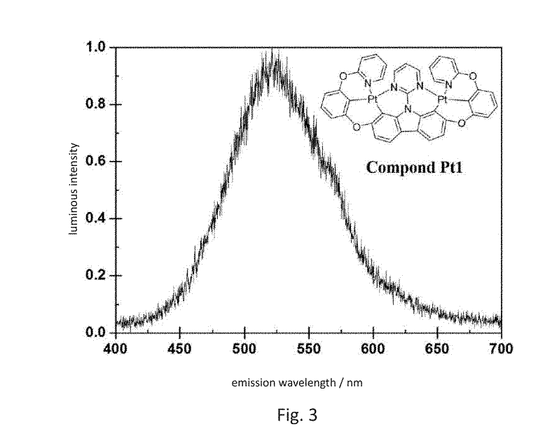

The luminescence spectra of Compound Pt1 at room temperature are shown in FIG. 3 (the luminescence intensity is converted by normalized method and the main emission peak is 525 nm), which is a kind of green luminescent material.

The binuclear organometallic complexes of the embodiment of the present invention are adapted to various organic electronic components, e.g.: optical and optoelectronic devices, including, but not limited to organic light emitting diodes (OLED), light emitting diodes (LED), compact fluorescent lamps (CFL), incandescent Lampes, organic photovoltaic cells (OPV), organic field effect transistors (OFET) or luminescent electrochemical cell (LEEC).

In addition, the binuclear organometallic complexes of the embodiment of the invention can also be used as biomarkers or imaging techniques.

Binuclear organometallic complexes of the embodiment of the present invention may be used in lighting devices, e.g.: organic luminescent devices, in order to provide better efficiency and/or service life than traditional materials.

The binuclear organometallic complexes of the embodiment of the invention are used as phosphorescent materials and delayed fluorescent luminescent materials, and can be used in organic light-emitting diodes (OLED), light-emitting devices, displays and other light-emitting devices.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A binuclear organometallic complex being selected from at least one of the compounds from the general formula I: 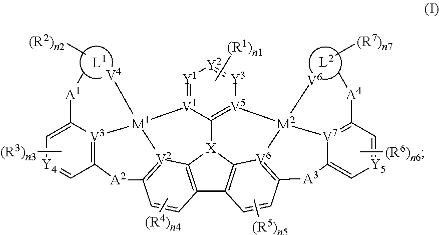
where, M¹ and M² are selected from platinum or palladium independently, respectively;
L¹ and L² denote C₆˜C₁₈ aromatic rings, C₃˜C₁₈ heterocycles and C₄˜C₈ aliphatic heterocycles independently, respectively;
V¹, V², V³, V⁴, V⁵, V⁶, V⁷ and V⁸ are selected from nitrogen or carbon atoms independently, respectively, and
at least two of V¹, V², V³ and V⁴ are nitrogen atoms, and at least two of V⁵, V⁶, V⁷ and V⁸ are nitrogen atoms;
Y¹, Y², Y³, Y⁴ and Y⁵ are selected from nitrogen or carbon atoms independently, respectively.
A¹, A², A³ and A⁴ are selected from —O—, —S—, —CH₂—, —CD₂-, —CR^{a}R^{b}—, —C(═O)—, —SiR^{a}R^{b}—, —GeH₂—, —GeR^{a}R^{b}—, —NH—, —NR^{c}—, —PH—, —PR^{c}—, —R^{c}P(═O)—, —AsR^{c}—, —R^{c}As(═O)—, —S(═O)—, —SO₂—, —Se—, —Se(═O)—, —SeO₂—, —BH—, —BR^{c}—, —R^{c}Bi(═O)—, —BiH—, or —BiR^{c}— independently, respectively;
X is selected from 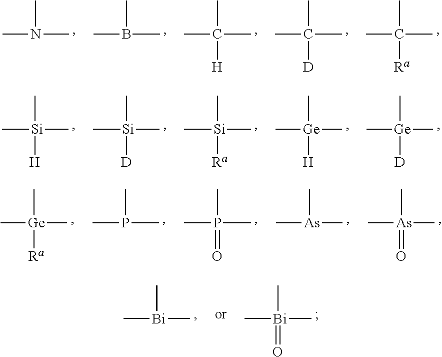
R¹, R², R³, R⁴, R⁵, R⁶, R⁷, R^{a}, R^{b}, R^{c} and R^{d} are selected from hydrogen, deuterium, halogen, hydroxyl, mercapto, nitro, cyanide, amino, carboxyl, sulfonyl, sulfoxyl, sulfoxyl, sulfoxyl, hydrazine, ureyl, substituted or unsubstituted C₁˜C₂₄ alkyl, substituted or unsubstituted C₂˜C₂₄ alkyl, substituted or unsubstituted C₂˜C₂₄ alkynyl, substituted or unsubstituted C₆˜C₃₆ aryl, substituted or unsubstituted C₃˜C₁₈ heterocyclic, substituted or unsubstituted C₃˜C₃₆ hetero aryl, substituted or unsubstituted C₁˜C₂₄ alkoxy, substituted or unsubstituted C₁˜C₂₄ alkyl thioyl, substituted or unsubstituted C₂˜C₂₄ enoxy, substituted or unsubstituted C₂˜C₂₄ alkyloxy, substituted or unsubstituted C₆˜C₃₆ aryl oxygen group, substituted or unsubstituted C₂˜C₂₄ alkoxy carbonyl, substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl group, substituted or unsubstituted C₁˜C₃₆ sulfonylamino, substituted or unsubstituted C₁˜C₃₆ phosphoryl amine, substituted or unsubstituted C₂˜C₂₄ alkoxy carbonyl amine, substituted or unsubstituted C₇˜C₃₇ aryoxy carbonyl amino groups, substituted or unsubstituted methylsilyl alkyl, substituted or unsubstituted C₁˜C₁₈ monoalkylamines, substituted or unsubstituted C₂˜C₃₆ dialkylamino, substituted or unsubstituted C₆˜C₃₆ monoaryl amine, substituted or unsubstituted C₁₂˜C₇₂ bis aryl amine, C₁˜C₃₆ and C₂˜C₃₆ substituted or unsubstituted; the substituents are selected from deuterium, halogen, hydroxyl, sulfhydryl, nitro, cyano, amino, carboxyl, sulfonyl, hydrazine, ureyl, C₁˜C₆ alkyl, C₆˜C₁₂ aryl group independently, respectively; two or more adjacent R¹, R², R³, R⁴, R⁵, R⁶ and R⁷ can be connected into rings; and
n₁, n₂, n₃, n₄, n₅, n₆, and n₇ are selected from integer 1˜4 independently, respectively.

2. The binuclear organometallic complex as described in claim 1, wherein the compounds shown in the general formula I are selected from the groups composed of compounds indicated in the general formula IA and the general formula IB:

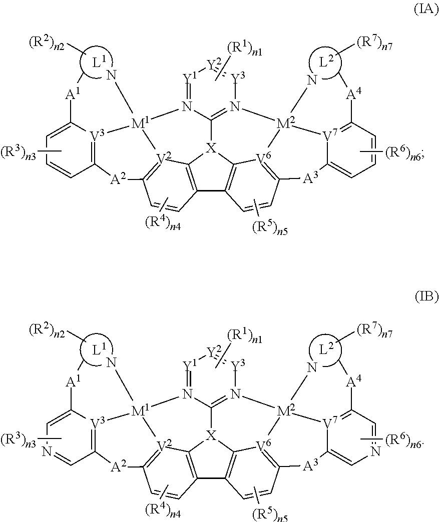

3. The binuclear organometallic complex described in claim 2 are characterized in that the compounds shown in the general formula IA are selected from the groups composed of compounds shown in the general formula IAa, the general formula IAb, the general formula IAc and the general formula IAd:

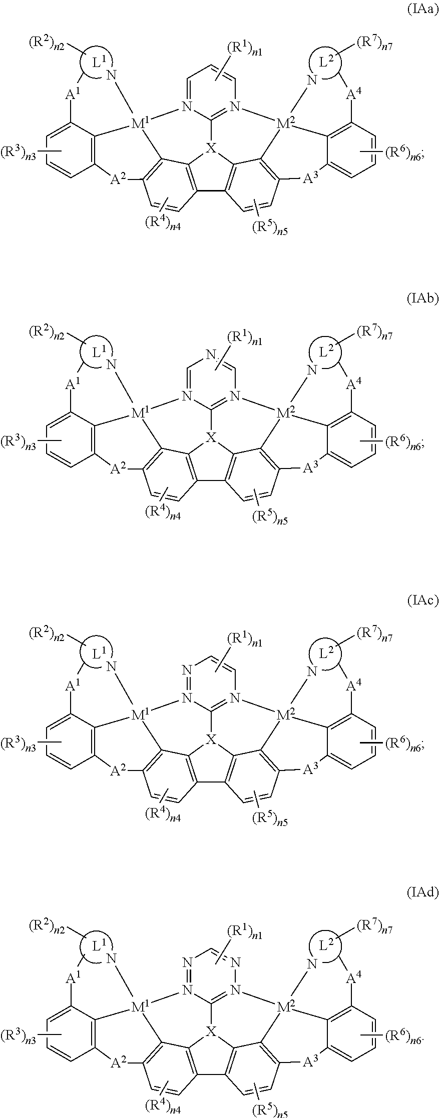

4. The binuclear organometallic complex as described in claim 3, wherein the compounds shown in the general formula IAa are selected from the groups composed of the compounds shown in the general formula IAa1, the general formula IAa2, the general formula IAa3, the general formula IAa4, the general formula IAa5: 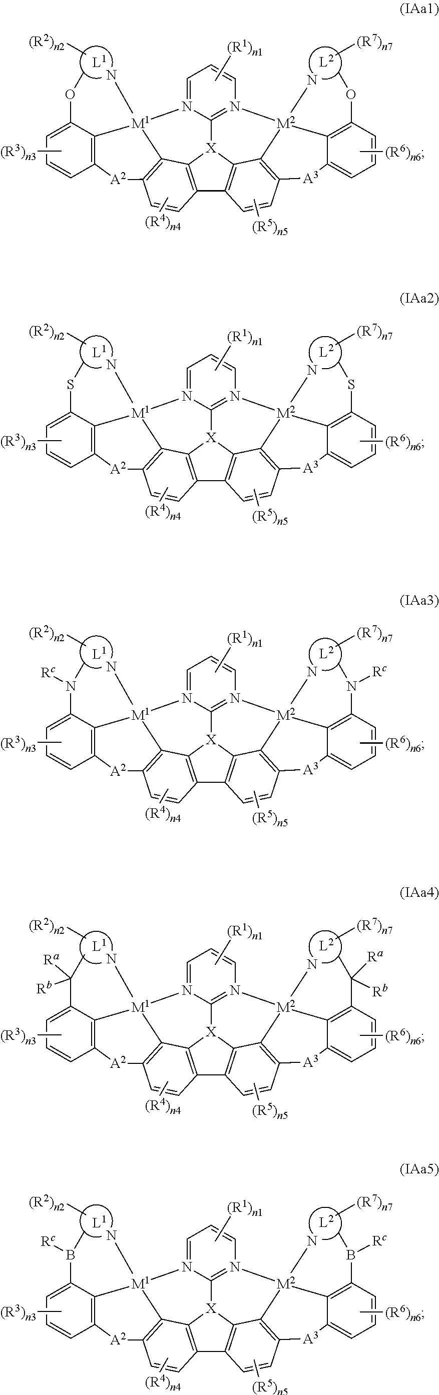
in which, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, Substituted or unsubstituted C₃˜C₃₆ hetero aryl group independently, respectively, and the substituents are selected from C₁˜C₆ alkyl and C₆˜C₁₂ aryl groups independently, respectively.

5. The binuclear organometallic complexes described in claim 4 are characterized in that the compounds shown in the general formula IAa1 are selected from the groups composed of compounds shown in the general formula IAa11, the general formula IAa12, the general formula IAa13, the general formula IAa14, the general formula IAa15, the general formula IAa16, the general formula IAa17 and the general formula IAa18:

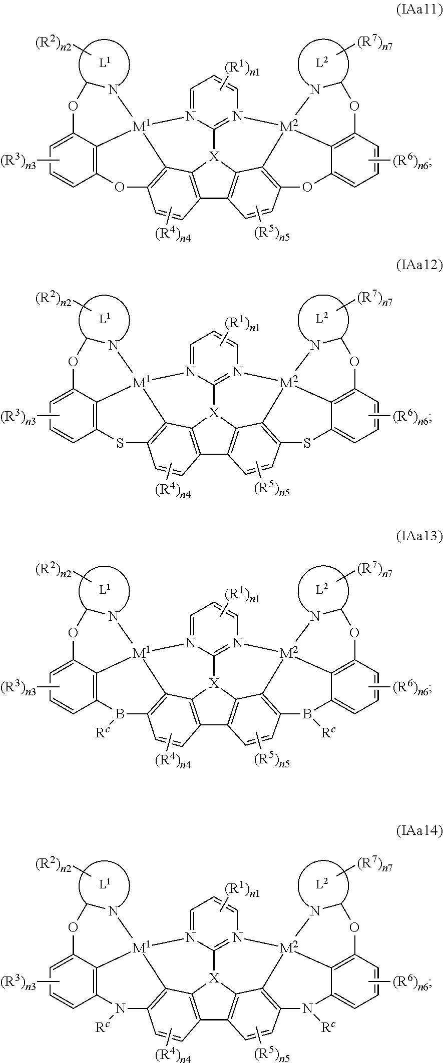

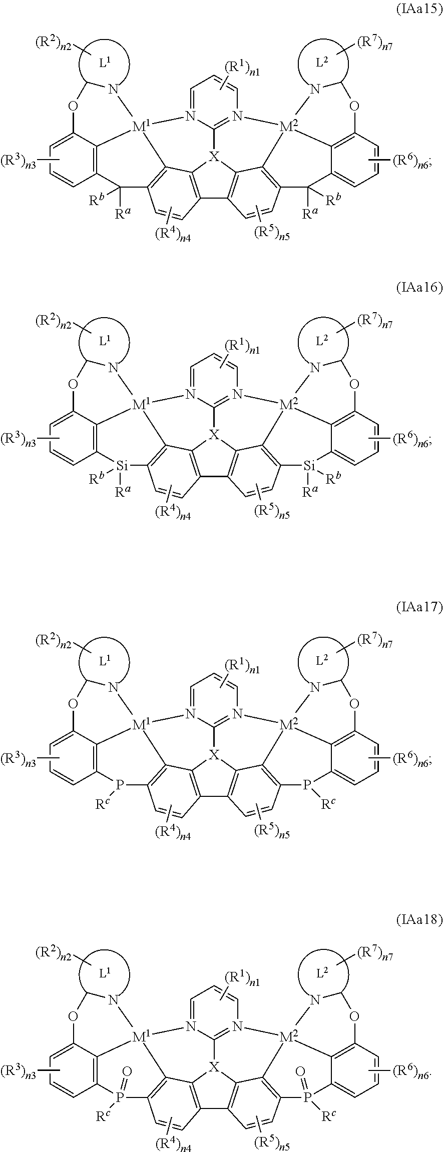

6. The binuclear organometallic complex as described in claim 5, wherein the compounds shown in the general formula IAa11 are selected from the groups composed of compounds shown in the general formula IAa111, IAa112, the general formula IAa113, the general formula IAa114, the general formula IAa115, the general formula IAa116, the general formula IAa116, the general formula IAa117 and the general formula IAa118:

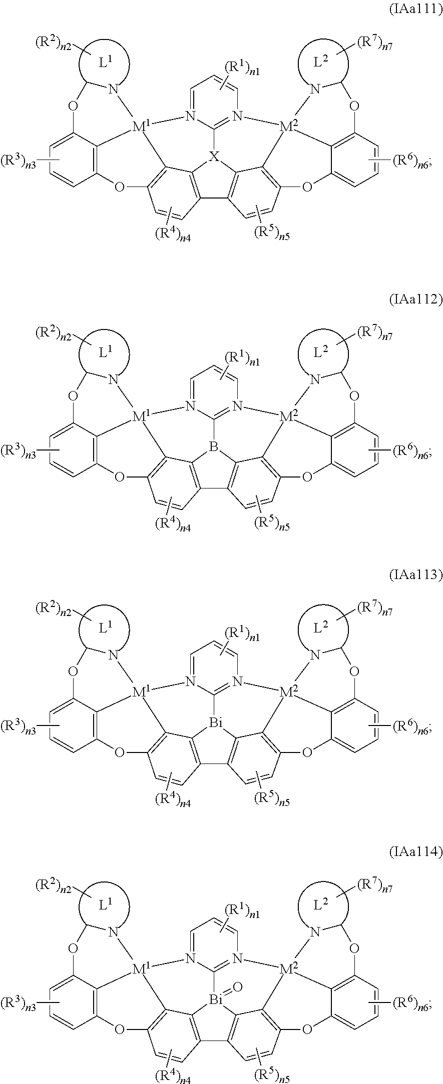

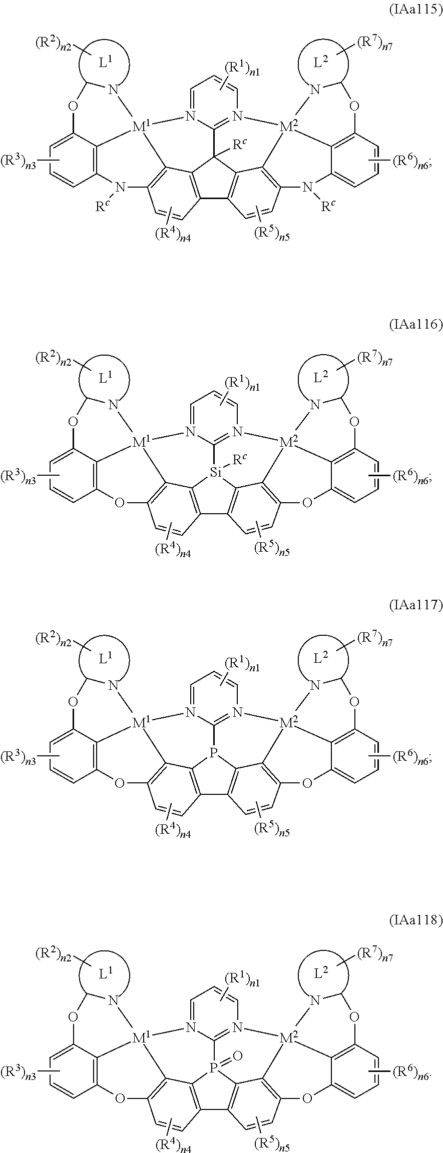

7. The binuclear organometallic complex as described in claim 3, wherein the compounds shown in the general formula IAb are selected from the compounds composed of the compounds shown in the general formula IAb1, the general formula IAb2, the general formula IAb3, the general formula IAb4, the general formula IAb5: 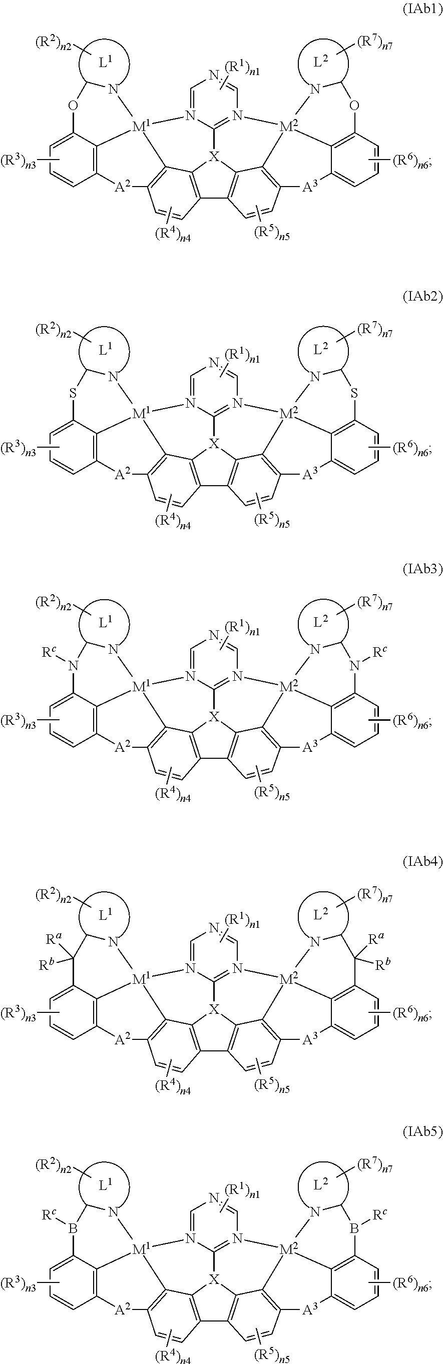
where, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

8. The binuclear organometallic complex as described in claim 7, wherein the compounds shown in the general formula IAb1 are selected from the groups composed of compounds shown in the general formula IAb11, the general formula IAb12, the general formula IAb13, the general formula IAb14, the general formula IAb15, the general formula IAb16, the general formula IAb17 and the general formula IAb18:

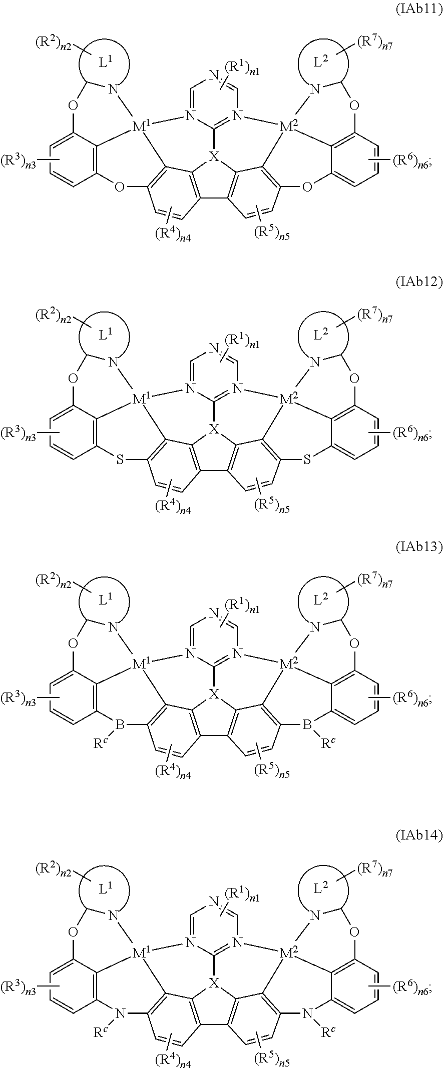

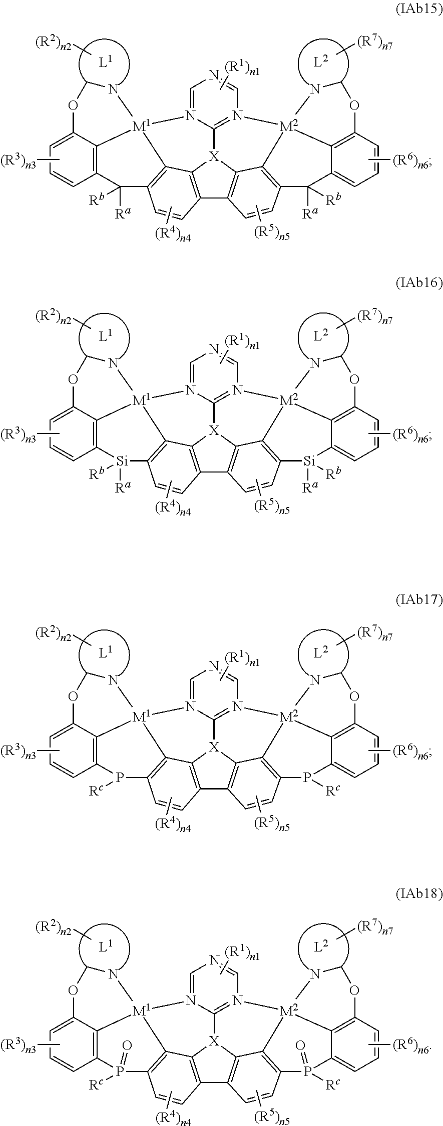

9. The binuclear organometallic complex as described in claim 8, wherein the compounds shown in the general formula IAb11 are selected from the groups composed of compounds shown in the general formula IAb111, IAb112, the general formula IAb113, the general formula IAb114, the general formula IAb115, the general formula IAb116, the general formula IAb117 and the general formula IAb118:

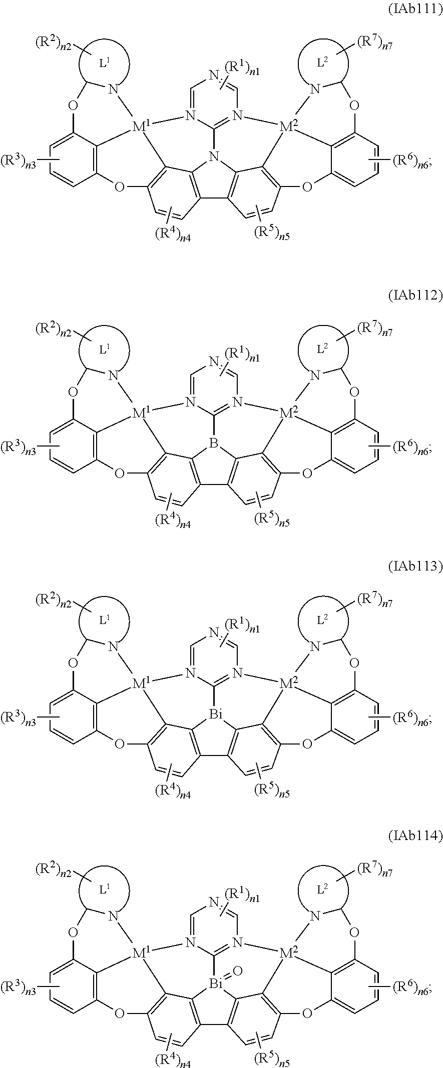

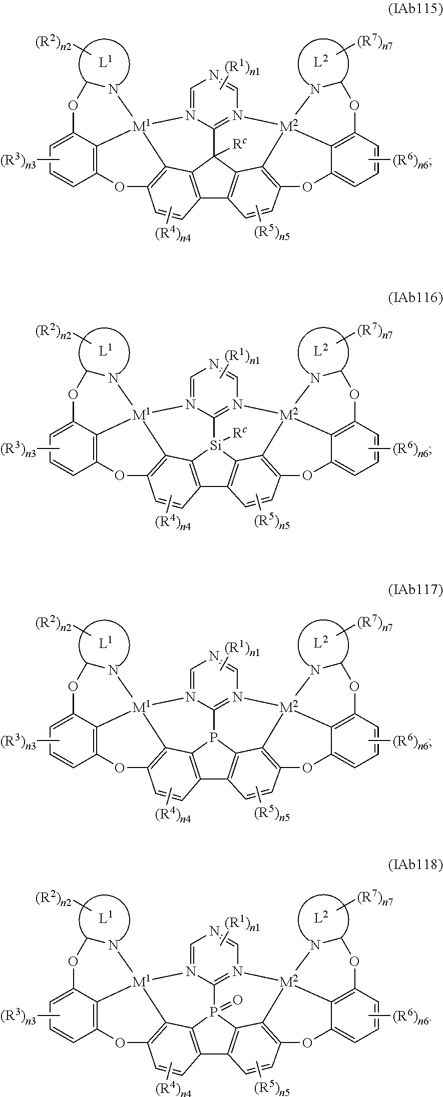

10. The binuclear organometallic complex as described in claim 3, wherein the compounds shown in the general formula IAc are selected from the groups composed of the compounds shown in the general formula IAc1, the general formula IAc2, the general formula IAc3, the general formula IAc4, the general formula IAc5: 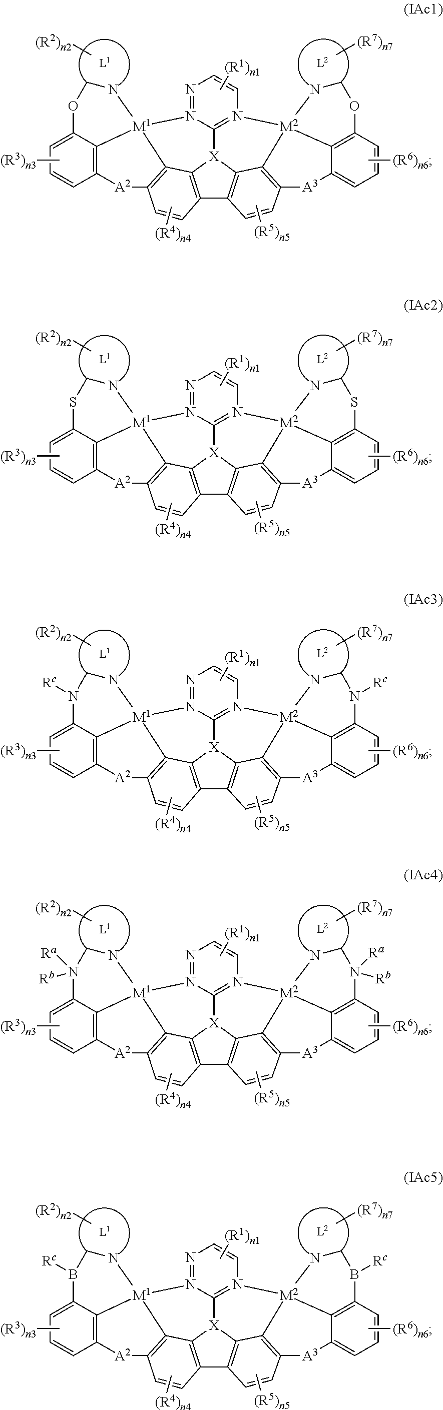
in which, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

11. The binuclear organometallic complex as described in claim 10, wherein the compounds shown in the general formula IAc1 are selected from the groups composed of compounds shown in the general formula IAc11, the general formula IAc12, the general formula IAc13, the general formula IAc14, the general formula IAc15, the general formula IAc16, the general formula IAc17 and the general formula IAc18:

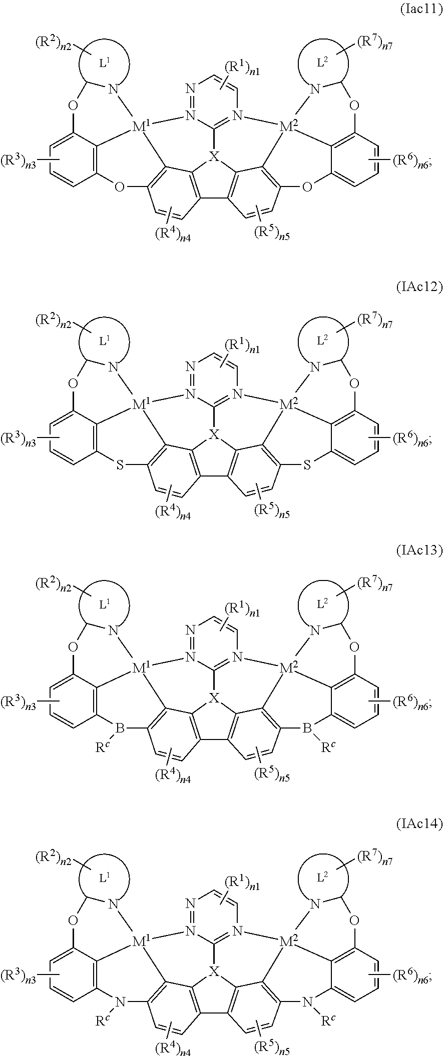

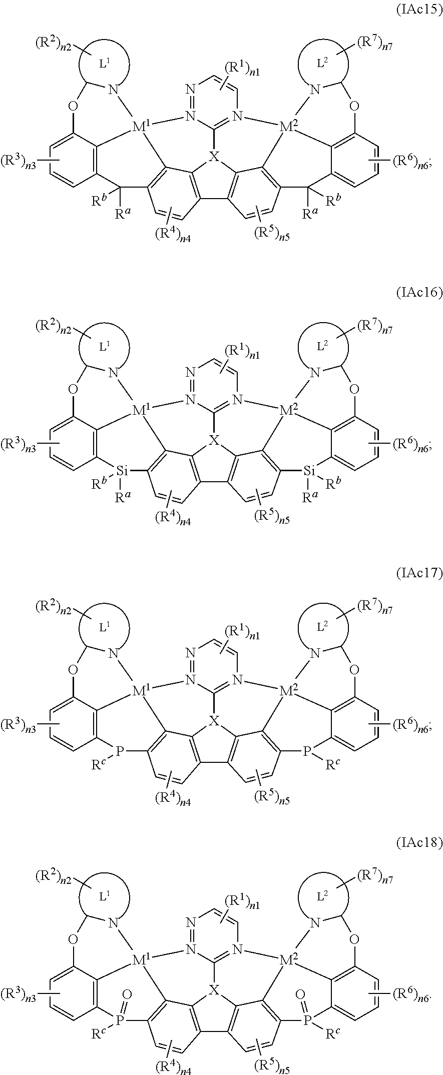

12. The binuclear organometallic complex as described in claim 11, wherein the compounds shown in the general formula IAc11 are selected from the groups composed of compounds shown in the general formula IAc111, IAc112, the general formula IAc113, the general formula IAc114, the general formula IAc115, the general formula IAc116, the general formula IAc117 and the general formula IAc118:

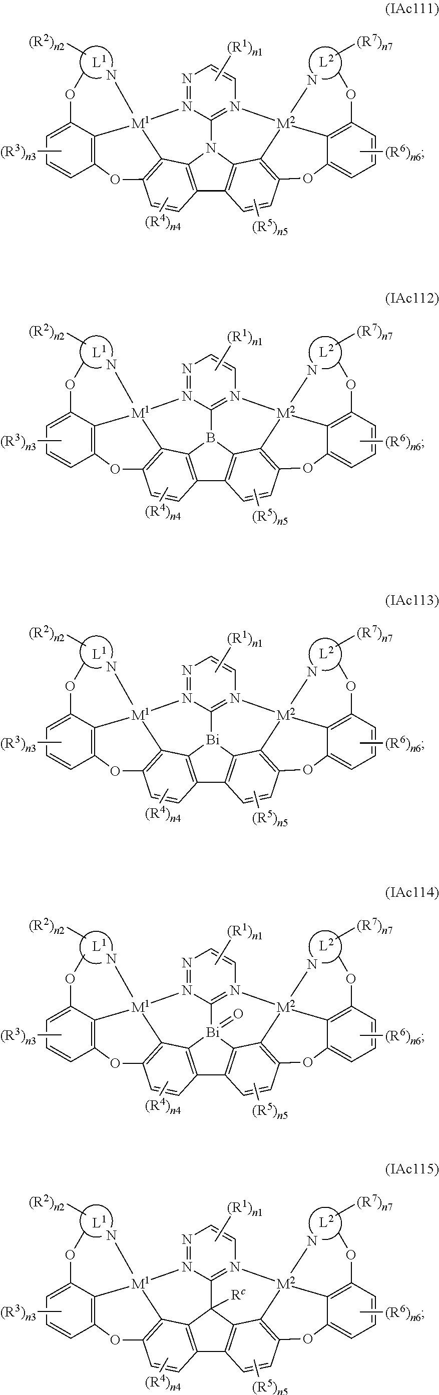

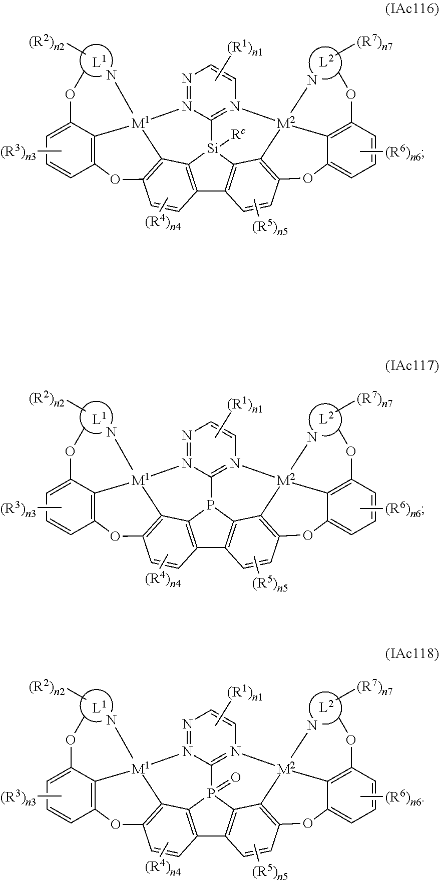

13. The binuclear organometallic complex as described in claim 3, wherein the compounds shown in the general formula IAd are selected from the groups composed of the compounds shown in the general formula IAd1, the general formula IAd2, the general formula IAd3, the general formula IAd4, the general formula IAd5: 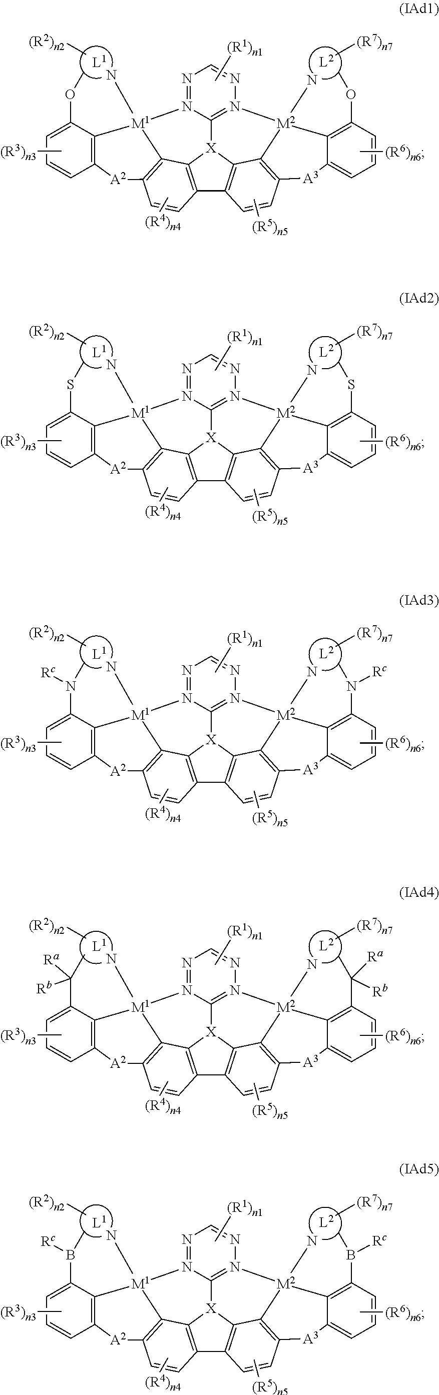
in which, R^{a}, R^{b} and R^{c} are selected from substituted or unsubstituted C₁˜C₁₈ alkyl, substituted or unsubstituted C₆˜C₃₆ aryl group, substituted or unsubstituted C₃˜C₁₈ heterocyclic group, substituted or unsubstituted C₃˜C₃₆ hetero aryl group and substituents are selected from C₁˜C₆ alkyl and C₆˜C₁₂ aryl groups independently, respectively.

14. The binuclear organometallic complex as described in claim 13, wherein the compounds shown in the general formula IAd1 are selected from the groups composed of compounds shown in the general formula IAd11, the general formula IAd12, the general formula IAd13, the general formula IAd14, the general formula IAd15, the general formula IAd16, the general formula IAd17 and the general formula IAd18:

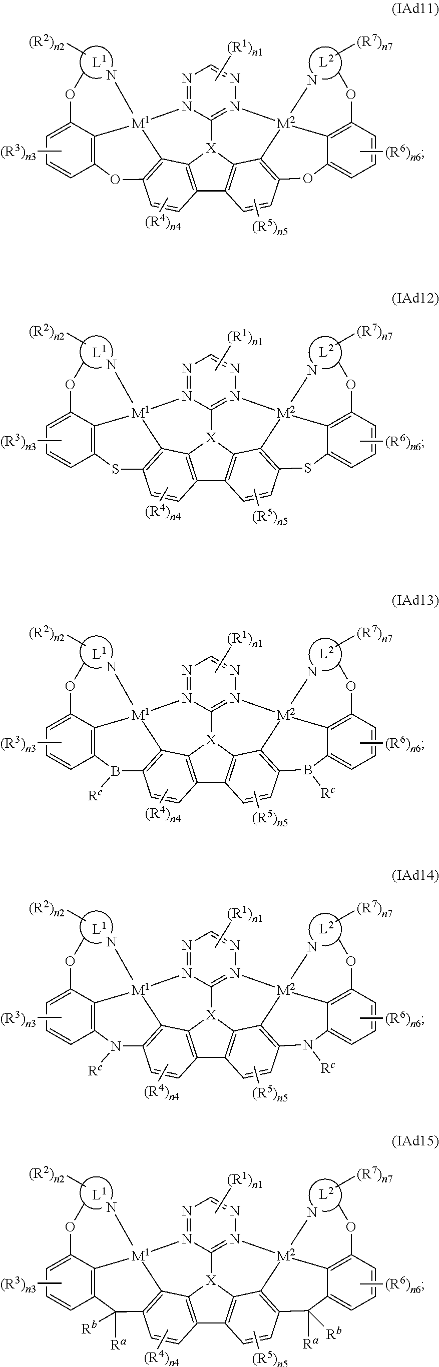

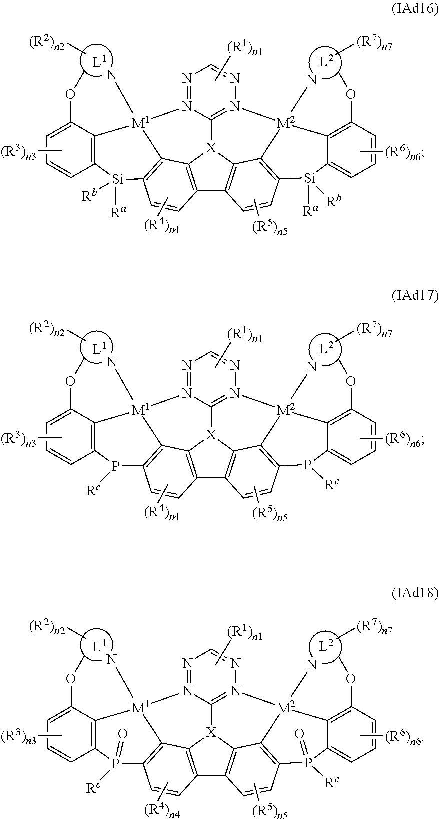

15. The binuclear organometallic complex as described in claim 14, wherein the compounds shown in the general formula IAd11 are selected from the groups composed of compounds shown in the general formula IAd111, IAd112, the general formula IAd113, the general formula IAd114, the general formula IAd115, the general formula IAd116, the general formula IAd117 and the general formula IAd118:

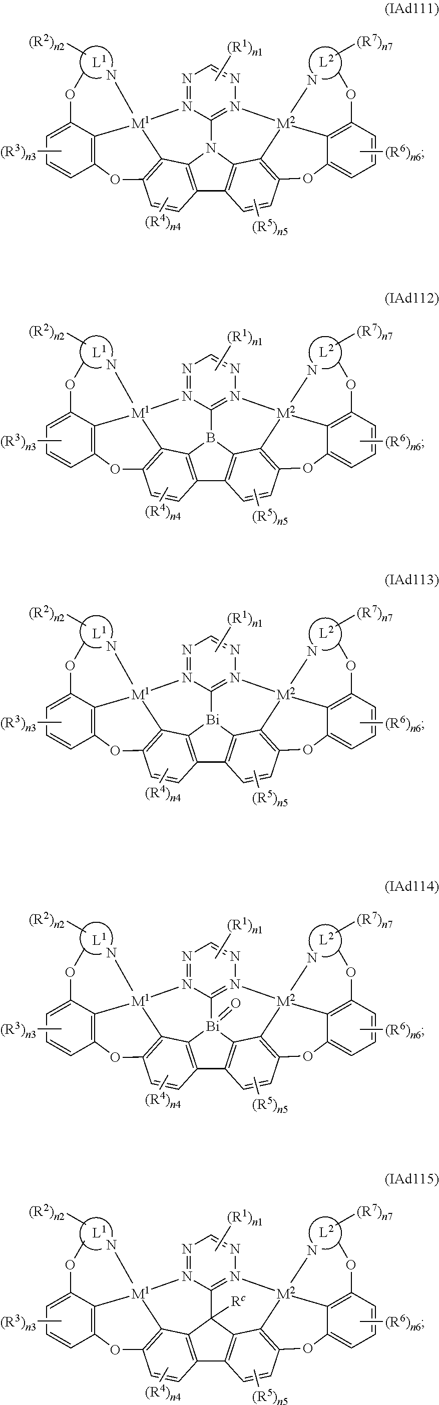

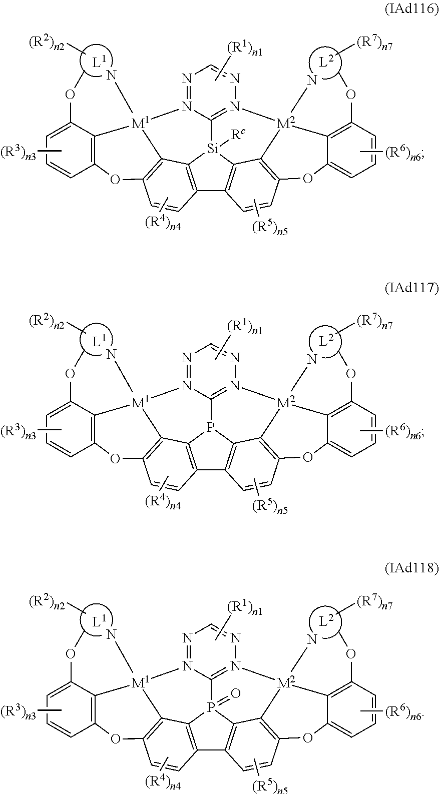

16. The binuclear organometallic complex as described in claim 2, wherein compounds shown in the general formula IB are selected from the compounds shown in the general formula IBa:

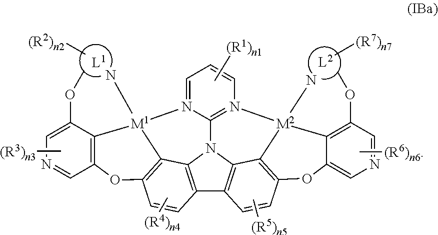

17. The binuclear organometallic complex as described in claim 3, wherein each of L¹ and L² represents a ring of the following structural expressions independently:

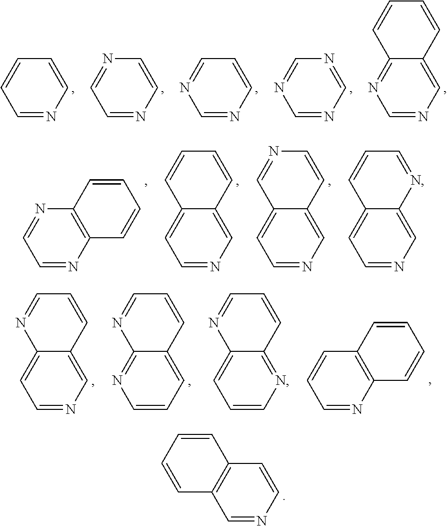

18. The binuclear organometallic complex as described in claim 3, wherein R¹ is selected from at least one of the following substituents:
halogen, deuterium, methyl sulfonyl group, C₁˜C₆ alkyl, C₁˜C₆ deuteroalkyl, C₁˜C₆ fluoroalkyl, C₁˜C₆ alkoxy, phenyl, 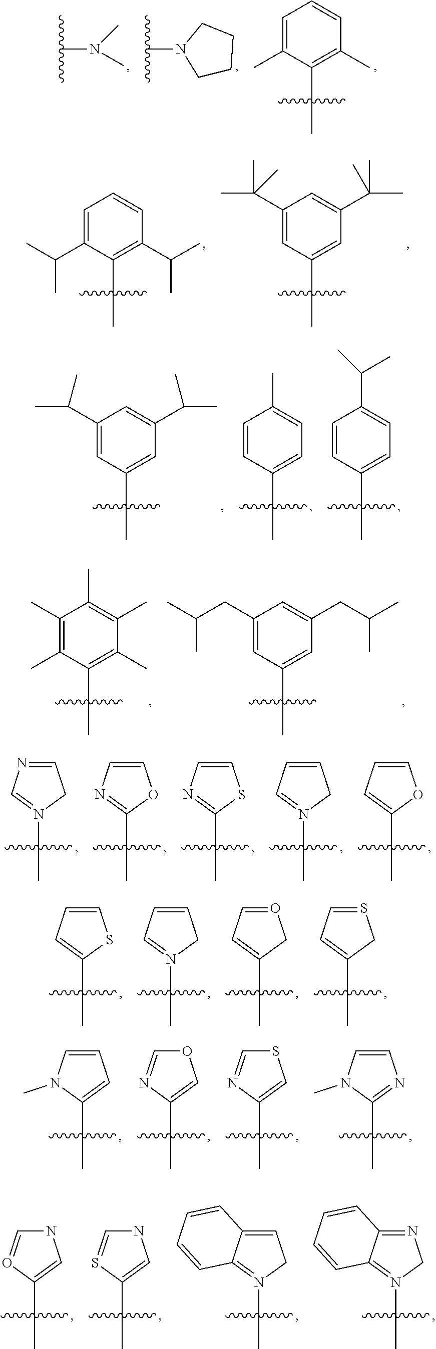 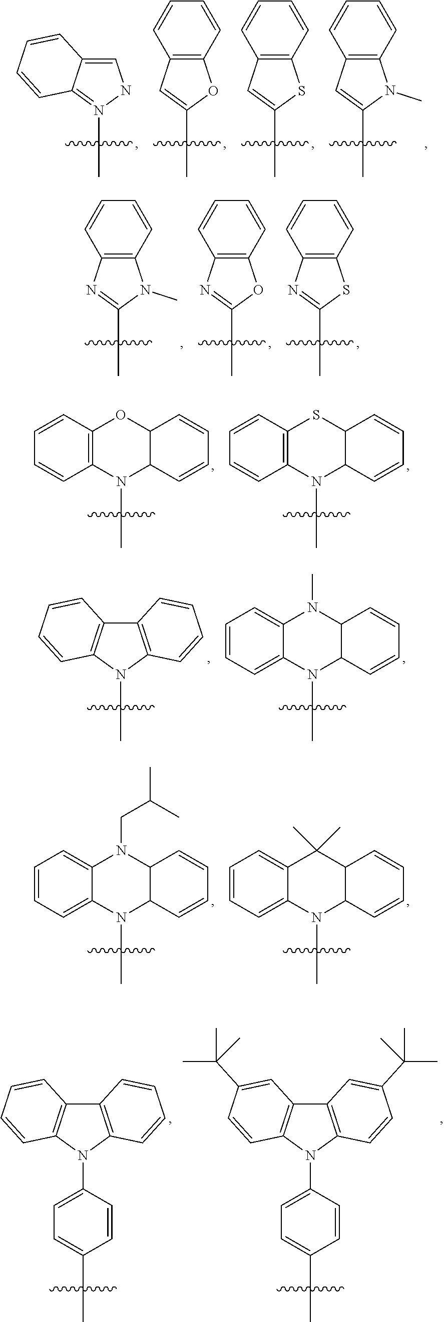 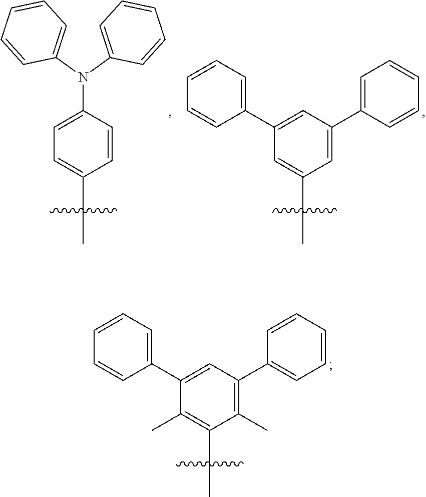
when two or more adjacent R¹ are connected into a ring: the ring formed by R¹ is selected from: benzene ring, cyclopentane, cyclohexane, cyclohexane,

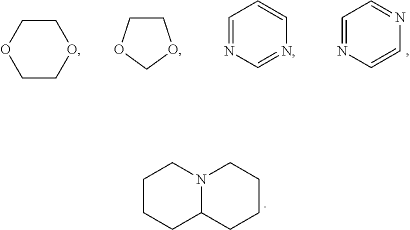 [SMILES: C1COCCO1 ; C1COCO1 ; c1cncnc1 ; c1cnccn1 ; C1CCN2CCCCC2C1]

19. The binuclear organometallic complex as described in claim 1 being selected from Compound Pt1˜Compound Pt441, Compound Pd1˜Compound Pd441, Compound PtPd1˜Compound PtPd441;
in which, R^{x} is selected from hydrogen, deuterium, halogen, hydroxyl, mercapto, nitro, cyanide, amino, carboxyl, sulfonyl, hydrazine, ureyl, substituted or unsubstituted C₁˜C₂₄ alkyl, substituted or unsubstituted C₂˜C₂₄ alkenyl, substituted or unsubstituted C₂˜C₂₄ alkynyl, substituted or unsubstituted C₆˜C₃₆ aryl group, substituted or unsubstituted C₃˜C₁₈ heterocyclic group, substituted or unsubstituted C₃˜C₃₆ hetero-aryl, substituted or unsubstituted C₁˜C₂₄ alkoxy, substituted or unsubstituted C₁˜C₂₄ alkyl thioyl, substituted or unsubstituted C₂˜C₂₄ oxy, substituted or unsubstituted C₂˜C₂₄ alkynyl, substituted or unsubstituted C₆˜C₃₆ aryl, substituted or unsubstituted C₂˜C₂₄ alkoxy carbonyl, substituted or unsubstituted C₂˜C₃₆ ester, substituted or unsubstituted C₂˜C₃₆ amide, substituted or unsubstituted C₁˜C₃₆ sulfonyl group, substituted or unsubstituted C₁˜C₃₆ sulfonyl group, substituted or unsubstituted C₁˜C₃₆ sulfonylamino, substituted or unsubstituted C₁˜C₃₆ phosphoryl amine, substituted or unsubstituted C₂˜C₂₄ alkoxy carbonyl amine, substituted or unsubstituted C₇˜C₃₇ aryoxy carbonyl amino groups, substituted or unsubstituted methylsilyl alkyl, substituted or unsubstituted C₁˜C₁₈ monoalkylamines, substituted or unsubstituted C₂˜C₃₆ dialkylamino, substituted or unsubstituted C₆˜C₃₆ monoaryl amine, substituted or unsubstituted C₁₂˜C₇₂ bis aryl amine, substituted or unsubstituted C₁˜C₃₆ ureylene, substituted or unsubstituted C₂˜C₃₆ imino; the substituents are selected from deuterium, halogen, hydroxyl, mercapto, nitro, cyanide, amino, carboxyl, sulfonyl, hydrazine, ureyl, C₁˜C₆ alkyl, C₆˜C₁₂ aryl group.

20. The binuclear organometallic complex as described in claim 1 being electrically neutral.
